(19) United States
(12) Patent Application Publication
(10) Pub. No.: US 2007/0081197 A1
(43) Pub. Date: Apr. 12, 2007

(54) SYSTEM AND METHOD FOR SEMANTIC KNOWLEDGE RETRIEVAL, MANAGEMENT, CAPTURE, SHARING, DISCOVERY, DELIVERY AND PRESENTATION

(76) Inventor: Nosa Omoigui, Redmond, WA (US)

Correspondence Address: BLACK LOWE & GRAHAM, PLLC, 701 FIFTH AVENUE, SUITE 4800, SEATTLE, WA, 98104, US

(21) Appl. No.: 11/462,688

(22) Filed: Aug. 4, 2006

Related U.S. Application Data
(63) Continuation of application No. 10/781,053, filed on Feb. 17, 2004.
Application No. 10/781,053 is a continuation-in-part of application No. 10/179,651, filed on Jun. 24, 2002.
(60) Provisional application No. 60/360,610, filed on Feb. 28, 2002.
(60) Provisional application No. 60/300,385, filed on Jun. 22, 2001.

(51) Int. Cl. H04N 1/00

(52) U.S. Cl. 358/403; 358/1.15

(57) ABSTRACT

The present invention is directed to an integrated implementation framework and resulting medium for knowledge retrieval, management, capture, sharing, discovery, delivery and presentation. The system is responsible for maintaining semantic information.

### PRIORITY CLAIM

This application is a Continuation of U.S. application Ser. No. 10/781,053 filed Feb. 17, 2004. This application is also a Continuation-In-Part of U.S. application Ser. No. 10/179,651 filed Jun. 24, 2002, which claims priority to U.S. Provisional Application No. 60/360,610 filed Feb. 28, 2002 and to U.S. Provisional Application No. 60/300,385 filed Jun. 22, 2001. This Application also claims priority to U.S. Provisional Application No. 60/447,736 filed Feb. 14, 2003. This Application also claims priority to PCT/US02/20249 filed Jun. 24, 2002. All of the foregoing applications are hereby incorporated by reference in their entirety as if fully set forth herein.

### COPYRIGHT NOTICE

This disclosure is protected under United States and International Copyright Laws. © 2002-2004 Nosa Omoigui. All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to computers and, more specifically, to information management and research systems.

### BACKGROUND OF THE INVENTION

The general background to this invention is described in my co-pending parent application (U.S. application Ser. No. 10/179,651 filed Jun. 24, 2002), which is incorporated by reference herein, and of which this application is a Continuation in Part.

### SUMMARY OF THE INVENTION

The present invention is directed in part to a semantically integrated knowledge retrieval, management, delivery and presentation system, as is more fully described in my co-pending parent application (U.S. application Ser. No. 10/179,651 filed Jun. 24, 2002). The present invention and system includes several additional improved features, enhancements and/or properties, including, without limitation, Entities, Profiles and Semantic Threads, as are more fully described in the Detailed Description below.

### BRIEF DESCRIPTION OF THE DRAWINGS

The preferred and alternative embodiments of the present invention are described in detail below with reference to the following drawings.

FIG. 1 is a partial screenshot overview and FIG. 2 is an expansion of a dialog box of FIG. 1 for a scenario of a Patent Examiner using the preferred embodiment in a prior art search, a screenshot of where “Magnetic Resonance Imaging” occurs in a Pharmaceuticals taxonomy.

FIG. 3 shows the Sharable Smart Request System Interaction, which is the binary document format that encapsulates the SQML buffer with the smart request and also illustrates how the extension handler opens a document.

FIG. 4 is a partial screenshot overview of document files, showing an illustration of two .REQ documents (titled ‘Headlines on Reuters™ Related to My Research Report (Live)’ and ‘Headlines on Reuters™ (as of Jan. 21, 2003, 08 17AM)’ on the far right) with a registered association in the Windows™ shell.

FIG. 5 is a Diagram Illustrating the Text-to-Speech Object Skin and shows an illustration of an email message being rendered via a text-to-speech object skin.

FIG. 6 is a Diagram Illustrating a Text-to-Speech Request Skin.

FIG. 7 is a Diagram Illustrating Knowledge Modeling for a Pharmaceuticals Company Example.

FIG. 8 is a Diagram Illustrating Client Component Integration and Interaction Workflow.

FIGS. 9-11 show three different views of the Explore Categories dialog box.

FIGS. 12 and 13 show sample screenshots of the Dossier Smart Lens in operation.

FIG. 14 shows how the server-side semantic query processor processes incoming semantic queries (represented as SQML).

FIG. 15 illustrates the semantic browser showing two profiles (the default profile named “My Profile” and a profile named “Patents”). Observe how the user is able to navigate his/her knowledge worlds via both profiles without interference.

FIGS. 16A-C illustrate how a user would configure a profile (to create a profile, the user will use the “Create Profile Wizard” and the profile can then be modified via a property sheet as shown in other Figures).

FIG. 17 shows how a user would select a profile when creating a request with the “Create Request Wizard.” FIG. 18 shows a screenshot with the ‘Smart Styles’ Dialog Box illustrating some of the foregoing operations and features.

FIG. 19 illustrates the “Smart Request Watch” Dialog Box.

FIG. 20 illustrates a Watch Window displaying Filtered Smart Requests (e.g., Headlines on Wireless). FIG. 20 is an Illustration of the Watch Window with a Current Smart Request Title (e.g., “Breaking News”).

FIG. 21 illustrates Entity views displayed in the Semantic Browser.

FIGS. 22A and 22B show the UI for the Knowledge Community Subscription.

FIG. 23 illustrates a semantic thread object and its semantic links.

FIGS. 24 through 46B are additional screen shots further illustrating the functions, options and operations as described in the Detailed Description.

FIG. 47 as a sample semantic image for Pharmaceuticals/Biotech industry (DNA helix).

FIG. 48 is an illustration of a semantically appropriate image visualization for the Breaking News context template.

FIG. 49 is a Visualization—Sample Image for smart hourglass, interstitial page, transition effects, background chrome, etc. (Headlines).

FIG. 50 is a Visualization—Sample Image for smart hourglass, interstitial page, transition effects, background chrome, etc. (Two people working at a desk).

FIG. 51 illustrates a semantic “Newsmaker” Visualization or Sample Image for smart hourglass, interstitial page, transition effects, background chrome, etc.

FIG. 52 illustrates a semantic “Upcoming Events” Visualization—Sample Image for smart hourglass, interstitial page, transition effects, background chrome, etc.

FIG. 53 is a Visualization—Sample Image for smart hourglass, interstitial page, transition effects, background chrome, etc. (Petri Dish).

FIG. 54 illustrates a semantic “History” Visualization—Sample Image for smart hourglass, interstitial page, transition effects, background chrome, etc.

FIG. 55 illustrates a semantic Visualization—Sample Image for smart hourglass, interstitial page, transition effects, background chrome, etc. (Spacecraft).

FIG. 56 illustrates a “Best Buys” Visualization—Sample Image for smart hourglass, interstitial page, transition effects, background chrome, etc.

FIG. 57 illustrates a semantic Visualization—Sample Image for smart hourglass, interstitial page, transition effects, background chrome, etc. (Coffee).

FIG. 58 illustrates a semantically appropriate Sample Image for “Classics” for smart hourglass, interstitial page, transition effects, background chrome, etc. (Car).

FIG. 59 illustrates a semantically appropriate “Recommendation” Visualization—Sample Image for the contextual/application elements of smart hourglass, interstitial page, transition effects, background chrome, etc. (Thumbs up).

FIG. 60 illustrates a semantic “Today” Visualization—Sample Image for the elements smart hourglass, interstitial page, transition effects, background chrome, etc.

FIG. 61 illustrates a semantic “Annotated Items” Visualization—Sample Image for smart hourglass, interstitial page, transition effects, background chrome, etc.

FIG. 62 illustrates a semantic “Annotations” Visualization—Sample Image for smart hourglass, interstitial page, transition effects, background chrome, etc.

FIG. 63 illustrates a semantic “Experts” Visualization—Sample Image for smart hourglass, interstitial page, transition effects, background chrome, etc.

FIG. 64 illustrates a semantic “Places” Visualization—Sample Image for smart hourglass, interstitial page, transition effects, background chrome, etc.

FIG. 65 illustrates a semantic “Blenders” Visualization—Sample Image for smart hourglass, interstitial page, transition effects, background chrome, etc.

FIGS. 66 through 84 illustrate semantic Visualizations for the following Information Object Types, respectively: Documents, Books, Magazines, Presentations, Resumes, Spreadsheets, Text, Web pages, White Papers, Email, Email Annotations, Email Distribution Lists, Events, Meetings, Multimedia, Online Courses, People, Customers, and Users.

FIG. 85 illustrates a semantic “Timeline” Visualization—Sample Image for smart hourglass, interstitial page, transition effects, background chrome, etc.

### DETAILED DESCRIPTION OF THE PREFERRED EMBODIMENT

### Table of Contents

A. ADDITIONAL ILLUSTRATIVE SCENARIOS . . . 9
   1. Patent Examiner Prior Art Search Tool . . . 9
   2. BioTech Company Research Scenario . . . 13
B. SUBJECT MATTER FOR THE PRESENTLY PREFERRED EMBODIMENT OF THE INFORMATION NERVOUS SYSTEM . . . 17
   1. Smart Selection Lens Overview . . . 18
   2. Pasting Person Objects Overview . . . 20
   3. Saving and Sharing Smart Requests Overview . . . 22
   4. Saving and Sharing Smart Snapshots Overview . . . 24
   5. Virtual Knowledge Communities . . . 25
   6. Implementing Time-Sensitive Semantic Queries . . . 26
   7. Text-To-Speech Skins Overview . . . 26
   8. Language Translation Skins . . . 28
   9. Categories as First Class Objects in the User Experience . . . 29
   10. Categorized Annotations . . . 29
   11. Additional Context Templates . . . 30
   12. Importing and Exporting User State . . . 31
   13. Local Smart Requests . . . 32
   14. Integrated Navigation . . . 32
   15. Hints for Visited Results . . . 33
   16. Knowledge Federation . . . 34
   17. Anonymous Annotations and Publications . . . 38
   18. Offline Support in the Semantic Browser . . . 38
   19. Guaranteed Cross-Platform Support in the Semantic Browser . . . 39
   20. Knowledge Modeling . . . 40
   21. KIS Housekeeping Rules . . . 41
   22. Client Component Integration & Interaction Workflow . . . 41
   23. Categories Dialog Box User Interface Specification . . . 42
   24. Client-Assisted Server Data Consistency Checking . . . 45
   25. Client-Side Duplicate Detection . . . 46
   26. Client-Side Virtual Results Cursor . . . 46
   27. Virtual Single Sign-On . . . 47
   28. Namespace Object Action Matrix . . . 49
   29. Dynamic End-to-End Ontology/Taxonomy Updating and Synchronization . . . 50
   30. Invoking Dossier (Guide) Queries . . . 51
   31. Knowledge Community (Agency) Semantics . . . 52
   32. Dynamic Ontology and Taxonomy Mapping . . . 53
   33. Semantic Alerts Optimizations . . . 53
   34. Semantic “News” Images . . . 54
   35. Dynamically Choosing Semantic Images . . . 54
   36. Dynamic Knowledge Community (Agency) Contacts Membership . . . 54
   37. Integrated Full-Text Keyword and Phrase Indexing . . . 55
   38. Semantic “Mark Object as Read . . . 56
   39. Multi-Select Object Lens . . . 57
   40. Ontology-Based Filtering and Spam Management . . . 58
   41. Results Refinement . . . 58
   42. Semantic Management of Information Stores . . . 60
   43. Slide-Rule Filter User Interface . . . 61
C. SERVER-SIDE SEMANTIC QUERY PROCESSOR SPECIFICATION . . . 62
   1. Overview . . . 62
   2. Semantic Relevance Score . . . 63
   3. Semantic Relevance Filter . . . 63
   4. Time-Sensitivity Filter . . . 64
   5. Knowledge Type Semantic Query Implementations . . . 64
D. EXTENSIBLE CLIENT-SIDE USER PROFILES SPECIFICATION FOR THE INFORMATION NERVOUS SYSTEM . . . 71
E. SMART STYLES SPECIFICATION FOR THE INFORMATION NERVOUS SYSTEM . . . 73
   1. Smart Styles Overview . . . 73
   2. Implicit and Dynamic Smart Style Properties . . . 73
F. SMART REQUEST WATCH SPECIFICATION FOR THE INFORMATION NERVOUS SYSTEM . . . 75
   1. Overview . . . 75
   2. Request Watch Lists (RWLs) and Groups (RWGs) . . . 76
   3. The Notification Manager (NM) . . . 79
   4. Watch Group Monitors . . . 80
   5. The Watch Pane . . . 80
   6. The Watch Window . . . 81
   7. Watch List Addendum . . . 82
G. ENTITIES SPECIFICATION FOR THE INFORMATION NERVOUS SYSTEM . . . 82
   1. Introduction . . . 82
   2. Portfolios (or Entity Collections) . . . 88
   3. Sample Scenarios . . . 89
H. KNOWLEDGE COMMUNITY BROWSING AND SUBSCRIPTION SPECIFICATION FOR THE INFORMATION NERVOUS SYSTEM . . . 90
I. CLIENT-SIDE SEMANTIC QUERY DOCUMENT SPECIFICATION FOR THE INFORMATION NERVOUS SYSTEM . . . 91
   1. Semantic Query Markup Language (SQML) Overview . . . 91
   2. SQML Generation . . . 100
   3. SQML Parsing . . . 100
J. SEMANTIC CLIENT-SIDE RUNTIME CONTROL API SPECIFICATION FOR THE INFORMATION NERVOUS SYSTEM . . . 101
   1. Introducing the Nervana Semantic Runtime Control—Overview . . . 101
   2. The Nervana Semantic Runtime Control API . . . 101
   3. Email Control APIs . . . 112
   4. Person Control APIs . . . 115
   5. System Control Events . . . 118
K. SECURITY SPECIFICATION FOR THE INFORMATION NERVOUS SYSTEM . . . 120
   1. Authorization . . . 120
   2. People Groups . . . 124
   3. Identity Metadata Federation . . . 125
   4. Access Control . . . 126
L. DEEP INFORMATION SPECIFICATION FOR THE INFORMATION NERVOUS SYSTEM . . . 132
M. CREATE REQUEST WIZARD SPECIFICATION FOR THE INFORMATION NERVOUS SYSTEM . . . 138
N. CREATE PROFILE WIZARD SPECIFICATION FOR THE INFORMATION NERVOUS SYSTEM . . . 140
O. CREATE BOOKMARK WIZARD SPECIFICATION FOR THE INFORMATION NERVOUS SYSTEM 141
   1. Introducing the Create Bookmark Wizard . . . 141
   2. Scenarios . . . 142
   3. Intelligent Publishing-Tool Metadata Suggestion and Maintenance . . . 142
P. SEMANTIC THREADS SPECIFICATION FOR THE INFORMATION NERVOUS SYSTEM™ . . . 143
   1. Semantic Threads . . . 143
   2. Semantic Thread Conversations . . . 146
   3. Semantic Thread Management . . . 147
Q. SAMPLE SCREEN SHOTS . . . 148
R. SPECIFICATION FOR SEMANTIC QUERY DEFINITIONS & VISUALIZATIONS FOR THE INFORMATION NERVOUS SYSTEM . . . 148
   1. Semantic Images & Motion . . . 148
   2. The Smart Hourglass . . . 153
   3. Visualizations—Context Templates . . . 154

In a currently preferred embodiment, the system incorporates not only the features and functions described in my parent application and this CIP.

A. Additional Illustrative Scenarios

The following scenarios help to explain the utility and operation of the system, and will thereby make the rest of the detailed description easier to follow and understand.

1. Patent Examiner Prior Art Search Tool

Largely because of PTO fee diversion, there is a great deal of pressure on U.S. Patent Examiners to conduct a robust prior art search in very little time. And, while the research tools available to Examiners have improved dramatically in the last several years, those tools still have many shortcomings. Among the shortcomings are that most of the research tools are text based, rather than meaning based. So, for example, the search tool on the PTO website will search for particular words in particular fields in a document. Similarly, the advanced search tool on Google™ enables the Examiner to locate documents with particular words, or particular strings of words, or documents without a particular word or words. However, in each case, the search engine does not allow the Examiner to locate documents on the basis of meaning. So, for example, if there is a relevant reference that teaches essentially the same idea, but uses completely different words (e.g., a synonym, or worse yet, a synonymous phrase) than those in the query, the reference, even though perhaps anticipating, may well not be discovered. Even if the Examiner could spare the time to imagine and search every possible synonym, or even synonymous phrase to the key words critical to the invention, it could still overlook references because sometimes the same idea can be expressed without using any of the same words at all, and sometimes the synonymous idea is not neatly compressed into a phrase, but distributed over several sentences or paragraphs.

The reason for this is that words do not denote or connote meaning one to one as, for example, numerals tend to do. Put differently, certain meanings can be denoted or connoted by several different words or an essentially infinite combination of words, and, conversely, certain words or combinations of words can denote or connote several different meanings. Despite this infinite many-to-many network of possibilities human beings can isolate (because of context, experience, reasoning, inference, deduction, judgment, learning and the like) isolate probable meanings, at least tolerably effectively most of the time. The current prior art computer-automated search tools (e.g. the PTO website, or Google™, or Lexis™), cannot. The presently preferred embodiment of my invention bridges this gap considerably because it can search on the basis of meaning.

For example, using the some of the search functions of the preferred embodiment of the present invention, the Examiner could conduct a search, and with no additional effort or time as presently invested, obtain search results relevant to patentability even if they did not contain a single word in common with the key words chosen by the Examiner. Therefore, the system would obtain results relevant to the Examiner's task that would not ordinarily be located by present systems because it can locate references on the basis of meaning.

Also on the basis of meaning, it can exclude irrelevant references, even if they share a key word or words in common with the search request. In other words, one problem in prior art research is the problem of a false positive; results that the search engine “thought” were relevant merely because they had a key word in common, but that were in fact totally irrelevant because the key word, upon closer inspection in context, actually denoted or connoted an irrelevant idea. Therefore, the Examiner must search for the needle in the haystack, which is a waste of time.

In contrast, using some of the search functions of the preferred embodiment of the present invention, the density of relevant search results increases dramatically, because the system is “intelligent” enough to omit search results that, despite the common key words, are not relevant. Of course, it is not perfect in this respect any more than human beings are perfect in this respect. But, it is much more effective at screening irrelevant results than present systems, and in this respect resembles in function or in practice an intelligent research assistant than a mere keyword based search engine. Thus, using the system, the Examiner can complete a much better search in much less time. The specific mechanics of using the system this way, in one example, would work as follows:

Imagine the Examiner is assigned to examine an application directed to computer software for a more accurate method of interpreting magnetic resonance data and thereby generating more accurate diagnostic images. To search for relevant prior art using the search functions of the preferred embodiment of the present invention, the Examiner would:

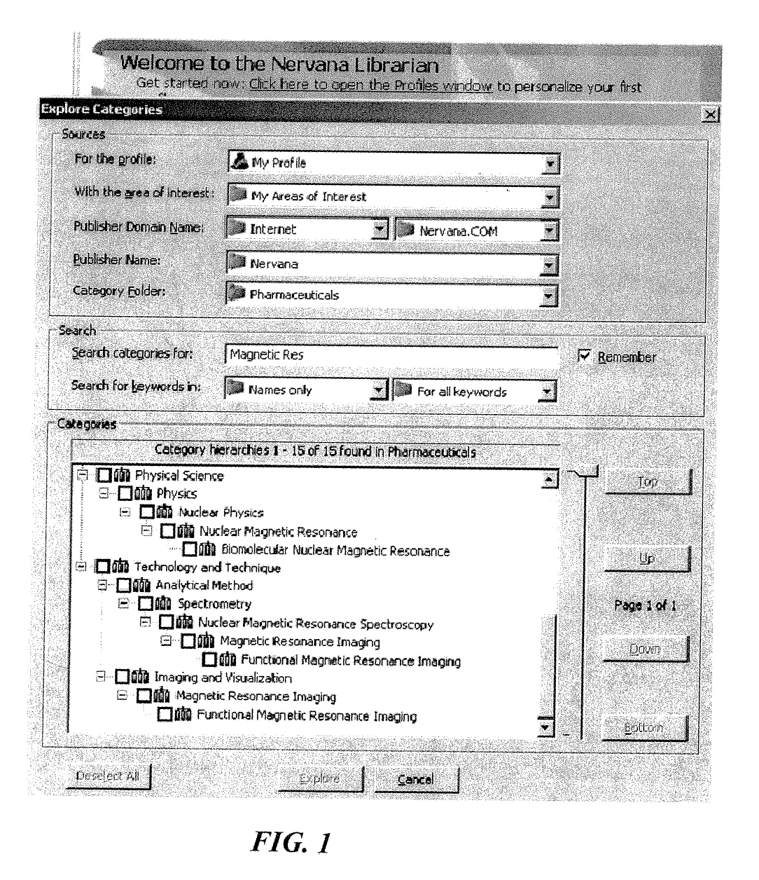

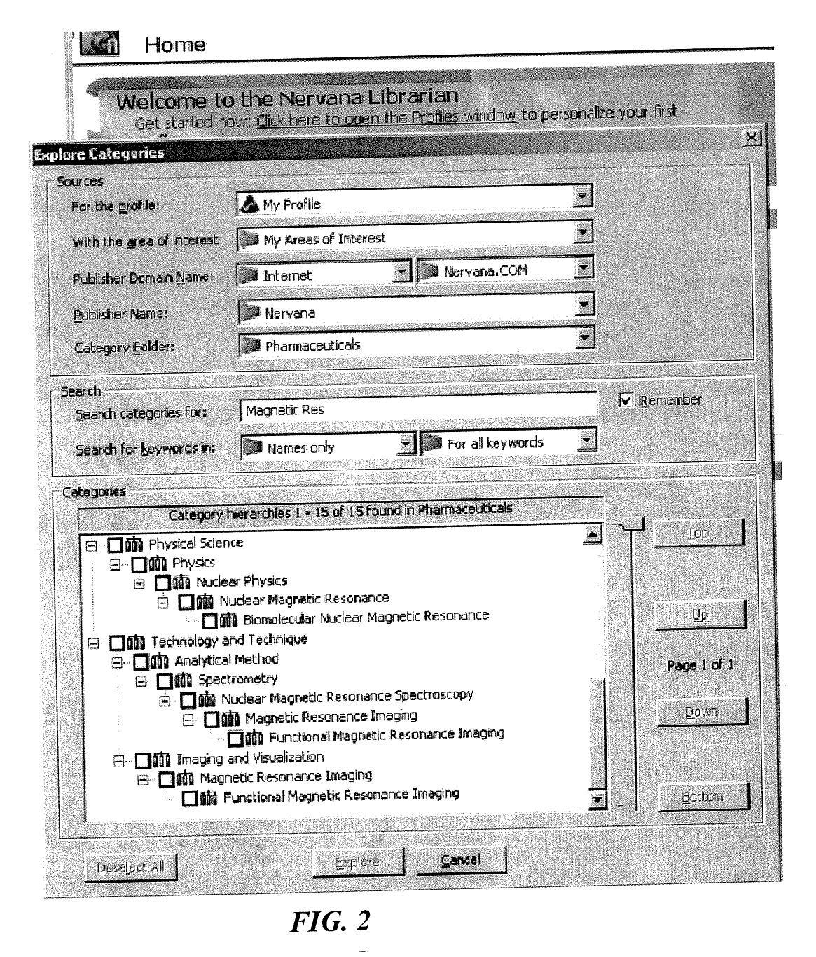

a. Using the Create Entity wizard, create a “Topic” entity with the relevant categories in the various contexts in which “Magnetic Resonance Imaging” occurs. As an illustration, FIGS. 1 and 2 show where “Magnetic Resonance Imaging” occurs in a Pharmaceuticals taxonomy. Notice that there are several contexts in which the category occurs. Add the relevant categories to the entity and apply the “OR” operation. Essentially, this amounts to defining the entity “Magnetic Resonance Imaging” (as it relates to YOUR specific task) as being equivalent to all the occurrences of Magnetic Resonance Imaging in the right contexts—based on the patent application being examined.

b. Name the new entity “Magnetic Resonance Imaging” and perhaps “imaging” and “diagnostic” or some variations and combinations of the same.

c. Drag and drop the “Magnetic Resonance Imaging” Topic entity to the Dossier (special agent or default knowledge request) icon in the desired profile (the profile is preferably configured to include the “Patent Database” knowledge community). This launches a new Dossier request/agent that displays each special agent (context template). Each special agent is displayed with the right default predicate as follows:
All Bets on Magnetic Resonance Imaging
Best Bets on Magnetic Resonance Imaging
Breaking News on Magnetic Resonance Imaging
Headlines on Magnetic Resonance Imaging
Random Bets on Magnetic Resonance Imaging
Experts in Magnetic Resonance Imaging
Newsmakers in Magnetic Resonance Imaging
Interest Group in Magnetic Resonance Imaging
Conversations on Magnetic Resonance Imaging
Annotations on Magnetic Resonance Imaging
Annotated Items on Magnetic Resonance Imaging
Upcoming Events on Magnetic Resonance Imaging
Popular Items on Magnetic Resonance Imaging
Classics on Magnetic Resonance Imaging

d. Alternatively, the request can be created by using the Create Request Wizard. To do this, select the Dossier context template and select the “Patent Database” knowledge community as the knowledge source for the request. Alternatively, you can configure the profile to include the “Patents Database” knowledge community and simply use the selected profile for the new request. Hit Next—the wizard intelligently suggests a name for the request based on the semantics of the request. The wizard also selects the right default predicates based on the semantics of the “Magnetic Resonance Imaging” “Topic” entity. Because the wizard knows the entity is a “Topic,” it selects the right entities that make sense in the right contexts. Hit Finish. The wizard compiles the query, sends the SQML to the KISes in the selected profile, and then displays the results.

In the foregoing example, the results could be drawn, ultimately, from any source. Preferably, some of the results would have originated on the Web, some on the PTO intranet, some on other perhaps proprietary extranets. Regardless of the scope or origin of the original documents, by use of the system they have been automatically processed, and automatically “read” and “understood” by the system, so that when the Examiner's query was initiated, and also “read” and “understood” semantically, and by context, the system locates all relevant, and only relevant results. Again, not perfectly, but radically more accurately than in any prior systems. Note also that the system does not depend on any manual tagging or categorization of the documents in advance. While that would also aid in accuracy, it is so labor intensive as to utterly eclipse the advantages of online research in the first place, and is perfectly impractical given the rate of increase of new documents.

In this scenario, the Examiner may also wish to use additional features of the preferred embodiment of the invention. For example, the Examiner may wish to consult experts within the PTO, or literature by experts outside the PTO, as follows (note that Experts in Magnetic Resonance Imaging would be included in the Dossier on Magnetic Resonance Imaging; however, the examiner might want to create a separate request for Experts in order to track it separately, save it as a “request document,” email it to colleagues, etc.). Find all Experts in Magnetic Resonance Imaging:

a. Follow steps 1-4 above.

b. Drag and drop the “Magnetic Resonance Imaging” entity to the Experts (special agent or default knowledge request) icon in the desired profile. This automatically launches a new request/agent appropriately titled “Experts in Magnetic Resonance Imaging.” The semantic browser selects the right default predicate “in” because it “knows” the entity is a “Topic” entity and the context template is a “People” template (Experts). As such, the default predicate is selected based on the intersection of these two arguments (“in”) since this is what makes sense.

2. BioTech Company Research Scenario

Biotech companies are research intensive, not only in laboratory research, but in research of the results of research by others, both within and outside of their own companies. Unfortunately, the research tools available to such companies have shortcomings. Proprietary services provide context-sensitive and useful results, but those services themselves have inferior tools, and thus rely heavily on indexing and human effort, and subscriptions to expensive specialized journals, and as consequence are very expensive and not as accurate as the present system. On the other hand, biotech researchers can search inexpensively using Google™, but it shares all the key word based limitations described above.

In contrast, using the search features of the preferred embodiment of the present invention, a biotech researcher could more efficiently locate more relevant results. Specifically, the researcher might use the system as follows. For example, if some researchers wanted to Find Headlines on Genomics and Anatomy written by anyone in Marketing or Research, they would do that as follows:

a. Using the wizard, launch an information-type request/agent for distribution lists with the keywords “Marketing Research”.

b. Select the Marketing distribution list result and click “Save as Entity” —this saves the object as a “Team” entity (because the semantic browser “knows” the original object is a distribution list—as such, a “Team” entity makes sense in this context).

c. Select the Research distribution list result and click “Save as Entity” —this saves the object as a “Team” entity (because the semantic browser “knows” the original object is a distribution list).

d. Using the Create Entity Wizard, create a new “Team” entity and select the “Marketing” and “Research” team entities as members. Name the new entity “Marketing or Research”.

e. Using the Create Request Wizard, select the Headlines context template, and then select the “Marketing or Research” entity as a filter. Also, select the Genomics category and the Anatomy category. Next, select the “AND” operator. Hit Next—the wizard intelligently suggests a name for the request based on the semantics of the request. The wizard also selects the right default predicates based on the semantics of the “Marketing or Research” team entity (“by anyone in”). Because the wizard knows the entity is a “Team,” it selects “by anyone in” by default since this makes sense. Hit Finish. The wizard compiles the query, sends the SQML to the KISes in the selected profile, and then displays the results.

In addition, the researchers may wish to Find all Experts in Marketing or Research:

a. Follow steps 1-4 above.

b. Drag and drop the “Marketing or Research” entity to the Experts (special agent or default knowledge request) icon in the desired profile. This launches a new request/agent appropriately titled “Experts in Marketing or Research.” The semantic browser selects the right default predicate “in” because it “knows” the entity is a “Team” entity and the context template is a “People” template (Experts). As such, the default predicate is selected based on the intersection of these two arguments (“in”) since this is what makes sense.

If the researchers expect to need to return to this research, or to supplement it, or to later analyze the results, they may wish to Open a Dossier on Marketing or Research, as follows:

a. Follow steps 1-4 above.

b. Drag and drop the “Marketing or Research” entity to the Dossier (special agent or default knowledge request) icon in the desired profile. This launches a new Dossier request/agent that displays each special agent (context template). Each special agent is displayed with the right default predicate as follows:
All Bets by anyone in Marketing or Research
Best Bets by anyone in Marketing or Research
Breaking News by anyone in Marketing or Research
Headlines by anyone in Marketing or Research
Random Bets by anyone in Marketing or Research
Experts in Marketing or Research
Newsmakers in Marketing or Research
Interest Group in Marketing or Research
Conversations involving anyone in Marketing or Research
Annotations by anyone in Marketing or Research
Annotated Items by anyone in Marketing or Research
Upcoming Events by anyone in Marketing or Research
Popular Items by anyone in Marketing or Research
Classics by anyone in Marketing or Research

The researchers may be interested in Finding “Breaking News on my Competitors”, and would do so as follows:

a. For each competitor, create a new “competitor” entity (under “companies”) using the Create Entity Wizard. Select the right filters as needed. For instance, a competitor with a well-known English name—like “Groove” should have an entity that includes categories in which the company does business and also the keyword.

b. Using the Create Entity Wizard, create a portfolio (entity collection) and add all the competitor entities you created in step a. Name the entity collection “My Competitors.”

c. Using the Create Request Wizard, select the Breaking News context template and add the portfolio (entity collection) you created in step b. as a filter. Keep the default predicate selection. Hit “Next”—the wizard intelligently suggests a name for the request using the default predicate (“Breaking News on My Competitors”). Hit Finish. The wizard launches a new request/agent named “Breaking News on My Competitors.”

In addition, the researchers may wish to be kept apprised. They could instruct the system to alert them on “Breaking News on our Competitors”, as follows:

a. Create the “Breaking News on My Competitors” request as described above.

b. Add the request to the request watch list. The semantic browser will now display a watch pane (e.g., a ticker) showing “Breaking News on My Competitors.” Using the Notification Manager (NM), you can also indicate that the semantic browser send alerts via email, instant messaging, text messaging, etc. when there are new results from the request/agent.

In addition, the researchers may wish to keep records of competitors for future reference, and to have them constantly updated. The system will create and update such records, by the researchers instructing the system to Show a collection of Dossiers on each of our competitors, as follows:

a. Create entities for each of your competitors as described in 4a. above.

b. For each competitor entity, create a new Dossier on that competitor by dragging the entity to the Dossier icon for the desired profile—this creates a Dossier on the competitor.

c. Using the Create Request Wizard, create a new request collection (blender) and add each of the Dossier requests created in step b. above to the collection (you can also drag and drop requests to the collection after it has been created in order to further populate the collection). Hit Next—the wizard intelligently suggests a name for the request collection. Hit Finish. The wizard launches a request collection that contains the individual Dossiers. You can then add the request collection as a favorite and open it everyday to get rich, contextual competitive intelligence.

The researchers may wish to review a particular dossier, and can do so by instructing the system to Show a Dossier on the CEO (e.g., named John Smith):

a. Using the wizard, launch an information-type request/agent for People with the keywords “John Smith”.

b. Select the result and click “Save as Entity”—this saves the object as a “Person” entity (because the semantic browser “knows” the original object is a person—as such, a “Person” entity makes sense in this context).

c. Using the Create Request Wizard, select the Dossier context template, and then select the “John Smith” entity as a filter. Hit Next—the wizard intelligently suggests a name for the request based on the semantics of the request. The wizard also selects the right default predicates based on the semantics of the “John Smith” person entity. Hit Finish. The wizard compiles the query, sends the SQML to the KISes in the selected profile, and then displays the results (as sub-queries/agents) as follows:
All Bets by John Smith
Best Bets by John Smith
Breaking News by John Smith
Headlines by John Smith
Random Bets by John Smith
Experts like John Smith (this returns Experts that have expertise on the same categories as those in which John Smith has expertise)
Newsmakers like John Smith (this returns Newsmakers that have recently “made news” in the same categories as those in which John Smith has recently “made news”)
Interest Group like John Smith (this returns the people that have shown an interest in the same categories as those in which John Smith has shown interest—within a time-window (2-3 months in the preferred embodiment))
Conversations involving John Smith
Annotations by John Smith
Annotated Items by John Smith
Upcoming Events by John Smith
Popular Items by John Smith
Classics by John Smith

The foregoing scenarios illustrate the operation of the system. The system itself is described in greater detail below.

B. Subject Matter for the Presently Preferred Embodiment of the Information Nervous System

Several improvements, enhancements and variations have been developed since the filing of my co-pending parent application and prior provisional applications referenced above. Some of these are improvements on, or only clarifications of, features previously included in the parent application, and some are new features of the system altogether. These are listed and described below. They are not arranged in order of importance, or in any particular order. While the preferred embodiment of the present invention would allow the user to use any or all of these features and improvements described below, alone or in combination, no single feature is necessary to the practice of the invention, nor any particular combination of features.

Also, in this application, reference is made to the same terms as are defined in my parent application Ser. No. 10/179,651, and the Description throughout this application is intended to be read in conjunction with the definitions, terminology, nomenclature and Figures of my parent application except where the context of this application clearly indicates to the contrary.

1. Smart Selection Lens Overview

The Smart Selection Lens is similar to the Smart Lens feature of the Information Nervous System information medium. In this case, the user can select text within the object and the lens will be applied using the selected text as the object (dynamically generating new “images” as the selection changes). This way, the user can “lens” over a configurable subset of the object metadata, as opposed to being constrained to “lens” over either the entire object or nothing at all. This feature is similar to a selection cursor/verb overloaded with context. For example, the user can select a piece of text in the Presenter and hit the “Paste as Lens” icon over the object in which the text appears. The Presenter will then pass the text to the client runtime component (e.g., an ActiveX object) with a method call like:

bstrSRML=GetSRMLForText(bstrText);

This call then returns a temporary SRML buffer that encapsulates the argument text. The Presenter will then call a method like:

bstrSQML=GetQueryForSmartLensOnObject(bstrSRMLObject);

This method gets the SQML from the clipboard, takes the argument SRML for the object, and dynamically creates new SQML that includes the resource in the SRML as a link in the SQML (with the default predicate “relevant to”). The method then returns the new SQML. The Presenter then calls the method:

ProcessSemanticQuery(bstrSQML);

This method passes the generated lens SQML and then retrieves the number of items in the results and the SRML results, preferably asynchronously. For details on this call, see the specification “Information Nervous System Semantic Runtime OCX.” The Presenter then displays a preview window (or the equivalent, based on the current skin) with something like:

[Lens Agent Title]

Found 23 items

[PREVIEW OBJECT 1]

[PREVIEW WINDOW CONTROLS]

where the “Lens Agent Title” is the title of the agent on the clipboard. For details of the preview window (and the preview window controls), please refer to my parent application Ser. No. 10/179,651.

In the preferred embodiment, the preview window will:
Disappear after a timer expires (maybe 500 ms)—on mouse move, the timer is preferably reset (this will avoid flashing the window when the user moves the mouse around the same area).
Fade out slowly (eventually).

The preferred embodiment also has the following features:

1. One selection range per object but multiple selections per results-set is the best option. Otherwise, the system would result in a confusing user experience and complex UI to show lens icons per selection per object (as opposed to per object).

2. Outstanding lens query requests (which are regular SQML queries, albeit with SQML dynamically generated consistent with the agent lens) should be cancelled when the Presenter no longer needs them (e.g. if the Presenter is navigating to a new page, or if we are requesting new lens info for an object). In any case, such cancellation is not critical from a performance (or bandwidth) standpoint because lens queries will likely only ask for a few objects at a time. Even if the queries are not cancelled, the Presenter can ignore the results. Regardless, because the Presenter also has to deal with stale results, dropping them on the floor -the Presenter will have to do this anyway (whether or not lens queries are also cancelled). There will be a window of delay between when the Presenter issues a cancel request and when the cancellation actually is complete. Because some results can trickle in during this time, they need to be discarded. Thus, the preferred embodiment has asynchronous cancellation implementations—the software component has been designed to always be prepared to ignore bad or stale results.

3. The Presenter preferably has both icons (indicating the current lens request state) and tool-tips: When the user hovers over or clicks on an object, the Presenter can put up a tool-tip with the words, “Requesting Lens Info” (or words to that effect). When the info comes back, hovering will show the “Found 23 Objects” tip and clicking will show the results. This interstitial tool tip can then be transitioned to the preview window if it is still up when the results arrive.

In addition, note that the smart selection lens, like the smart lens, can be applied to objects other than textual metadata. For instance, the Smart Selection Lens can be applied to images, video, a section of an audio stream, or other metadata. In these cases, the Presenter would return the appropriate SRML consistent with the data type and the “selection region.” This region could be an area of an image, or video, a time span in an audio stream, etc. The rest of the smart lens functionality would apply as described above, with the appropriate SQML being generated based on the SRML (which in turn is based on the schema for the data type under the lens).

2. Pasting Person Objects Overview

The Information Nervous System (which, again, is one of our current shorthand names for certain aspects of our presently preferred embodiments) also supports the drag and drop or copy and paste of ‘Person’ objects (People, Users, Customers, etc.). There are at least two scenarios to illustrate the operation of the preferred embodiment in this case:

1. Pasting a Person object on a smart request representing a Knowledge community (or Agency) from whence the Person came. In this case, the server's semantic query processor merely resolves the SQML from the client using the Person as the argument. For instance, if the user pastes (or drags and drops) a person ‘Joe’ on top of a smart request ‘Headlines on Reuters™,’ the client will create a new smart request using the additional argument. The Reuters™ Information Nervous System Web service will then resolve this request by returning all Headlines published or annotated by ‘Joe.’ In this case, the server will essentially apply the proper default predicate (‘published or annotated by’)—that makes sense for the scenario.

2. Pasting a Person object on a smart request representing a Knowledge community (or Agency) from whence the Person did not come. In this case, because the Person object is not in the semantic network of the destination Knowledge community (on its SMS), the server's semantic query processor would not be able to make sense of the Person argument. As such, the server must resolve the Person argument, in a different way, such as, for example, using the categories on which the person is an expert (in the preferred embodiment) or a newsmaker. For instance, taking the above example, if the user pastes (or drags and drops) a person ‘Joe’ on top of a smart request ‘Headlines on Reuters™’ and Joe is not a person on the Reuters™ Knowledge community, the Reuters™ Web service (in the preferred embodiment) must return Headlines that are “relevant to Joe's expertise.” This embodiment would then require that the client take a two-pass approach before sending the SQML to the destination Web service. First, it must ask the Knowledge community that the person belongs to for “representative data (SRML)” that represents the person's expertise. The Web service resolves this request by:

a. Querying the Knowledge community (e.g., Reuters™) on which the person object is pasted or dropped for that community's semantic domain information which comprises and/or represents that community's specifictaxonomy and ontology. Note that there could be several semantic domains.

b. Querying the Knowledge community from whence the person object came for that person object's semantic domain information.

c. If the semantic domains are identical or if there is at least one common semantic domain, the client queries the Knowledge community from whence the person came for the person's categories of expertise. The client then constructs SQML with these categories as arguments and passes this SQML to the Knowledge community on which the person was pasted or dropped.

If the semantic domains are not identical or there is not least one common semantic domain, the client queries the Knowledge community from whence the person came for several objects that belong to categories on which the person is an expert. In the preferred embodiment, the implementation should pick a high enough number of objects that accurately represent the categories of expertise (this number is preferably picked based on experimentation). The reason for picking objects in this case is that the destination Web service will not understand the categories of the Knowledge community from whence the person came and as such will not be able to map them to its own categories. Alternatively, a category mapper can be employed (via a centralized Web service on the Internet) that maps categories between different Knowledge Communities. In this case, the destination Knowledge community will always be passed categories as part of the SQML, even though it does not understand those categories—the Knowledge community will then map these categories to internal categories using the category mapper Web service. The category mapper Web service will have methods for resolving categories as well as methods for publishing category mappings.

3. Saving and Sharing Smart Requests Overview

Users of the Information Nervous System semantic browser (the Information Agent or Librarian) will also be able to save smart requests to disk, email them as an attachment, or share them via Instant Messenger (also as an attachment) or other means. The client application will expose methods to save a smart request as a sharable document. The client application will also expose methods to share a smart request document as an attachment in email or Instant Messenger.

A sharable smart request document is a binary document that encapsulates SQML (via a secure stream in the binary format). It provides a safe, serialized representation of a semantic query that, among other features, can protect the integrity and help protect the intellectual property of the specification. For example, the query itself may embody trade secrets of the researcher's employer, which, if exposed, could enable a competitor to reverse engineer critical competitive information to the detriment of the company. The protection can be accomplished in several ways, including by strongly encrypting the XML version of the semantic query (the SQML) or via a strong one-way hash. The sharable document has an extension (.REQ) that represents the request. An extension handler on the client operating system is installed to represent this extension. When a document with the extension is opened, the extension handler is invoked to open the document. The extension handler opens the document by extracting the SQML from the secure stream, and then creating a smart request in the semantic namespace with the SQML. The handler then opens the smart request in the semantic namespace.

When a smart request in the semantic namespace is saved or if the user wants to send it as an email attachment, the client serializes the SQML representing the smart request in the binary .REQ format and saves it at the requested directory path or opens the email client with the .REQ document as an attachment.

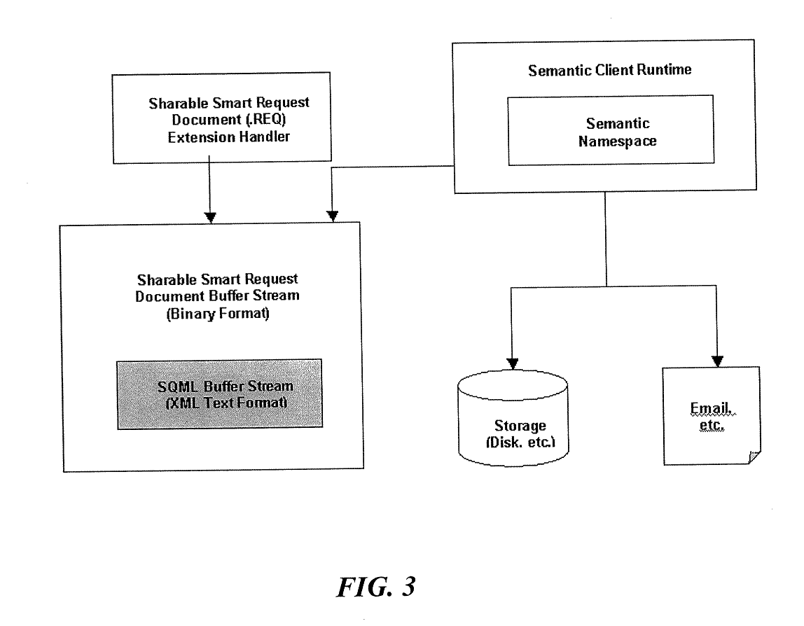

FIG. 3 shows the binary document format that encapsulates the SQML buffer with the smart request and also illustrates how the extension handler opens the document. A similar model can also be employed for sharing results (via SRML). In this case, a binary document encapsulates the SRML, rather than the SQML as in the case above.

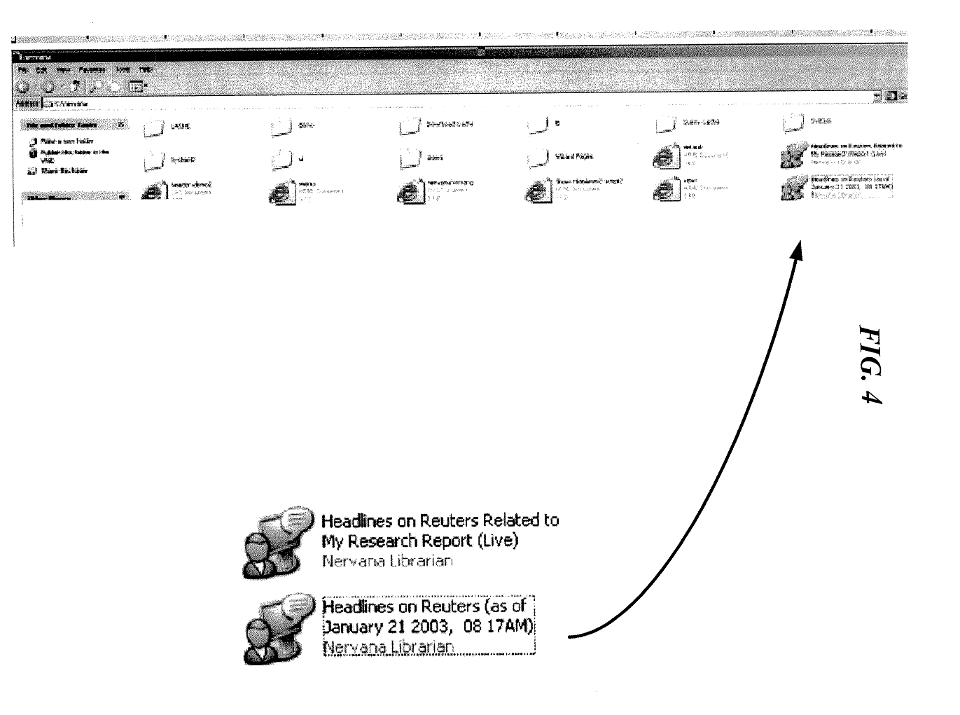

FIG. 4 shows an illustration of two .REQ documents (titled ‘Headlines on Reuters™ Related to My Research Report (Live)’ and ‘Headlines on Reuters™ (as of Jan. 21, 2003, 08 17AM)’ on the far right) with a registered association in the Windows™ shell. The first request document is ‘live’ and the second one is a snapshot at a particular time (they are both time-sensitive requests). Notice that the operating system has associated the semantic browser application (Nervana Librarian) with the document. When the document is opened, the semantic query gets opened in the application.
Saving and sharing entities—the same process applies as above except with a .ENT extension to represent an entity. When an entity document is invoked, the Nervana Librarian opens the entity SQML in the browser.
Extension Property Sheet—this will create a temporary smart request or entity (depending on the kind of document) in the semantic environment and display the property sheet for a smart request or entity.
Extension Tool tips—this will display a helpful tool tip when the user hovers over a librarian document (a request, .REQ or an entity, .ENT).

4. Saving and Sharing Smart Snapshots Overview

The Information Nervous System also supports the sharing of what the inventor calls “Smart Snapshots.” A smart snapshot is a smart request frozen in time. This will enable a scenario where the user wants to share a smart request but not have it be “live.” For instance, by default, if the user shares the smart request “Breaking News on Reuters™ related to this document” with a colleague, the colleague will see the live results of the smart request (based on the “current time”). However, if the user wants to share “[Current] Breaking News on Reuters™ related to this document,” a smart snapshot will be employed.

A smart snapshot is the same as a smart request (it is also represented by an SQML query document) except that the “attributes” section of the SQML document contains attributes marking it as a snapshot (the flag QUERYATTRIBUTES_SNAPSHOT). The creation date/time of the SQML document is also stored in the SQML (as before—the SQML schema contains a field for the creation date/time). When the user indicates that he/she wants to share the smart request, the user interface (the semantic browser, Information Agent, or Librarian) prompts him/her whether he/she wants to share the smart request (live) or a smart snapshot. If the user indicates s smart request, the process described above (in Part 3) is employed. If the user indicates a smart snapshot, the binary document is populated with the edited SQML (containing the snapshot attribute) and the remainder the process is followed as above.

When the recipient of the binary document receives it (by email, instant messaging, etc.), and opens it, the extension handler opens the document and adds an entry into the semantic namespace as a smart request (as described above). When the recipient opens the smart request, the client's semantic query processor will send the processed SQML to the server's XML web service (as previously described). The server's semantic query processor then processes the SQML and honors the snapshot attribute by invoking the semantic query relative to the SQML creation date/time. As such, results will be relative to the original date/time, thereby honoring the intent of the sender.

5. Virtual Knowledge Communities

Virtual Knowledge Communities (agencies) refer to a feature of the Information Nervous System that allows the publisher of a knowledge community to publish a group of servers to appear as though they were one server. For instance, Reuters™ could have per-industry Reuters™ Knowledge Communities (for pharmaceuticals, oil and gas, manufacturing, financial services, etc.) but might also choose to expose one ‘Reuters™’ knowledge community. To do this, Reuters™ will publish and announce the SQML for the virtual knowledge community (rather than the URL to the WSDL of the XML Web Service). The SQML will contain a blender (or collection) of the WSDLs of the actual Knowledge Communities. The semantic browser will then pick up the SQML and display an icon for the knowledge community (as though it were a single server). Any action on the knowledge community will be propagated to each server in the SQML. If the user does not have access for the action, the Web service call will fail accordingly, else the action will be performed (no different from if the user had manually created a blender containing the Knowledge Communities).

6. Implementing Time-Sensitive Semantic Queries

Semantic queries that are time-sensitive are preferably implemented in an intelligent fashion to account for the rate of knowledge generation at the knowledge community (agency) in question. For instance, ‘Breaking News’ on a server that receives 10 documents per second is not the same as ‘Breaking News’ on a server that receives 10 documents per month. As such, the server-side semantic query processor would preferably adjust its time-sensitive semantic query handling according to the rate at which information accumulates at the server. To implement this, general rules of thumb could be used, for instance:
The most recent N objects where N is adjusted based on the number of new objects per minute.
All objects received in the last N minutes with a cap on the number of objects (i.e., min (cap, all objects received in the last N minutes)).

N can also be adjusted based on whether the query is a Headline or Breaking News. In the preferred embodiment, newsmaker queries is preferably implemented with the same time-sensitivity parameters as Headlines.

7. Text-To-Speech Skins Overview

Text-to-speech is implemented at the object level and at the request level. At the object level, the object skin runs a script to take the SRML of the object, interprets the SRML, and then passes select pieces of text (in the SRML fields) to a text-to-speech engine (e.g., using the Microsoft™ Windows™ Speech SDK) that generates voice output.

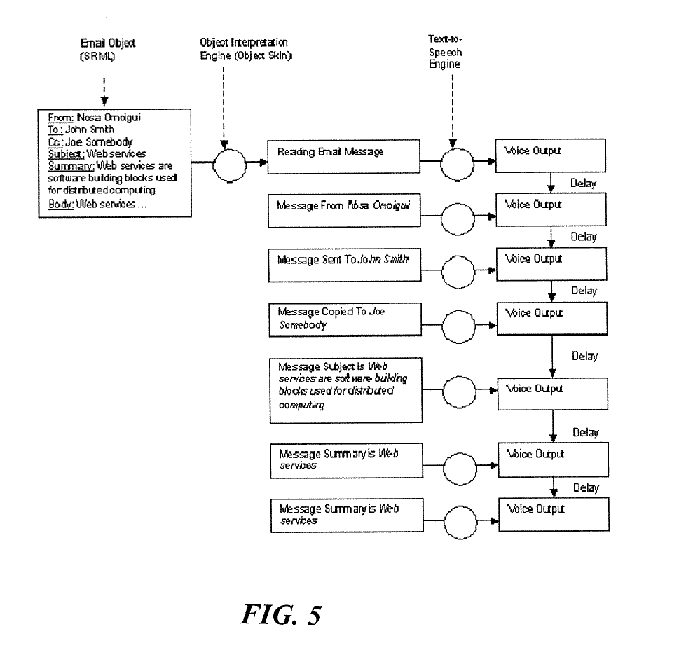

FIG. 5 shows a diagram illustrating text-to-speech object skin. When executed, the pipeline shown in FIG. 5 results in the following voice output:
1. Reading Email Message
2. Appropriate Delay
3. Message From Nosa Omoigui
4. Appropriate Delay
5. Message Sent to John Smith
6. Appropriate Delay
7. Message Copied To Joe Somebody
8. Appropriate Delay
9. Message Subject Is Web services are software building blocks used for distributed computing
10. Appropriate Delay
11. Message Summary is Web services
12. Appropriate Delay
13. [Optional] Message Body is Web services are software building blocks used for distributed computing

This example assumes a voice skin template as follows:
1. Reading Email Message
2. Appropriate Delay
3. Message From<message author name>
4. Appropriate Delay
5. Message Sent to<message to: recipient name>
6. Appropriate Delay
7. Message Copied To<message cc: recipient name>
8. Appropriate Delay
9. Message Subject Is<message subject text>
10. Appropriate Delay
11. Message Summary is<message body summary>
12. Appropriate Delay
13. [Optional] Message Body is<message body>

Other templates can also be used to render voice that is easily understandable and which conveys the semantics of the object type being rendered. Like the example shown above (which is for email), the implementation should use appropriate text-to-speech templates for all information object types, in order to capture the semantics of the object type.

At the request level, the semantic browser's presentation engine (the Presenter) loads a skin that takes the SRML for all the current objects being rendered (based on the user-selected cursor position) and then invokes the text-to-speech object skin for each object. This essentially repeats the text-to-speech action for each XML object being rendered, one after another.
Email Object (SRML)
Object Interpretation Engine (Object Skin)
Text-to-Speech Engine
From: Nosa Omoigui
To: John Smith
Cc: Joe Somebody
Subject: Web services
Summary: Web services are software building blocks used for distributed computing
Body: Web services . . .
Voice Output
Reading Email Message
Delay
Voice Output
Message From Nosa Omoigui
Delay
Voice Output
Message Sent To John Smith
Delay
Voice Output
Message Copied To Joe Somebody
Delay
Message Subject is Web services are software building blocks used for distributed computing
Voice Output
Delay
Voice Output
Message Summary is Web services
Delay
Voice Output
Message Summary is Web services

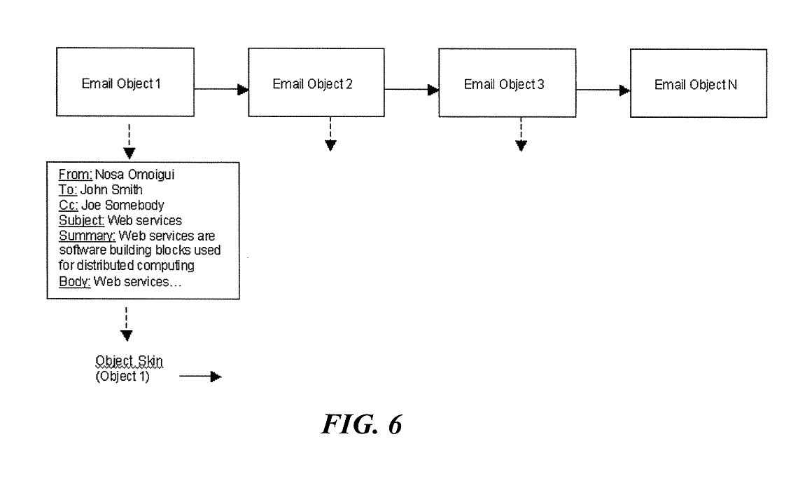

FIG. 6 shows an illustration of several email objects being presented in the semantic browser via a request skin.
From: Nosa Omoigui
To: John Smith
Cc: Joe Somebody
Subject: Web services
Summary: Web services are software building blocks used for distributed computing
Body: Web services . . .
Email Object 1
Object Skin (Object 1)
Email Object 2
Email Object 3
Email Object N

8. Language Translation Skins

Language translation skins are implemented similar to text-to-speech skins except that the transform is on the language axis. The XSLT skin (smart style) can invoke a software engine to automatically perform language translation in real-time and then generate XML that is encoded in Unicode (16 bits per character) in order to account for the universe of languages. The XSLT transform that generates the final presentation output then will render the output using the proper character set given the contents of the translated XML.

Language Agnostic Semantic Queries

Semantic queries can also be invoked in a language-agnostic fashion. This is implemented by having a translation layer (the SQML language translator) that translates the SQML that is generated by the semantic browser to a form that is suitable for interpretation by the KDS (or KBS) which in turn has a knowledge domain ontology seeded for one or more languages. The SQML language translator translates the objects referred to by the predicates (e.g., keywords, text, concepts, categories, etc.) and then sends that to the server-side semantic query processor for interpretation. The results are then translated back to the original language by the language translation skin.

9. Categories as First Class Objects in the User Experience This refers to a feature by which categories of a knowledge community are exposed to the end user. The end user will be able to issue a query for a category as an information type—e.g., ‘Web services.’ The metadata will then be displayed in the semantic browser, as would be the case for any first-class information object type. Visualizations, dynamic links, context palettes, etc. will also be available using the category object as a pivot. This feature is useful in cases where the user wants to start with the category and then use that as a pivot for dynamic navigation, as opposed to starting off with a smart request (smart agent) that has the category as a parameter.

10. Categorized Annotations

Categorized annotations follow from categories being first-class objects. Users will be able to annotate a category directly—thereby simulating an email list that is mapped to a category. However, for cases where there are many categories (for instance, in pharmaceuticals), this is not recommended because information can belong to many categories and the user should not have to think about which category to annotate—the user should publish the annotation directly to the knowledge community (agency) where it will be automatically categorized or annotate an object like a document or email message that is more contextual than a category.

11. Additional Context Templates

1. Experts—The Experts feature was indicated as a special agent in my parent application Ser. No. 10/179,651. As should have also been understood from that application, the Experts feature can also operate in conjunction with the context templates section. Experts are a context template and as the name implies indicate people that have expertise on one or more subject matters or contexts (indicated by the PREDICATETYPEID_EXPERTON predicate).

2. Interest Group—this refers to a context template which as the name implies indicate people that have interest (but not necessarily expertise) on one or more subject matters or contexts (indicated by the PREDICATETYPEID_INTERESTIN predicate). This context template returns People that have shown interest in any semantic category in the semantic network. A very real-world scenario will have Experts returning people that have answers and Interest Group returning results of people that have questions (or answers). In the preferred embodiment, this is implemented by returning results of people who have authored information that in turn has been categorized in the semantic network, with the knowledge domains configured for the KIS. Essentially, this context template presents the user with dynamic, semantic communities of interest. It is a very powerful context template. Currently, most organizations use email distribution lists (or the like) to indicate communities of interest. However, these lists are hard to maintain and require that the administrator manually track (or guess) which people in the organization preferably belong to the list(s). With the Interest Group context template, however, the “lists” now become intelligent and semantic (akin to “smart distribution lists”). They are also contextual, a feature that manual email distribution lists lack.

Like with other context templates, the Interest Group context predicate in turn is interpreted by the server-side semantic query processor. This allows powerful queries like “Interest Group on XML” or “Interest Group on Bioinformatics.” Similarly, this would allow queries (via drag and drop and/or smart copy and paste) like “Interest Group on My Local Document” and “Interest Group on My Competitor (an entity).” The Interest Group context template also becomes a part of the Dossier (or Guide) context template (which displays all special agents for each context templates and loads them as sub-queries of the main agent/request).

In the preferred embodiment, the context template should have a time-limit for which it detects “areas of interest.” An example of this would be three months. The logic here is that if the user has not authored any information (most typically email) that is semantically relevant to the SQML filter (if available) in three months, the user either has no interest in that category (or categories) or had an interest but doesn't any longer.

3. Annotations of My Items—this is a context template that is a variant of Annotations but is further filtered with items that were published by the calling user. This will allow the user to monitor feedback specifically on items that he/she posted or annotated.

12. Importing and Exporting User State

The semantic browser will support the importation and exportation of user state. The user will be able to save his/her personal state to a document and export it to another machine or vice-versa. This state will include information (and metadata) on:
Default user state (e.g., computer sophistication level, default areas of interest, default job role, default smart styles, etc.)
Profiles
Entities (per profile)
Smart requests (per profile)
Local Requests (per profile)
Subscribed Knowledge Communities (per profile)

The semantic browser will show UI (likely a wizard) that will allow the user to select which of the user state types to import or export. The UI will also ask the user whether to include identity/logon information. When the UI is invoked, the semantic browser will serialize the user state into an XML document that has fields corresponding to the metadata of all the user state types. When the XML document is imported, the semantic browser will navigate the XML document nodes and add or set the user state types in the client environment corresponding to the nodes in the XML document.

13. Local Smart Requests

Local smart requests would allow the user to browse local information using categories from an knowledge community (agency). In the case of categorized local requests, the semantic client crawls the local hard drives, email stores, etc. extracts the metadata (including summaries) and stores the metadata in a local version of the semantic metadata store (SMS). The client sends the XML metadata (per object) to an knowledge community for categorization (via its XML Web Service). The knowledge community then responds with the category assignment metadata. The client then updates the local semantic network (via the local SMS) and responds to semantic queries just like the server would. Essentially, this feature can provide functionality equivalent to a local server without the need for one.

14. Integrated Navigation

Integrated Navigation allows the user to dynamically navigate from within the Presenter (in the main results pane on the right) and have the navigation be integrated with the shell extension navigation on the left. Essentially, this merges both stacks. In the preferred embodiment, this is accomplished via event signaling. When the Presenter wants to dynamically navigate to a new request, it sets some state off the GUID that identifies the current browser view. The GUID maps to a key in the registry that also has a field called ‘Navigation Event,’ ‘Next Namespace Object ID’ and ‘Next Path.’ The ‘Navigation Event’ field holds a DWORD value that points to an event handle that gets created by the current browser view when it is loaded. When the Presenter wants to navigate to a new request, it creates the request in the semantic environment and caches the returned ID of the request. It then dynamically gets the appropriate namespace path of the request (depending on the information/context type of the request) and caches that too. It then sets the two fields (‘Next Namespace Object ID’ and ‘Next Path’ with these two values). Next, it sets the ‘Navigation Event’ (in Windows™, this is done by calling a Win32 API named ‘SetEvent’).

To catch the navigation event, the browser view starts a worker thread when it first starts. This thread waits on the navigation event (and also simultaneously waits on a shutdown event that gets signaled when the browser view is being terminated—in Windows™, it does this via a Win32 API named ‘WaitForMultipleObjects’). If the navigation event is signaled, the ‘Wait’ API returns indicating that the navigation event was signaled. The worker thread then looks up the registry to retrieve the navigation state (the object id and the path). It then calls the shell browser to navigate to this object id and path (in Windows™, this is done by retrieving a ‘PIDL’ and then calling IShellBrowser::BrowseTo off the shell view instance that implements IShellView).

15. Hints for Visited Results

The Nervana semantic browser empowers the user to dynamically navigate a knowledge space at the speed of thought. The user could navigate along context, information or time axes. However, as the user navigates, he/she might be presented with redundant information. For instance, the user can navigate from a local document to ‘Breaking News’ and then from one of the ‘Breaking News’ result objects to ‘Headlines.’ However, semantically, some of the Headlines might overlap with the breaking news (especially if not enough time has elapsed). This is equivalent to browsing the Web and hitting the same pages over and over again from different ‘angles.’

The Nervana semantic browser handles this redundancy problem by having a local cache of recently presented results. The Presenter then indicates redundant results to the user by showing the results in a different color or some other UI mechanism. The local cache is aged (preferably after several hours or the measured time of a typical ‘browsing experience’). Old entries are purged and the cache is eventually reset after enough time might have elapsed.

Alternately, at the users option, the redundant results can be discarded and not presented at all. Specifically, the semantic browser will also handle duplicate results by removing duplicates before rendering them in the Presenter—for instance if objects with the same metadata appear on different Knowledge Communities (agencies). The semantic browser will detect this by performing metadata comparisons. For unstructured data like documents, email, etc., the semantic browser will compare the summaries—if the summaries are identical the documents are very likely to be identical (albeit this is not absolutely guaranteed, especially for very long documents).

16. Knowledge Federation

Client-Side Knowledge Federation

Client-side Knowledge Federation which allows the user to federate knowledge communities and operate on results as though they came from one place (this federation feature was described in my parent application Ser. No. 10/179,651). In the preferred embodiment, such Client-side Knowledge Federation is accomplished by the semantic browser merging SRML results as they arrive from different (federated) KISes.

Server-Side Knowledge Federation

Server-Side Knowledge Federation is technology that allows external knowledge to be federated within the confines of a knowledge community. For instance, many companies rely on external content providers like Reuters™ to provide them with information. However, in the Information Nervous System, security and privacy issues arise—relating to annotations, personal publications, etc. Many enterprise customers will not want sensitive annotations to be stored on remote servers hosted and managed by external content providers.

To address this, external content providers will provide their content on a KIS metadata cache, which will be hosted and managed by the company. For instance, Reuters™ will provide their content to a customer like Intel™ but Intel™ will host and manage the KIS. The Intel™ KIS would crawl the Reuters™ KIS (thereby chaining KIS servers) or the Reuters™ DSA. This way, sensitive Intel™ annotations can be published as ‘Post-Its’ using Reuters™ content as context while Intel™ will still maintain control over its sensitive data.

Federated Annotations

Federated annotations is a very powerful feature that allows the user to annotate an object that comes from one agency/server (KIS) and annotate the object with comments (and/or attachment(s))—like “Post-Its” on another server. For example, a server (call it Server A) might not support annotations (this is configurable by the administrator and might be the common case for Internet-based servers that don't have a domain of trust and verifiable identity). A user might get a document (or any other semantic result) from Server A but might want to annotate that object on one or more agencies (KISes) that do support annotations (more typically Intranet or Extranet-based agencies that do have a domain of trust and verifiable identity). In such a case, the annotation email message would include the URI of the object to be annotated (the email message and its attachment(s) would contain the annotation itself). When the server crawls its System Inbox and picks up the email annotation, it scans the annotation's encoded To or Subject field and extracts the URI for the object to be annotated. If the URI refers to a different server, the server then invokes an XML Web Service call (if it has access) to that server to get the SRML metadata for the object. The server then adds the SRML metadata to its Semantic Metadata Store (SMS) and adds the appropriate semantic links from the email annotation to the SRML object. This is very powerful because it implies that users of the agency would then view the annotation and also be able to semantically navigate to the annotated object even though that object came from a different server.

If the destination server (for the annotation) does not have access to the server on which the object to be annotated resides, the destination server informs the client of this and the client then has to get the SRML from the server (on which the object resides) and send the complete SRML back to the destination server (for the annotation). This embodiment essentially implies that the client must first “de-reference” the URI and send the SRML to the destination server, rather than having the destination server attempt to “de-reference” the URI itself. This approach might also be superior for performance reasons as it spreads the CPU and I/O load across its clients (since they have to do the downloading and “de-referencing” of the URI to SRML).

Semantic Alerts for Federated Annotations

In the same manner that semantic browser would poll each KIS in the currently viewed user profile for “Breaking News” relevant to each currently viewed object on a regular basis (e.g., every minute), the same will be performed for annotations. Essentially, this resembles polling whether each object that is currently displayed “was just annotated.” For annotations that are not federated (i.e., annotations that have strong semantic links to the objects they annotate), this is a straightforward SQML call back to the KIS from whence the annotated object came. However, for federated annotations, the process is a bit more complicated because it is possible that a copy of object has been annotated on a different KIS even though the KIS from whence the object came doesn't support annotations or contain an annotation for the specific object.

In this case, for each object being displayed, the semantic browser would poll each KIS in the selected profile and pass the URI of the object to “ask” the KIS whether that object has been annotated on it. This way, semantic alerts will be generated even for federated annotations.

Annotation Hints

This refers to a feature where the KIS returns a context attribute indicating that an object has been annotated. This can be cached when the KIS detects an annotation (typically from the System Inbox) and is updating the semantic network. This context attribute then becomes a performance optimizer because for those objects with the attribute set, the client wouldn't have to query the KIS again to check if the object has been annotated. This amounts to caching the state of the object to avoid an extra (and unnecessary) roundtrip call to the KIS.

Another Perspective on Annotations

An interesting way to think of the Simple and Semantic Annotations feature of the Information Nervous System is that now every object/item/result in a user's knowledge universe will have its own contextual inbox. That way, if a user views the object, the inbox that is associated with the object's context is always available for viewing. In other words,

Category Naming and Identification (URIs) for Federated Knowledge Communities

This refers to how categories will be named on federated knowledge communities. For instance, a Reuters™ knowledge community (agency) deployed at Intel™ will be named Reuters@Intel with categories named like ‘Reuters@Intel/Information Technology/Wireless/80211’. In the preferred embodiment, every category will be qualified with at least the following properties:
Knowledge Domain ID—this is a globally unique identifier that uniquely identifies the knowledge domain from whence the category came
Name—this is the name of the category
Path—this is the full taxonomy path of the category

The preferred embodiment, the categories knowledge domain id (and not the name) is preferably used in the category URI, because the category could be renamed as the knowledge domain evolves (but the identifier should remain the same). An example of a category URI in the preferred embodiment is:

nerv://c9554bce-aedf-4564-81f7-48432bf8e5a0?type=category&path=Information Technology/Wireless/80211

In this example, the knowledge domain id is c9554bce-aedf-4564-81f7-48432bf8e5a0, the URI type is “category” and the category path is “Information Technology/Wireless/80211”.

17. Anonymous Annotations and Publications

The semantic browser will also allow users to anonymously annotate and publish to an knowledge community (agency). In this mode, the metadata is completely stored (with the user identity) but is flagged indicating that the publisher wishes to remain anonymous. This way, the Inference Engine can infer using the complete metadata but requests for the publisher will not reveal his/her identity. Alternately, the administrator will also be able to configure the knowledge community (agency) such that the inference engine cannot infer using anonymous annotations or publications.

18. Offline Support in the Semantic Browser

The semantic browser will also have offline support. The browser will have a cache for every remote call. The cache will contain entries to XML data. This could be SRML or could be any other data that gets returned from a call to the XML Web Service. Each call is given a unique signature by the semantic browser and this signature is used to hash into the XML data. For instance, a semantic query is hashed by its SQML. Other remote calls are hashed using a combination of the method name, the argument names and types, and the argument data.

For every call to the XML Web Service, the semantic runtime client will extract the signature of the call and then map this to an entry in the local cache. If the browser (or the system) is currently offline, the client will return the XML data in the cache (if it exists). If it does not exist, the client will return an error to the caller (likely the Presenter). If the browser is online, the client will retrieve the XML data from the XML Web Service and update the cache by overwriting the previous contents of the file entry with a file path indicated by the signature hash. This assumes that the remote call actually goes through—it might not even if the system/browser is online, due to network traffic and other conditions. In such a case, the cache does not get overwritten (it only gets overwritten when there is new data; it does not get cleared first).

19. Guaranteed Cross-Platform Support in the Semantic Browser

Overview

As discussed in my parent application (Ser. No. 10/179,651), the Information Nervous System can be implemented in a cross-platform manner. Standard protocols are preferably employed where possible and the Web service layer should use interoperable Web service standards and avoid proprietary implementations. Essentially, the test is that the semantic browser does not have to “know” whether the Knowledge community (or agency) Web service it is talking to is running on a particular platform over another. For example, the semantic browser need not know whether the Web service it is talking to is running on Microsoft's NET™ platform or Sun's J2EE™ platform (to take 2 examples of proprietary application servers), a Linux or any other “open source” server. The Knowledge community Web service and the client-server protocol should employ Web service standards that are commonly supported by different Web service implementations like NET™ and J2EE™.

In an ideal world, there will be a common set of standards that would be endorsed and properly implemented across Web service vendor implementations. However, this might not be the case in the real world, at least not yet. To handle a case where the semantic browser must handle unique functionality in different Web service implementations, the Knowledge community schema is preferably extended to include a field that indicates the Web service platform implementation. For instance, a NET™ implementation of the Knowledge community is preferably published with a field that indicates that the platform is NET™. The same applies to J2EE™. The semantic browser will then have access to this field when it retrieves the metadata for the Knowledge community (either directly via the WSDL URL to the Knowledge community, or by receiving announcements via multicast, the enterprise directory (e.g., LDAP), the Global Knowledge community Directory, etc.).

The semantic browser can then issue platform-specific calls depending on the platform that the Knowledge community is running on. This is not a recommended approach but if it is absolutely necessary to make platform-specific calls, this model is preferably employed in the preferred embodiment.

20. Knowledge Modeling

Knowledge Modeling refers to the recommended way enterprises will deploy an Information Nervous System. This involves deploying several KIS servers (per high-level knowledge domain) and one (or at most few) KDS (formerly KBS) servers that host the relevant ontology and taxonomy. KIS servers are preferably deployed per domain to strike a balance between being too narrow such that there is not enough knowledge sharing possibility of navigation and inference in the network and being too high that scalability (in storage and CPU horsepower needed by the database and/or the inference engine) becomes a problem. Of course, the specific point of balance will shift over time as the hardware and software technologies evolve, and the preferred embodiment does not depend on the particular balance struck. In addition, KIS servers are preferably deployed where access control becomes necessary at the server level (for higher-level security) as opposed to imposing access control at the group level with multiple groups sharing the same KIS. For instance, a large pharmaceutical company could have a knowledge community KIS for oncology for the entire company and another KIS for researchers working on cutting-edge R&D and applying for strategic patents. These two KIS' might crawl the same sources of information but the latter KIS would be more secure because it would provide access only to users from the R&D group. Also, optionally, these researchers' publications and annotations will not be viewable on the corporate KIS.

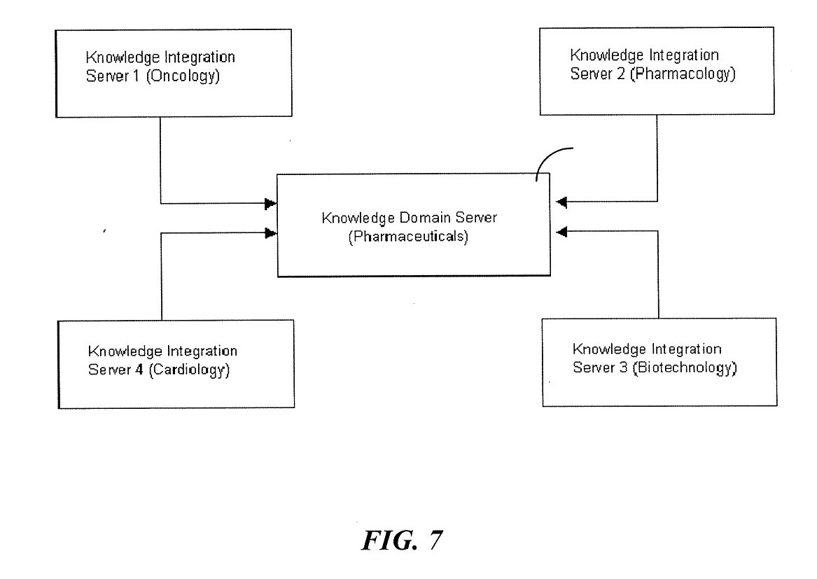

FIG. 7 illustrates an example of a possible knowledge architecture for a pharmaceuticals company. As shown in FIG. 7, the KDS can serve several subsidiary KIS', as follows:

Client

Knowledge Integration Server 1 (Oncology)

Knowledge Integration Server 2 (Pharmacology)

Knowledge Integration Server 3 (Biotechnology)

Knowledge Integration Server 4 (Cardiology)

Knowledge Domain Server (Pharmaceuticals)

21. KIS Housekeeping Rules

The Knowledge Integration Server (KIS) will allow the admin to set up ‘housekeeping’ rules to purge old or stale metadata. This will prevent the SMS on the KIS from growing infinitely large. These rules could be as simple as purging any metadata older than a certain age (between 2-5 years depending on the company's policies for keeping old data) and which does not have any annotations and that is not marked as a favorite (or rated).

22. Client Component Integration & Interaction Workflow

The client components of the system can be integrated in several different steps or sequences, as can the workflow interaction or usage patterns. In the presently preferred embodiment, the workflow and component integration would be as follows:

1) Shell: User implicitly creates a SQML query (i.e. an agent) via UI navigation or a wizard.

2) Shell: User opens an agent (via tree or folder view).

3) The query buffer is saved as a file, and a registry entry created is created for the agent.
a) Registry entry contains: Agent Name, Creation date, Agent (Request)-GUID, SQML path, Comments, Namespace object type (agency, agent, blender, etc), and attributes

4) Shell: The request is handed off to the presenter:
a) A registry request GUID entry is created containing (namespace path that generated the request, and SQML file URL).
b) Browser is initialized and opened with command line [http] ://PresenterPage.html#RequestGUID[http]://presenterpage.html/. The Presenter loads default Chrome contained in the page.
c) Presenter page loads presenter binary behavior and Semantic Runtime OCX.

5) Presenter: Loads SQML and issues requests via the query manager.
a) Resolves request GUID to get SQML file path.
b) Loads SQML file into buffer, creates resource handler requests, passes them to resource handlers, waits for and gathers results. Summarization of local resources happens here. All summarization follows one of two paths: Summarize the doc indicated by this file path, or summarize this text (extracted from clipboard, Outlook™, Exchange™, etc.). Both paths produce a summary in the same form, suitable for inclusion in a request to the semantic server XML Web service.
c) Compiles SQML file into individual server request buffers, including any resource summary from above.
d) Initiates Server Requests by calling semantic runtime client Query Manager.

6) Query Manager: Monitors server requests and makes callback on data. It also signals an event on request completion or timeout. The callback is into the Presenter, which mean inter-process messaging to pass the XML.

7) Presenter: receives data and loads appropriate skin:
a) Receives SRML data in buffer; this will happen incrementally.
b) Determines if there is a preferred skin (smart style) associated with this agent, otherwise chooses default skin.
c) Transforms SRML into preferred skin format via XSLT. This is multistage, for the tree of results (root is list, then objects, then Deep/Lens/BN info) as results come in.
d) Display results in target DIV in page. The target is an argument to the behavior itself and is defined by the root page.

8) Presenter: Calls Semantic Runtime to fill context panels (per context template), deep info, smart copy and paste, and other semantic commands. The Presenter also loads the smart style, which then loads semantic images, motion, etc. consistent with the semantics of the request.

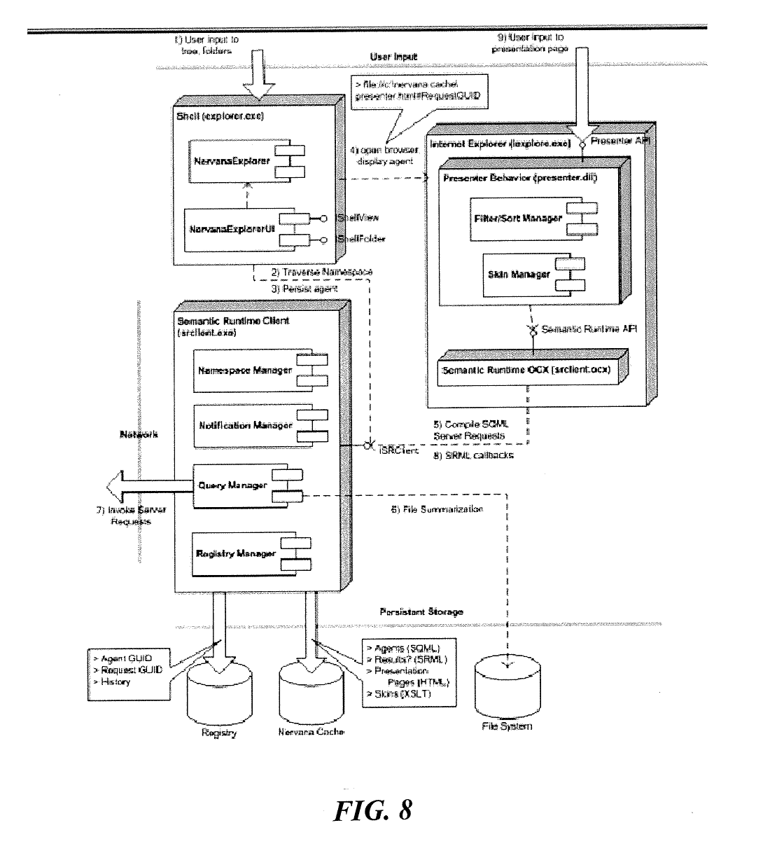

FIG. 8 illustrates the presently preferred client component integration and interaction workflow described above.

23. Categories Dialog Box User Interface Specification

a. Overview

The Categories Dialog Box allows the user to select one or more categories from a category folder (or taxonomy) belonging to a knowledge domain. While more or fewer can be deployed in certain situations, in the preferred embodiment, the dialog box has all of the following user interface controls:

1. Profile—this allows the user to select a profile with which to filter the category folders (or taxonomies) based on configured areas of interest. For instance, if a profile has areas of interest set to “Health and Medicine,” selecting that profile will display only those category folders that belong to the “Health and Medicine” area of interest (for instance, Pharmaceuticals, Healthcare, and Genes). This control allows the user to focus on the taxonomies that are relevant to his/her knowledge domain, without having to see taxonomies from other domains.

2. Area of Interest—this allows the user to select a specific area of interest. By default, this combo box is set to “My Areas of Interest” and the profile combo box is set to “All Profiles.” This way, the dialog box will display category folders for all areas of interest for all profiles. However, by using the “Area of Interest” combo box, the user can directly specify an area of interest with which to filter the category folders, regardless of the areas of interest in his/her profile(s).

3. Publisher Domain Zone/Name—this allows the user to select the domain zone and name of the taxonomy publisher. This is advantageous to distinguish publishers that might have name collisions. In the preferred embodiment, the Publisher Domain Name uses the DNS naming scheme (for instance, IEEE.org, Reuters.com™). The domain zone allows the user to select the scope of the domain name. In the preferred embodiment, the options are Internet, Intranet, and Extranet. The zone selection further distinguishes the published category folder (or taxonomy). A fairly common case would be where a department in a large enterprise has its own internal taxonomy. In this case, the department will be assigned the Intranet domain zone and will have its own domain name—for instance, Intranet\Marketing or Intranet\Sales.

4. Category Folder—this allows the user to select a category folder or taxonomy. When this selection is made, the categories for the selected category folder are displayed in the categories tree view.

5. Search categories—this allows the user to enter one or more keywords with which to filter the currently displayed categories. For instance, a Pharmaceuticals researcher could select the Pharmaceuticals taxonomy but then enter the keyword “anatomy” to display only the entries in the taxonomy that contain the keyword “anatomy.”

6. “Remember” check box—this allows the user to specify whether the dialog box should “remember” the last search when it exits. This is very helpful in cases where the user might want to perform many similar category-based searches/requests from the same category folder and with the same keyword filter(s).

7. Search Options—these controls allow the user to specify how the dialog box should interpret the keywords. The options allow the user to select whether the keywords should apply to the entire hierarchy of each entry in the taxonomy tree, or whether the keywords should apply to only the [end] names of the entries. For instance, the taxonomy entry “Anatomy\Cells\Chromaffin Cells” will be included in a hierarchy filter because the hierarchy includes the word “Anatomy.” However, it will be excluded from a names filter because the end-name (“Chromaffin Cells”) does not include the word “Anatomy.”

Also, the search options allow the user to select whether the dialog box should check for all keywords, for any keyword, or for the exact phrase.

8. Categories Tree View—the tree view displays the taxonomy hierarchy and allows the user to select one or more items to add to the Create Request Wizard or to open as a new Dossier (Guide) request/agent. The user interface breaks the category hierarchy into “category pages”—for performance reasons. The UI allows the user to navigate the pages via buttons and a slide control. There is also a “Deselect All” button that deselects all the currently selected taxonomy items.

9. Explore Button—this is the main invocation button of the dialog box. When the dialog box is launched from the Create Request Wizard, this button is renamed to “Add” and adds the selected items to the wizard “filters” property page. When the dialog box is launched directly from the application, the button is titled “Explore” and when clicked launches a Dossier request on the selected categories. If the user has multiple profiles or if multiple taxonomy categories are selected, the dialog box launches another dialog box, the “Explore Categories Options” dialog box that prompts the user to select the profile with which to launch the Dossier and/or the operator to use in applying the categories as filters to the Dossier (AND or OR).

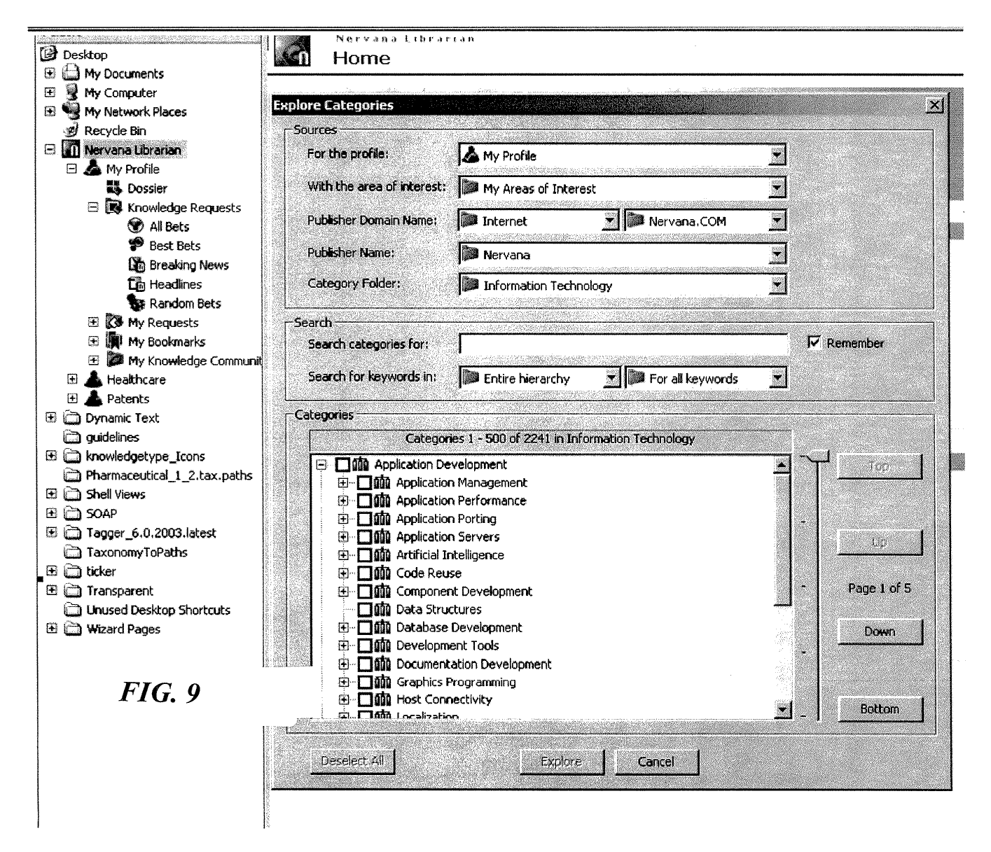

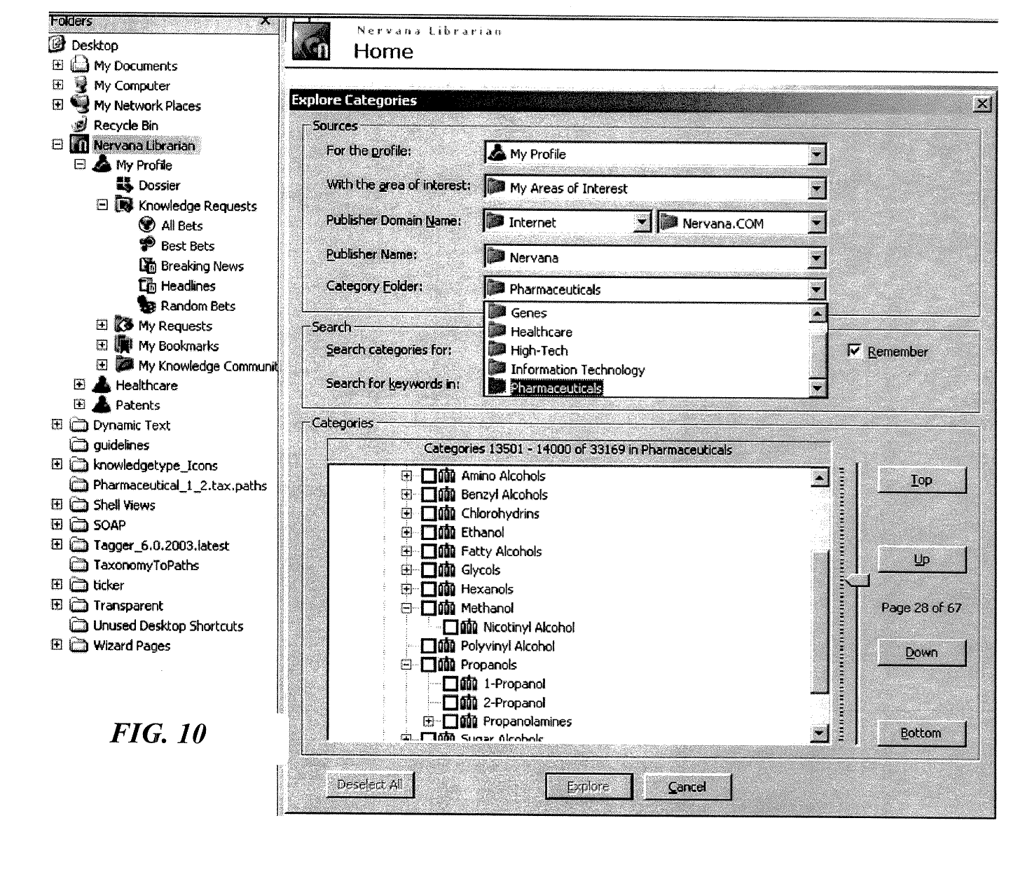

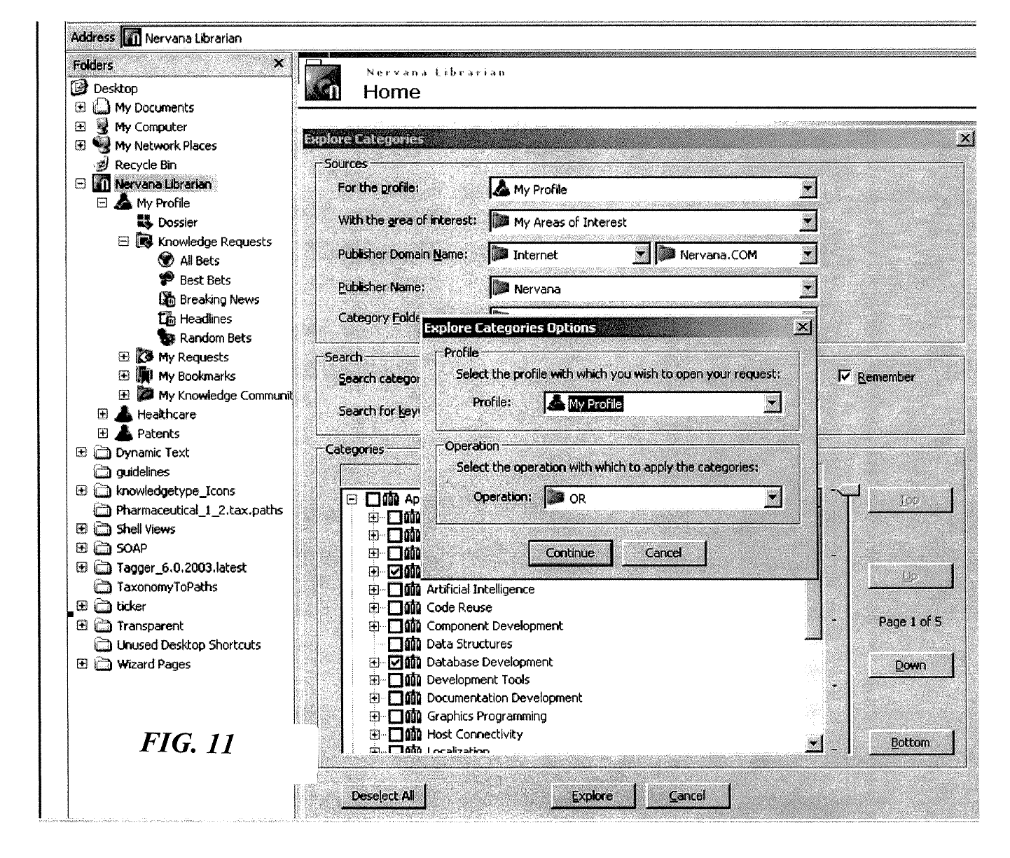

The features described above are illustrated in FIGS. 9-11, which show three different views of the Explore Categories dialog box.

24. Client-Assisted Server Data Consistency Checking

As the server (KIS) crawls knowledge sources, there will be times when the server's metadata cache is out of sync with the sources themselves. For instance, a web crawler on the KIS that periodically crawls the Web might add entries into the semantic metadata store (SMS) that become out of date. In this case, the client would get a 404 error when it tries to invoke the source URI. For data source adapters (DSAs) that have monitoring capabilities (for instance, for file-shares that can be monitored for changes), this wouldn't be much of an issue because the KIS is likely to be in sync with the knowledge source(s). However, for sources such as Web sites that don't have monitoring/change-notification services, this may present an issue of concern.

My parent application (Ser. No. 10/179,651) described how the KIS can use a consistency checker (CC) to periodically purge stale entries from the SMS. However, in some situations this approach might impair performance because the CC would have to periodically scan the entire SMS and confirm whether the indexed objects still exist. An alternative embodiment of this feature of the invention is to have the client (the semantic browser) notify the server if it gets a 404 error. To do this, the semantic browser would have to track when it gets a 404 error for each result that the user “opens.” For Web documents, the client can poll for the HTTP headers when it displays the results, even before the user opens the results. In this case, if the source web server reports a 404 error (object not found), the client should report this to the KIS.

When the KIS gets a “404 report” from the client, it then intelligently decides whether this means the object is no longer available. The KIS cannot arbitrarily delete the object because it is possible that the 404 error was due to an intermittent Web server failure (for instance, the directory on the Web server could have been temporarily disabled). The KIS should itself then attempt to asynchronously download the object (or at the very least, the HTTP headers in the case of a Web object) several times (e.g., 5 times). If each attempt fails, the KIS can then conclude that the object is no longer available and remove it from the SMS. If another client reports the 404 error for the same object while the KIS is processing the download, the KIS should ignore that report (since it is redundant).

This alternate technique could be roughly characterized as lazy consistency checking. In some situations, it may be advantageous and preferred.

25. Client-Side Duplicate Detection

The server (KIS) performs duplicate detection by checking the source URIs before adding new objects into the semantic metadata store (SMS). However, for performance reasons, it is sometimes advantageous if the server does not perform strict duplicate-detection. In such cases, duplicate detection is best performed at the client. Furthermore, because the client federates results from several KISes, it is possible for the client to get duplicates from different KISes. As such, it is advantageous if the client also performs duplicate detection.

In the preferred embodiment, the client removes objects that are definitely duplicates and flags objects that are likely duplicates. Definite duplicates are objects that have the same URI, last modified time stamp, summary/concepts, and size. Likely duplicates are objects that have the same summary/concepts, but have different URIs, last modified times, or sizes. For objects for which summary extraction is difficult, it is recommended that the title also be used to check for likely duplicates (i.e., objects that have the same summary but different titles are not considered likely duplicates because the summary might not be a reliable indicator of the contents of the object). Also, if summary/concept extraction is difficult (in order to detect semantic overlap/redundancy), the semantic browser can limit the file-size check to plus or minus N % (e.g., 5%)—for instance, an object with the same summary/concepts and different URIs, last-modified times, and sizes might be disqualified as a likely duplicate if the file-size is within 5% of the file-size of the object it is being compared to for redundancy checking.

26. Client-Side Virtual Results Cursor

The client (semantic browser) also provides the user with a seamless user experience when there are multiple knowledge communities (agencies) subscribed to a user profile. The semantic browser preferably presents the results as though they came from one source. Similarly, the browser preferably presents the user with one navigation cursor—as the user scrolls, the semantic browser re-queries the KISes to get more results. In the preferred embodiment, the semantic browser keeps a results cache big enough to prevent frequent re-querying—for instance, the cache can be initialized to handle enough results for between 5-10 scrolls (pages). The cache size are preferably capped based on memory considerations. As the cursor is advanced (or retreated), the browser checks if the current page generates a cache hit or miss. If it generates a cache hit, the browser presents the results from the cache, else if re-queries the KISes for additional results which it then adds to the cache.

The cache can be implemented to grow indefinitely or to be a sliding window. The former option has the advantage of simplicity of implementation with the disadvantage of potentially high memory consumption. The latter option, which is the preferred embodiment, has the advantage of lower memory consumption and higher cache consistency but with the cost of a more complex implementation. With the sliding window, the semantic browser will purge results from pages that do not fall within the window (e.g., the last N—e.g., 5-10—pages as opposed to all pages as with the other embodiment).

27. Virtual Single Sign-On

The client (semantic browser) also provides the user with a seamless user experience when authenticating the user to his/her subscribed knowledge communities (agencies). It does this via what the inventor calls “virtual single sign-on.” This model involves the semantic browser authenticating the user to knowledge communities without the user having to enter his/her username and password per knowledge community. Typically, the user will have a few usenames and passwords but might have many knowledge communities of which he/she is a member (especially within a company based on departmental or group access, and on Internet-based knowledge communities). As such, the ratio of the number of knowledge communities to the number of authentication credentials (per user) is likely to be very high.

With virtual single sign-on, the user specifies his/her logon credentials to the semantic browser in a server (knowledge community)-independent fashion. The semantic browser stores the credentials in a Credential Cache Table (CCT). The CCT has columns as illustrated below:

| | | | |
|---|---|---|---|
| Account Name | User Name | Password | Knowledge Community |
| | | | Entry List |

Account Name—this is a friendly name for the account
User Name—this is the logon user name (e.g., an email address)
Password—this is the password, stored encrypted with a secure private key
Knowledge Community Entry List (KCEL)—this is a list of knowledge communities that authenticate the user using the credentials for this account

When the user first attempts to subscribe to a knowledge community (or access the knowledge community in some other way—for instance, to get the properties of the community), the semantic browser prompts the user for his/her password and then tries to logon to the server using the supplied credentials. If a logon is successful, the semantic browser creates a new CCT entry (CCTE) with the supplied credentials and adds the KC to the Knowledge Community Entry List (KCEL) for the new CCT entry.

For each subsequent subscription attempt, the semantic browser checks the CCT to see if the KC the user is about to subscribe to is in the KCEL for any CCTE. If it is, the semantic browser retrieves the credentials for the CCTE and logs the user on with those credentials. This way, the user does not have to redundantly enter his/her logon credentials.

Note that the semantic browser also supports pass-through authentication when the operating system is already logged on to a domain. For instance, if a Windows™ machine is already logged on to an NT (or Active Directory™) domain, the client-side Web service proxy also includes the default credentials to attempt to logon to a KC. In the preferred embodiment, the additional credentials supplied by the user are preferably passed via SOAP security headers (via Web Services Security (WS-Security) or a similar scheme). For details of WS-Security and passing authentication-information in SOAP headers, see [http]://[www].oasis-open.org/committees/download.php/3281/WSS-SOAPMessageSecurity-17-082703-merged.pdf

The semantic browser exposes a property to allow the user to indicate whether the credentials for a CCTE are preferably purged when the KCEL for the CCTE is empty or whether the credentials should be saved. In the preferred embodiment, the credentials are preferably saved by default unless the user indicates otherwise. If the user wants the credentials purged, the semantic browser should remove a KC from a CCTE in which it exists when that KC is no longer subscribed to any profile in the browser. If after removing the KC from the CCTE's KCEL, the CCTE becomes empty, the CCTE is preferably deleted from the CCT.

The virtual single sign-on feature, like many of the features in this application, could be used in applications other than with my Information Nervous System or the Virtual Librarian. For example, it could be adapted for use by any computer user who must log into more than one domain.

28. Namespace Object Action Matrix

The table below shows the actions that the semantic browser invokes when namespace objects are copied and pasted onto other namespace objects.

| | Destination | | | | | | | | |
|---|---|---|---|---|---|---|---|---|---|
| | | Portfolio | | | | | | Knowledge | |
| | | (Entity | Object | | Default | | Dossier | Community | Application |
| Source | Entity | Collection) | (Result) | Profile | Profile | Request | (Guide) | (Agency) | (Root Icon) |
| Entity | Object | Copy | Object | Copy | Copy | Query | Dossier | Dossier | N/A (Open |
| | Lens | | Lens | | | | Query | Query | as bookmark |
| | (Dossier) | | (Dossier) | | | | | (from KC) | in default |
| | | | | | | | | | profile in |
| | | | | | | | | | alternative |
| | | | | | | | | | embodiment) |
| Portfolio | Object | Copy | Object | Copy | Copy | Query | Dossier | Dossier | N/A (Open |
| (Entity | Lens | (contents) | Lens | | | | Query | Query | as bookmark |
| Collection) | (Dossier) | | (Dossier) | | | | | (from KC) | in default |
| | | | | | | | | | profile in |
| | | | | | | | | | alternative |
| | | | | | | | | | embodiment) |
| Object | Object | Object | Object | Copy | Copy | Query | Dossier | Dossier | (Open as |
| (Result) | Lens | Lens | Lens | (Bookmark) | (Bookmark) | | Query | Query | bookmark in |
| | (Dossier) | (Dossier) | (Dossier) | | | | | (from KC) | default |
| | | | | | | | | | profile) |
| Profile | N/A | N/A | N/A | N/A | N/A | N/A | N/A | N/A | N/A |
| Default | N/A | N/A | N/A | N/A | N/A | N/A | N/A | N/A | N/A |
| Profile | | | | | | | | | |
| Request | Smart | Smart Lens | Smart | Copy | Copy | Agent | Dossier | Dossier | Copy (to |
| | Lens | | Lens | | | Lens | Agent | Agent Lens | default |
| | | | | | | | Lens | (from KC) | profile) |
| Dossier | Dossier | Dossier | Dossier | Copy | Copy | Dossier | Dossier | Dossier | Copy (to |
| (Guide) | Smart | Smart Lens | Smart | | | Agent | Agent | Agent Lens | default |
| | Lens | | Lens | | | Lens | Lens | (from KC) | profile) |
| Knowledge | Dossier | Dossier | Dossier | Copy | Copy | Dossier | Dossier | Dossier | Copy |
| Community | Smart | Smart Lens | Smart | (subscribe) | (subscribe) | Agent | Agent | Agent Lens | (subscribe) |
| (Agency) | Lens | (from KC) | Lens | | | Lens | Lens | (from | to default |
| | (from KC) | | (from KC) | | | (from | (from | source KC) | profile |
| | | | | | | KC) | KC) | | |

29. Dynamic End-to-End Ontology/Taxonomy Updating and Synchronization

The Information Nervous System™ will support dynamic updates of ontologies and taxonomies. Knowledge domain plug-ins that are published by Nervana (or that are provided to Nervana by third-party ontology publishers) will be hosted on a central Web service (an ontology depot) on the Nervana Web domain (Nervana.com). Each KDS will then periodically poll the central Web service via a Web service call (for each of its knowledge domain plug-ins, referenced by the URI or a globally unique identifier of the plug-in) and will “ask” the Web service if the plug-in has been updated. The Web service will use the last-modified timestamp of the ontology file to determine whether the plug-in has been updated. If the plug-in has been updated, the Web service will return the new ontology file to the calling KDS. The KDS then replaces its ontology file.

If the KDS is running during the update, it will ordinarily temporarily stop the service before replacing the file, unless it supports file-change notifications and reloads the ontology (which is the recommended implementation).

Each KIS also has to poll each KDS it is connected to in order to “ask” the KDS if its ontology has changed. In the preferred embodiment, the KIS should poll the KDS and not the central Web service in case the KDS has a different version of the ontology. The KDS also uses the last modified time stamp of the knowledge domain plug-in (the ontology) to determine if the ontology has changed. It then indicates this to the KIS. If the ontology has changed, the KIS needs to update the semantic network accordingly. In the preferred embodiment, it does this by removing semantic links that refer to categories that are not in the new version of the ontology and adding/modifying semantic links based on the new version of the ontology. In an alternative embodiment, it purges the semantic network and re-indexes it.

The client then polls each KIS it is subscribed to in order to determine if the taxonomies it is subscribed to (directly via the central Web service or via the KISes) have changed. The KIS exposes a method via the XML Web service via which the client determines if the taxonomy has changed (via the last modified time stamp of the taxonomy/ontology plug-in file). If the taxonomy has changed, the client needs to update the Categories Dialog user interface (and other UI-based taxonomy dependents) to show the new taxonomy.

For taxonomies that are centrally published (e.g., via Nervana), the client should poll the central Web service to update the taxonomies.

With this model, the client, KIS, KDS, and central taxonomy/ontology depot will be kept synchronized.

30. Invoking Dossier (Guide) Queries

Dossier Semantic Query Processing

Dossier (Guide) queries are preferably invoked by the client-side semantic query processor by parsing the SQML of the request/agent and replacing the Dossier context predicate with each special agent (context template) context predicate—e.g., All Bets, Best Bets, Breaking News, Headlines, Random Bets, Newsmakers, etc. Each query (per context template) is then invoked via the query processor—just like an individual query. This way, the user operates at the level of the Dossier but the semantic browser maps the dossier to individual queries behind the scenes.

For example, the SQML for “Dossier on Category C” is parsed and new SQML queries are generated as follows:
All Bets on Category C
Best Bets on Category C
Breaking News on Category C
Headlines on Category C
Random Bets on Category C
Newsmakers on Category C
Etc.

The client-side semantic query processor retains every other predicate except the context predicate. This way, the filters remain consistent as illustrated by the example above.

Dossier Smart Lens

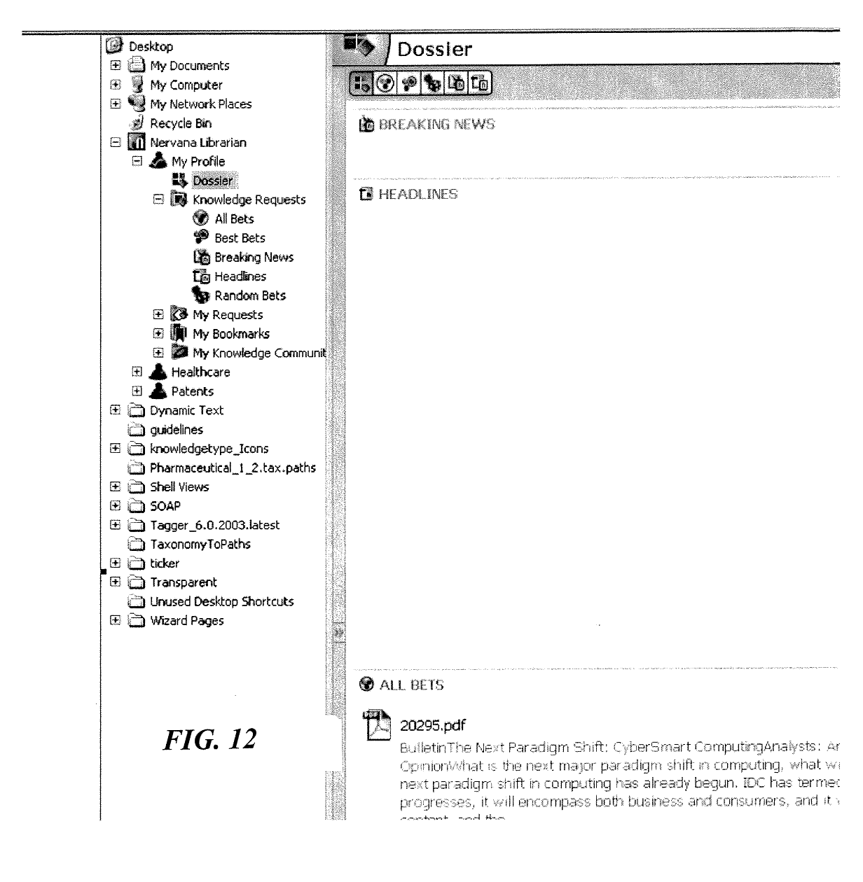

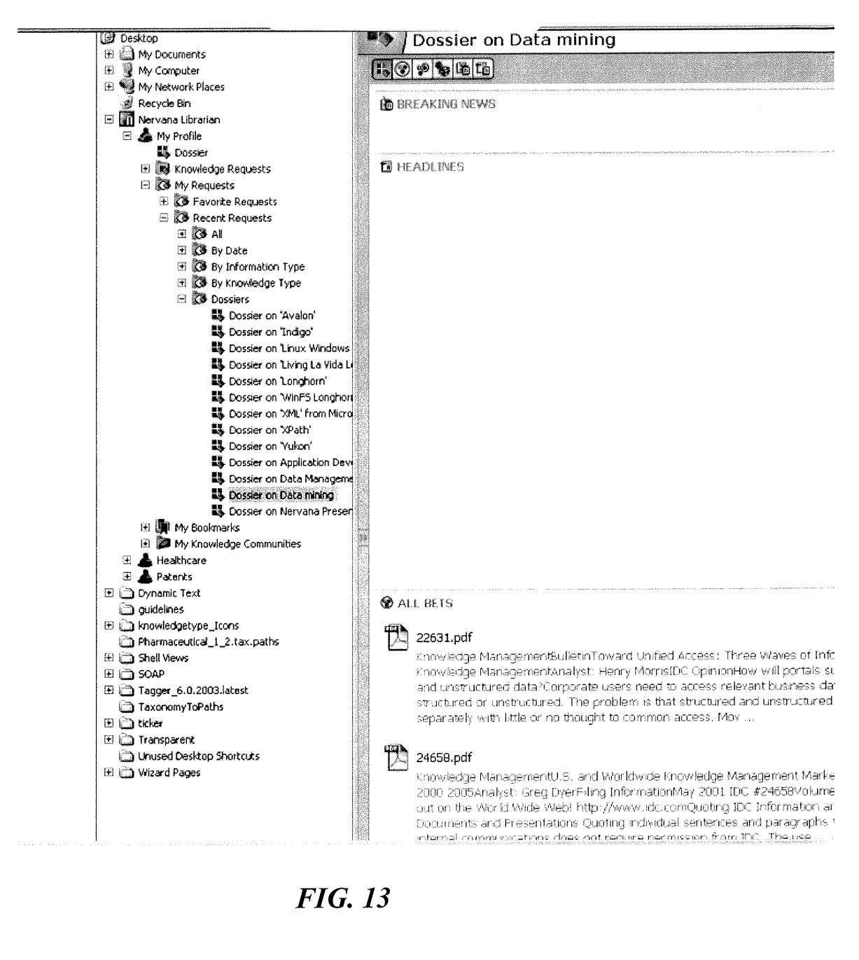

Like other requests/agents in the Information Nervous System™, dossiers (guides) can be used as a Smart Lens (just like how they can be targets for drag and drop, smart copy and paste, etc.). In this case, the smart lens displays a “Dossier Preview Window” with sections/tabs/frames for each context template (special agent). Sample screenshots of the Dossier showing the UI of the Dossier Smart Lens are included in FIGS. 12 and 13.

Dossier Screenshots

31. Knowledge Community (Agency) Semantics

The following describe the semantics of a knowledge community (agency) within the context of the semantic namespace/environment in the semantic browser:

1. Selecting a knowledge community—this opens a dossier request from that KC. Essentially, the Dossier becomes the equivalent of the KC's “home page.”

2. Drag and drop (document, text, entity, keywords, etc.) to a KC—this opens a Dossier request/agent on the object (using the default predicate) from the KC

3 . Copy KC to the clipboard—this selects KC as the Smart Lens. When the user hovers over a result or entity, the semantic browser displays the Smart Lens by showing the KC name and the KC's profile name under the cursor and then opens a Dossier from the KC on the object underneath the lens in the lens preview pane

4. Subscribing to a KC—when a KC is subscribed for the first time, the semantic browser adds the KC's email address to the local email contacts (e.g., in Microsoft Outlook™ or Outlook Express™). This makes it easy for the user to publish knowledge to the KC by sending it email (via the integrated contacts list). Similarly, when the KC is unsubscribed from all profiles, the semantic browser prompts the user whether it should remove the KC from the local email contacts list.

32. Dynamic Ontology and Taxonomy Mapping

One of the challenges of using taxonomies and ontologies is how to map the semantics of one taxonomy/ontology onto another. The Information Nervous System™ accomplishes this by the following algorithm:

Each KDS will be responsible for ontology mapping (via an Ontology Mapper (OM)) and will periodically update the central Web service (the ontology depot) with an Ontology Mapping Table (OMT). The updates are bidirectional: the KDS will periodically update its ontologies and taxonomies from the central Web service and send updates of the OMT to the central Web service. Each OMT will be different but the central ontology depot will consolidate all OMTs into a Master OMT. The ontology mapper will create a consistent user experience because the user wouldn't have to select all items in the umbrella taxonomy that are relevant but overlapping. The semantic browser will automatically handle this. The KIS wouldn't have any concept of the mapper but will get mapped results from the KDS which it will then use to update the semantic network.

The KDS and KIS administrators would still be responsible for selecting the right KDS ontology plug-ins, however—based on the quality of each ontology/taxonomy (the ontology mapping doesn't improve ontologies; it merely maps them).

33. Semantic Alerts Optimizations

Semantic Alerts in the semantic browser can be optimized by employing the following rule (in order):

For a given filter (e.g., result, document, text, keywords, entity):

1. Check for Headlines first.

2. If there are Headlines, check for Breaking News and Newsmakers.

This is because in the preferred embodiment, Headlines are implemented similar to Breaking News except with a larger time window. As a consequence, if there are no Headlines (in the preferred embodiment), there is no Breaking News. Also, in the preferred embodiment, Newsmakers are implemented by returning the authors of Headlines. As such, if there are no Headlines, there are no Newsmakers.

34. Semantic “News” Images

Both Corbis™ ([http]://[www].corbis.com) and Getty Images™ ([http]://[www].gettyimages.com) have “News” images that are constantly kept fresh. The Information Nervous System™ can use these kinds of images for semantic images that are not only context-sensitive but also “fresh.” This can be advantageous in terms of keeping the user interface interesting and “new.” For instance, “Breaking News on SARS” can show not only pharmaceutical images but images showing doctors responding to recent SARS outbreaks, etc.

35. Dynamically Choosing Semantic Images

Semantic images can be dynamically and intelligently selected using the following rules:

1. If the currently displayed namespace object is a request, parse the SQML of the object for categories. If there are categories, send the categories to the central Web service (that hosts the semantic image cache) to get images that are relevant to the categories. Also, send the request type (e.g., knowledge types like All Bets and Headlines, or information types like Presentations) to the central Web service to return images consistent with the request type

2. If the namespace object is not a request, send the areas of interest for the current profile (if available) to the central Web service. The Web service then returns semantic images consistent with the profile's areas of interest. If the profile does not have configured areas of interest, send the areas of interest for the application (the semantic browser). If the application does not have configured areas of interest, send an empty string to the central Web service—in this case, the central Web service returns generic images (e.g., branded images).

36. Dynamic Knowledge Community (Agency) Contacts Membership

Knowledge communities (agencies) have members (users that have read, write, or read-write access to the community) and contacts. Contacts are users that are relevant to the community but are not necessarily members. For example, a departmental knowledge community (KC) in a large enterprise would likely have the members of the department as members of the KC but would likely have all the employees of the enterprise as contacts. Contacts are advantageous because they allow members of the KC to navigate users that are semantically relevant to the KC but might not be members. The KC might semantically index sent by contacts—the index in this case would include the contacts even though the contacts are not members of the KC.

Another way to think of this is that communities of knowledge in the real world tend to have core members and peripheral members. Core members are users that are very active in the community while peripheral members include “other” users such as knowledge hobbyists, occasional contributors, potential recruits, and even members of other relevant communities.

With dynamic KC contacts membership in the Information Nervous System™, the KIS will add users to its Contacts table in the semantic metadata store (SMS) and to the semantic network “when and as it sees them” (in other words, as it indexes email messages that have new users that are not members). This allows the community to dynamically expand its contacts, but in a way that distinguishes between Members and mere Contacts, and “understands” the importance of the distinction semantically when operating the system (e.g., executing searches and the like).

37. Integrated Full-Text Keyword and Phrase Indexing

The KIS also indexes concepts (key phrases) and keywords as first-class members of the semantic network. This can be done in a domain-independent fashion as follows:

For each new object (e.g., documents) to be added to the semantic network:

1. Extract concepts (key phrases) from the body of the object.

2. For each concept, add the concept to the semantic network with the object type id OBJECTTYPEID_CONCEPT. Add a semantic link with the predicate PREDICATETYPEID_CONTAINSCONCEPT to the “Semantic Links” table with the new object as subject and the new concept object as the subject.

3. For the current concept, extract the keywords from the concept key phrase and add each keyword to the semantic network with the object type id OBJECTTYPEID_KEYWORD. Also, add a semantic link with the predicate PREDICATETYPEID_CONTAINSKEYWORD to the “Semantic Links” table with the new object as subject and the new keyword object as the subject.

Repeat the steps above for the title of the object and other meta-tags as appropriate for the schema of the object.

While some embodiments do not require integrated full-text indexing, it is included in the presently preferred embodiment because it provides several useful advantages:

1. It allows a consistent model for implementing semantic filters (in SQML). The user can add categories, documents, entities, and keywords as filters and the filters are applied consistently to the semantic network (as sub-queries).

2. In particular, it supports the semantic query processing of entities. Entities can be defined with categories and can be further narrowed with keywords (to disambiguate the keywords in the case where the keywords could mean different things in different contexts). Integrated full-text indexing allows the KIS semantic query processor (SQP) to interpret entities seamlessly—by applying the necessary sub-queries with categories and keywords/concepts to the semantic network.

3. In general, integrated full-text indexing results in a seamless and consistent data and query model.

38. Semantic “Mark Object as Read”

In some cases, the KIS might not have the resources to store semantic links between People and objects on a per-object basis. In addition, semantic-based redundancy is not the same as per-object redundancy—as in email. To take an example, email clients allow users to select an email message as read or unread—this is typically implemented as a flag stored on the mail server with the email message. However, because email is not a semantic system, a semantically similar or identical message on the server would not be flagged as such—the user has to flag each message separately regardless of semantic redundancy.

In the Information Nervous System™, the user is able to flag an object as read not unlike in email. However, in this case, the semantic browser extracts the concepts from the object and informs all the KISes in the request profile that the “concepts” have been read. The KIS then dynamically maps the concepts to categories via the KDSes it is configured with and adds a flag to the objects belonging to those categories (in the preferred embodiment) and/or adds a flag to the semantic network with a semantic link with the predicate PREDICATETYPEID_VIEWEDCATEGORY between the categories corresponding to the concepts and all the objects that are linked to the categories. In the preferred embodiment, the KIS should only flag those categories over a link-strength threshold (for the source concepts). This ensures that only those objects (in the preferred embodiment) and/or categories that are semantically close to the original object will be flagged.

When the semantic browser flags the object via the KISes, the KISes should return a flag indicating whether the network was updated (it is possible that no changes would be made in the event that the object does not have any “strong” categories or if there are no other objects that share the same “strong” categories). If at least one KIS in the request profile indicates that the network was updated, the semantic browser should refresh the request/agent. The semantic browser can expose a property to allow the user to indicate whether he/she wants the KISes to return only unread objects or all objects (read or unread), in which case the browser should display unread objects differently (like how email clients display unread messages in a bold font). The presentation layer in the semantic browser should then display the read and unread objects with an appropriate font and/or color to provide a clear visual distinction.

39. Multi-Select Object Lens

Multi-select object lens is an alternative implementation of the object lens that was described in my parent application. In that embodiment, the object lens was invoked via smart copy and paste—pasting an object over another object would invoke the object lens with the appropriate default predicate. This has the benefit of allowing the user to copy objects across instances of the semantic browser, across profiles, and from other environments (like the file-system, word processors, email clients, etc.).

In the currently preferred embodiment, the object lens is a Dossier Lens (the context predicate is a Dossier, the filters are the source and target objects, and the profile is the profile in which the source object was displayed).

Multi-selection can also be used instead of copy and paste to invoke an object lens. The semantic browser will allow the user to select multiple objects (results). The user can then hit a button (or alternative user-interface object) to invoke the object lens on the selected objects. In this case, a Dossier Lens will be displayed (in a preview pane) with a Dossier context predicate, with the filters as the selected objects, and the current profile as the request profile.

40. Ontology-Based Filtering and Spam Management

The KIS (in the preferred embodiment) would only add objects to the Semantic Metadata Store (SMS) if those objects belong to at least one category from at least one of the knowledge domains the KIS is configured with (via one or more KDSes). This essentially means the KIS will not index objects it “does not understand.” The exception to this is that the KIS will index all objects from its System Inbox—because this contains at-times personal community-specific publications and annotations that might be relevant but not always semantically relevant.

A side-effect of this ontology-based filtering model is spam management—ontology-based indexing would be effective in preventing spam from being indexed and stored. If users use the semantic browser to access email, as opposed to their inboxes, only email that has been semantically filtered will get through.

41. Results Refinement

The results of a request/agent can be further refined via additional filters and predicates. For example, the request/agent Headlines on Bioinformatics could be further refined with keywords specific to certain areas of Bioinformatics. This way, the end-user can further narrow the result set using the request/agent as a base. In addition, for time-sensitive requests, the user can specify a time-window to override the default time-window. For example, the default Breaking News time-request could be set to 3 hours. The user should be able to override this for a specific request/agent (in addition to changing the defaults on a per-profile or application-wide basis) with an appropriate UI mechanism (e.g., a slider control that ranges from 1 hour to 24 hours). The same applies to Headlines and Newsmakers (e.g., a slider control that ranges from 1 day to 1 week).

When the user specifies a filter-override, the semantic browser invokes the XML Web Service call for each of the KISes in the request profile and passes the override arguments as part of the call. If override arguments are present, the Web service uses those values instead of the default filter values. The same applies to additional filters (e.g., keywords)—these will be passed as additional arguments to the Web service and the Web service will apply additional sub-queries appropriately to further filter the query that is specified in the agent/request SQML (in other words, the SQML is passed as always, but in addition, the filter overrides and additional filters are also passed).

A good case for filter-overrides will be for Best Bets. The default semantic relevance strength for Best Bets could be set to 90% (in the preferred embodiment). However, for a given request/agent, the user might want to see “bets” across a semantic relevance range. Exposing a relevance UI control (e.g., a slider control that ranges from 0% to 100%) will allow this. This essentially allows the user to change the Best Bets on the fly from “All Bets” (0%) all the way to “Perfect Bets” (100%).

A hybrid model should also be employed for embodiments of context template (special agent) implementations that involve multiple axes of filtering. For instance, Breaking News could also impose a relevance filter of 25% and Headlines and Newsmakers could impose a relevance filter of 50% (Breaking News has a lower relevance threshold because it has a higher time-sensitivity threshold; as such, the relevance threshold can be relaxed). In this case, the semantic browser should expose UI controls to allow the user to refine the special agents across both axes (a slider control for time-sensitivity and another slider control for relevance).

With dossiers, the semantic browser can display UI controls for each special agent displayed in the Dossier—the main Dossier pane can show all the UI controls (changing any UI control would then refresh the Dossier sub-request for that special agent). Also, if the Dossier has tabs for each special agent, each tab can have a UI control specific to the special agent for the tab.

42. Semantic Management of Information Stores

The Information Nervous System™ can also be used to manage information stores such as personal email inboxes, personal contact lists, personal event calendars, a desktop file-system (e.g., the Microsoft Windows Explorer™ file-management system for local and network-based files), and also other stores like file-shares, content management systems, and web sites.

For client-based stores (such as email inboxes and file-systems), the client runtime of the semantic browser should periodically poll the store via a programmatic interface to check for items that have become redundant, stale, or meaningless. This would address the problem today where email inboxes keep growing and growing with stale messages that might have “lost their meaning and relevance.” However, due to the sheer volume of information users are having to cope with, many computer users are losing the ability to manage their email inboxes themselves, resulting in a junk-heap of old and perhaps irrelevant messages that take up storage space and make it more difficult to find relevant messages and items.

The client runtime should enumerate the items in the user's information stores, extract the concepts from the items (e.g., from the body of email messages and from local documents) and send the concepts to the KISes in the user's profiles. In an alternative embodiment, only the default profile should be used. The client then essentially “asks” the user's subscribed KISes whether the items mean anything to them. In the preferred embodiment, the client should employ the following heuristics:

1. First, check for redundancy—by flagging (or deleting) duplicate email items, duplicate documents that share concepts and summaries (but perhaps with different titles or file-sizes). The client should either delete the duplicate items (user-configurable) or flag the items by moving them into a special folder (user-configurable) in the email client or desktop.

2. Next, for non-duplicate items, the client should check for meaninglessness or irrelevance. First, the client should only check items that are “older” than N days (e.g., 30 days) by examining the last-modified time of the email item, document, or other object. For items that qualify, extract the concepts and call the XML Web Service for each KIS in all the user's profiles (or the default profile in an alternative embodiment).

3 . For very old items (e.g., older than 180 days), the client should specify a very low threshold of meaning to the XML Web Service (e.g., 25%) for preservation. Essentially, this is akin to deleting (or flagging) those items that are very old and weak in meaning.

4. For fairly old items (e.g., older than 90 days old but younger than 180 days old), the client should specify a very low threshold (e.g., 10%) for preservation. This is akin to deleting (or flagging) those items that are fairly old and very weak in meaning.

5. For old items (but not too old—e.g., older than 1 day old but younger than 30 days old), the client should specify a very low threshold (e.g., 0%) for preservation. This is akin to deleting (or flagging) those items that are old (but not too old) but are meaningless, based on the user's profile(s).

Essentially, the model for this aspect or feature of the preferred embodiment balances semantic sensitivity with time-sensitivity by imposing a higher semantic threshold on younger items (thereby preserving items that might be largely—albeit not totally—meaningless if they are fairly young. For example, fairly recent email threads might be very weak in meaning—the client should preserve them anyway because their “youth” is also a sign of relevance. As they “age,” however, the client can safely delete them (or flag them for deletion).

This model can also be applied to manage documents on local file-systems. The model can be extended to content-management systems, document repositories, etc. by configuring an Information Store Monitor (ISM) to monitor these systems (via calls to the Information Nervous System™ XML Web Services) and configuring the ISM with KISes that are configured with KDSes that have ontologies consistent with the domain of the repositories to be semantically managed. This feature will save storage space and storage/maintenance costs by semantically managing content management systems and ensuring that only relevant items get preserved on those systems over time.

43. Slide-Rule Filter User Interface

The refinement pane in the semantic browser allows the user to “search within results.” The user will be able to add additional keywords, specify date ranges, etc. The date-range control can be implemented like a slide-rule. Shifting one panel in the slide-rule would shift the lower date boundary while moving the other panel will shift the upper date boundary. Other panels can then be added for time boundaries—shifting both time and date panels will impose both date and time constraints. Panels can also be added for other filter axes.

C. Server-side Semantic Query Processor Specification

1. Overview

This section describes a currently preferred embodiment of how the server-side semantic query processor (SQP) resolves SQML queries. On a given server, queries can be broken into several components:

a. Context (documents, keywords, entities, portfolios (or entity collections)).

b. Context/Knowledge Template (or Special Agent) or Information Template—this describes whether the request if for a knowledge type (e.g., Breaking News, Conversations, Newsmakers, or Popular Items) or for a particular information type (e.g., Documents, Email).

On the client, a semantic query is made up of the triangulation of context, request (or Agent) type, and the knowledge communities (or Agencies). The client sends the SQML that represents the semantic query to all the knowledge communities in the profile in which the request lives. The client asks for a few results at a time and then aggregates the results from one or more servers.

The server-side semantic query processor subdivides semantic queries into several sub-queries, which it then applies (via SQL inner joins or sub-queries in the preferred embodiment). These sub-queries are:

1. Request type sub-query—this represents a sub-query (semantic or non-semantic) depending on the request type. Examples are context (knowledge) types (e.g., All Bets, Best Bets, Headlines, Experts, etc.) and information types (like General Documents, Presentations, Web Pages, Spreadsheets, etc.).

2. Semantic context sub-query—this represents a semantic sub-query derived from the context (filter) passed from the client (an example of this is categories sent from the client or mapped from keywords/text via semantic stemming).

3. Non-semantic context sub-query—this represents a non-semantic sub-query derived from the context (filter) passed from the client (examples are keywords without semantic stemming—mapping to ontology-based categories).

4. Access-control sub-query—this represents a sub-query that filters out those items in the semantic metadata store (SMS) that the calling user does not have access to. For details, see the “Security” specification.

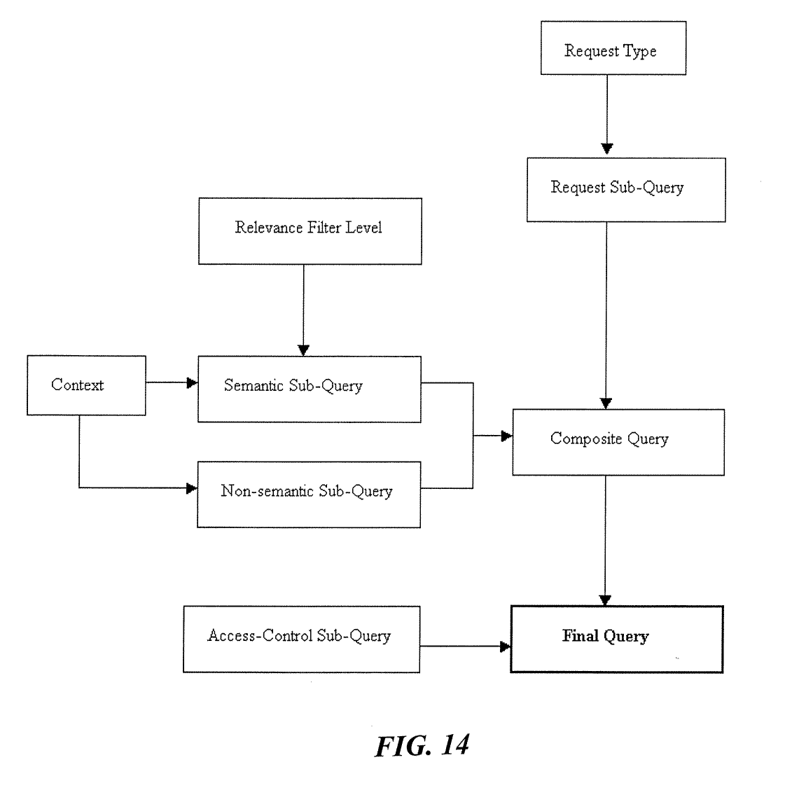

The foregoing steps are illustrated in FIG. 14 (Server-Side Semantic Query Processor Components). FIG. 14 shows how the server-side semantic query processor processes incoming semantic queries (represented as SQML).

2. Semantic Relevance Score

The semantic relevance score defines the normalized score that the concept extraction engine returns. It maps a given term of “blob” of text to one or more categories for a given ontology. The score is added to the semantic network (in the “LinkStrength” field of the “SemanticLinks” table) when items are added to the Semantic Network.

3. Semantic Relevance Filter

The relevance filter is different from the relevance score (indeed, both will typically be combined). The relevance filter indicates how the SQP will semantically interpret context (note: in the currently preferred embodiment, the filtering is always semantic in this case). There are two relevance filters: High and Low. With the High relevance filter, the SQP will include a sub-query that is the intersection of categories and terms. For instance, context for the keyword “XML” will be interpreted as: Items that share the same categories as XML and also include the keyword “XML.” This is the highest level of ontology-based semantic filtering that can occur. However, it could lead to information loss in cases where there are objects in the Semantic Network (or Semantic Metadata Store (SMS)) that are semantically equivalent to the context but that do not share its keywords or terms. For instance, the query described above would miss items that share the same categories as XML but which include the term “Extensible Markup Language” instead. A Low relevance filter will only include objects that share the same categories as the context but unlike the High relevance filter, would not include the additional constraint of keyword equivalence.

For this reason, the relevance filter is preferably used only to create sub-query “buckets” that are then used for ordering results. For instance, the SQP might decide to prioritize a High relevance filter ahead of a Low relevance filter when filtering the semantic network but would still return both (with duplicates removed) in order to help guarantee that synonyms don't get rejected during the final semantic filtering process.

4. Time-Sensitivity Filter

The time-sensitivity filter determines how time-critical the semantic sub-query is. There are two levels: High and Low. A High filter is meant to be extremely time-critical. Default is 3 hours (this accounts for lunch breaks, time away from the office/desk, etc.). A Low filter is meant to be moderately time-critical. The default is 12 hours.

5. Knowledge Type Semantic Query Implementations

Throughout this application certain specific knowledge types are referred to by apt shorthand names, some of which the applicant uses or may use as trademarks. This section explains the nature and function of some of these in greater detail.

a. All Bets

For “All Bets” queries, the server simply returns all the items in the semantic metadata store. If the SQML has filters, the filters are imposed via an inner sub-query with no semantic link strength threshold. For instance, All Bets on Topic A will return all items that have anything (strongly or barely) to do with Topic A.

b. Random Bets

In the preferred embodiment, for “Random Bets” queries, the server simply returns all the items in the semantic metadata store (like in the case of “All Bets” queries) but orders the results randomly. If the SQML has filters, the filters are imposed via an inner sub-query with no semantic link strength threshold. For instance, Random Bets on Topic A will return all items (ordered randomly) that have anything (strongly or barely) to do with Topic A.

C. Breaking News

If the server has user-state, Breaking News can be implemented in a very intelligent way. The table below illustrates the currently preferred ranking and prioritization for Breaking News when the server tracks what items (and/or categories) the user has read:

| | | Time- | Semantic | Primary | Secondary |
|---|---|---|---|---|---|
| | Sub-Query | Sensitivity | Relevance | Ordering | Ordering |
| Priority | Name | Filter | Filter | Axis | Axis |
| 1 | Breaking | Low | High | Creation | Semantic |
| | Unread | | | Time | Relevance |
| | Semantic | | | | Score |
| | News | | | | |
| 2 | Breaking | Low | Low | Creation | Semantic |
| | Unread | | | Time | Relevance |
| | Semantic | | | | Score |
| | News | | | | |
| 3 | Breaking | High | High | Creation | Semantic |
| | Read | | | Time | Relevance |
| | Semantic | | | | Score |
| | News | | | | |
| 4 | Breaking | High | Low | Creation | Semantic |
| | Read | | | Time | Relevance |
| | Semantic | | | | Score |
| | News | | | | |

In the preferred embodiment, the server processes SQML for Breaking News (via the Breaking News context predicate) as follows:

1. All breaking news is filtered with a sub-query that the returned news must be “younger” than N hours (or days, or months, configurable)—this imposes the key time-sensitivity constraint.

2. Breaking News is always semantic.

3. In the preferred embodiment, the Semantic Network Manager (SNM) should update the semantic network to indicate the “last read time” for each user to each category. This is then used in the sub-query to check whether news has been “read” or not (per category or per object—per category is the preferred embodiment because the latter will not scale).

4. Priority is given to news items that the user has not “read” (this is implemented by comparing the last read time in the SemanticLinks table with the semantic link type that links “User” to “Category”).

5. The implication of the semantic prioritization scheme is that the user could get “older” breaking news first because the news is more semantically relevant and “younger” breaking news “later” because the news is less semantically relevant. This results in a hybrid relevance-time sensitivity prioritization scheme.

6. The primary ordering axis (Creation Time) guarantees that results are filtered by freshness. The secondary ordering axis (Relevance Score) acts as a tiebreaker and guarantees that equally fresh results are distinguished primary based on relevance.

7. Breaking News Intrinsic Alerts can be implemented on the client by limiting the Breaking News priority to Priority 2 and by changing the Priority 1 and Priority time-sensitivity filters to high. This way, only very fresh Breaking Unread Semantic News (of both High and Low semantic relevance filters) will be returned. This is advantageous because the alert should have a higher disruption threshold than the Breaking News Request (or agent)—since it is implicit rather than explicit.

8. Unread Breaking News is higher priority than Read Breaking News because users are likely to be more interested in stuff they haven't seen yet.

9. Unread Breaking News has a lower time-sensitivity filter than Read Breaking News because users are likely to be more tolerant of older news that is new to them than younger news that is not.

In some cases, the server might not have user-state (and “read” information). In this case, a simple implementation of Breaking News is shown below:

1. By default (no filter), Breaking News should return only items younger than N hours (default is 3 hours).

2. If there is at least one filter in the SQML, Breaking News should apply the time-sensitivity filter (3 hours) to the outer sub-query and also apply a moderately strong relevance filter to the inner sub-query (off the SemanticLinks table). In the preferred embodiment, this should correspond to a relevance score (and link strength) of 50%. For instance, Breaking News on Topic A should return those items that have been posted in the last 3 hours and which belong to the category (or categories) represented by Topic A with at least a relevance score of 50%. This will avoid false positives like Breaking News items which are barely relevant to Topic A.

d. Headlines

Ditto with Breaking News (except that time-sensitivity constraints are more relaxed—e.g., the High filter is 12 hours instead of 3 hours and the low filter is 1 day instead of 12 hours). In the simple implementation, the time-sensitivity constraint is 1 day. This can also be made 3-days on Mondays to dynamically handle weekends (making the number of days the “number of working days”).

e. Newsmakers

Newsmakers are handled the same way as Headlines, except that the SQP returns the authors of the Headline items rather than the items themselves.

f. Best Bets

As described in my parent application (Ser. No. 10/179,651), Best Bets are implemented by imposing a filter on the strength of the semantic link with the “Belongs to Category” predicate. The preferred default is 90%, although the client (at the option of the user) can change this on the fly via an argument passed via the XML Web Service. Best Bets are implemented with a SQL inner join between the Objects table and the SemanticLinks table and joining only those rows in the SemanticLinks table that have the “Belongs to Category” predicate and a LinkStrength greater than 90% (default). When the SQML that is being processed contains filters (e.g., keywords, text, entities, etc.), the server-side semantic query processor must also invoke a sub-query, which is a SQL inner join that maps to the desired filters. In the preferred embodiment, this sub-query should also include a “Best Bets” filter.

In the preferred embodiment, it is advantageous and probably preferable for most users for the outer sub-query to be a Best Bet, and for the inner sub-query. To illustrate this, “Best Bets on Topic A” is semantically different from “Best Bets that are also relevant to Topic A.” In the first example, only Best Bets, which are Best Bets “ON” Topic A, will be returned (via applying the “Best Bets” semantic filter on the inner sub-query). In contrast, the second example will return Best Bets on anything that might have anything to do with Topic A. As such, the second example might return false positives because for example, a document, which is a Best Bet on Topic B but a “weak bet” on Topic B, will be returned and that is not consistent with the semantics of the query or the presumably desired results. Extending the “Best Bets” filter to not only the outer sub-query but also all inner sub-queries will prevent this from happening. Other query implementations can also follow this rule (with the right sub-queries applied based on the semantics of the main query) if the SQML contains filters.

g. Query Implementation for Other Knowledge Types

Other knowledge types are implemented in a similar fashion as above (via the right predicates). Several examples are described below.

Information Type Semantic Query Implementations

All information type semantic query implementations can follow, and preferably (but not necessarily) follow, the same pattern: the SQP returns only those objects that have the object type id that corresponds to the requested information type. An example is “Information Type\Presentations.” When the SQP parses the SQML received from the client, it extracts this attribute from the SQML and maps it to an object type id. It then invokes a SQL query with an added filter for the object type id. For special information types that could span several individual information types (such as “Information Type\All Documents”), the SQP maps the request to a set of object type ids and invokes a SQL query with this added filter.

Context Semantic Query Implementations

When the client sends SQML that contains concepts (extracted on the client from text or documents), the server-side SQP has to first semantically interpret the context before generating sub-queries that correspond to it. To do this, the server sends the concepts to all KDS'es (KBS'es) it is configured with (for the desired knowledge community or agency) for semantic categorization. When the server gets the categories back, it preferably determines which of those categories are “strong” enough to be used as filters before generating the appropriate sub-queries.

This “filter-strength” determination is advantageous because if the context is, for example, a fairly long document, that document could contain thousands of concepts and categories. As a result, the “representative semantics” of the document might be contained in only a subset of all the concepts/categories in the document. Mapping all the categories to sub-queries will return results that might be confusing to the user—the user would likely have a “sense” of what the document contains and if he/she sees results that are relevant to some weak concepts in the document, the user might not be able to reconcile the results with the document context. Therefore, in the preferred embodiment, the server-side SQP preferably chooses only “strong categories” to apply to the sub-queries. It is recommended that these be categories with a semantic strength of at least 50%. That way, only those categories that register strongly in the semantic context would be applied to the sub-query. The implementation of the sub-query would then follow the rules described above depending on whether the query contains a context predicate, is based on a knowledge type, information type, etc.

Semantic Stemming Implementation

As described in my parent application, the server-side semantic query processor performs semantic stemming to map keywords, text, and concepts to categories based on one or more domain ontologies. One way it does this by invoking an XML Web Service call to the KDS/KBS (or KDSes/KBSes) it is configured with in order to obtain the categories. It then maps the categories to its semantic network. This form of stemming is superior to regular stemming that is based on keyword variations (such as singular and plural variations, tense variations, etc.) because it also involves domain-specific semantic mapping that stems based on meaning rather than merely stemming based on keyword forms.

In the currently preferred embodiment, the KIS calls the KDS/KBS each time it receives SQML that requires further semantic interpretation. However, this could result in delays if the KDS/KBS resides on a different server, if the network connection is not fast, or if the KDS/KBS is busy processing many requests. In this case, the KIS can also implement a Semantic Stemming Cache. This cache maps keywords and concepts to categories that are fully qualified with URIs (making them globally unique). When the server-side semantic query processor receives SQML that contains keywords, text, or concepts (extracted from, say, documents on the client by the client-side semantic query processor), it first checks the cache to see if the keywords have already been semantically stemmed. If there is a cache hit, the SQP simply retrieves the categories from the cache and maps those categories to the semantic network via SQL queries. If there is a cache miss (i.e., if the context is not in the cache), it then calls the KDSes/KBSes to perform semantic categorization. It then takes the results, maps them to unique category URIs, and adds the entry to the cache (with the context as the hash code). Note that even if the context does not map to any category, the “lack of a category” is preferably cached. In other words, the context is added as a cache entry with no categories. This way, the server can also quickly determine that a given context does not have any categories, without having to call the KDSes/KBSes each time to find out.

Cache Management

The SQP can also manage the semantic stemming cache. It has to do this for two reasons: first, to keep the cache from growing uncontrollably and consuming too much system resources (particularly memory with a heap-based hash table); and, second, if the KIS configuration is changed (e.g., if knowledge domains are added/removed), the cache is preferably purged because the entries might now be stale. The first scenario can be handled by assigning a maximum number of entries to the cache. In the preferred embodiment, the SQP caches the current amount of memory consumed by the cache and the cache limit is dictated by memory usage. For example, the administrator might set the maximum cache size to 64MB. To simplify the implementation, this can be mapped to an approximate count of items (e.g., by dividing the maximum memory usage by an estimate of the size of each cache entry).

For each new entry, if the cache limit has not been reached, the SQP simply adds the entry to the cache. However, if the cache limit has been reached, the SQP (in the preferred embodiment) should purge the least recently added items from the cache. In the preferred embodiment, this can be implemented by keeping a queue of items that is kept in sync with a hash table that implements the cache itself (for quick lookups using the context as a key). When the SQP needs to purge items from the cache to free up space, it de-queues an item from the least-recently-added queue and also removes the corresponding item from the hash table (using the context as key). This way, fresh items are more likely to result in a cache hit than older items. This will result in a faster user experience on the client because context for saved agents/requests/queries will end up being cached with quick-lookups each time the user opens the agent/request/query. The same goes for Dossier (Guide) queries which will have the same context (but with different knowledge types)—the client will request for each knowledge type for the same context and since the context will be cached, each sub-query will execute faster.

D. Extensible Client-side User Profiles Specification for the Information Nervous System

Overview

Extensible client-side user profiles allow the user of a semantic browser to have a different state for different job roles, knowledge sources, identities, personas, work styles, etc. This essentially allows the user to create different “knowledge worlds” for different scenarios. For instance, a Pharmaceuticals researcher might have a default profile that includes all sources of knowledge that are relevant to his/her work. As described in my parent application Ser. No. 10/179,651, the SRML from each of these sources will be merged on the client thereby allowing the user to seamlessly go through results as though they were coming from one source. However, the researcher might want to track patents separate from everything else. In such a case, the researcher would be able to create a separate “Patents” profile and also include those knowledge communities (agencies) that have to do with patents (e.g., the US Patent Office Database, the EU Patent Database, etc.)

To take another example, for instance, the user might create a profile for ‘Work’ and one for ‘Home.’ Many investment analysts track companies across a variety of industries. With the semantic browser, they would create profiles for each industry they track. Consultants move from project to project (and from industry to industry) and might want to save requests and entities created with each project. Profiles will be used to handle this scenario as well.

Profiles contain the following user state:
Name/Description—the descriptive name of the profile.
One or more knowledge communities (agencies) that indicate the source of knowledge (running on a KIS) at which requests (agents) will be invoked.
Identity Information—the user name (currently tagged with the user's email address) and password.
Areas of Interest or Favorite Categories—this is used to suggest information communities (agencies) to the user (by comparing against information communities with identical or similar categories) and as a default query filter for requests created with the profile.
Smart styles—the smart styles to be used by default for requests and entities created with the profile.
Default Flag—this indicates whether the profile is the default profile. The default profile is initiated by default when the user wishes to create requests and entities, browse information communities, etc. Unless the user explicitly selects a different profile, the default profile gets used.

Profiles can be created, deleted, modified, and renamed. However, in the preferred embodiment the default profile cannot be deleted because there has to be at least one profile in the system at all times. In alternate embodiments, a minimum profile would not be required.

Preferably, all objects in the semantic browser are opened within the context of a profile. For instance, a smart request is created in a profile and at runtime, the client semantic query processor will use the properties of the profile (specifically the subscribed knowledge communities (agencies) in that profile) to invoke the request. This allows a user to correlate or scope a request to a specific profile based on the knowledge characteristics of the request (more typically the sources of knowledge the user wants to use for the request).

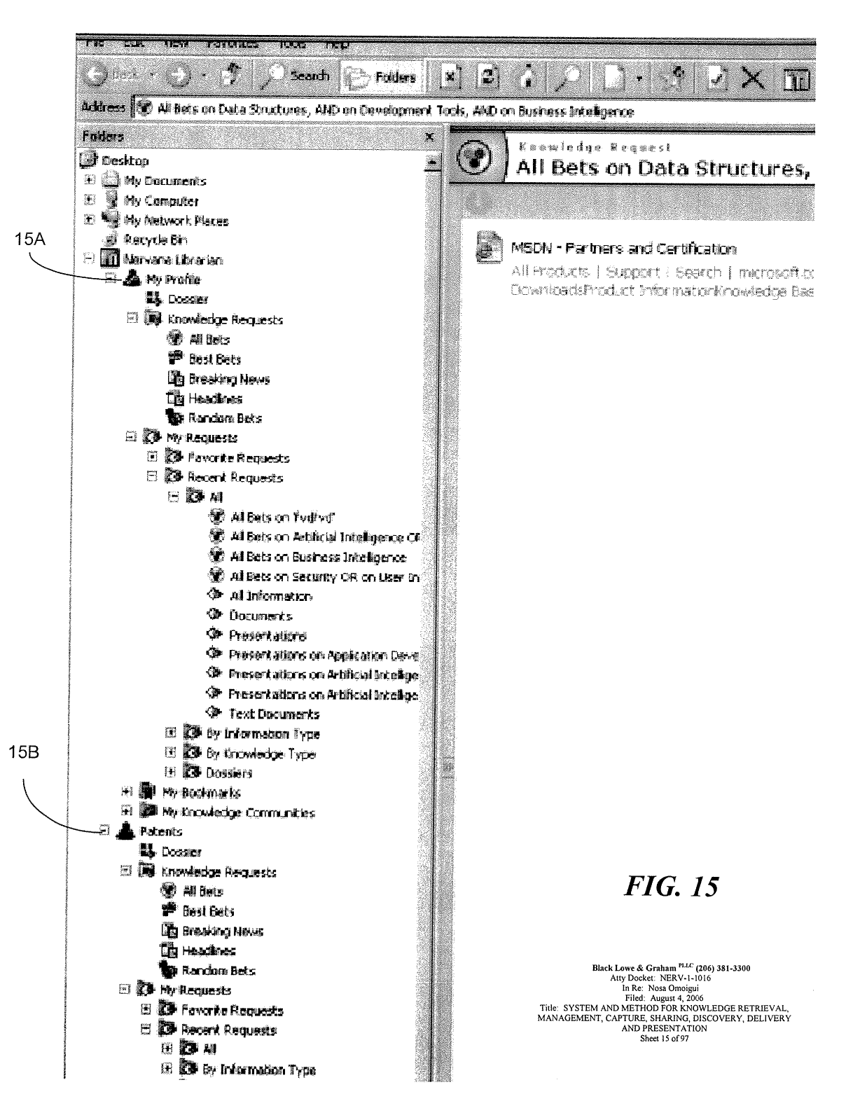

FIG. 15 illustrates the semantic browser showing two profiles (the default profile named “My Profile” and 15A and a profile named “Patents” 15B). Observe how the user is able to navigate his/her knowledge worlds via both profiles without interference.

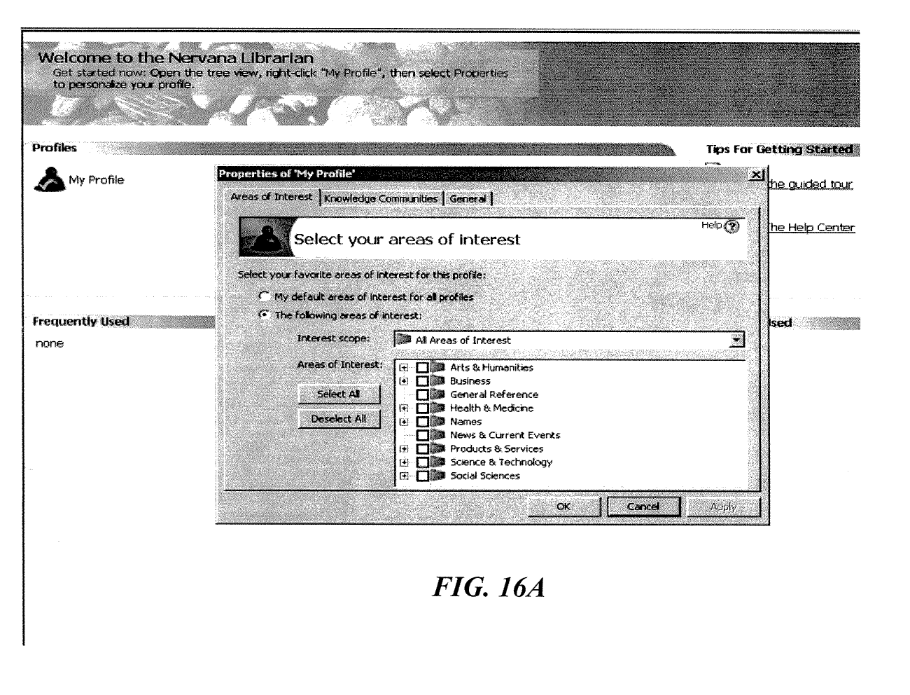

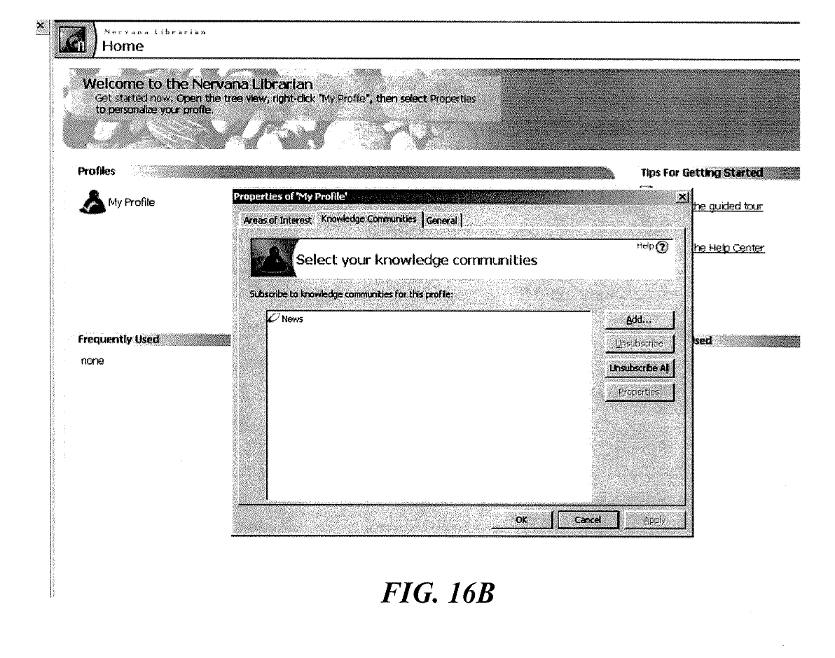

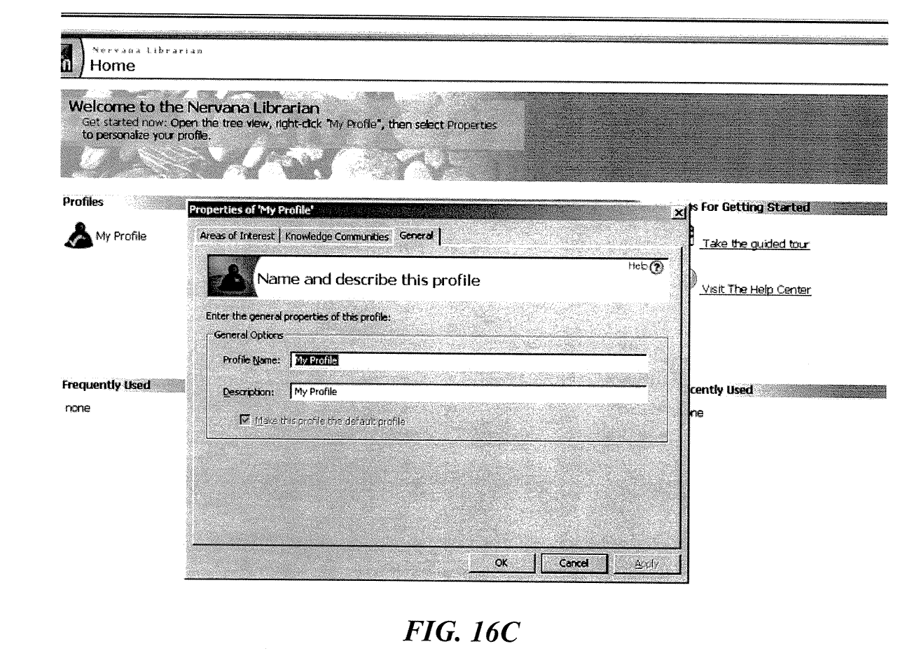

FIGS. 16A-C illustrate how a user would configure a profile (to create a profile, the user will use the “Create Profile Wizard” and the profile can then be modified via a property sheet as shown).

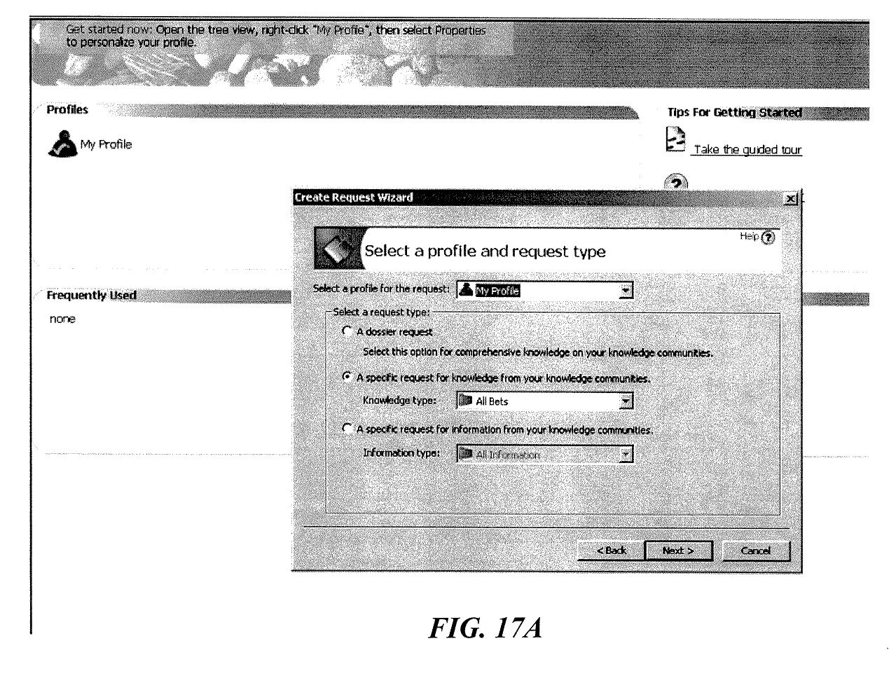

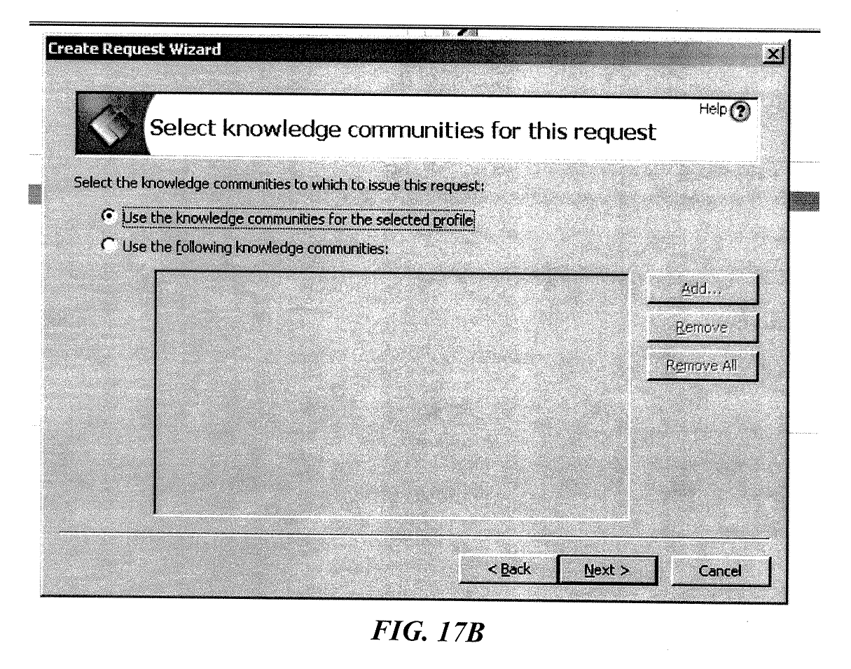

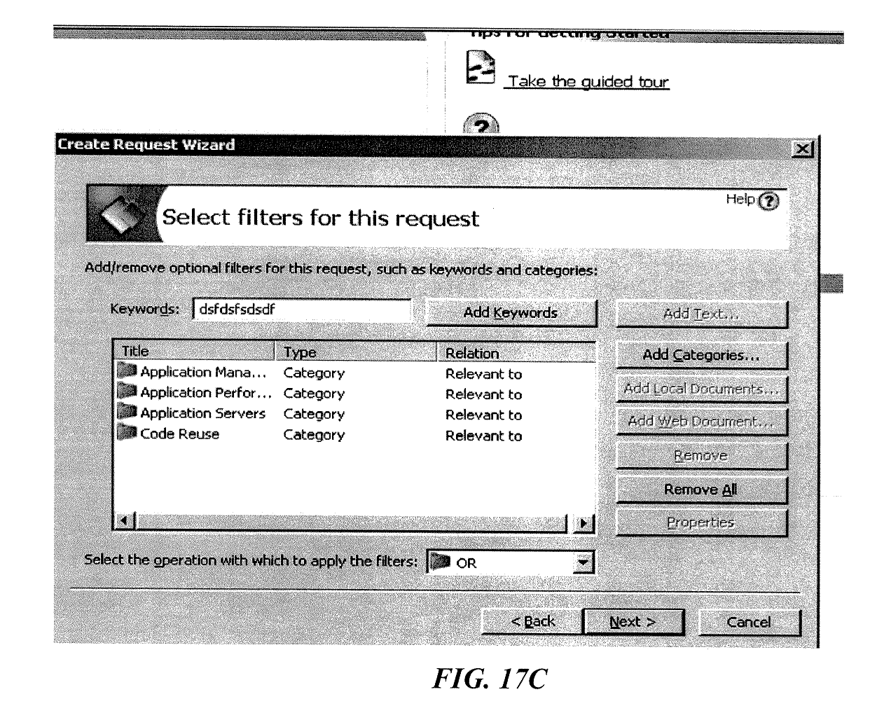

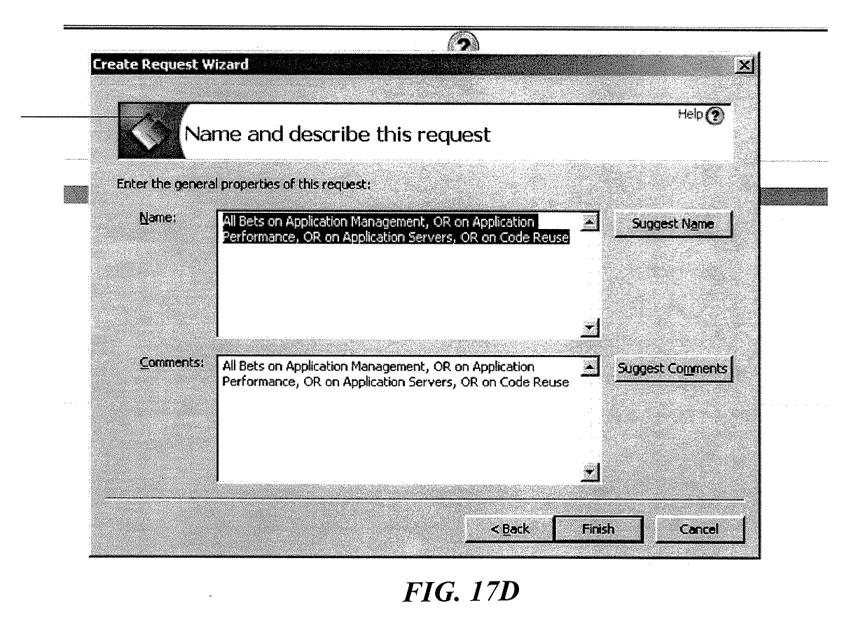

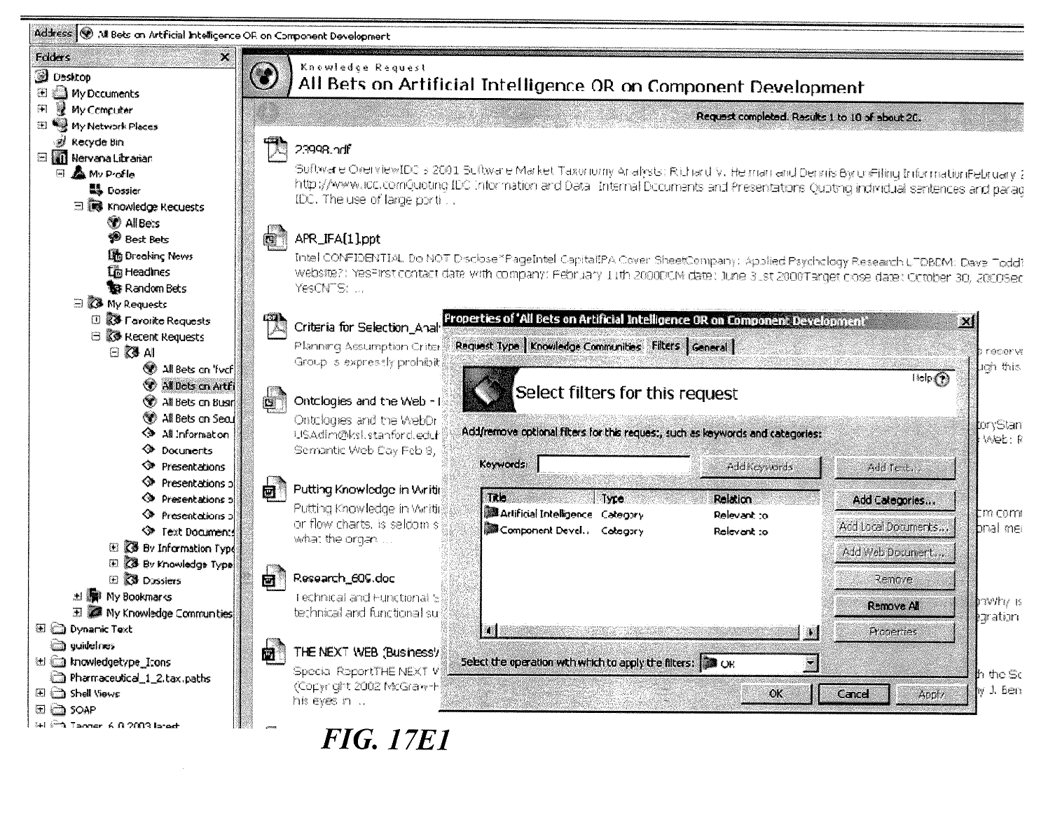

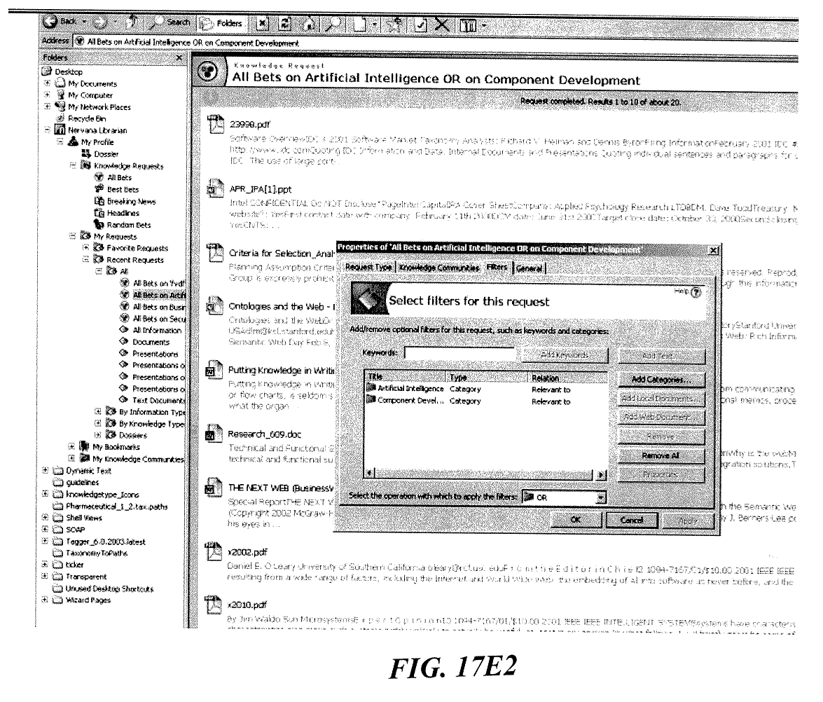

FIG. 17 shows how a user would select a profile when creating a request with the “Create Request Wizard.”

E. Smart Styles Specification or the Information Nervous System

1. Smart Styles Overview

A color theme and animation theme applied to a style theme yields a “smart style”. “Smart” in this context means the style is adaptive or responsive to the mood of its request, context panes, preview mode, handheld mode, live mode, slideshow mode, screensaver mode, blender/collection mode, accessibility, user settings recognition, and possibly other variables within the system (see below). There is an infinite number and kind or “Classes” of possible styles. The preferred embodiment comprises at least the following style Classes:

1. Subtle—for task-oriented productivity.

2. Moderate—for task-oriented productivity with some presentation effects.

3. Exciting—exciting effects (good for both primary and secondary machines, and for inactive Nervana Windows™—e.g., Nervana client Windows™ in the background or docked on the taskbar).

4. Super-exciting (great for smart screensavers with productivity—e.g., secondary machines—when the user is using his/her primary machine).

5 Sci-Fi (for Matrix fans, great for smart screensavers without specific need for productivity—e.g., when the user is away from his/her desk).

Style, Color & Animation Themes—Variable, unlimited—created by Nervana, and perhaps users and/or third party skin authors

2. Implicit and Dynamic Smart Style Properties

a. Mood—the smart style must convey the mood of the request (i.e., the request is a parameter passed to the smart style). This will involve semantic images, semantic motions, Visualizations, etc. that convey the semantically informed or semantically determined properties of the smart request (the context template or information type, the categories, whether there are filters (e.g., local documents), the information types of those filters, etc.)

b. Context panes—e.g., deep info pane (per object), dockable preview panes, dockable contextual PIP watch groups/panes, etc.

c. Preview Mode—each smart style must be able to display its results for preview (in a small window).

d. Handheld Mode—each smart style must be able to display its results optimized for a handheld device.

e. Live mode—each smart style must have a “live” mode during which it would display real-time semantic Visualizations (per object). This can be toggled on or off (e.g. if the user does not want real-time semantic Visualizations, or to save bandwidth that results from real-time Web service calls per object).

f. Slideshow mode—preferably, each smart style must be able to “play” the results of the request—like a live stream.

g. Screensaver mode—preferably, each smart style must be able to “play” the results of the request as a screensaver. This is a variant of slideshow mode, except in full-screen/theater mode.

h. Blender/collection mode—preferably, each smart style must change its UI appropriately if the request it is displaying is a blender/collection.

i. Accessibility—preferably, each smart style must support accessibility.

j. User settings recognition—the Nervana Librarian will allow users to indicate whether they are beginners, moderate users, or power-users, and their respective job function(s) (R&D, sales, marketing, executive, etc.). Preferably, each smart style considers (or is influenced by) these functions where appropriate.
Preferably, each smart style is responsible, consistent with the semantics of the request, for recognizing (or discerning or perceiving) and then Visualizing (or presenting or depicting or illustrating, consistent with what should deserve the user's attention):
the Mood of the Current Request (including semantic images, motion, chrome, etc.
a Change in the number of Items in the Current Request
the Mood of each object (intrinsically)
the Mood of each object's context (headlines, breaking news, experts, etc.)
Binary/Absolute issues or characteristics (e.g., is there breaking news, OR NOT? how many experts are there? how many headlines?) as distinct from issues that are matters of degree, or on a gradient or continuum
If the characteristic is on a gradient or continuum, perceiving the relative placement along it (e.g., how breaking is breaking news?, how critical are the headlines? what is the level of expertise for the experts?, etc.)
a change in each object's context (there is new breaking news, there are new annotations, etc.)
the RELATIVE criticality of each object being displayed (different sized view ports, different fonts, different chrome, etc.)
a request navigation and “loading” status (interstitials that INTRODUCE the mood of the new request being loaded)
all properties of any individual PIP Windows (animated with an animation control)
the addition of a new PIP window (to a PIP window palette)
any Resizing/Moving/Docking PIP Windows
any preview windows (for context palettes, “Visualization UI” on each object, timelines, etc.)
Sounds consistent with all of the foregoing Visualizations of mood and notifications (across the board)

FIG. 18 shows a screenshot with the ‘Smart Styles’ Dialog Box illustrating some of the foregoing operations and features. As can be seen, the Dialog Box allows the user to browse smart styles by pivoting across style classes, style themes, color themes, and animation themes. A preview window shows the user a preview of the currently selected smart style.

F. Smart Request Watch Specification for the Information Nervous System

1. Overview

Smart Request Watch refers to a feature of the Information Nervous System that allows users of the semantic browser (the Information Agent or the Librarian) to monitor (or “watch”) smart requests in parallel. This is a very advantageous feature in that it enhances productivity by allowing users to track several requests at the same time.

The feature is implemented in the client-side semantic runtime, the semantic browser, and skins that allow a configurable way of watching smart requests (via a mechanism similar to “Picture-In-Picture” (PIP) functionality in television sets). Preferably, one or more of the following software components are used:

1. The Request Watch List (RWL)

2. Request Watch Groups

3. The Notification Manager (NM)

4. Watch Group Monitors (WLM)

5. The Watch Pane

6. The Watch Window

2. Request Watch Lists (RWLs) and Groups (RWGs)

The Request Watch List is a list of smart requests (or smart agents) that the client runtime manages. This list essentially comprises the smart requests the user wishes to monitor. The Request Watch List comprises a list of entries, the Request Watch List Entry (RWLE) with the following data structure:

| | Field | |
|---|---|---|
| Field Name | Type | Field Description |
| RequestID | GUID | The unique identifier of the smart request |
| Notification Reference | DWORD | The reference count indicating whether the |
| Count | | Notification Manager should track whether |
| | | there are “new” objects for this smart request |
| RequestViewInstanceID | GUID | The unique identifier of the smart request |
| | | view instance that “owns” the RWLE. This |
| | | is used for dynamically added and browser- |
| | | instance-specific RWLEs like Categorized |
| | | Headlines, Breaking News, and Newsmakers (see |
| | | below). For system-wide RWLEs added |
| | | manually by the user or via non-categorized |
| | | Request Watch Rules (RWRs) (see below), |
| | | this entry is initialized to NULL. |
| LastUpdateTime | Date/Time | The last date/time the notification manager |
| | | updated the request results count |
| RequestResultsCount | DWORD | The number of results in the smart request |
| LastResultTime | Date/Time | The date/time of the most recently published |
| | | result |

The Request Watch List (RWL) contains an array or vector of RWLE structures. The Request Watch List Manager manages the RWL. The semantic browser provides a user interface that allows the user to add smart requests to the RWL—the UI talks to the RWLM to add and remove RWLEs to/from the RWL. The RWL is stored (and persisted) centrally by the client-side semantic runtime (either as an XML file-based representation or in a store like the Windows™ registry).

The RWL can also be populated by means of Request Watch Groups (RWGs). A Request Watch Group provides a means for the user to monitor a collection of smart requests. It also provides a simple way for users to have the semantic browser automatically populate the RWL based on configurable criteria. There are at least two types of RWGs: Auto Request Watch Groups and the Manual Request Watch Group. Auto Request Watch Groups are groups that are dynamically populated by the semantic browser depending on the selected profile, the profile of the currently displayed request, etc. The Manual Request Watch Group allows the user to manually populate a group of smart requests (regular smart requests or blenders) to monitor as a collection. The Manual Request Watch Group also allows the user to add support context types (e.g., documents, categories, text, keywords, entities, etc.)—in this case, the system will dynamically generate the semantic query (SQML) from the filter(s) and add the resulting query to the Manual Request Watch Group. This saves the user from having to first create a time-sensitive request based on one or more filters before adding the filters to the Watch Group—the user can simply focus on the filters and the system will do the rest.

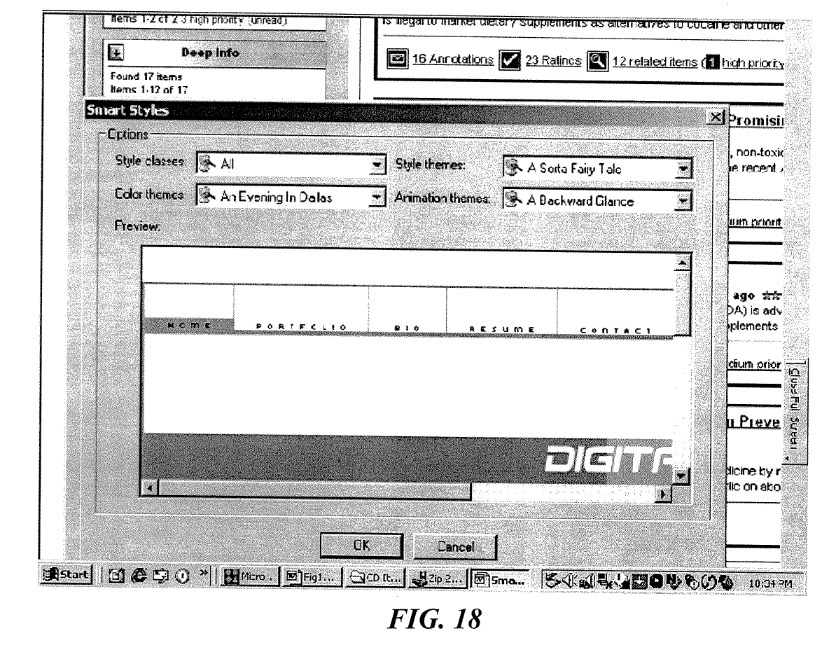

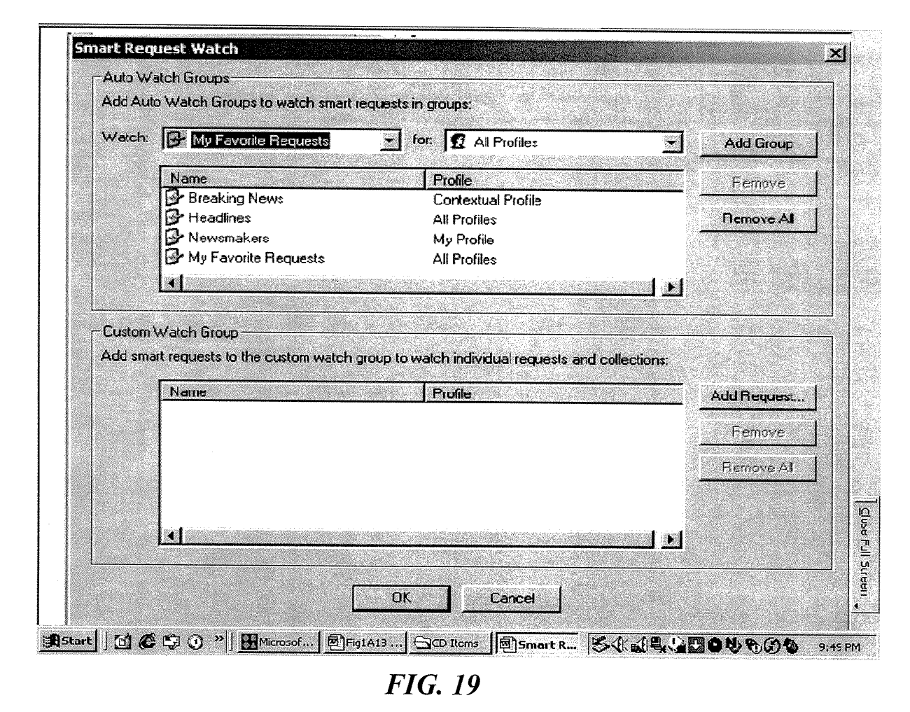

Users will be able to add the following types of Auto-RWGs (for one or more configurable profiles, including “All Profiles” as shown in the Smart Request Watch Dialog Box in FIG. 19):

1. Breaking News—this tells the semantic browser to automatically add a Breaking News smart request to the RWL (for the selected profile(s)).

2. Headlines—this tells the semantic browser to automatically add a Headlines smart request to the RWL (for the selected profile(s)).

3. Newsmakers—this tells the semantic browser to automatically add a Newsmakers smart request to the RWL (for the selected profile(s)).

4. Categorized Breaking News—this tells the semantic browser to automatically add Categorized Breaking News smart requests to the RWL (for the contextual profile). The semantic browser will dynamically add smart requests with category filters corresponding to each subcategory of the currently displayed smart request (and for the contextual or current profile)—if the currently displayed smart request has categories. For example, if the smart request “Breaking News” about Technology” is currently being displayed in a semantic browser instance, and if the category “Technology” has 5 sub-categories (e.g., Wireless, Semiconductors, Nanotechnology, Software, and Electronics), the following smart requests will be dynamically added to the RWL when the current smart request is loaded:
Breaking News about Technology.Wireless[<Contextual Profile Name>]
Breaking News about Technology.Semiconductors[<Contextual Profile Name>]
Breaking News about Technology.Nanotechnology[<Contextual Profile Name>]
Breaking News about Technology.Software[<Contextual Profile Name>]
Breaking News about Technology.Electronics[<Contextual Profile Name>]

Also, the RWLEs for these entries will be initialized with the RequestViewInstanceID of the current semantic browser instance. If the user navigates to a new smart request, the categorized Breaking News for the previously loaded smart request will be removed from the RWL and a new list of categorized Breaking News will be added for the new smart request (if it has any categories)—and initialized with a new RequestViewInstanceID corresponding to the new smart request view. This creates a smart user experience wherein relevant categorized breaking news (for subcategories) will be dynamically displayed based on the currently displayed request. The user will then be able to monitor Categorized Breaking News smart requests as a watch group or collection.

5. Categorized Headlines—this tells the semantic browser to automatically add Categorized Headlines smart requests to the RWL (for the contextual profile). This is similar to Categorized Breaking News, except that Headlines are used in this case. The user will then be able to monitor Categorized Headlines smart requests as a watch group or collection.

6. Categorized Newsmakers—this tells the semantic browser to automatically add Categorized Newsmakers smart requests to the RWL (for the contextual profile). This is similar to Categorized Breaking News, except that Newsmakers are used in this case. The user will then be able to monitor Categorized Newsmakers smart requests as a watch group or collection.

7. My Favorite Requests—this tells the semantic browser to automatically add all favorite smart requests to the RWL (for the selected profile(s)). This allows the user to watch or monitor all his/her favorite smart requests as a group.

8. My Favorite Breaking News—this tells the semantic browser to automatically add all favorite breaking news smart requests to the RWL (for the selected profile(s)). This allows the user to watch or monitor all his/her favorite breaking news smart requests as a group.

9. My Favorite Headlines—this tells the semantic browser to automatically add all favorite headlines smart requests to the RWL (for the selected profile(s)). This allows the user to watch or monitor all his/her favorite headlines smart requests as a group.

10. My Favorite Newsmakers—this tells the semantic browser to automatically add all favorite newsmakers smart requests to the RWL (for the selected profile(s)). This allows the user to watch or monitor all his/her favorite newsmakers smart requests as a group.

Request Watch Group Manager User Interface

FIG. 19 illustrates the “Smart Request Watch” Dialog Box in the semantic browser of the preferred embodiment. The top half of the dialog is used to add auto-watch groups. The user can select auto-watch group types and profile types (“All Profiles,” “Contextual Profile,” and the actual profile names) and add them to the auto-watch-group list. The user can also remove auto-watch-groups. The bottom half of the dialog box is used to add/remove smart requests to/from the manual watch group.

3. The Notification Manager (NM)

In the preferred embodiment the Notification Manager (NM) is a component of the semantic runtime client that monitors smart requests in the RWL. The NM has a thread that periodically invokes each smart request in the RWL (via the client semantic query processor) and updates the RWLE with the “results count” and the “last update time.” In the preferred embodiment the NM preferably invokes the smart requests every 5-30 seconds. The NM can intelligently adjust the periodicity or frequency of request checks depending on the size of the RWL (in order to minimize bandwidth usage and the scalability impact on the Web service).

For time-sensitive smart requests (like Breaking News, Headlines, and Newsmakers), the NM preferably invokes the smart request without any additional time filter. However, for non time-sensitive requests (like for information as opposed to context types or for non time-sensitive context templates like Favorites and Recommendations), the NM preferably invokes the query for the smart request with a time filter (e.g., the last 10 minutes).

4. Watch Group Monitors

In the preferred embodiment, the semantic runtime client manages what the inventor calls Watch Group Monitors (WGM). For each watch group the user has added to the watch group list, the client creates a watch group monitor. A watch group monitor tracks the number of new results in each request in its watch group. The watch group monitor creates a queue for the RWLEs in the watch group that have new results. The WGM manages the queue in order to maximize the freshness of the results. The WGM periodically polls the NM to see whether there are new results for each request in its watch group. If there are, it adds the request to the queue depending on the ‘last result time’ of the request. It does this in order to prioritize requests with the freshest results first. The currently displayed visual style (skin) running in the Presenter would then call the semantic runtime OCX to dequeue the requests in the WGM queue. This way, the request watch user interface will be consistent with the existence of new results and the freshness of the results. Once there are no more new results in the currently displayed request, the smart style will dequeue the next request from the WGM queue.

5. The Watch Pane

The Watch Pane (WP) refers to a panel that gets displayed in the Presenter (alongside the main results pane) and which holds visual representations of the user's watch groups. The WP allows the user to glance at each watch group to see whether there are new results in its requests. The WP also allows the user to change the current view with which each watch group's real-time status gets displayed. The following views are currently defined:
Tiled View—this displays the title of the watch group along with the total number of new results in all its smart requests.
Ticker View—this displays the total number of new results in all the watch group's smart requests but also shows an animation that sequentially displays the number of new results in each smart request (as a ticker).
Preview View—this is similar to the ticker view except that the most recent result per smart request is also displayed alongside the number of new results in the ticker.
Deep View—in this view, the WP displays the total number of new results in all the watch group's smart requests along with a ticker that shows the number of new results in each smart request and a slide-show of all the new results per smart request.

6. The Watch Window

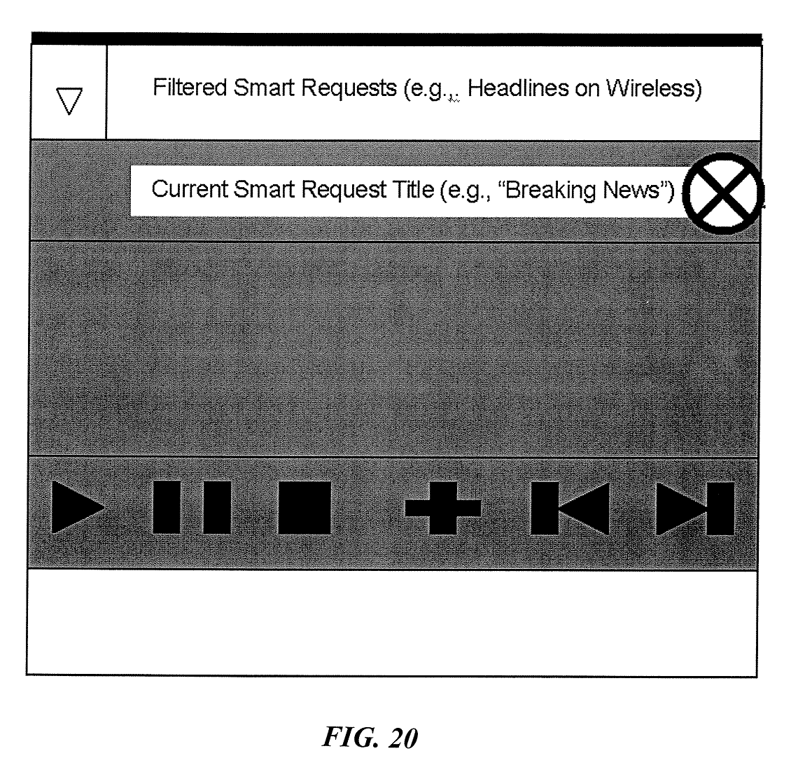

The WP also allows the user to watch a watch group. The user will do this by selecting one of the watch groups in the WP and dragging it into the main results pane (or by a similar technique). This forms a Watch Window (WW). This WW resembles or can be analogized to TV's picture-in-picture functionality in appearance or layout, but differs in several ways, most noticeably in that in this case the displayed content is comprised of semantic requests and results as opposed to television channels are being “watched.” Of course, the underlying technology generating the content is also quite different. The WW can be displayed in any of the aforementioned views. When the WW is in Deep View however, the WW's view controls are displayed. The following controls are currently defined:
Pinning Requests—this allows the user to pin a particular request in the watch group. The WW will keep displaying the new results for only the pinned requests (in a cycle) and will not advance to other requests in the watch group for as long as the current request remains pinned.
Swapping Requests—this allows the user to swap the currently displayed request with the main request being shown in the semantic browser. The smart style will invoke a method on the OCX to create a temporary request with the swapped request (hashed by its SQML buffer) and then navigate to that request while also informing the Presenter to now display the main request in its place (in the WW).
Stop, Play, Seek, FF, RW, Speedup—these allow the user to stop, play, seek, fast-forward, rewind or speedup the “watch group request stream.” For instance, a fast-forward will advance to several requests ahead of the currently displayed one.
Results controls—this allows the user to control the results in each request in the watch group. Essentially, the results are a stream within a stream and this will also allow the user to control the results in the current request in the current watch group.
Auto-Display Mode—this will automatically hide the WW when there are no results to display and fade it in when there are new results. This way, the user can maximize the utility of his/her real estate on the screen knowing that watch windows will fade in when there are new semantic results. This feature also allows the user to manage his/her attention during information interaction in a personal and semantic way.
Docking, Closing, Minimizing, Maximizing—these features, as the names imply, allow the user to dock, close, minimize or maximize watch windows. FIG. 20 illustrates a Watch Window displaying Filtered Smart Requests (e.g.,. Headlines on Wireless). FIG. 20 is an Illustration of the Watch Window with a Current Smart Request Title (e.g., “Breaking News”).

7. Watch List Addendum

In the User Interface, the Watch List can be named “News Watch.” The user will be asked to add/remove requests, objects, keywords, text, entities, etc. to/from the “News Watch.” The “News Watch” can be viewed with a Newsstand watch pane. This will provide a spatially-oriented view of the user's requests and dynamically-created requests (via objects added to the Watch List, and created dynamically by the runtime using those objects as filters)—not unlike the view of a news-magazine rack when one walks into a Library or Bookstore.

G. Entities Specification for the Information Nervous System

1. Introduction

Entities are a very powerful feature of the preferred embodiment of the Information Nervous System. Entities allow the user to create a contextual definition that maps to how they work on a regular basis. Examples of entities include:

| | |
|---|---|
| 1. | People |
| 2. | Teams |
| 3. | Action Items |
| 4. | Companies |
| 5. | Competitors |
| 6. | Customers |
| 7. | Meetings |
| 8. | Organizations |
| 9. | Partners |
| 10. | Products |
| 11. | Projects |
| 12. | Topics |

There are also industry-specific entities. For instance, in pharmaceuticals, entities could include drugs, drug interaction issues, patents, FDA clinical trials, etc. Essentially, an entity is a semantic envelope that is a smart contextual object. An entity can be dragged and dropped like any other smart object. However, an entity is represented by SQML and not SRML (i.e., it is a query-object because it has much richer semantics). An entity can be included as a parameter to a smart request.

The user creates entities based on his/her tasks. Entities in the preferred embodiment contain at least the following information (in alternate embodiments they could contain more or less information):

1. Name/Description—a friendly descriptive name for the entity.

2. The categories of the entity—based on standard cross-industry taxonomies or vertical/company-specific taxonomies.

3. Contextual resources—these could include keywords, local documents, Internet documents, or smart objects (such as people).

An entity can be opened in the semantic browser, can be used as a pivot for navigation, as a parameter for a smart request (e.g., Headlines on My Project), can be dragged and dropped, can be copied and pasted, can be used with the smart lens, can be visualized with a smart style, can be used as the basis for an intrinsic alert, can be saved as a .ENT document, can be emailed, shared, etc. In other words, an entity is a first-class smart object.

The semantic runtime client dynamically creates SQML by appending the rich metadata of the entity to the subject of the relational request to create a new rich SQML that refers to the entity.

Entities preferably also have other powerful characteristics:

1. Regarding topics, entities allow the user to create his/her private taxonomy (without being at the mercy of or restricted exclusively to a public taxonomy that is strictly defined and as such, might not map exactly to the user's specific context for a request). The problem with taxonomies is that no taxonomy can ever fit everybody's needs—even in the same organization. Context is very personal and entities allow the user to create a personal taxonomy. For instance, take the example of a dog (of the boxer breed) named Kashmir owned by a dog-owner Steve. To everyone else (but Steve), Kashmir can be expressed (taxonomically) as:

```
Living Things
  Animals
    Mammals
      Dogs
        Boxers
          Kashmir
But to Steve, Kashmir is also:
My Loved Ones
  My Pets
    Kashmir
To Steve's veterinary doctor, however, Kashmir is:
My Clients
  My Dogs
    My Dogs in Good Health
      Kashmir
```

If taxonomies (standalone) were used to “define” Kashmir, none of the three taxonomies would satisfy the general public, Steve, and Steve's veterinary doctor. With entities on the other hand, Steve could create a “Kashmir” entity based on “what Kashmir means to him.” Everyone else could then do the same. And so can Steve's veterinary doctor. Entities therefore empower the user with the ability to create private topics that might be extensions of broad taxonomies.

To take another example, a Pharmaceuticals researcher in a large Pharmaceutical company might be working on a new top-secret project (named “Gene Project”) on Genomics. Because “Gene Project” is an internal project, it would likely not exist in a public taxonomy which could be used with the semantic browser of this the preferred embodiment of my invention. However, the researcher could create an entity named “Gene Project”, typed as a Project, and could then initialize the entity by scoping it to Genomics (which exists in broad taxonomies) and then also qualifying it with the keyword-phrase “Gene Project” (using the AND operator). Essentially, this is akin to defining “Gene Project” as anything on Genomics that has the phrase “Gene Project.” This will impose much stricter context than merely using the keywords “Gene Project” (which might return results that contain the word “Project” but have nothing to do with Genomics). By defining a personal topic, “Gene Project” that is scoped to Genomics but also extends “Gene Project” with a specific qualifier, the researcher now has much more precise and personal context. The entity can then be dragged and dropped, copied and pasted, etc. to create requests (e.g., “Experts on Gene Project.” At runtime, the server-side semantic query processor will interpret this (by mapping the SQML to the semantic network) as “Experts on any information that belongs to the category Genomics AND which also includes the phrase “Gene Project.”

2. Entities also allow the user to create a dynamic taxonomy—public taxonomies are very static and are not updated regularly. With entities, the user can “extend” his/her private taxonomy dynamically and at the speed of thought. Knowledge is transferred at the speed of thought. Entities allow the user to create context with the same speed and dynamism as his/her mind or thought flow. This is very significant. For instance, the user can create an entity for a newly scheduled meeting, a just-discovered conference, a new customer, a newly discovered competitor, etc.—ALL AT THE SPEED OF THOUGHT. Taxonomies don't allow this.

3. Taxonomies assume that topics are the only source of context. With entities, a user can create abstract contextual definitions that include—but are not limited to—topics. Examples include people, teams, events, companies, etc. Entities might eventually “evolve” into topics in a taxonomy (over time and as those entities gain “fame” or “notoriety”) but in the “short-term,” entities allow the user to create context that has not yet evolved (or might never evolve) into a full-blown taxonomic entry. For instance, Nervana (our company) was initially an entity (known only to itself and its few employees) but as we have grown and attracted public attention, as an entity we are evolving into a topic in a public taxonomy. With entities, users don't have to wait for context (like Nervana) to “eventually become” topics.

4. Entities allow the user to create what the inventor calls “compound context.” An example of this is a meeting. A meeting typically involves several participants with documents, presentation slides, and/or handouts relevant to the topic of discussion. With entities in the Information Nervous System, a user can create a “meeting” context that captures the semantics of the meeting. Using the Create Entity Wizard, the user can specify that the entity is a meeting, and then specify the semantic filters. Consider an example of a project meeting with five participants and 2 handed out documents, and one presentation slide. The Presenter of the meeting might want to create an entity in order to track knowledge specifically relevant to the meeting. For instance, he/she might want to do this to determine when to schedule a follow-up meeting or to track specific action items relating to the meeting. To create the entity, the user would add the email addresses of the participants, the handed out documents, and also the presentation to the entity filter definition. The user then saves the entity which is then created in the semantic namespace/environment. The user can then edit the entity with new or removed filters (and/or a new name/description) at a later date/time—for instance, if he/she has discovered new documents that would have been relevant to the meeting. When the user drags and drops the entity or includes it in a request/agent, the semantic browser then compiles the entity and includes it in a master SQML with the sub-queries also passed to the XML Web Service for interpretation. The server-side semantic query processor then processes the compound SQML by constructing a series of SQL sub-queries (or an equivalent) and by joining these queries with the entity sub-queries which in turn are generated using SQL sub-queries.

The user can use an AND or OR (or other) operator to indicate how the entity filters should be applied. For instance, the user can indicate that the meeting (semantically) is the participants of the meeting AND the documents/slides handed out during the meeting. When the entity is compiled at the client and the server, the SQML equivalent is used to interpret the entity (with the desired operator). This is very powerful. It means that the user can define an entity named “Project Meeting” and drag and drop that entity to the special agent named “Breaking News.” This then creates a request named “Breaking News on Project Meeting” (with the appropriate SQML referring to the identifier of the entity—which will then be compiled into sub-SQML before it is passed to the server(s) for interpretation. The server then applies default predicates to the entries in the entity (based on what “makes sense” for the object). In this particular example, because of the definition of the entity, the server will then only return:

Breaking News BY ALL the participants AND which is ALSO semantically relevant TO ALL the documents/slides

For instance, this will only return conversations/threads that involve all the participants of the meeting and which are semantically relevant to all the handouts given out during the meeting. This is precisely what the user desired (in this case) and the semantic browser would have empowered the user to essentially construct a rather complex query.

Even more complex queries are possible. Entities can include other entities to allow for compound entities. For instance, if an entire team of people were involved in the meeting, the Presenter might want to create an entity that includes an email distribution list of those people. In this case, the user might search the Information Nervous System for the distribution list and then save the result as an entity. The browser will allow the user to save results as entities and based on the result type, it will automatically create an entity with a default entity type that “makes sense.” For instance, if the user saves a document result as an entity, the semantic browser it will create a “Topic” entity. If the user saves a Person result as an entity, the semantic browser will create a “Person” entity. If the user saves an email distribution list as an entity, the semantic browser will create a “Team” entity.

In this example, the user can save a Person result as a Person entity and then drag and drop that entity into the Project Meeting entity. The Team entity that maps to the email distribution list of the meeting participants can be dragged and dropped to the Project Meeting entity. The user can then create a request called “Headlines on Project Meeting” that includes the entity. The semantic query processor will then return Headlines BY anyone in the email distribution list (using the right default predicate) and which is semantically relevant to ALL the handouts given out during the meeting. Similarly, a Dossier (Guide) on the Project Meeting will return All Bets on the meeting, Best Bets on meeting, Experts on the meeting, etc.

Note that such a compound entity that includes other entities gets checked by the client-side semantic consistency checker for referential integrity. In other words, if Entity A refers to Entity B and the user attempts to delete Entity B, the semantic browser will detect this and flag the user that Entity B has an outstanding reference. If the user deletes Entity B anyway, the reference in Entity A (and any other references to Entity B) will get removed. Alternately, in some embodiments, the user could be prohibited (whether informed or not) from deleting Entity B in the same situation, based on permissions of others within an organization associated with the entity. For example, employers could monitor activities of employees for risk management purposes, like as is done with email in some companies, only much potentially much more powerfully (Of course, appropriate policies and privacy considerations would have to be addressed). The same process applies to Request Collections (Blenders), Portfolios (Entity Collections—see below), and other compound items in the semantic namespace/environment (items that could refer to other items in the namespace/environment).

5. Popular entities can also be shared amongst members of a knowledge community. Like other items in the semantic browser (like requests or knowledge communities (agencies), entities can be saved as files (so the user can later open them or email them to colleagues, or save them on a central file share, etc.). A common scenario would be that the corporate Librarians at businesses would create entities that map to internal projects, meetings, seminars, tasks, and other important corporate knowledge items of interest. These entities would then be saved on a file-share or other sharing mechanism (like a portal or web-site) or on a knowledge community (agency). The knowledge workers in the organization would then be able to use the entities. As the entities get updated, in the preferred embodiment the Librarians can and will automatically edit their context and users will be able refresh or synchronize to the new entities. Entities could also and alternately be shared on a peer-to-peer basis by individual users. This is akin to a legal peer-to-peer file sharing for music, but instead of music, what is shared is context to facilitate meaning, or more meaningful communication.

2. Portfolios (or Entity Collections)

Portfolios are a special type of entity that contains a collection of entities. In the preferred embodiment, to minimize complexity and confusion (at least of nomenclature or terminology), while an entity can be of any size or composition, and portfolio can contain any kind or number of entities, a portfolio would not contain other portfolios. A portfolio allows the user to manage a group of entities as one unit. A portfolio is a first-class entity and as such has all the aforementioned features of an entity. When a portfolio is used as a parameter in a smart request, the OR qualifier is applied (by default) to its containing entities. In other words, if Portfolio P contains entities E1 and E2, a smart request titled ‘Headlines on P’ will be processed as ‘Headlines on E1 or E2.’ The user can change this setting on individual smart requests (to an AND qualifier).

3. Sample Scenarios

Again, in reviewing the scenarios below, it is helpful to recall that, conceptually, the system can gather more relevant information in part because it “knows” who is asking for it, and “understands” who that person or group is, and the kinds of information they are probably interested in. Of course, strictly speaking, the system is not cognitive or self aware in the full human sense, and the operative verbs in the preceding sentence are conceptual metaphors or similes. Still, in operation and results, it mimics understanding and knowledge to an unprecedented degree in part because of its underlying semantically-informed architecture and execution.

This point can be illustrated by a simplistic contrast: If two very different people entered the exact same search at the exact same time into a search engine such as Google™, they would get the exact same results. In contrast, with the preferred embodiment of the present system, if those same two people entered the same request via an Entity, each would get different results tailored to be relevant to each.

To appreciate some of the potential power of this feature, it is useful to note that while the system or Entities “know” who is posing the query, the Entities do not depend for that knowledge on the user informing them and keeping them constantly updated and informed (although user information can be supplied and considered at any time). If that were the case, the system could be too labor intensive to be efficient and useful in many situations; it would just be too much work. Instead, the Entities “know” who the requester is by inference and from semantics from characteristics sometimes supplied by others, sometimes derived or deduced, sometimes collected from other requests and the like, as explained throughout this application and its parent application.

Some example scenarios of Entities in operation:

1. A pharmaceuticals ‘patent’ entity could include the categories of the patent, relevant keywords, and relevant documents.

2. A CIA agent could create a ‘terrorist’ entity to track terrorists. This could include categories on terrorism, suspicious wire transfers, suspicious arms sales, classified documents, keywords, and terrorism experts in the information community.

3. Find All Breaking News on Yesterday's Meeting.

4. Find Headlines on any of my competitors (this is done by creating the competitor entities, and then creating a smart request with the entities as parameters using the OR qualifier with each predicate).

5. Find Experts on my investment portfolio companies (create the individual entities, create a portfolio containing these entities and then create a smart request that has the ‘Experts’ context template and that uses the portfolio as an argument).

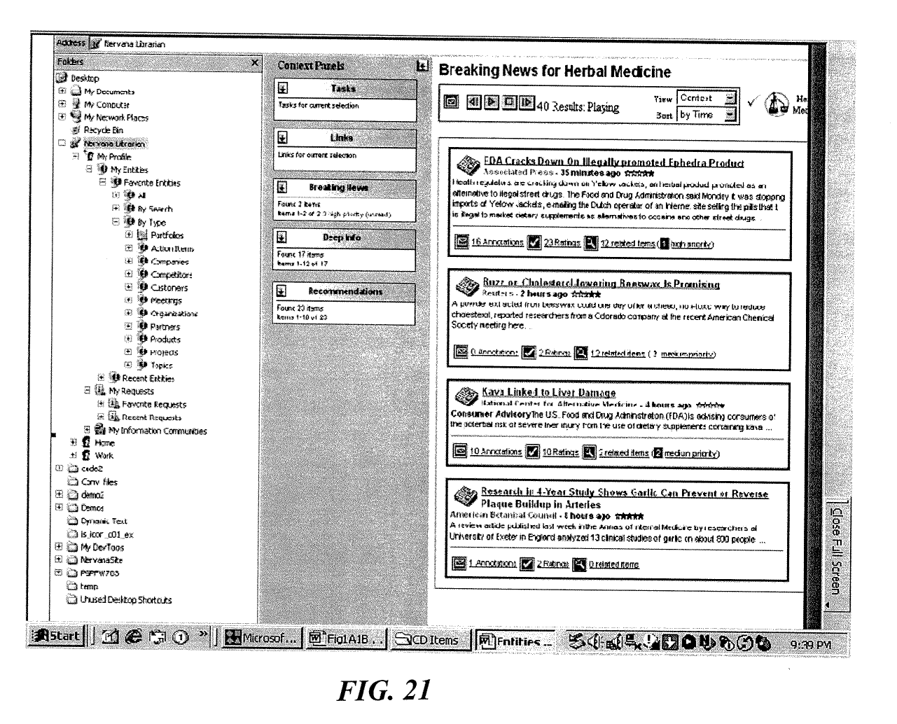

6. Open a Dossier (Guide) on my competitors (create the individual competitor entities, create a portfolio containing these entities and then create a smart request that has the ‘Dossier’ (or ‘Guide’) context template and that uses the portfolio as an argument). FIG. 21 shows Entity views displayed in the semantic browser (on the left).

H. Knowledge Community Browsing and Subscription Specification for the Information Nervous System

Overview

The Nervana semantic browser will allow the user to subscribe and unsubscribe to/from knowledge communities (agencies) for a given profile. These knowledge communities will be readily available to the user underneath the profile entry in the semantic environment. In addition, these knowledge communities will be queried by default for intrinsic alerts, context panels, and etc. whenever results are displayed for any request created using the same profile.

The semantic environment includes state indicating the subscribed knowledge communities for each profile. The client-side semantic query processor (SQP) uses this information for dynamic requests that start from results for requests of a given profile (the SQP will ask the semantic runtime client for the knowledge communities for the profile and then issue XML Web Service calls to those knowledge communities as appropriate).

FIGS. 22A and 22B show the user interface for the knowledge community subscription and un-subscription. The dialog box has combo boxes allowing the user to filter by profile, to view all, new, subscribed, suggested, and un-subscribed communities, by industry and area of interest, by keywords, by publishing point (all publishing points, the local area network, the enterprise directory, and the global knowledge community directory), and by creation time (anytime, today, yesterday, this week, and last week). The semantic runtime client queries the publishing point endpoint listeners (for each publishing point) using the filters. It then gathers the results and displays them in the results pane. The user is also able to view the categories of each knowledge community in the results pane via a combo box. FIG. 20B illustrates the bottom portion of the Knowledge Communities Dialog Box.

I. Client-side Semantic Query Document Specification for the Information Nervous System

1. Semantic Query Markup Language (SQML) Overview

In the currently preferred embodiment, the Nervana Semantic DHTML Behavior is an Internet Explorer DHTML Behavior that, from the client's perspective, every thing it understands as a query document. The client opens ‘query documents,’ in a manner resembling how a word processor opens ‘textual and compound documents.’ The Nervana client is primarily responsible for processing a Nervana semantic query document and rendering the results. A Nervana semantic query document is expressed and stored in form of the Nervana Semantic Query Markup Language (SQML). This is akin to a “semantic file format.”

In the preferred embodiment, the SQML semantic file format comprises of the following:
Head—The ‘head’ tag, like in the case of HTML, includes tags that describe the document.
Title—The title of the document.
Comments—The comments of the document.
UserName—The username of the document creator.
SystemName—The systemname of the device on which the document was created.
Subject—The subject of the document.
Creator—The creator of the document.
Company—The company in which the document was created.
RequestType—This indicates the type of request. It can be “smart request” (indicating requests to one or more information community web services) or “dumb request” (indicating requests to one or more local or network resources).
ObjectType—This fully qualifies the type of objects returned by the query.
URI—The location of the document.
CreationTime—The creation time of the document.
LastModifiedTime—The last modified time of the document.
LastAccessedTime—The last accessed time of the document.
Attributes—The attributes of the document, if any.
RevisionNumber—The revision number of the document.
Language—The language of the document.
Version—this indicates the version of the query. This allows the web service's semantic query processor to return results that are versioned. For instance, one version of the browser can use V1 of a query, and another version can use V2. This allows the web service to provide backwards compatibility both at the resource level (e.g., for agents) and at the link level.
Targets—This indicates the names and the URLs of the information community web services that the query document targets.
Type—this indicates the type of targets. This can be “targetentries,” in which case the tag includes sub-tags indicating the actual web service targets, or “allsubscribedtargets,” in which case the query processor uses all subscribed information communities.
Categories—This indicates the list of category URLs that the query document refers to. Each “category” entry contains a name attribute and a URI attribute that indicates the URL of the Knowledge Domain Server (KDS) from which the category came.
Type—this indicates the type of categories. This can be either “categoryentries,” in which case the sub-tag refers to the list of category entries, “allcategories,” in which case all categories are requested from the information community web services, or “myfavoritecategories,” in which case the query processor gets the user's favorite categories and then generates compiled SQML that contains these categories (this compiled SQML is then sent to the server(s)).
Query—This is the parent tag for all the main query entries of the query document
Resource—The reference to the ‘dumb’ resource being queried. Examples include file paths, URLs, cache entry identifiers, etc. These will be mapped to actual resource managers components by the interpreter.
Type—The type of resource reference, qualified with the namespace. Examples of defined resource reference types are: nervana:url (this indicates that the resource reference is a well-formed standard Internet URL, or a custom Nervana URL like ‘agent:// . . . ”), nervana:filepath (this indicates that the resource reference is a path to a file or directory on the file-system), and nervana:namespaceref (this indicates that the resource comes from the client semantic namespace).
Uri—This indicates the universal resource identifier of the resource. In the case of paths and Internet URLs, this indicates the URL itself. In the case of namespace entries, this indicates the GUID identifier of the entry.
Mid—This indicates the metadata identifier, which is used by the SQML interpreter to map the resource to the metadata section of the document. The metadata id is mapped to the same identifier within the metadata section.
Args—This indicates the arguments of the resource identifier.
Links—this indicates the reference to the semantic links (for “targets” only)
Type—this indicates the type of links. This can be “linkentries,” indicating the links are explicit entries.
LinkEntries—this indicates the details of a link entry.
Predicate—this indicates the type of predicate for the link. For instance, the predicate “nervana:relevantto” indicates that the query is “return all objects from the resource R that are relevant to the object O,” where R and O and the specified resource and object, respectively. Other examples of predicates include nervana:reportsto, nervana:teammateof, nervana:from, nervana:to, nervana:cc, nervana:bcc, nervana:attachedto, nervana:sentby, nervana:sentto, nervana:postedon, nervana:containstext, etc.
Type—this indicates the type of object reference indicates in the ‘Link’ tag. Examples include standard XML data types like xml:string, xml:integer, Nervana equivalents of same, custom Nervana types like nervana:datetimeref (which could refer to object references like ‘today’ and ‘tomorrow’), and any standard Internet URL (HTTP, FTP, etc.) or Nervana URL (objects://, etc.) that refers to an object that Nervana can process as a semantic XML object.
Metadata—this contains the references to the metadata entries.
MetadataEntry—this indicates the details of a metadata entry.
Mid—this indicates the metadata identifier (GUID).
Value—this indicates the metadata itself.

Example: Documents (Information or Context-based)

```
<?xml version=“1.0” encoding=“utf-8”?>
<sqml>
  <head
    requesttype=“smart request”
    objecttype=“context\headlines”
    uri=“c:\foo's\bar.pdf”
    creationtime=“foo”
    lastmodifiedtime=“foo”
    lastaccessedtime=“foo”
    attributes=“0”
    revisionnumber=“0”
    language=“foo”
    version=“foo” />
    <title>foo</title>
    <comments>foo</comments>
    <username>foo</username>
    <systemname>foo</systemname>
    <subject>foo</subject>
    <creator>foo</creator>
    <company>foo</company>
  <targets>
    <target
      name=“Marketing”
      reftype=“uri”
      ref=“kisp://marketing/default.wsdl”
    />
    <target
      name=“Research”
      reftype=“uri”
      ref=“kisp://research/default.wsdl”
    />
  </targets>
  <categories>
    <category
      name=“reuters\pharmaceuticals\biotechnology”
      reftype=“uri”
      ref=“kdsp://reuters.com/categories.wsdl?id=45”
    />
    <category
      name=“reuters\pharmaceuticals\life_sciences”
      reftype=“uri”
      ref=“kdsp://reuters.com/categories.wsdl?id=57”
    />
  </categories>
  />
  <resources>
    <resource
      name=“foo”
      type=“information\documents\general document”
      reftype=“nervana:filepath”
      ref=“file://c:\bar.doc”
      mid=“7886e4a0-55d9-45ac-a084-97adc6fffd0f”
      args=““
    />
    <resource
      name=“foo”
      type=“information\all information”
      reftype=“nervana:url”
      ref=“file://c:\bar.doc”
      mid=“01fc64a3-c068-4339-bc97-17e5ff37e93f”
      args=““
    />
    </resource
      name=“foo”
      type=“information\all information”
      reftype=“nervana:folderpath”
      ref=“file://c:\”
      mid=“f8cc39c3-e4f0-4a29-be2a-d2faf36eb3a0”
      args=“includesubfolders=true”
    />
    <resource
      name=“foo”
      type=“information\documents\general document”
      reftype=“nervana:url”
      ref=“[http]://[www].bar.com/doc.htm”
      mid=“f8cc39c3-e4f0-4a29-be2a-d2faf36eb3a0”
      args=““
    />
    <resource
      name=“foo”
      type=“information\documents\general document”
      reftype=“nervana:url”
      ref=“ftp://gate.com/doc.txt”
      mid=“f8cc39c3-e4f0-4a29-be2a-d2faf36eb3a0”
      args=““
    />
    <resource
      name=“foo”
      type=“information\documents\general document”
      reftype=“nervana:filepath”
      ref=“file://\\servers\server\file.pdf”
      mid=“1b870a25-4e98-45d8-a444-f0283a495357”
      args=““
    />
    <resource
      name=“foo”
      type=“information\documents\text document”
      reftype=“nervana:text”
      ref=““
      mid=“7886e4a0-55d9-45ac-a084-97adc6fffd0f”
      args=““
    />
    <resource
      name=“foo”
      type=“information\documents\general document”
      reftype=“nervana:cacheentry”
      ref=“ef9c90ea-282d-46d6-b355-ac8a4fc2f3e5”
      mid=““
      args=““
    />
    <resource
      name=“foo”
      type=“information\email\email message”
      reftype=“nervana:url”
      ref=“request://email.all@ibm.com”
      mid=““
      args=““
    />
    <resource
      name=“foo”
      type=“information\email\email annotation”
      reftype=“nervana:url”
      ref=“objects://rad.com/agency.asp”
      mid=““
      args=““
    />
    <resource
      name=“foo”
      type=“information\documents\general document”
      reftype=“nervana:url”
      ref=“objects://rad.com/agency.asp”
      mid=““
      args=““
    />
    <resource
      name=“foo”
      type=“information\documents\general document”
      reftype=“nervana:url”
      ref=“objects://rad.com/agency.asp”
      mid=““
      args=““
    />
    <resource
      name=“foo”
      type=“information\documents\general document”
      reftype=“nervana:url”
      ref=“request://documents.all@intel.com”
      mid=““
      args=““
    />
    </resources>
    <links>
    <link
      operator=“and”
      predicate=“nervana:relatedto”
      name=“foo”
      type=“information\documents\general document”
      reftype=“nervana:filepath”
      ref=“file://c:\foo.doc”
      mid=“7886e4a0-55d9-45ac-a084-97adc6fffd0f”
      args=““
    />
    <link
      operator=“and”
      predicate=“nervana:contains”
      name=“foo”
      type=“information\documents\general document”
      reftype=“nervana:text”
      ref=““
      mid=“46ea76cb-1383-4885-af6f-0e0fc6a66896”
      args=““
    />
    <link
      operator=“and”
      predicate=“nervana:postedon”
      name=“foo”
      type=“types\datetime”
      reftype=“nervana:datetimeref”
      ref=““
      mid=“3fa64c3c-4754-4380-91b5-521299036c62”
      args=““
    />
    <link
      operator=“and”
      predicate=“nervana:relatedto”
      name=“foo”
      type=“information\documents\general document”
      reftype=“nervana:url”
      ref=“kisp://98@in.com/m.asp”
      mid=“c2649c39-a1c3-4ca8-ae8d-c85c04372e9a”
      args=““
    />
    <link
      operator=“and”
      predicate=“nervana:isofpriority”
      name=“foo”
      type=“types\priority”
      reftype=“nervana:priority”
      ref=““
      mid=“69bbc048-98c8-4f76-8edf-5a00ce91c183”
      args=““
    />
  </links>
<metadata>
    <metadataentry
      mid=“7886e4a0-55d9-45ac-a084-97adc6fffd0f”
      reftype=“uri”
      ref=“file://c:\foo\bar.pdf” />
      <value>
        <document>
          <title>scenario modelling</title>
          <type>text</type>
          <format>application/pdf</format>
          <filepath>c:\foo\bar.pdf</filepath>
          <shortfilename>bar.pdf</shortfilename>
          <creationtime>foo</creationtime>
          <lastmodifiedtime>foo</lastmodifiedtime>
          <lastaccessedtime>foo</lastaccessedtime>
          <attributes>0</attributes>
          <size>0</size>
          <subject>foo</subject>
          <creator>foo</creator>
          <manager>foo</manager>
          <company>foo</company>
          <category>foo</category>
          <keywords>foo</keywords>
          <comments>foo</comments>
          <hlinkbase>foo</hlinkbase>
          <template>foo</template>
          <lastsavedby>foo</lastsavedby>
          <revisionnumber>0</revisionnumber>
          <totaleditingtime>foo</totaleditingtime>
          <numpages>0</numpages>
          <numparagraphs>0</numparagraphs>
          <numlines>0</numlines>
          <numwords>0</numwords>
          <numcharacters>0</numcharacters>
<numcharacterswithspaces>0</numcharacterswithspaces>
          <numbytes>0</numbytes>
          <language>foo</language>
          <version>foo</version>
          <abstract>foo</abstract>
        </document>
      </value>
    />
    <metadataentry
      mid=“bfcb12b4-70bb-473a-847c-ebffe187828f”
      reftype=“uri”
      ref=“file://c:\foo\bar.pdf” />
      <value>
        <email>
          <title>scenario modelling</title>
          <type>text</type>
          <format>application/pdf</format>
          <filepath>c:\foo\bar.pdf</filepath>
          <shortfilename>bar.pdf</shortfilename>
          <creationtime>foo</creationtime>
          <lastmodifiedtime>foo</lastmodifiedtime>
          <lastaccessedtime>foo</lastaccessedtime>
          <attributes>0</attributes>
          <size>0</size>
          <subject>foo</subject>
          <creator>foo</creator>
          <manager>foo</manager>
          <company>foo</company>
          <category>foo</category>
          <keywords>foo</keywords>
          <comments>foo</comments>
          <hlinkbase>foo</hlinkbase>
          <template>foo</template>
          <lastsavedby>foo</lastsavedby>
          <revisionnumber>0</revisionnumber>
          <totaleditingtime>foo</totaleditingtime>
          <numpages>0</numpages>
          <numparagraphs>0</numparagraphs>
          <numlines>0</numlines>
          <numwords>0</numwords>
          <numcharacters>0</numcharacters>
<numcharacterswithspaces>0</numcharacterswithspaces>
          <numbytes>0</numbytes>
          <language>foo</language>
          <version>foo</version>
          <abstract>foo</abstract>
        </email>
      </value>
    />
  </metadata>
</sqml>
```

2. SQML Generation

Preferably, SQML is generated in any one or more of several possible ways:
By creating a smart request
By creating a local request
By creating an entity
By opening one or more local documents in the semantic browser
By the client (dynamically)—in response to a drag and drop, smart copy and paste, intrinsic alert, context panel/link invocation, etc.

3. SQML Parsing

In some embodiments in some situations, SQML that gets created on the client might not be ready (in real-time) for remote consumption—by the server's XML web service or at another machine site. This is especially likely to be the case when the SQML refers to local context such as documents, Entities, or Smart Requests (that are identified by unique identifiers in the semantic environment).¹ In the preferred embodiment, the client generally creates SQML that is ready for remote consumption. Preferably, it does this by caching the metadata for all references in the metadata section of the document. This is preferable because in some cases, the resource or object to which the reference points might no longer exist when the query is invoked. For instance, a user might drag and drop a document from the Internet to a smart request in order to generate a new relational request. The client extracts the metadata (including the summary) from the link and inserts the metadata into the SQML. Because the resolution of the query uses only the metadata, the query is ready for consumption once the metadata is inserted into the SQML document. However, the link that the object refers to might not exist the day after the user found it. In such a case, even if the user invokes the relational request after the link might have ceased to exist, the request will still work because the metadata would already have been cached in the SQML.
¹ Blenders (or collections) contain references to smart requests.

The client SQML parser performs “lazy” updating of metadata in the SQML. When the request is invoked, it attempts to update the metadata of all parameters (resources, etc.) in the SQML to handle the case where the objects might have changed since they were used to create the relational request. If the object does not exist, the client uses the metadata it already has. Otherwise, it updates it and uses the updated metadata. That way, even if the object has been deleted, the user experience is not interrupted until the user actually tries to open the object from whence the metadata came.

J. Semantic Client-side Runtime Control API Specification for the Information Nervous System

1. Introducing the Nervana Semantic Runtime Control—Overview

In the preferred embodiment, the Nervana Semantic Runtime Control is an ActiveX control that exposes properties and methods for use in displaying semantic data using the Nervana semantic user experience. The control will be primarily called from XSLT skins that take XML data (using the SRML schema) and generate DHTML+TIME or SVG output, consistent with the requirements of the Nervana semantic user experience. Essentially, in this embodiment, the Nervana control encapsulates the “SDK” on top of which the XSLT skins sit in order to produce a semantic content-driven user experience. The APIs listed below illustrate the functionality that will be exposed or made available by the final API set in the preferred embodiment.

2. The Nervana Semantic Runtime Control API

a. EnumObjectsInNamespacePath

### Introduction

The EnumObjectsInNamespacePath method returns the objects in a namespace path.

### Usage Scenario

A Nervana client application (for instance, the semantic browser) or a Nervana skin will call this method to open a namespace path in order for the user to navigate the namespace from within the semantic browser.

PROTOTYPE
SCODE
EnumObjectsInNamespacePath(
[in] BSTR Path,
[in] LONG QueryMask,
[out] BSTR *pQueryRequestGuid );

b. CompileSemanticQueryFromBuffer

### Introduction

The CompileSemanticQueryFromBuffer method opens an SQML buffer and compiles it into one or more execution-ready SQML buffers. For instance, an SQML file containing a blender will be compiled into SQML buffers representing each blender entry. If the blender contains blenders, the blenders will be unwrapped and an SQML buffer will be returned for each contained blender. A compiled or “execution-ready” SQML buffer is one that can be semantically processed by an agency. The implication is that a blender that has agents from multiple agencies will have its SQML compiled to buffers with the appropriate SQML from each agency.

Note: If the buffer is already compiled, the method returns S_FALSE and the return arguments are ignored.

### Usage Scenario

A Nervana client application (for instance, the semantic browser) or a Nervana skin will call this method to compile an SQML buffer and retrieve generated “compiled code” that is ready for execution. In typical scenarios, the application or skin will compile an SQML buffer and then prepare frame windows where it wants each individual SQML query to sit. It can then issue individual SQML semantic calls by calling OpenSemanticQueryFromBuffer and then have the results displayed in the individual frames.

| PROTOTYPE | |
|---|---|
| SCODE | |
| CompileSemanticQueryFromBuffer( | |
| [in] | BSTR SQMLBuffer, |
| [in] | DWORD Flags, |
| [out] | DWORD *pdwNumCompiledBuffers, |
| [out] | BSTR *pbstrCompiledBuffers ); |

c. OpenSemanticQueryFromBuffer

### Introduction

The OpenSemanticQueryFromBuffer method opens an SQML buffer and asynchronously fires the XML results (in SRML) onto the DOM, from whence a Nervana skin can sink the event. Note that in this embodiment the SQML has to be “compiled” and ready for execution. If the SQML is not ready for execution, the call will fail. To compile an SQML buffer, call CompileSemanticQueryFromBuffer.

### Usage Scenario

A Nervana client application (for instance, the semantic browser) or a Nervana skin will call this method to open a compiled SQML buffer.

PROTOTYPE
SCODE
OpenSemanticQueryFromBuffer(
[in] BSTR SQMLBuffer,
[in] DWORD Flags,
[Out] GUID *pQueryID );

d. GetSemanticQueryBufferFromFile

### Introduction

The GetSemanticQueryBufferFromFile method opens an SQML file, and returns the buffer contents. The buffer can then be compiled and/or opened.

### Usage Scenario

A Nervana client application (for instance, the semantic browser) or a Nervana skin will call this method to convert an SQML file into a buffer before processing it.

| PROTOTYPE | |
|---|---|
| SCODE | |
| GetSemanticQueryBufferFromFile ( | |
| [in] | BSTR SQMLFilePath, |
| [in] | DWORD FileOpenFlags, |
| [Out] | BSTR *pbstrSQMLBuffer ); |

e. GetSemanticQueryBufferFromNamespace

### Introduction

The GetSemanticQueryBufferFromNamespace method opens a namespace object, and retrieves its SQML buffer.

### Usage Scenario

A Nervana client application (for instance, the semantic browser) or a Nervana skin will call this method to open an SQML buffer when it already has access to the id and path of the namespace object.

| | PROTOTYPE |
|---|---|
| | SCODE |
| GetSemanticQueryBufferFromNamespace( | |
| [in] | GUID ObjectID, |
| [in] | BSTR Path, |

[Out] BSTR *pbstrSQMLBuffer );

f. GetSemanticQueryBufferFromURL

### Introduction

The GetSemanticQueryBufferFromURL method wraps the URL in an SQML buffer, and returns the buffer.

### Usage Scenario

A Nervana client application (for instance, the semantic browser) or a Nervana skin will call this method to convert an URL of any type to SQML. This can include file paths, HTTP URLs, FTP URLs, Nervana agency object URLs (prefixed by “wsobject://”) or Nervana agency URLs (prefixed by “wsagency://”).

PROTOTYPE
SCODE
GetSemanticQueryBufferFromURL(
[in] BSTR URL,
[Out] BSTR *pBuffer );

g. GetSemanticQueryBufferFromClipboard

### Introduction

The GetSemanticQueryBufferFromClipboard method converts the clipboard contents to SQML, and returns the buffer.

### Usage Scenario

A Nervana client application (for instance, the semantic browser) or a Nervana skin will call this method to get a semantic query from the clipboard. The application can then load the query buffer.

PROTOTYPE
SCODE GetSemanticQueryBufferFromClipboard( [Out] BSTR *pBuffer );

h. Stop

### Introduction

The Stop method stops current open request.

### Usage Scenario

A Nervana client application (for instance, the semantic browser) or a Nervana skin will call this method to stop a load request is just issued.

PROTOTYPE

SCODE Stop([in] GUID QueryID);

i. Refresh

### Introduction

The Refresh method refreshes the current open request.

### Usage Scenario

A Nervana client application (for instance, the semantic browser) or a Nervana skin will call this method to refresh the currently loaded request.

PROTOTYPE
SCODE Refresh( [in] GUID QueryID );

j. CreateNamespaceObject

### Introduction

The CreateNamespaceObject method creates a namespace object and returns its GUID.

### Usage Scenario

A Nervana client application (for instance, the semantic browser) or a Nervana skin will typically call this method to create a temporary namespace object when a new query document has been opened.

| PROTOTYPE | |
|---|---|
| SCODE | |
| CreateNamespaceObject( | |
| [in] | BSTR Name, |
| [in] | BSTR Description, |
| [in] | BSTR QueryBuffer, |
| [in] | LONG AgentObjectType, |
| [in] | LONG Attributes, |
| [in] | LONG NamespaceObjectType, |
| [Out] | GUID *pObjectID ); |

k. DeleteNamespaceObject

### Introduction

The DeleteNamespaceObject method deletes a namespace object.

### Usage Scenario

A Nervana client application (for instance, the semantic browser) or a Nervana skin will typically call this method to delete a temporary namespace object.

PROTOTYPE
SCODE DeleteNamespaceObject( [in] GUID ObjectID );

1. CopyObject

### Introduction

The CopyObject method copies the semantic object to the clipboard as an SQML buffer using a proprietary SQML clipboard format. The object can then be “pasted” onto agents for relational semantic queries, or used as a lens over other objects or agents.

### Usage Scenario

A Nervana skin will typically call the CopyObject method when the user clicks on the “Copy” menu option—off a popup menu on the object.

PROTOTYPE
SCODE CopyObject( [in] BSTR ObjectSRML );

m. CanObjectBeAnnotated

### Introduction

The CanObjectBeAnnotated method checks whether the given object can be annotated.

### Usage Scenario

A Nervana skin will typically call the CanObjectBeAnnotated method to determine whether to show UI indicating the “Annotate” command.

PROTOTYPE
SCODE CanObjectBeAnnotated( [in] BSTR bstrObjectSRML );

n. AnnotateObject

### Introduction

The AnnotateObject method invokes the currently installed email client and initializes it to send an email annotation of the object to the email agent of the agency from whence the object came.

### Usage Scenario

A Nervana skin will typically call the AnnotateObject method when the user clicks on the “Annotate” menu option—off a popup menu on the object.

PROTOTYPE
SCODE AnnotateObject( [in] BSTR bstrObjectSRML );

o. CanObjectBePublished

### Introduction

The CanObjectBePublished method checks whether the given object can be published.

### Usage Scenario

A Nervana skin will typically call the CanObjectBePublished method to determine whether to show UI indicating the “Publish” command.

PROTOTYPE
SCODE CanObjectBePublished ( [in] BSTR bstrObjectSRML );

p. PublishObject

### Introduction

The PublishObject method invokes the currently installed email client and initializes it to send an email publication of the object to the email agent of the agency from whence the object came.

### Usage Scenario

A Nervana skin will typically call the PublishObject method when the user clicks on the “Publish” menu option—off a popup menu on the object.

PROTOTYPE
SCODE AnnotateObject( [in] BSTR bstrObjectSRML );

q. OpenObjectContents

### Introduction

The OpenObjectContents method opens the object using an appropriate viewer. For instance, an email object will be opened in the email client, a document will be opened in the browser, etc.

### Usage Scenario

A Nervana skin will typically call the OpenObjectContents method when the user clicks on the “Open” menu option—off a popup menu on the object.

PROTOTYPE
SCODE OpenObjectContents ( [in] BSTR ObjectSRML );

r. SendEmailToPersonObject

### Introduction

The SendEmailToObject method is called to send email to a person or customer object. The method opens the email client and initializes it with the email address of the person or customer object.

### Usage Scenario

A Nervana skin will typically call the SendEmailToObject method when the user clicks on the “Send Email” menu option—off a popup menu on a person or customer object.

PROTOTYPE
SCODE SendEmailToObject( [in] BSTR ObjectSRML );

s. GetObjectAnnotations

### Introduction

The GetObjectAnnotations method is called to get the annotations an object has on the agency from whence it came.

### Usage Scenario

A Nervana skin will typically call the GetObjectAnnotations method when it wants to display the titles of the annotations an object has—for instance, in a popup menu or when it wants to display the annotations metadata in a window.

PROTOTYPE
SCODE
GetObjectAnnotations(
[in] BSTR ObjectSRML,
[in] LONG QueryMask,
[out] BSTR *pQueryRequestGuid );

t. IsObjectMarkedAsFavorite

### Introduction

The IsObjectMarkedAsFavorite method is called to check whether an object is marked as a favorite on the agency from whence it came.

### Usage Scenario

A Nervana skin will typically call the IsObjectMarkedAsFavorite method to determine what UI to show—either the “Mark as Favorite” or the “Unmark as Favorite” command. If the object cannot be marked as a favorite (for instance, if it did not originate on an agency), the error code E_INVALIDARG is returned.

PROTOTYPE
SCODE
IsObjectMarkedAsFavorite( in] BSTR ObjectSRML );

u. MarkObjectAsFavorite

### Introduction

The MarkObjectAsFavorite method is called to mark the object as a favorite on the agency from whence it came.

### Usage Scenario

A Nervana skin will typically call the MarkObjectAsFavorite method when the user clicks on the “Mark as Favorite” command.

PROTOTYPE
SCODE
MarkAsFavorite( in] BSTR ObjectSRML );

v. UnmarkObjectAsFavorite

### Introduction

The UnmarkObjectAsFavorite method is called to unmark the object as a favorite on the agency from whence it came.

### Usage Scenario

A Nervana skin will typically call the UnmarkObjectAsFavorite method when the user clicks on the “Unmark as Favorite” command.

PROTOTYPE
SCODE
UnmarkAsFavorite( in] BSTR ObjectSRML );

w. IsSmartAgentOnClipboard

### Introduction

The IsSmartAgentOnClipboard method is called to check whether a smart agent has been copied to the clipboard.

### Usage Scenario

A Nervana skin will typically call the IsSmartAgentOnClipboard method when it wants to toggle the user interface to display the “Paste” icon or when the “Paste” command is invoked.

PROTOTYPE
SCODE
IsSmartAgentOnClipboard( );

x. GetSmartLensQueryBuffer

### Introduction

The GetSmartLensQueryBuffer method is called to get the query buffer of the smart lens. This returns the SQML of the query that represents the objects on the smart agent that is on the clipboard, and which are semantically relevant to a given object.

### Usage Scenario

A Nervana skin will typically call the GetSmartLensQueryBuffer method when the user hits “Paste as Smart Lens” to invoke the smart lens off the smart agent that is on the clipboard.

PROTOTYPE
SCODE
GetSmartLensQueryBuffer(
[in] BSTR ObjectSRML,
[in] LONG QueryMask,
[out] BSTR *pQueryRequestGuid );

y. OpenObjectContents

### Introduction

The OpenObjectContents method opens the object using an appropriate viewer. For instance, an email object will be opened in the email client, a document will be opened in the browser, etc.

### Usage Scenario

A Nervana skin will typically call the OpenObjectContents method when the user clicks on the “Open” menu option—off a popup menu on the object.

PROTOTYPE
SCODE OpenObjectContents( [in] BSTR ObjectSRML );
Part

3. Email Control APIs

a. Email_GetFromLinkObjects

### Introduction

The Email_GetFromLinkObjects method is called to get the metadata for the “From” links on an email object from the agency from whence it came.

### Usage Scenario

A Nervana skin will typically call the Email_GetFromLinkObjects method when it wants to navigate to the “From” list from an email object, or to display a popup menu with the name of the person in the “From” list.

PROTOTYPE
SCODE
Email_GetFromLinkObjects(
[in] BSTR EmailObjectSRML,
[in] LONG QueryMask,
[out] BSTR *pQueryRequestGuid );

b. Email_GetToLinkObjects

### Introduction

The Email_GetFromLinkObjects method is called to get the metadata for the “To” links on an email object from the agency from whence it came.

### Usage Scenario

A Nervana skin will typically call the Email_GetToLinkObjects method when it wants to navigate to the “To” list from an email object, or to display a popup menu with the name of the person in the “To” list.

PROTOTYPE
SCODE
Email_GetToLinkObjects(
[in] BSTR EmailObjectSRML,
[in] LONG QueryMask,
[out] BSTR *pQueryRequestGuid );

c. Email_GetCcLinkObjects

### Introduction

The Email_GetCcLinkObjects method is called to get the metadata for the “CC” links on an email object from the agency from whence it came.

### Usage Scenario

A Nervana skin will typically call the Email_GetCcLinkObjects method when it wants to navigate to the “CC” list from an email object, or to display a popup menu with the name of the person in the “CC” list.

PROTOTYPE
SCODE
Email_GetCcLinkObjects(
[in] BSTR EmailObjectSRML,
[in] LONG QueryMask,
[out] BSTR *pQueryRequestGuid );

d. Email_GetBccLinkObjects

### Introduction

The Email_GetBccLinkObjects method is called to get the metadata for the “BCC” links on an email object from the agency from whence it came.

### Usage Scenario

A Nervana skin will typically call the Email_GetBccLinkObjects method when it wants to navigate to the “BCC” list from an email object, or to display a popup menu with the name of the person in the “BCC” list.

PROTOTYPE
SCODE
Email_GetBccLinkObjects(
[in] BSTR EmailObjectSRML,
[in] LONG QueryMask,
[out] BSTR *pQueryRequestGuid );

e. Email_GetAttachmentLinkObjects

### Introduction

The Email_GetAttachmentLinkObjects method is called to get the metadata for the “Attachment” links on an email object from the agency from whence it came.

### Usage Scenario

A Nervana skin will typically call the Email_GetAttachmentLinkObjects method when it wants to navigate to the “Attachments” link from an email object, or to display a popup menu with the titles of the attachments in the “Attachments” list.

PROTOTYPE
SCODE
Email_GetAttachmentLinkObjects(
[in] BSTR EmailObjectSRML,
[in] LONG QueryMask,
[out] BSTR *pQueryRequestGuid );

4. Person Control APIs

a. Person_GetDirectReports

### Introduction

The Person_GetDirectReports method is called to get the metadata for the “Direct Reports” links on a person object from the agency from whence it came.

### Usage Scenario

A Nervana skin will typically call the Person_GetDirectReports method when it wants to navigate to the “Direct Reports” link from a person object, or to display a popup menu with the names of the direct reports in the “Direct Reports” list.

PROTOTYPE
SCODE
Person_GetDirectReports(
[in] BSTR EmailObjectSRML,
[in] LONG QueryMask,
[out] BSTR *pQueryRequestGuid );

b. Person_GetDistributionLists

### Introduction

The Person_GetDistributionLists method is called to get the metadata for the “Member of Distribution Lists” links on a person object from the agency from whence it came.

### Usage Scenario

A Nervana skin will typically call the Person_GetDistributionLists method when it wants to navigate to the “Member of Distribution Lists” link from a person object, or to display a popup menu with the names of the distribution lists of which the person is a member.

PROTOTYPE
SCODE
Person_GetDistributionLists(
[in] BSTR PersonObjectSRML,
[in] LONG QueryMask,
[out] BSTR *pQueryRequestGuid );

c. Person_GetInfoAuthored

### Introduction

The Person_GetInfoAuthored method is called to get the metadata for the “Info Authored by Person” links on a person object from the agency from whence it came.

### Usage Scenario

A Nervana skin will typically call the Person_GetInfoAuthored method when it wants to navigate to the “Info Authored by Person” link from a person object, or to display a preview window with time-critical or recent information that the person authored.

PROTOTYPE
SCODE
Person_GetInfoAuthored(
[in] BSTR PersonObjectSRML,
[in] BOOL SemanticQuery,
[in] LONG QueryMask,
[out] BSTR *pQueryRequestGuid );

d. Person_GetInfoAnnotated

### Introduction

The Person_GetInfoAnnotated method is called to get the metadata for the “Info Annotated by Person” links on a person object from the agency from whence it came.

### Usage Scenario

A Nervana skin will typically call the Person_GetInfoAnnotated method when it wants to navigate to the “Info Annotated by Person” link from a person object, or to display a preview window with time-critical or recent information that the person annotated.

PROTOTYPE
SCODE
Person_GetInfoAnnotated(
[in] BSTR PersonObjectSRML,
[in] LONG QueryMask,
[out] BSTR *pQueryRequestGuid );

e. Person_GetAnnotationsPosted

### Introduction

The Person_GetAnnotationsPosted method is called to get the metadata for the “Annotations Posted by Person” links on a person object from the agency from whence it came.

### Usage Scenario

A Nervana skin will typically call the Person_GetAnnotationsPosted method when it wants to navigate to the “Annotations Posted by Person” link from a person object, or to display a preview window with time-critical or recent annotations that the person posted.

PROTOTYPE
SCODE
Person_GetAnnotationsPosted(
[in] BSTR PersonObjectSRML,
[in] LONG QueryMask,
[out] BSTR *pQueryRequestGuid );

f. Person_SendEmailTo

### Introduction

The Person_SendEmailTo method is called to send email to a person or customer object. The method opens the email client and initializes it with the email address of the person or customer object.

### Usage Scenario

A Nervana skin will typically call the Person_SendEmailTo method when the user clicks on the “Send Email” menu option—off a popup menu on a person or customer object.

PROTOTYPE
SCODE Person_SendEmailTo( [in] BSTR ObjectSRML );

5. System Control Events

a. Event: OnBeforeQuery

### Introduction

The OnBeforeQuery event is fired before the control issues a query to resources consistent with the current semantic request.

### Usage Scenario

A Nervana client application (for instance, the semantic browser) or a Nervana skin will sink this event if it wants to cancel a query or cache state before the query is issued.

| PROTOTYPE | | |
|---|---|---|
| VOID | | |
| OnBeforeQuery( | | |
| [in] | GUID | QueryID, |
| [in] | BSTR | QueryBuffer, |
| [in] | DWORD | QueryMask, |
| [in] | DWORD | Flags, |
| [out] | BOOL | *Cancel ); |

b. Event: OnQueryBegin

### Introduction

The OnQueryBegin event is fired when the control issues the first query to a resource consistent with the current semantic request.

### Usage Scenario

A Nervana client application (for instance, the semantic browser) or a Nervana skin will sink this event if it wants to cache state or display status information when the query is in progress.

PROTOTYPE
VOID
OnQueryBegin( [in] GUID ObjectID );

c. Event: OnQueryComplete

### Introduction

The OnQueryComplete event is fired before the control issues a query to resources consistent with the current semantic request.

### Usage Scenario

A Nervana client application (for instance, the semantic browser) or a Nervana skin will sink this event if it wants to cancel a query or cache state before the query is issued.

PROTOTYPE
VOID
OnQueryComplete( [in] GUID QueryID );

d. Event: OnQueryResultsAvailable

### Introduction

The OnQueryResultsAvailable event is fired when there are available results of an asynchronous method call. The event indicates the request GUID, via which the caller can uniquely identify the specific method call that generated the response.

### Usage Scenario

A Nervana client application (for instance, the semantic browser) or a Nervana skin will sink this event to get responses to method calls on the control.

| PROTOTYPE | |
|---|---|
| VOID | |
| OnQueryResultsAvailable( | |
| [in] GUID | QueryID, |
| [in] SCODE | QueryResult, |
| [in] BSTR | Results, |
| [in] DWORD | NumResults, |
| [in] DWORD | QueryMask, |
| [in] VARIANT | ResultsParam ); |

e. Appendix A

| QUERY MASK VALUES | |
|---|---|
| #define QM_RESULTS | 0x01 |
| #define QM_RESULTCOUNT | 0x02 |
| #define QM_NEWRESULTS | 0x04 |
| #define QM_NEWRESULTCOUNT 0x08 | |
| #define QM_DEFAULT | ( QM_RESULTS ) |

Example:

Person_GetInfoAuthored(
PersonObjectSRML,
QM_RESULTS | QM_RESULTCOUNT,
&QueryRequestGuid );

K. Security Specification for the Information Nervous System

1. Authorization

### Introduction

The ‘People’ DSA will be initialized with an LDAP Directory URL and Group Name. The ‘Users’ DSA will also be initialized with an LDAP Directory URL and Group Name. Typically, the ‘Users’ will be a subset of ‘People.’ For instance, a pharmaceuticals corporation might install a KIS for different large pharmaceutical categories (e.g., Biotechnology, Life Sciences, Pharmacology, etc). Each of these will have a group of users that are knowledgeable or interested in that category. However, the KIS will also have the ‘People’ group populated with all employees of the corporation. This will enable users of the KIS to navigate to members of the entire employee population even though those members are not users of the KIS. In addition, the inference engine will be able to infer expertise with semantic links off people that are in the corporation, not necessarily just users of the KIS.

This is also advantageous for access control at the KIS level—this complements or supplements access control provided by the application server at the Web service layer. The Users group will contain people that have access to the KIS knowledge. However, the People group will contain people that are relevant to the KIS knowledge, even though those people don't have access to the KIS.

Both People and Users DSA populate the People table in the Semantic Metadata Store (SMS) and indicate the object type id appropriately. Note that preferably the passwords are NOT stored in the People table in the SMS.

The Users DSA also populates the User Authentication Table (UAT). This is an in-memory hash table that maps the user names to passwords. The server's Web service will implement the IPasswordProvider interface or an equivalent. The implementation of the PasswordProvider object will return the password that maps to a particular user name. The C# example below illustrates this:

```
namespace WSDK_Security
{
public class PasswordProvider : Microsoft.WSDK.Security.-
IpasswordProvider
{
  public string GetPassword( string username )
  {
    return “opensezme”;
  }
}
```

The following C# code shows how the Web service can retrieve the user information after the user has been authenticated:

```
using System;
using System.Collections;
using System.ComponentModel;
using System.Data;
using System.Diagnostics;
using System.Web;
using System.Web.Services;
using Microsoft.WSDK.Security;
using Microsoft.WSDK;
namespace WSDK_Security
{
  public class Service1 : System.Web.Services.WebService
  {
    [WebMethod]
    public string PersonalHello( )
    {
      string response = ““;
      SoapContext requestContext = HttpSoapContext.RequestContext;
      if (requestContext == null)
      {
        throw new ApplicationException(“Non-SOAP request.”);
      }
      foreach (SecurityToken tok in requestContext.Security.Tokens)
      {
        if (tok is UsernameToken)
        {
          response += “Hello “ + ((UsernameToken)tok).Username;
        }
      }
      return response;
    }
  }
}
```

The Nervana Web service can then go ahead and call the Server Semantic Runtime with the calling user name. The runtime then maps this to SQL and uses the appropriate filters to issue the semantic query.

For the Nervana ASP.NET application, the following entry is added as a child of the parent configuration element in the Web.config file:

```
<microsoft.wsdk>
  <security>
    <passwordProvider
      type=“WSDK_Security.PasswordProvider,
      WSDK-Security” />
    </security>
</microsoft.wsdk>
```

a. Client-Side Authorization Request

In order to create a UsernameToken for the request, the Nervana client has to pass the username and password as part of the SOAP request. The Nervana client can pass multiple tokens as part of the request—this is preferable for cases where the user's identity is federated across multiple authentication providers. The Nervana client will gather all the user account information the user has supplied (including user name and password information), convert these to WS-Security tokens, and then issue the SOAP request. The client code will look like the following (reference: [http]://[www].msdn.microsoft.com):

```
localhost.Service1 proxy = new localhost.Service1( );
UsernameToken clearTextToken =
  new UsernameToken(“Joe”,
            “opensezme”,
            PasswordOption.SendHashed);
proxy.RequestSoapContext.Security.Tokens.Add(clearTextToken);
label1.Text = proxy.PersonalHello( );
```

b. Validating the UsernameToken on the Server

([http]://msdn.microsoft.com/library/default.asp?url=/library/en-us/dnwssecur/html/wssecwithwsdk.asp)

Although the WSDK verifies the Security header syntax and checks the password hash against the password from the Password Provider, there is some extra verification that is preferably be performed on the request. For instance, the WSDK will not call the Password Provider if a UsernameToken is received that does not include a password element. If there is no password to check, there is no reason to call the password provider. This means we need to verify the format of the UsernameToken ourselves.

Another possibility is that there is more than one UsernameToken element included with the request. WS-Security provides support for including any number of tokens with a request that may be used for different purposes.

The code above can be modified for the Nervana Web method to verify that the UsernameToken includes a hashed password and to only accept incoming requests with a single UsernameToken. The modified code is listed below.

```
[WebMethod]
public string ProcessSemanticQuery( string Query )
{
  SoapContext requestContext = HttpSoapContext.RequestContext;
  if (requestContext == null)
  {
    throw new ApplicationException(“Non-SOAP request.”);
  }
  if (requestContext.Security.Tokens.Count == 1)
  {
    foreach (SecurityToken tok in requestContext.Security.Tokens)
    {
      if (tok is UsernameToken)
      {
        UsernameToken UserToken = (UsernameToken)tok;
        if (UserToken.PasswordOption
          == PasswordOption.SendHashed)
        {
          return ProcessSemanticQueryInternal( Query,
          UserToken.Username );
        }
        else
        {
          throw new SoapException(
            “Invalid UsernameToken password type.”,
            SoapException.ClientFaultCode);
          }
      }
      else
      {
        throw new SoapException(
          “UsernameToken security token required.”,
          SoapException.ClientFaultCode);
      }
    }
  }
  else
  {
    throw new SoapException(
      “Request must have exactly one security token.”,
      SoapException.ClientFaultCode);
  }
  return null;
}
```

2. People Groups

The KIS will include metadata for people groups. These are not unlike user groups in modern operating systems. The People Group will be a Nervana first-class object (i.e., it will inherit from the Object class). In addition, the People Group schema will be as follows:

| Field Name | Field Type | Description |
|---|---|---|
| ObjectID | String | The object id of the people group |
| Name | String | The name of the people group |
| Description | String | The description of the people group |
| URI | String | The URI of the people group - this uniquely |
| | | identifies the group and in the preferred |
| | | embodiment, will be an LDAP URI |

In most cases, people groups will map to user groups in directory systems (like LDAP). For instance, the KIS server admin will have the KIS crawl a configurable set of user groups. There will be a People DSA that will crawl the user groups and populate the People Groups and Users tables in the SMS. The People DSA will perform the following actions:
Create the group (if it doesn't exist in the SMS) or update the metadata of the Group (if it exists).
Enumerate all the users in the group (at the source—an LDAP directory in the preferred embodiment).
For all the users in the group, create People objects (or update the metadata if the objects already exist in the SMS).
Update the semantic network (via the ‘SemanticLinks’ table in the SMS) by mapping the people objects to the group objects (using the BELONGS_TO_GROUP semantic link type). This ensures that the SMS has semantic links that capture group membership information (in addition to the groups and users themselves).

3. Identity Metadata Federation

Identity Metadata Federation (IMF) refers to a feature wherein an Information Community (agency) is deployed over the Internet but is used to service corporate or personal customers. For instance, Reuters™ could set up an information community for all its corporate customers that depend on its proprietary content. In such a case where multiple customers share an information community (likely in the same industry), Reuters™ will have a group on the SMS for each customer. However, each of these customers would have to have its corporate directory mirrored on Reuters™ in order for people metadata to be available. This would cause problems, particularly from a security and privacy standpoint. Corporations will probably not be comfortable with having external content providers obtaining access to the metadata of their employees. IMF addresses this problem by having the Internet-hosted information community (agency) host only enough metadata for authentication of the user. For instance, Reuters™ will store only the logon information for the users of its corporate customers in its SMS. When the semantic browser receives SRML containing such incomplete metadata, the client will then issue another query to the enterprise directory (via LDAP access or via UDDI if the enterprise directory metadata is made available through a Web services directory) to fetch the complete metadata of the user. This is possible because the externally stored metadata will have the identity information with which the remaining metadata can be fetched. Since the client fetches the remaining metadata within the firewall of the enterprise, the sensitive corporate metadata is not shared with the outside world.

4. Access Control

a. Access Control Policy

In the preferred embodiment, the KIS will include and enforce access control semantics. The KIS employs a policy of “default access.” Default access here means that the KIS will grant access to the calling user to any metadata in the SMS, except in cases where access is denied. As such, the system can be extended to provide new forms of denial, as opposed to new forms of access. In addition, this implies that if there is no basis for denial, the user is granted access (this leads to a simpler and cleaner access control model).

The KIS will have an Access Control Manager (ACM). The ACM is primary responsible for generating a Denial Semantic Query (DSQ) which the SQP will append to its query for a given semantic request from the client. The ACM will expose the following method (C# sample):

String GetDenialSemanticQuery(String CallingUserName)

Preferably, the method takes in the calling user name and returns a SQL query (or equivalent) that encapsulates exception objects. These are objects that must not be returned to the calling user by the SQP (i.e., objects for which the user does not have access).

The SQP then builds a final raw query that includes the denial query as follows:

Aggregate Raw Query AND NOT IN (Denial Query)

For example, if the aggregate raw query is:

SELECT OBJECTID FROM OBJECTS WHERE OBJECTTYPEID=5,

and the denial query is:

SELECT OBJECTID FROM OBJECTS WHERE OWNERUSERNAME<> ‘JOHNDOE’,

The final raw query (which is that the SQP will finally execute and serialize to SRML to return to the calling user) will be:

SELECT OBJECTID FROM OBJECTS WHERE OBJECTTYPEID=5 AND NOT IN (SELECT OBJECTID FROM OBJECTS WHERE OWNERUSERNAME<> ‘JOHNDOE’)

Semantically, this is probably equivalent to:

“Select all objects that have an object type id of 5 but that are not in an object list not owned by John Doe.”

This in turn is probably semantically equivalent to:

“Select all objects that have an object type id of 5 that are owned by John Doe.”

b. General Access Control Rules

Each semantic query processed by the semantic query processor (SQP) will contain an access control check. This will guarantee that the calling user only receives metadata that he/she has access to. The SQP will employ the following access control rules when processing a semantic query:

1. Preferably, if the query is for ‘People’ objects (people, users, customers, experts, newsmakers, etc.), the returned ‘People’ objects must either:
Include the calling user, or
Include people that share at least one people group with the calling user, and be owned by the calling user or the system

Preferably, the corresponding denial query maps to the following rule: The returned objects must satisfy the following:
Is not the calling user+
Is not owned by the calling user or the system+
Has people that do not share any people group with the calling user

Sample Denial Query SQL

The SQL below illustrates the access control denial query that will be generated by the ACM and appended by the SQP to enforce the access control policy. In this example, the name of the calling user is ‘JOHNDOE.’

```
    SELECT OBJECTID FROM OBJECTS WHERE
    OWNERUSERNAME < > ‘JOHNDOE’ OR
    OWNERUSERNAME < > ‘SYSTEM’ OR
    WHERE OBJECTID NOT IN (SELECT OBJECTID FROM
PEOPLE WHERE NAME=‘JOHNDOE’) OR
    WHERE OBJECTID NOT IN
    (SELECT OBJECTID FROM SEMANTICLINKS WHERE
    OBJECTTYPEID  = “PERSON  AND
PREDICATETYPEID=‘BELONGS_TO_GROUP’ AND
SUBJECTID IN (SELECT SUBJECTID FROM SEMANTICLINKS
WHERE OBJECTID IN (SELECT OBJECTID FROM PEOPLE
WHERE NAME=‘JOHNDOE’ ) )
```

2. Preferably, if the query is for non-People objects (documents, email, events, etc.), the returned objects must:
Be owned by the calling user or the system user, and
Be the subject of a semantic link with the calling user as the object, or
Be the object of a semantic link with the calling user as the subject, or
Be the subject of a semantic link with the object being a person that shares at least one people group with the calling user, or
Be the object of a semantic link with the subject being a person that shares at least one people group with the calling user

Preferably, the corresponding denial query maps to the following rule: The returned objects must satisfy the following:
Is not owned by the calling user+
Is not owned by the system user+
Is not the subject of a semantic link with the calling user as the object+
Is not the object of a semantic link with the calling user as the subject+
Is not the subject of a semantic link with the object being a person that shares at least one people group with the calling user+
Is not the object of a semantic link with the subject being a person that shares at least one people group with the calling user

Sample Denial Query SQL

The SQL below illustrates the access control denial query that will be generated by the ACM and appended by the SQP to enforce the access control policy. In this example, the name of the calling user is ‘JOHNDOE.’

```
    SELECT  OBJECTID  FROM  OBJECTS  WHERE  OWNERUSERNAME  < >
‘JOHNDOE’ OR
    OWNERUSERNAME < > ‘SYSTEM’ OR
    OBJECTID NOT IN (SELECT OBJECTID FROM SEMANTICLINKS WHERE
    OBJECTTYPEID = “PERSON’ AND OBJECTID IN (SELECT OBJECTID FROM
PEOPLE WHERE NAME=‘JOHNDOE’) OR
    WHERE OBJECTID NOT IN (SELECT OBJECTID FROM SEMANTICLINKS
INNER JOIN PEOPLE WHERE SEMANTICLINKS.SUBJECTTYPEID=‘PERSON’ AND
SEMANTICLINKS.SUBJECTID = PEOPLE.OBJECTID) OR
    OBJECTID NOT IN (SELECT OBJECTID FROM SEMANTICLINKS WHERE
OBJECTTYPEID=‘PERSON’ AND PREDICATETYPEID=‘BELONGS_TO_GROUP’ AND
SUBJECTID IN (SELECT SUBJECTID FROM SEMANTICLINKS WHERE OBJECTID IN
(SELECT OBJECTID FROM PEOPLE WHERE NAME=‘JOHNDOE’)) OR
    OBJECTID NOT IN (SELECT OBJECTID FROM SEMANTICLINKS WHERE
OBJECTTYPEID=‘PERSON’ AND PREDICATETYPEID=‘BELONGS_TO_GROUP’ AND
OBJECTID IN (SELECT OBJECTID FROM PEOPLE WHERE NAME=‘JOHNDOE’))
```

Sample Merged Denial Query SQL

By merging these two rules, the ACM returns the following merged query to the SQP for access denial:

```
    SELECT OBJECTID FROM OBJECTS WHERE
    OWNERUSERNAME < > ‘JOHNDOE’ OR
    OWNERUSERNAME < > ‘SYSTEM’ OR
    OBJECTID  NOT  IN  (SELECT  OBJECTID  FROM  PEOPLE  WHERE
NAME=‘JOHNDOE’) OR
    OBJECTID NOT IN (SELECT OBJECTID FROM SEMANTICLINKS WHERE
    OBJECTTYPEID  = “PERSON  AND
PREDICATETYPEID =‘BELONGS_TO_GROUP’ AND SUBJECTID IN (SELECT
SUBJECTID FROM SEMANTICLINKS WHERE OBJECTID IN (SELECT OBJECTID
FROM PEOPLE WHERE NAME=‘JOHNDOE’)) OR
    OBJECTID NOT IN (SELECT OBJECTID FROM SEMANTICLINKS WHERE
OBJECTTYPEID = “PERSON’ AND OBJECTID IN (SELECT OBJECTID FROM PEOPLE
WHERE NAME=‘JOHNDOE’) OR
    OBJECTID NOT IN (SELECT OBJECTID FROM SEMANTICLINKS INNER JOIN
    PEOPLE  ON  SEMANTICLINKS.SUBJECTTYPEID=‘PERSON’ AND
SEMANTICLINKS.SUBJECTID = PEOPLE.OBJECTID) OR
    OBJECTID NOT IN (SELECT OBJECTID FROM SEMANTICLINKS WHERE
OBJECTTYPEID=‘PERSON’ AND PREDICATETYPEID=‘BELONGS_TO_GROUP’ AND
SUBJECTID IN (SELECT SUBJECTID FROM SEMANTICLINKS WHERE OBJECTID IN
(SELECT OBJECTID FROM PEOPLE WHERE NAME=‘JOHNDOE’)) OR
    OBJECTID NOT IN (SELECT OBJECTID FROM SEMANTICLINKS WHERE
OBJECTTYPEID=‘PERSON’ AND PREDICATETYPEID=‘BELONGS_TO_GROUP’ AND
OBJECTID IN (SELECT OBJECTID FROM PEOPLE WHERE NAME=‘JOHNDOE’))
```

Example Scenario

For instance, A Reuters™ agency (KIS) might have people groups for each enterprise customer that Reuters™ serves. The agency will have a common information base (Reuters™ content) but will have people groups per enterprise customer. These groups might include competitors. As such, it is preferable to ensure that the knowledge flow, generation, and inference do not cross competitor boundaries. For instance, an employee of Firm A must not derive knowledge directly from an employee of Firm B that competes with Firm A, not must he or she derive knowledge indirectly (via inference). An employee of Firm A must not be able to get recommendations for items annotated by employees of Firm B. Or an employee of Firm A must not be able to find experts that work for Firm B. Of course, this assumes that Firm A and Firm B are not partners in some fashion (in which case, they might want to share knowledge). In the case of knowledge partners, Reuters™ would create a people group (likely via LDAP) that includes the people groups of Firm A and Firm B. The Reuters™ KIS will then have the following people groups: Firm A, Firm B, and Firms A&B. The SMS will also include metadata that indicates that the people in Firms A and Firms B belong to these groups (via the “belongs to group” semantic link type). With this process in place, the aforementioned rules will guarantee that knowledge gets shared between Firms A and B.

c. Access Control Rules for Annotations

In the case of annotations, the calling user will be editing the semantic network, as opposed to querying it. In this case, the following rules would apply:

1. Preferably, if the object being annotated is a Person object, the object must either be:
The calling user, or
A person that shares at least one people group with the calling user, and be owned by the calling user or the system

2. Preferably, if the object being annotated is a non-Person object (e.g., a document, email, event, etc.), the object must either be:
Owned by the calling user
Owned by the system

Sample Denial Query SQL

The SQL below illustrates the access control denial query that will be generated by the ACM (for checking access control for annotations) and appended by the SQP to enforce the access control policy. In this example, the name of the calling user is ‘JOHNDOE.’

```
    SELECT OBJECTID FROM OBJECTS WHERE
    OWNERUSERNAME < > ‘JOHNDOE’ OR
    OWNERUSERNAME < > ‘SYSTEM’ OR
    OBJECTID  NOT  IN  (SELECT  OBJECTID  FROM  PEOPLE  WHERE
NAME=‘JOHNDOE’) OR
    OBJECTID NOT IN (SELECT OBJECTID FROM SEMANTICLINKS WHERE
OBJECTTYPEID=‘PERSON’ AND PREDICATETYPEID=‘BELONGS_TO_GROUP’ AND
OBJECTID IN (SELECT OBJECTID FROM SEMANTICLINKS WHERE OBJECTID IN
(SELECT OBJECTID FROM PEOPLE WHERE NAME=‘JOHNDOE’))
```

Access Control Enforcement

The ACM enforces access control for annotations and other write operations on the KIS. The KIS XML Web Service exposes an annotation method as follows (C# sample):

AnnotateObject(String CallingUserName, String ObjectID );

This method calls the ACM to get the denial query. It then creates a final query as follows:

Annotation Object Query AND NOT IN (Denial Query)

In the preferred embodiment, the annotation object query is always of the form:

SELECT OBJECTID FROM OBJECTS WHERE OBJECTID=ObjectID,

where ObjectID is the argument to the AnnotateObject method.

The ACM then builds a final access control query SQL and uses this SQL to check for access control. Because the ACM does not have to return the SQL, it merely invokes it directly in order to check for access control. In addition, because it is a binary check (access or no access), the ACM merely checks whether the denial query returns at least one row. For instance, a final query might look like:

```
    SELECT OBJECTID FROM OBJECTS WHERE OBJECTID =
    ObjectID AND NOT IN
(SELECT OBJECTID FROM OBJECTS WHERE
OWNERUSERNAME < > ‘JOHNDOE’)
```

The ACM then runs this query (via the SQL query processor) and asks for the count of the number of rows in the result set. If there is one row, access is granted, else access is denied. This model is implemented this way in order to have consistency with the denial query model (the ACM always builds a denial query and uses this as a basis for all access control checks).

L. Deep Information Specification for the Information Nervous System

Deep Information Overview

### Introduction

In the preferred embodiment, the Nervana ‘Deep Info’ tool is aimed at providing context-sensitive story-like information for a Nervana information object. Deep Info essentially provides Nervana users with information that otherwise would be lost, given a particular context. By way of rough analogy, Deep Info is like the contextual information that gets displayed on music videos on MTV (showing information on the current artist, the current song, and in some case, the current musical instrument in the song).

The ‘deep’ in ‘deep info’ refers to the fact that the contextual information will often span multiple “hops” in the semantic network on the agency from whence the object came. ‘Deep Info’ is comprised of ‘deep info nuggets’ which can either be plan textual metadata or metadata with semantic query links (via SQML).

In the preferred embodiment, there are at least five kinds of Deep Info nuggets:

1. Basic Semantic Link Nuggets

2. Context Template Nuggets

3. Trivia Nuggets

4. Matchmaker Nuggets

5. Recursive Nuggets

a. Basic Semantic Link Nuggets

With basic semantic link truths, deep info nuggets merely convey a semantic link of the current object. These nuggets involve a semantic link distance of 1. In this case, there is overlap with what will be displayed in the ‘Links’ context/task pane. Examples are:
Patrick Schmitz reports to Nosa Omoigui
Patrick Schmitz has 5 Direct Reports
Patrick Schmitz annotated 47 objects
Patrick Schmitz authored 13 objects
Patrick Schmitz was copied on 56 email objects

b. Context Template Nuggets

Context template nuggets display contextual information for each relevant context template, based on the information at hand. These nuggets are identical to those that will be displayed in the context bar or context panel for each type of context template. For example:
Patrick Schmitz posted 3 breaking news items
Patrick Schmitz posted 14 classics
Patrick Schmitz authored 7 headlines
Patrick Schmitz is involved in 13 discussions
Patrick Schmitz is a newsmaker on 356 objects

c. Trivia Nuggets

For all email objects on an agency:
Steve Judkins appears on the “To” list of all of them
Steve Judkins replied to 23% of them
Patrick Schmitz annotated 50% of them
Only 3 of these have a thread depth greater than 2

For all people objects on an agency:
Patrick Schmitz has sent email to 47% of them
14% of them report to Nosa Omoigui
Sally Smith has had discussions with 85% of them
12% of them are newsmakers on at least one topic
All of them have been involved in at least one discussion this week
33% of them are experts on at least one topic
8% of them are experts on more than three topics

For a given distribution list on an agency:
Steven Judkins has posted the most email to this list
Sarah Trent has replied to the most email on this list
Nosa Omoigui has never posted to this list
Patrick Schmitz has posted 87 messages to this list this month
Richard Novotny has posted 345 messages to this list this year

For all distribution lists on an agency:
Steven Judkins has posted the most email to all lists
Lisa Heibron has replied to email on only 2% of the lists
Nosa Omoigui has never posted to any list
Patrick Schmitz has posted at least once every week to all the lists
Richard Novotny has posted messages on 3 lists

For all information objects on an agency:
Steven Judkins has been the most prolific publisher (he published 5% of them)
Sally Smith has been the most prolific annotator (she annotated 2% of them)
Nosa Omoigui has been the most active newsmaker
Patrick Schmitz has the most aggregate expertise
Steve Judkins has the most expertise for information published this year
Gavin Schmitz has been involved in the most discussions (12% of them)
Richard Novotny has been involved in the most discussions this month (18% of them)

d. Matchmaker Nuggets

Person To Person

Semantic Link Based
Patrick Schmitz has sent mail to 13 people
47 people have appeared on same To list as Patrick Schmitz
47 people have appeared on same CC list as Patrick Schmitz
89 people in total have been referenced on email sent by Patrick Schmitz
24 people have annotated the same information as Patrick Schmitz
3 people are on all the same distribution lists as Patrick Schmitz
29 people are on at least one of Patrick Schmitz's distribution lists

Context-Template Based
12 people have expertise on the same information categories as Patrick Schmitz
14 people and Patrick Schmitz are newsmakers on the same information items
27 people are in discussions with Patrick Schmitz

Information To Person

Semantic Link Based
Patrick Schmitz posted this information item
Steve Judkins authored this information item
This information item was copied to 2 people
3 people annotated this information item

Context Template Based (similar to context template nuggets)
There are 4 experts on this information item
There are 27 newsmakers on this information item

Information To Information

Context Template Based (similar to context template nuggets)
There are 578 relevant ‘all bets’
There are 235 relevant ‘best bets’
There are 4 relevant breaking news items
There are 46 relevant headlines

Semantic Link Based (via people)
There are 21 information items that have the same experts with this one
There are 23 information items that have the same newsmakers with this one
There are 34 information items posted by the same person that posted this one
There are 34 information items authored by the same person that authored this one
There are 44 information items annotated by people that annotated this one

e. Recursive Nuggets

With recursive nuggets, displaying deep info on the subject of the current information nugget forms a contextual hierarchy. The system then recursively displays the nuggets based on the object type of the subject. With recursive nuggets, the system essentially probes the semantic network starting from the source object and continues to display nuggets along the path of the network. Probing is preferably stopped at a depth that is consistent with resource limitations and based on user feedback.

Another way to think of recursive nuggets is like a contextual version of an business organization chart. However, with Deep Information in the Information Nervous System, users will be able to browse a tree of KNOWLEDGE, as opposed to a tree of INFORMATION. To take an example, if a user selects an object and a tree view will show up like what is displayed below:

Example with document as context:

```
[+]Newsmakers on ‘Title of document’
    [+] Gavin Schmitz
        [+] Reports To ->
            [+] Steve Judkins
                [+] Experts Like Steve Judkins ->
                    [+] Nosa Omoigui
                    [+] Patrick Schmitz
                [+] Interest Group Like Steve Judkins ->
                    [+] Patrick Schmitz
                        ...
                    [+] Chuck Johnson
                        ...
        [+]Direct Reports ->
            [+]Joe Williams
                [+] Direct Reports □
                [+] Interest Group Like Joe Williams ->
    [+] Richard Novotny
        ...
    [+] Nosa Omoigui
        ...
[+] Interest Group
[+] Experts
```

Example with email as context:

```
[+] Email is From:
    [+] Nosa Omoigui
        [+] Experts like Nosa Omoigui
            ...
[+] Email is To:
    [+] Chuck Johnson
        [+] Experts like Chuck Johnson
            ...
[+] Email is Copied To:
    [+] Richard Novotny
        [+] Experts like Richard Novotny
            ...
[+] Email Attachments:
    foo.doc
        [+] Experts on foo.doc
            [+] Gavin Schmitz
                [+] Newsmakers like Gavin Schmitz
                    ...
[+] Newsmakers on ‘Title of Email’
            ...
```

Example with conversation object as context:

```
[+]Conversation Participants
    [+]Steve Judkins
        [+] Interest Group Like Steve Judkins...
            ...
    [+]Nosa Omoigui
        [+] Interest Group Like Nosa Omoigui
            ...
[+] Experts on ‘Title of Conversation’
    [+] Richard Novotny
        [+] Interest Group Like Richard Novotny
            ...
```

Notice the use of default predicates in the above example—e.g., with People subjects linked to People objects, the LIKE predicate is uses (e.g., Interest Group LIKE Richard Novotny).

Another example of recursive nuggets is shown below:

```
[+] Patrick Schmitz authored this email
[+] Patrick Schmitz reports to Nosa Omoigui
[+] Nosa Omoigui has 6 Direct Reports
            [+] Steve Judkins ...
        [+] Steve Judkins posted ...
            [+] Steve Judkins is an expert on ...
[+] Steve Judkins is a newsmaker on ...
[+] Steve Judkins has been involved in 6 discussions
        [etc.]
            [+] Richard Novotny...
            [+] [The remaining 6 direct reports]
        [+] Nosa Omoigui annotated 13 objects...
            [+] [More context template nuggets on the 13 objects]
        [+] Nosa Omoigui has authored 278 objects
[+] Nosa Omoigui has annotated 23 items  [...]
[+] Patrick Schmitz has 5 Direct Reports
        [+] John Doe ...
        [+] More Native Nuggets based on the direct reports
[+] Patrick Schmitz annotated 47 objects
```

In the preferred embodiment, recursive nuggets will most typically be displayed via a drill-down pane beside each result object in the semantic browser. This will allow the user to select a result object and then recursively and semantically “explore” the object (as illustrated above).

Also, each header item in the Deep Info drill down tree view will be a link to a request (e.g., Experts Like Steve Judkins), and each result will be a link to an entity. For example, users will be able to “navigate” to the “person” (semantically) Patrick Schmitz from anywhere in the Deep Info tree view. Users will then be able to view a dossier on Patrick Schmitz, copy Patrick Schmitz, and Paste it on, say, Breaking News—in order to open a request called Breaking News by Patrick Schmitz. Again, notice the use of a default predicate based on the Person subject (“BY”).

The preferred embodiment Presenter Deep Info tree view (with support from the semantic runtime API in the semantic browser) will keep track of those links that are requests and those links that are result objects; that way, it will intelligently interpret the user's intent when the user clicks on a link the tree view (it will navigate to a request or navigate to an entity).

M. Create Request Wizard Specification for the Information Nervous System

Introducing the Create Request Wizard

### Overview

The preferred embodiment Create Request (or Smart Agent) Wizard allows the user to easily and intuitively create new requests that represent semantic queries to be issued to one or more knowledge sources (running the Knowledge Integration Service).

Wizard Page 1: Select a Profile and Request Type: This page allows the user to select what profile the request is to be created in. The page also allows the user to select the type of request he/she wants to create. This type could be a Dossier (Guide) which will create a request containing sub-requests for each context template (based on the filters indicated in the request), knowledge types (corresponding to context templates such as Best Bets, Headlines, Experts, Newsmakers, etc.), information types (corresponding to types such as Presentations, General Documents, etc.), and request collections which are Blenders and allow the user to view several requests as a cohesive unit. See FIG. 17A.

Wizard Page 2: Select Knowledge Communities (Agencies): This page allows the user to select which knowledge communities (running on Knowledge Integration Servers (KISes) the request should get its knowledge from. The user can indicate that the request should use the same knowledge communities as those configured in the selected profile. The user can alternatively select specific knowledge communities. See FIG. 17B.

Wizard Page 3: Select Filters: This page allows the user to select which filters to include in the request. Filters can include one or more of the following: keywords, text, categories, local documents, Web documents, email addresses (for People filters), and Entities. In alternate embodiments, other filter types will be supported. The property page also allows the user to select the predicate with which to apply a specific filter. Preferably, the most common predicate that will be exposed is “Relevant to.” Other predicates can be exposed consistent with the filter type (for instance a filter that refers to a Person via an email address or entity will use the default predicate “BY” if the requested type is not ‘People’—e.g. Headlines BY John Smith and will use the default predicate “LIKE” if the request type is ‘People’—e.g., Experts LIKE John Smith). The property page also allows the user to select the operation with which to apply the filters. The two most common operators are AND (in which case only results that satisfy all the filters are returned) and OR (in which case results that satisfy any of the filters are returned). See FIG. 17C.

Wizard Page 4: Name and describe this request: This page allows the user to enter a name and description for the request. The wizard automatically suggests a name and description for the request based on the semantics of the request. Examples include:

1. Headlines on Security AND on Application Development AND on Web Services.

2. Experts from R&D on Encryption Techniques OR on User Interface Design, etc.

3. Presentations on Artificial Intelligence.

4. Dossier on Data Mining AND on Web Development. See FIG. 17D.

The user is allowed to override the suggested name/description. The suggestions are truncated as needed based on a maximum name and description length.

The semantic browser also exposes the properties of an existing request via a property sheet. This allows the user to “edit” a request. The property sheet exposes the same user interface as the wizard except that the fields are initialized based on the semantics of the request (by de-serializing the request's SQML representation). See FIG. 17E.

N. Create Profile Wizard Specification for the Information Nervous System

Introducing the Create Profile Wizard

### Overview

The Create Profile Wizard allows the user to easily and intuitively create new user profiles.

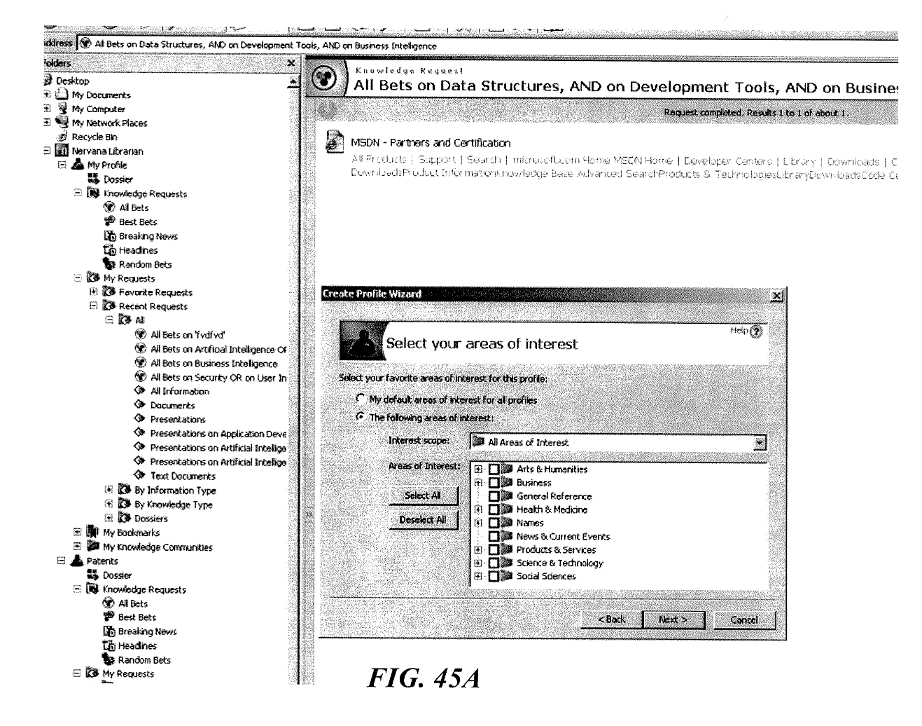

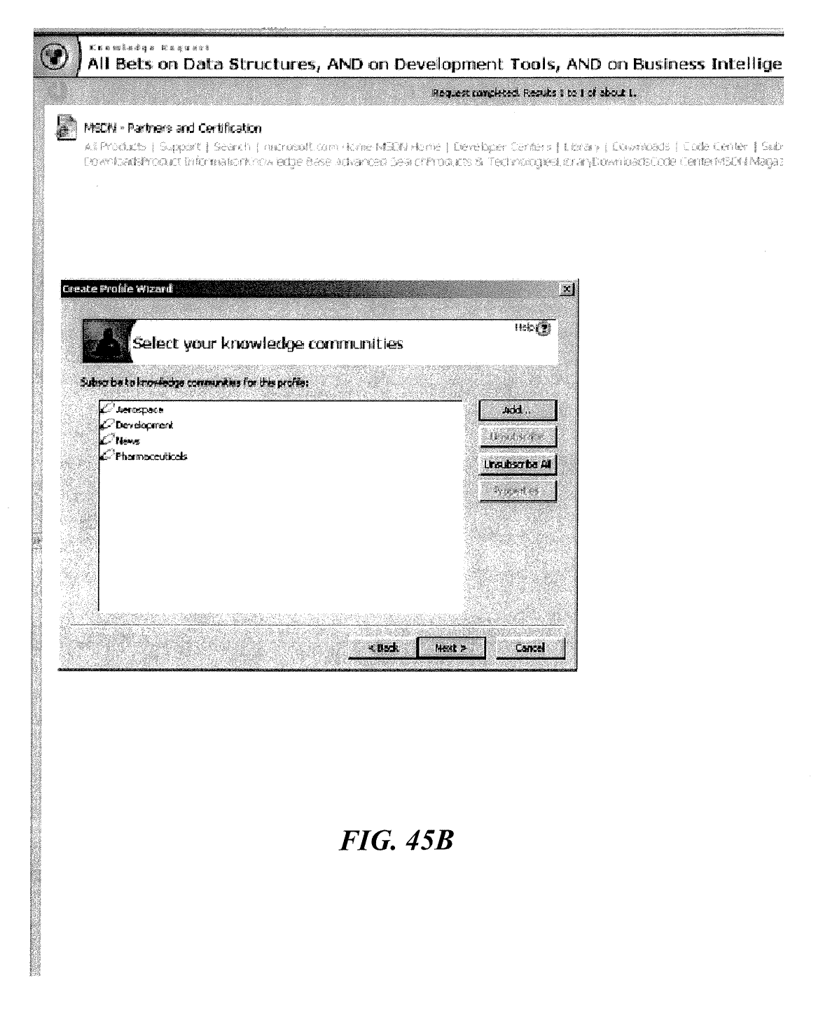

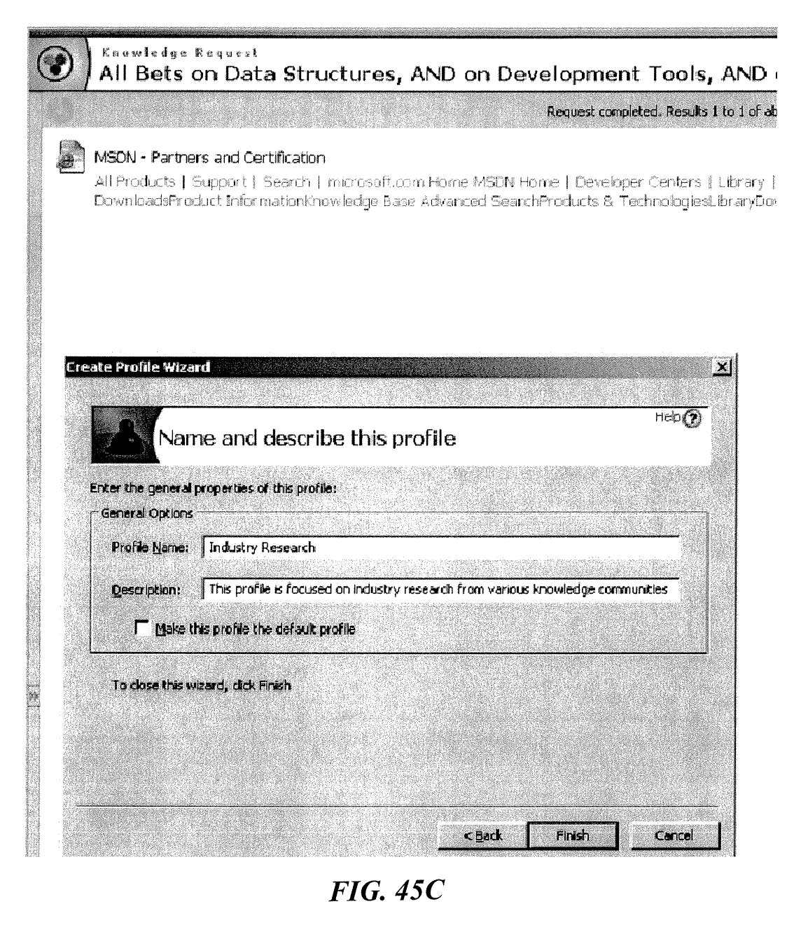

Wizard Page 1: Select your areas of interest: This page allows the user to select his/her areas of interest. This allows the semantic browser to get some high-level information about the user's knowledge interests (such as the industry he/she works in). This information is then used to narrow category selections in the categories dialog, recommend new knowledge communities (agencies) configured with knowledge domains consistent with the user's area(s) of interests, etc. See FIG. 45A.

Wizard Page 2: Select your knowledge communities: This page allows the user to subscribe to knowledge communities for the profile. This allows the semantic browser to “know” which knowledge sources to issue requests to, when those requests are created for the profile. The semantic browser also uses the knowledge communities in the profile when it invokes Visualizations, semantic alerts, the smart lens (when the lens is a request/agent for the given profile), the object lens (when the target object is a result from the given profile), when the user drags and drops (or copies and pastes) an object to a request/agent for the given profile, etc. See FIG. 45B.

Wizard Page 3: Name and describe this profile: This page allows the user to enter a name and description for the profile. The page also allows the user to indicate whether the profile is preferably made the default profile. The default profile is used when the user does not explicitly indicate a profile in any operation in the semantic browser (for example, dragging and dropping a document from the file system to the icon representing the semantic browser will open a bookmark with that document from the default profile, whereas dragging and dropping a document to an icon representing a specific profile will open a bookmark with that profile). See FIG. 45C.

O. Create Bookmark Wizard Specification for the Information Nervous System

1. Introducing the Create Bookmark Wizard

### Overview

The Create Bookmark (or Local/Dumb Request Agent) Wizard allows the user to easily and intuitively create new bookmarks (local/dumb requests) to view local/Web documents, entities, etc. in the semantic browser via which he/she can get access to the toolbox of the system (i.e., drag and drop, smart copy and paste, smart lens, smart alerts, Visualizations, etc.).

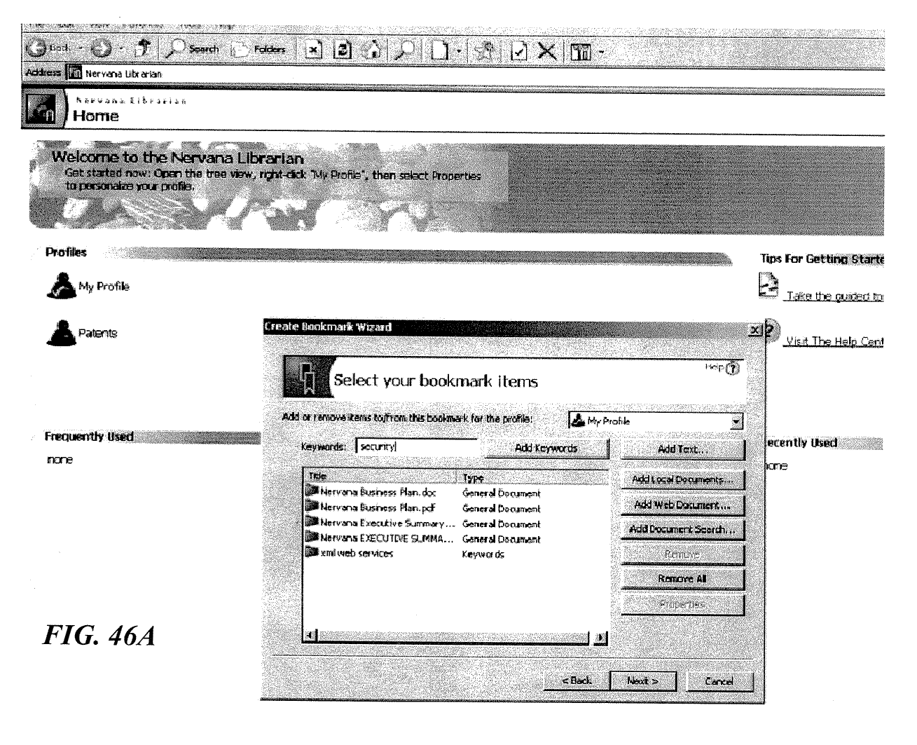

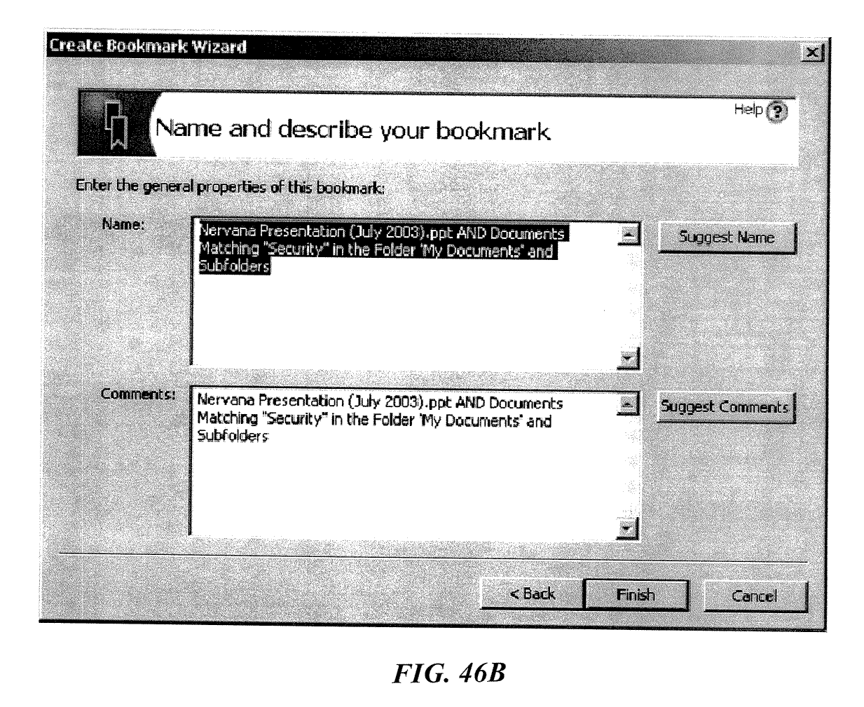

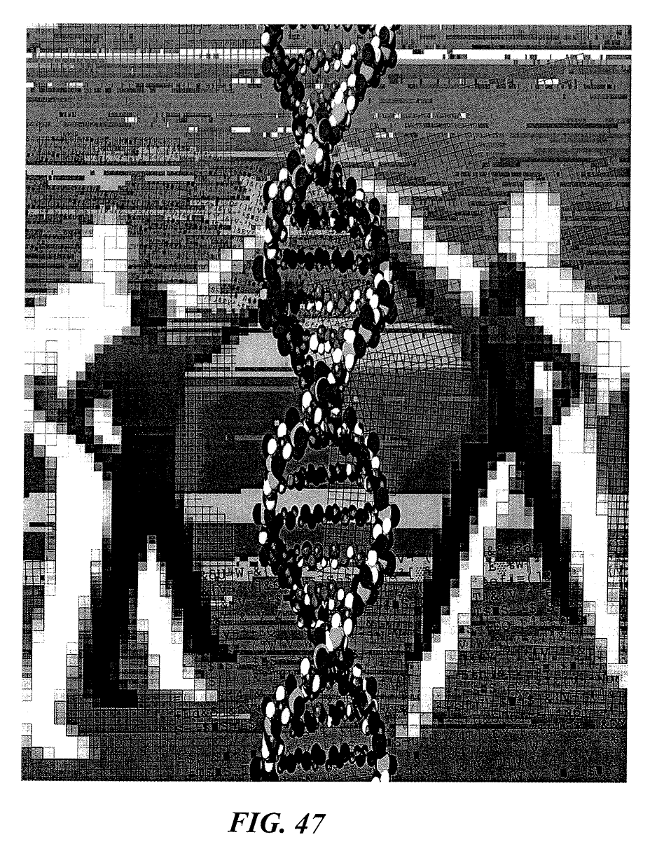

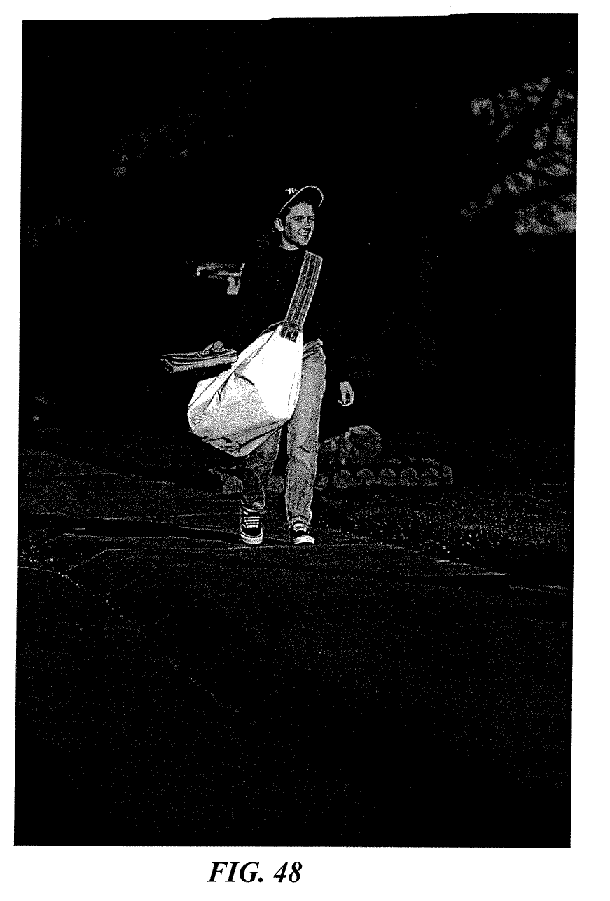

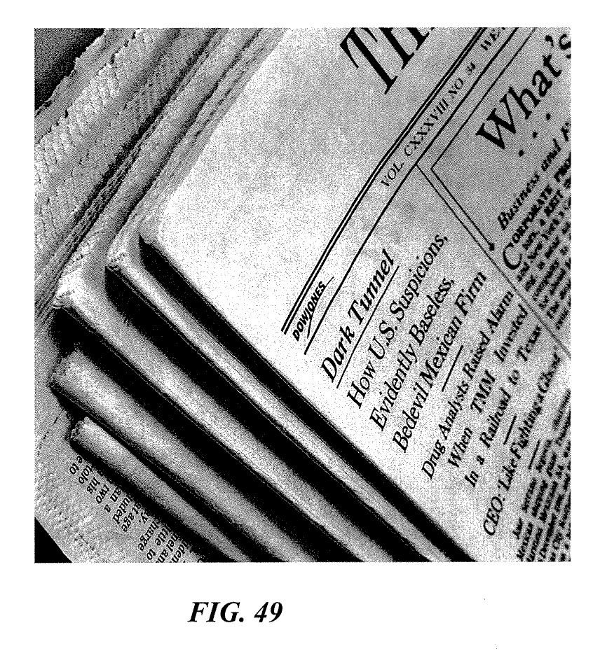

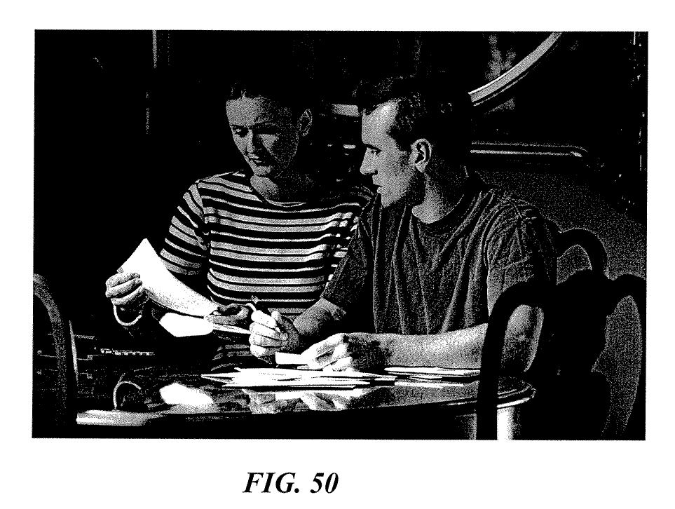

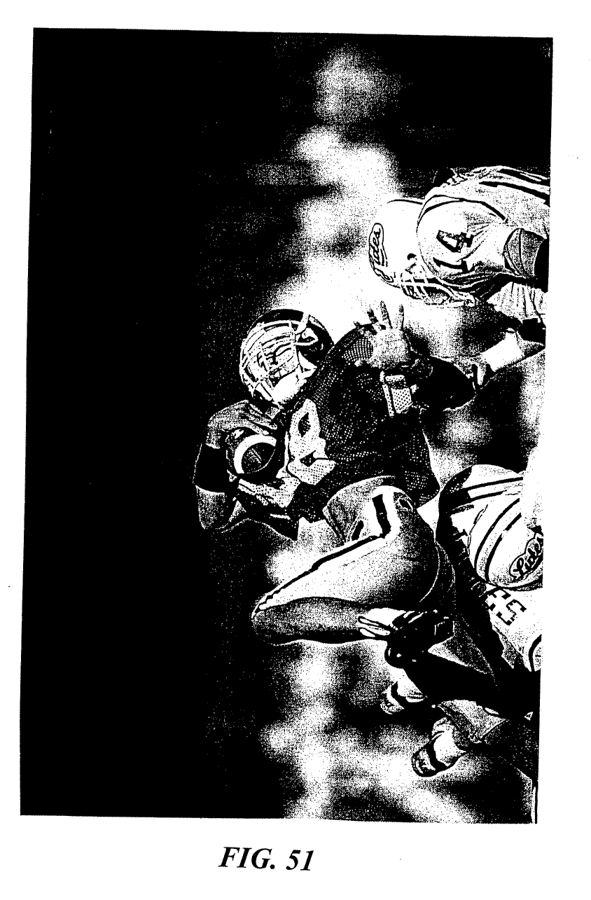

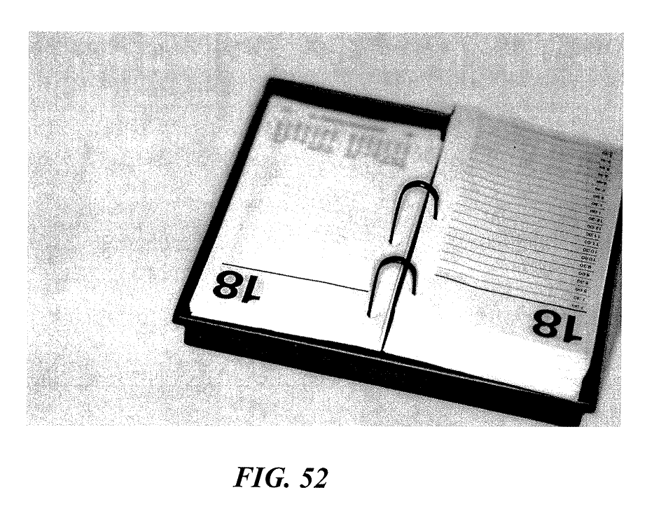

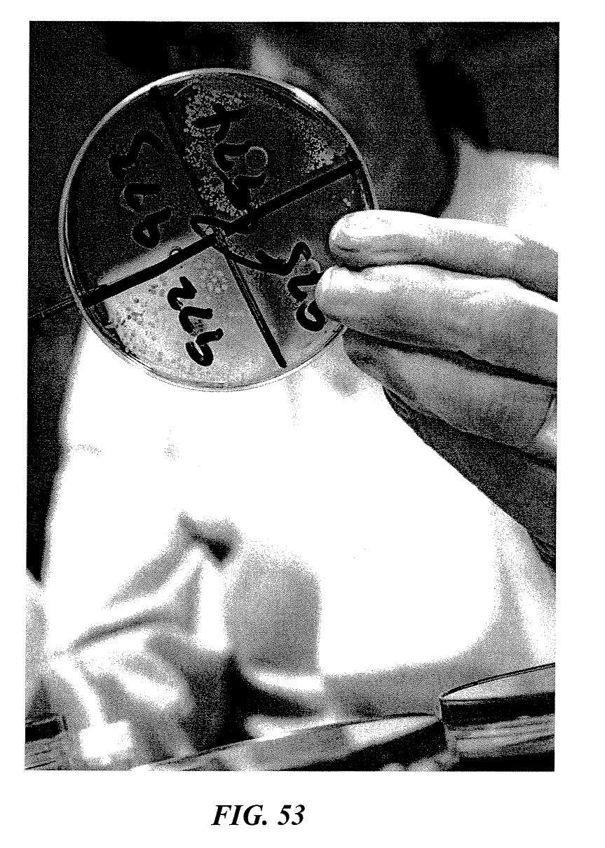

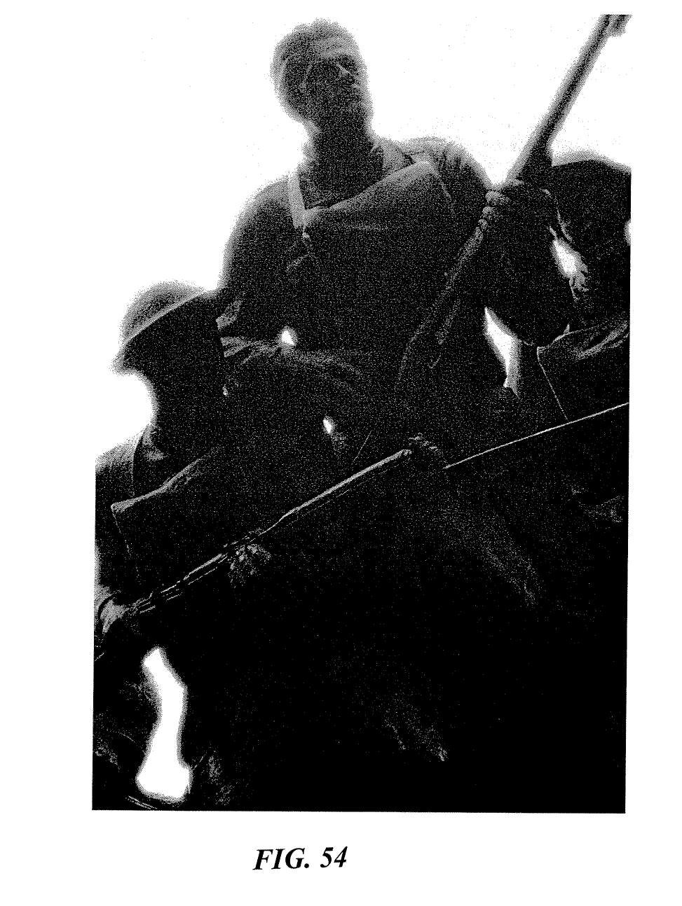

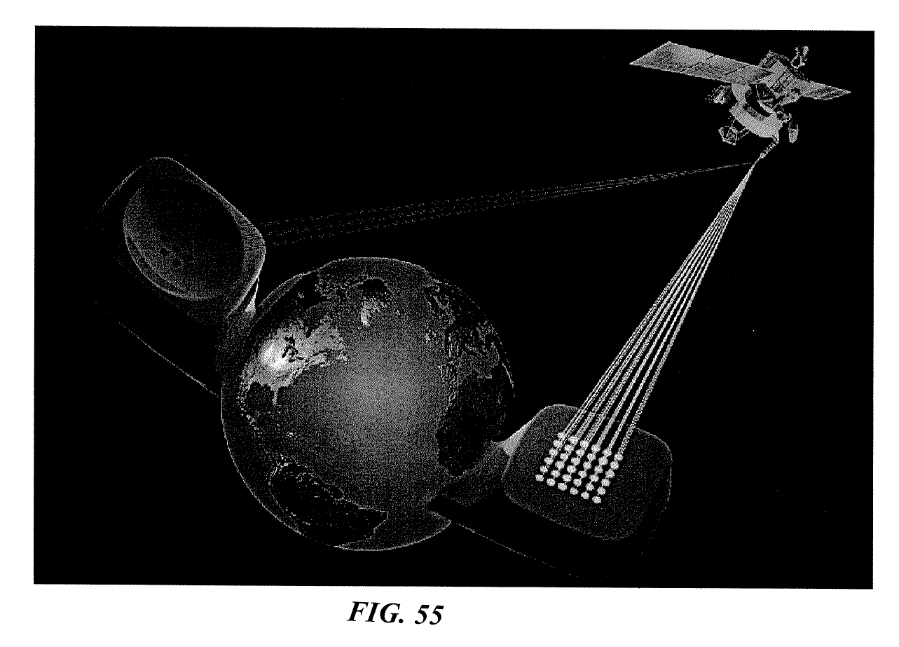

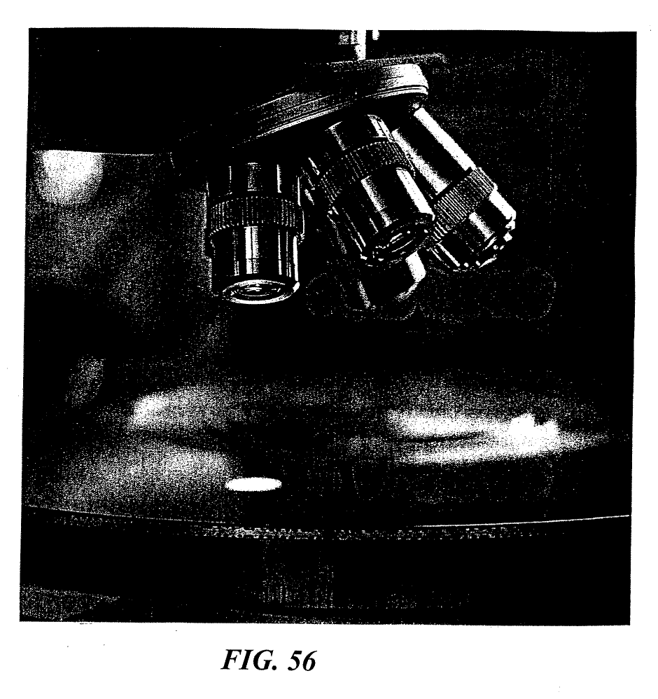

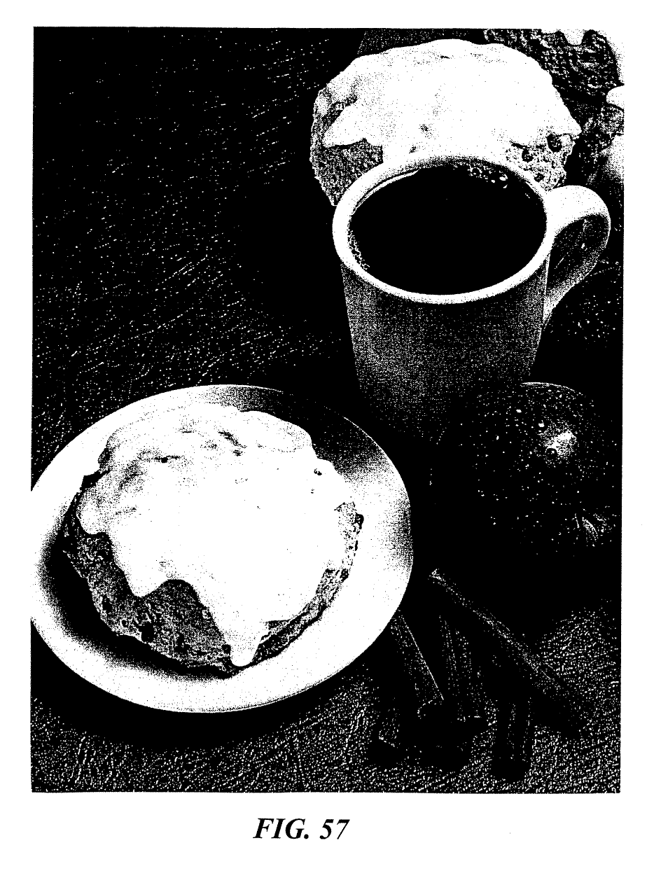

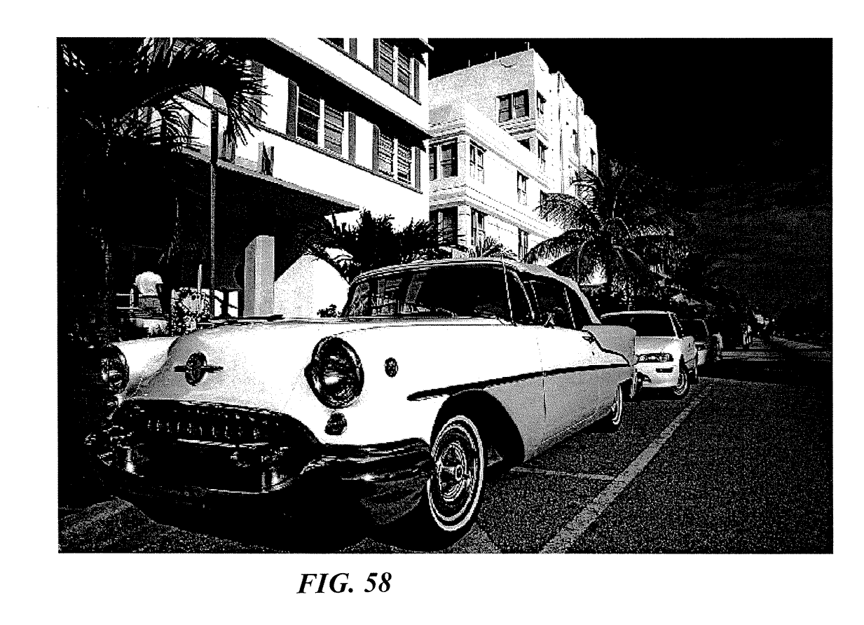

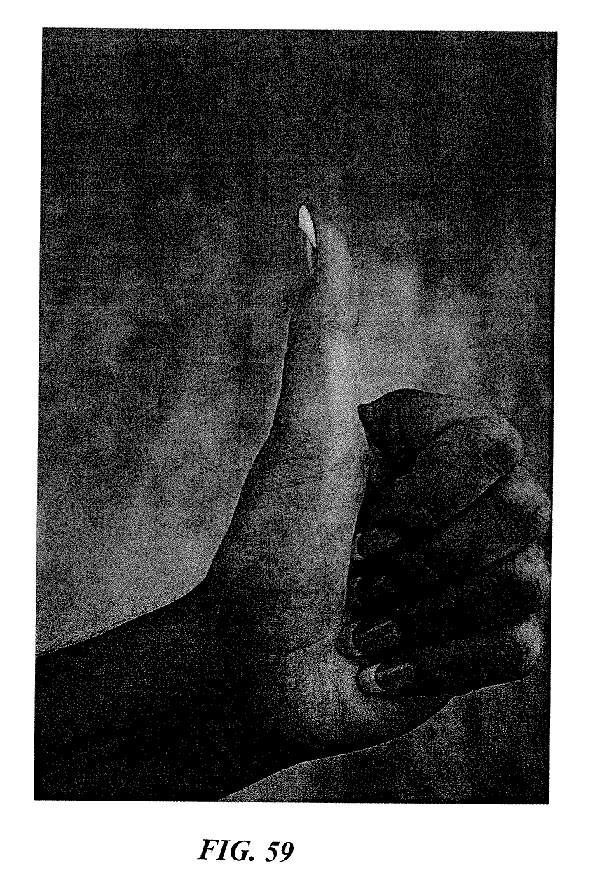

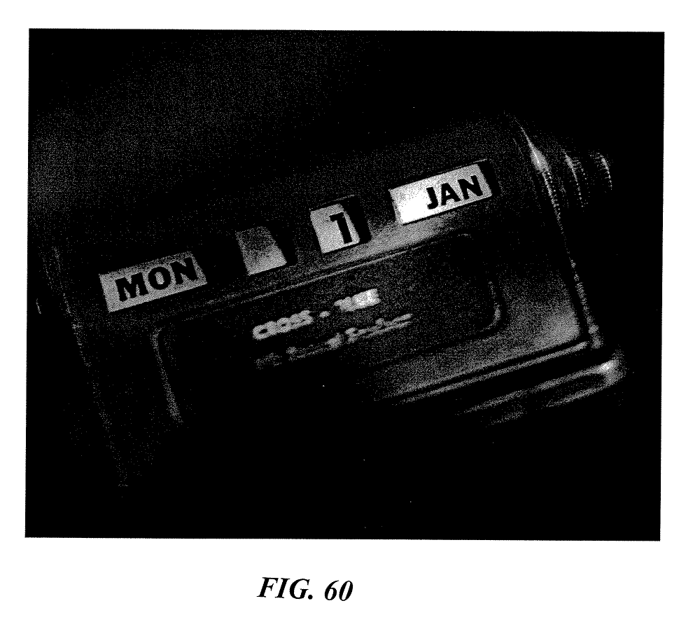

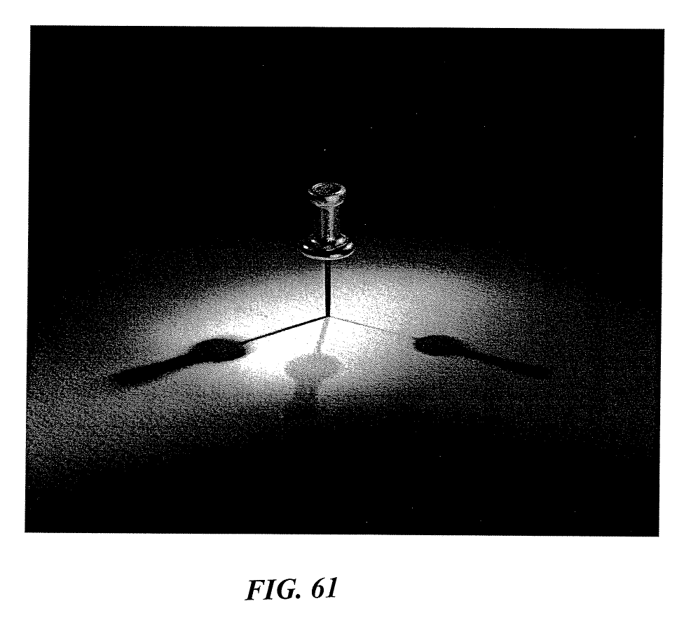

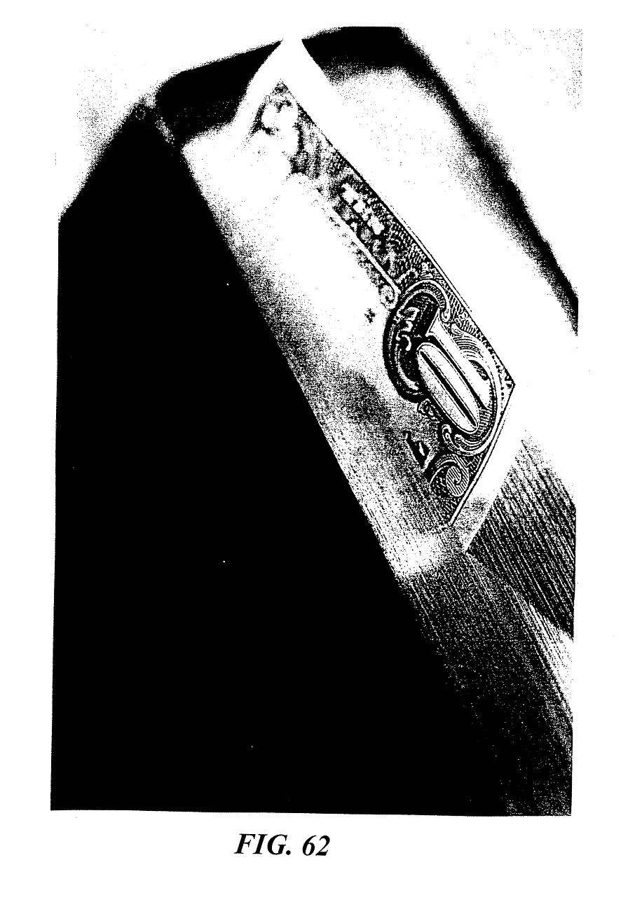

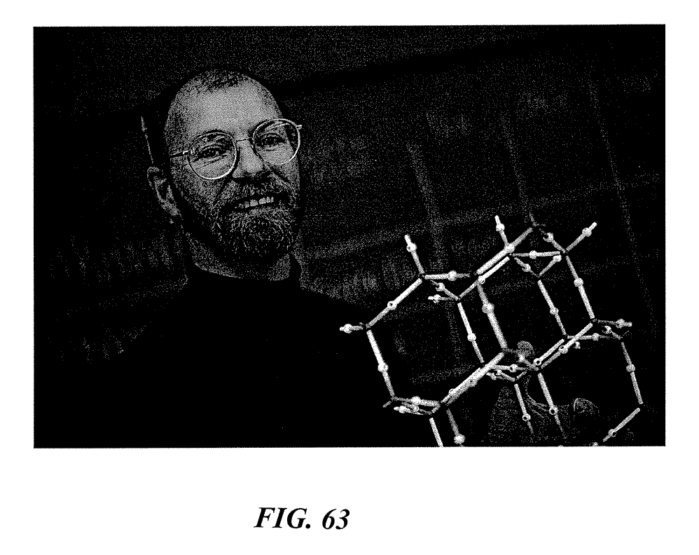

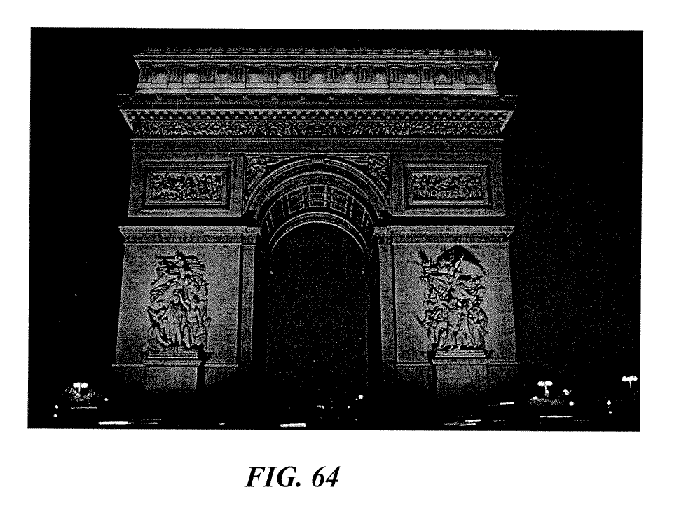

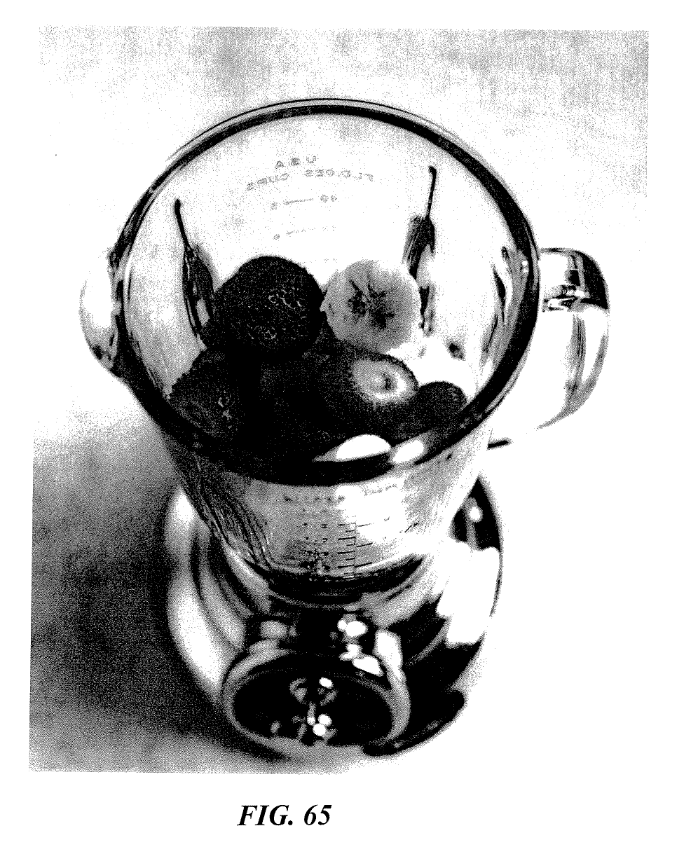

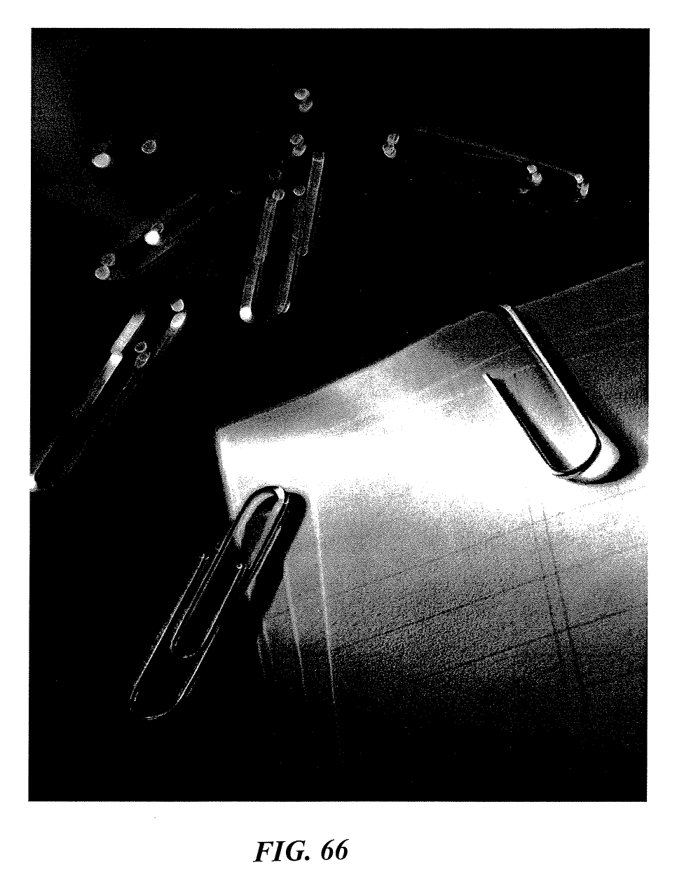

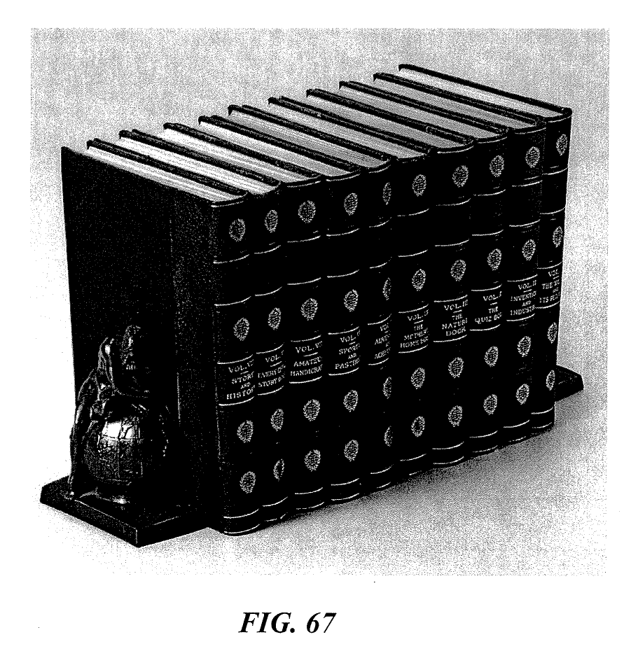

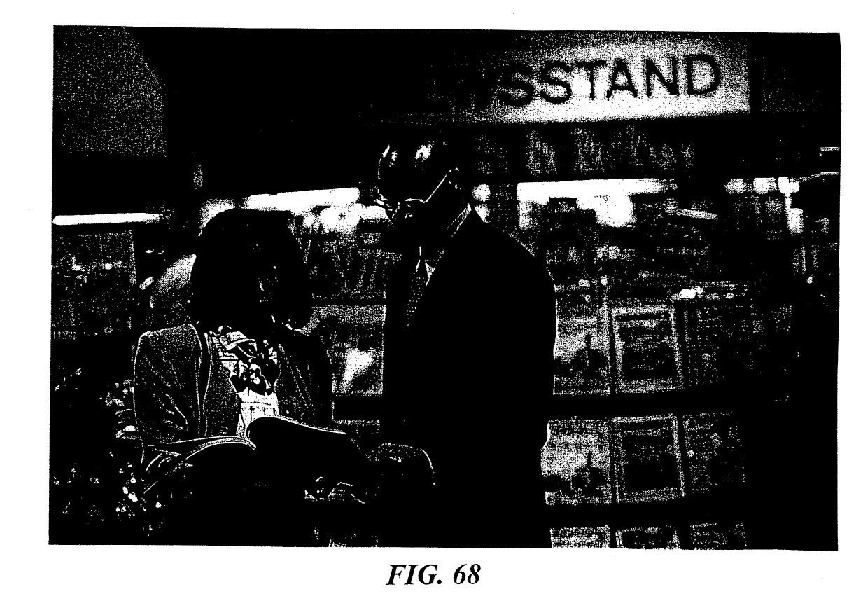

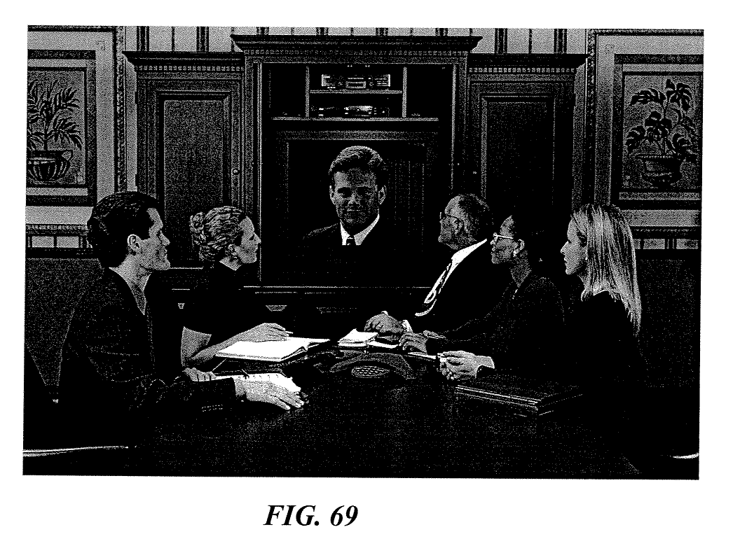

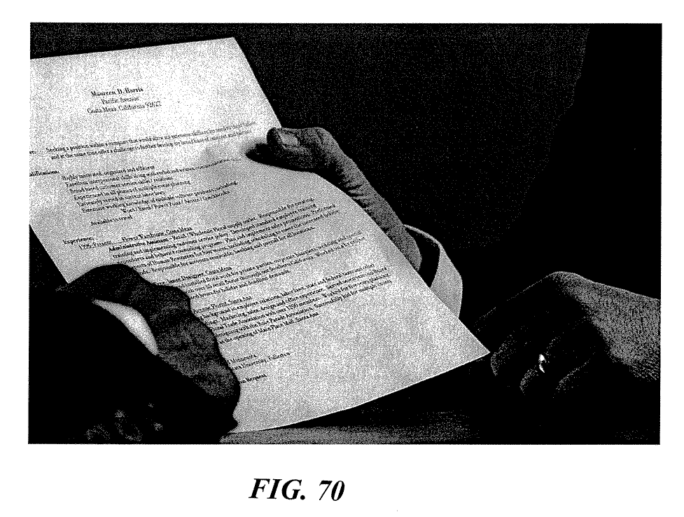

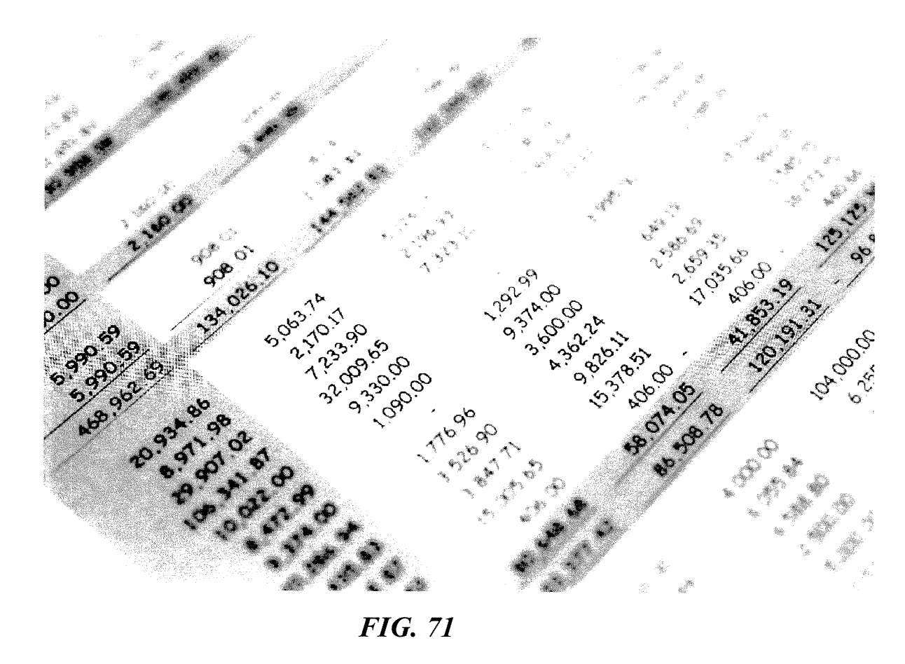

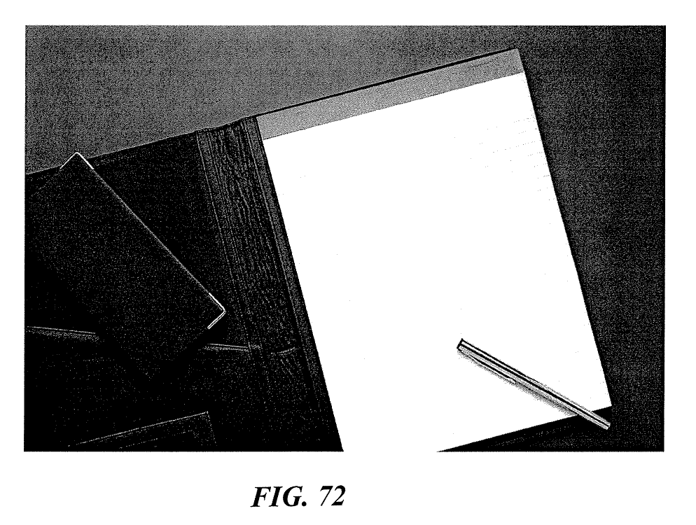

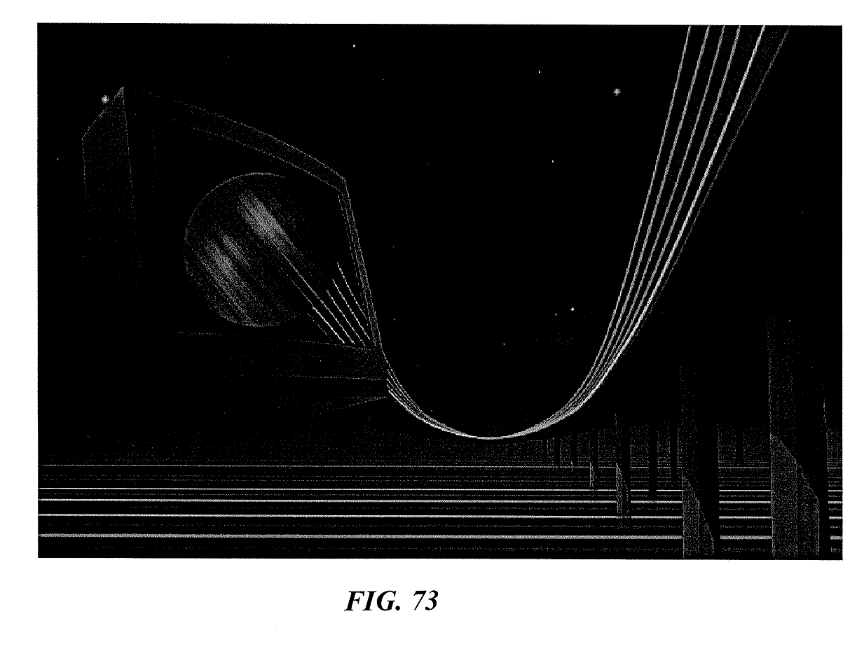

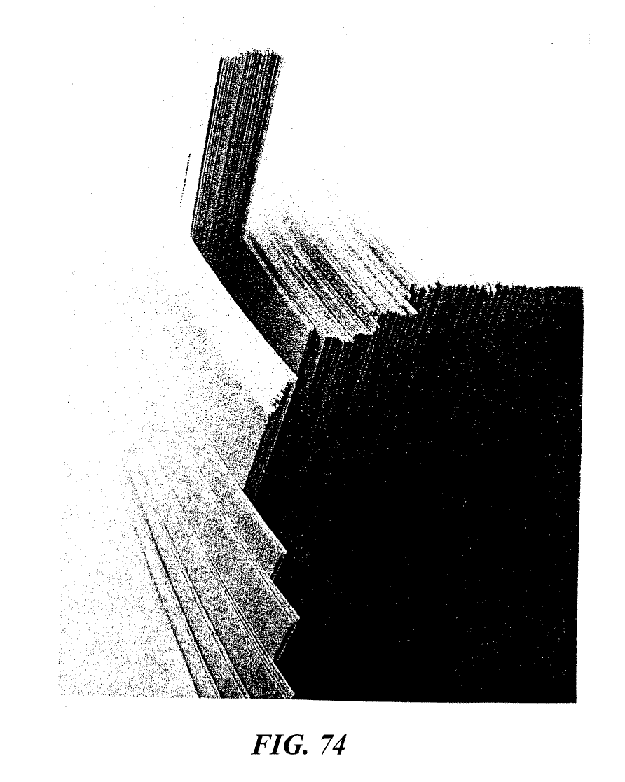

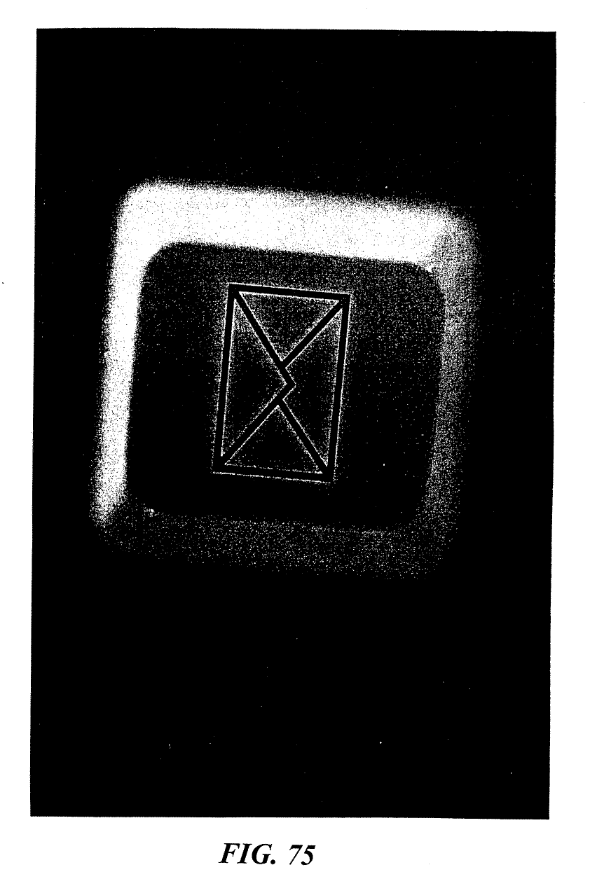

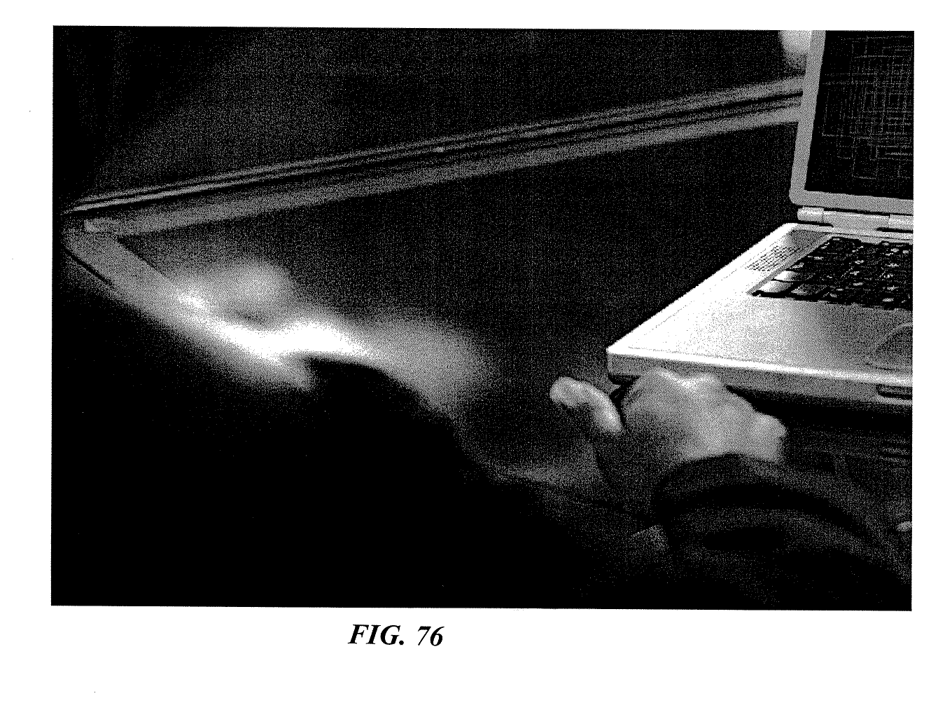

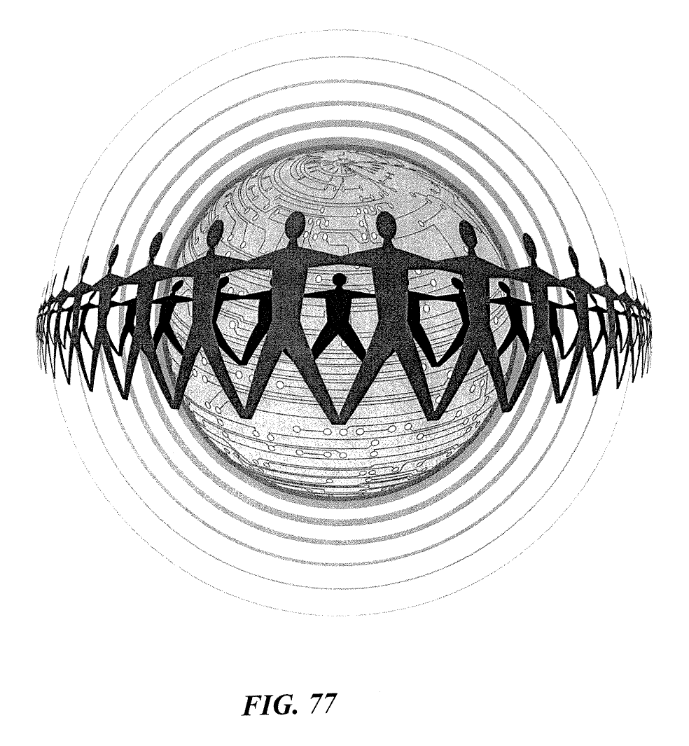

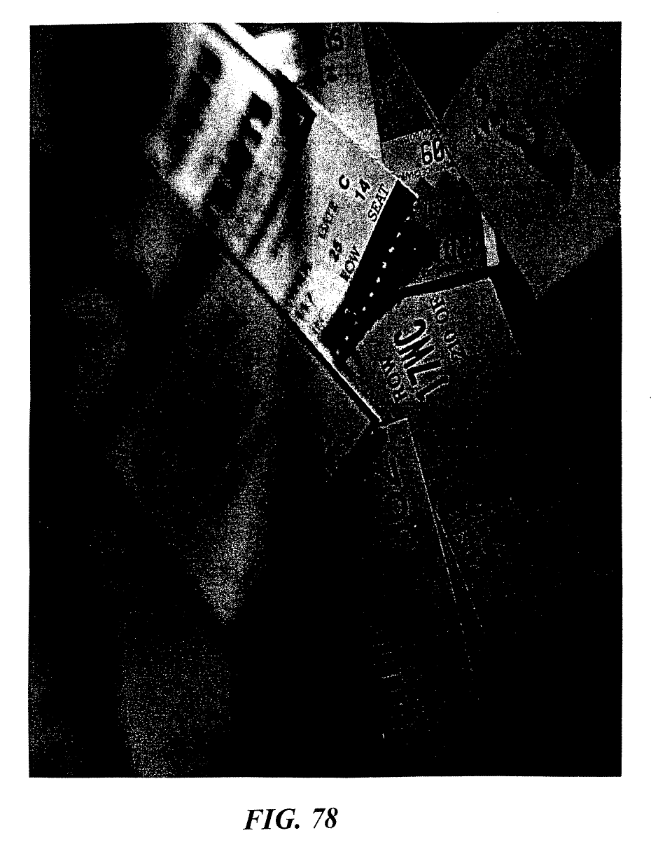

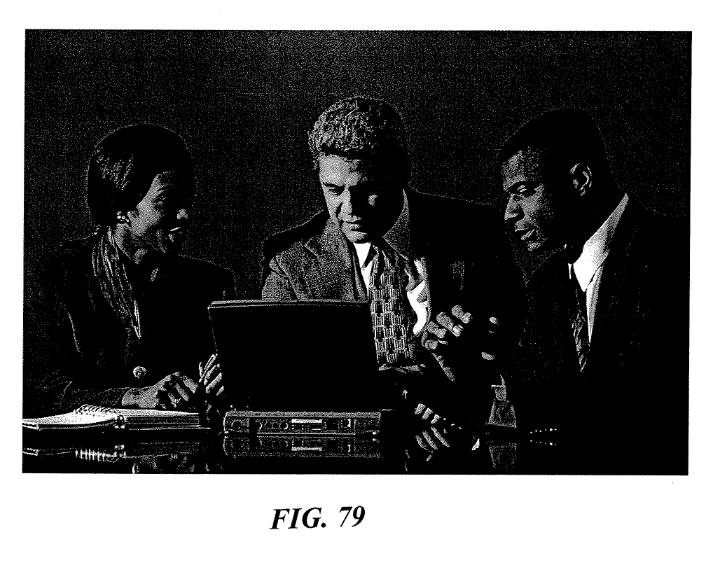

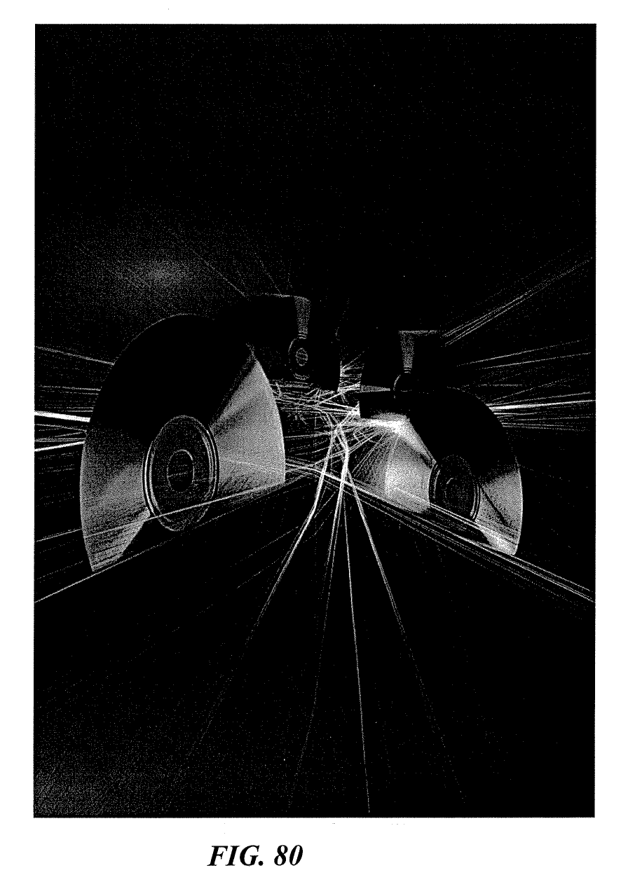

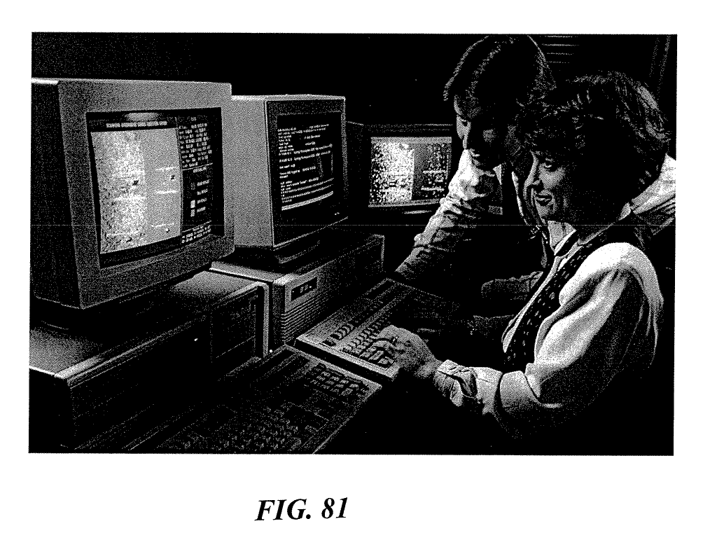

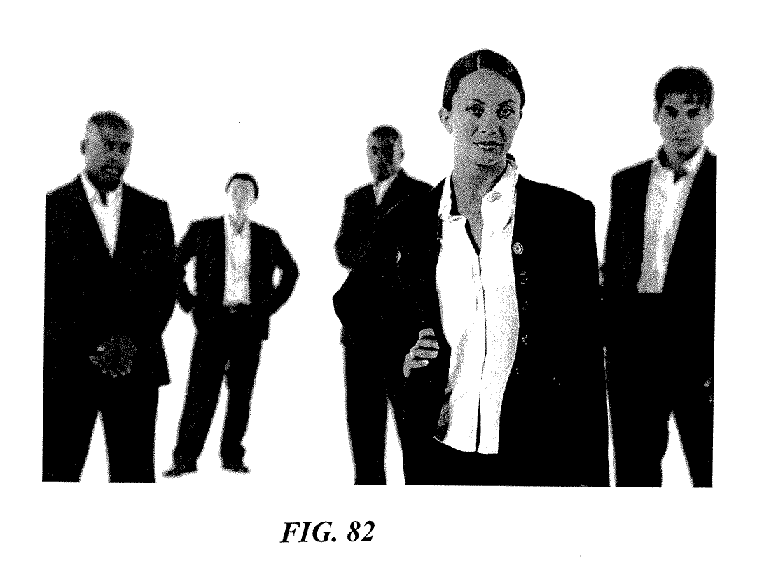

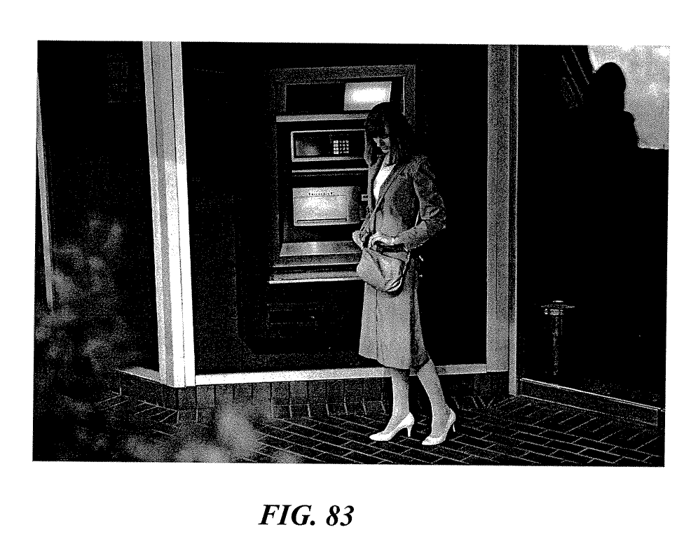

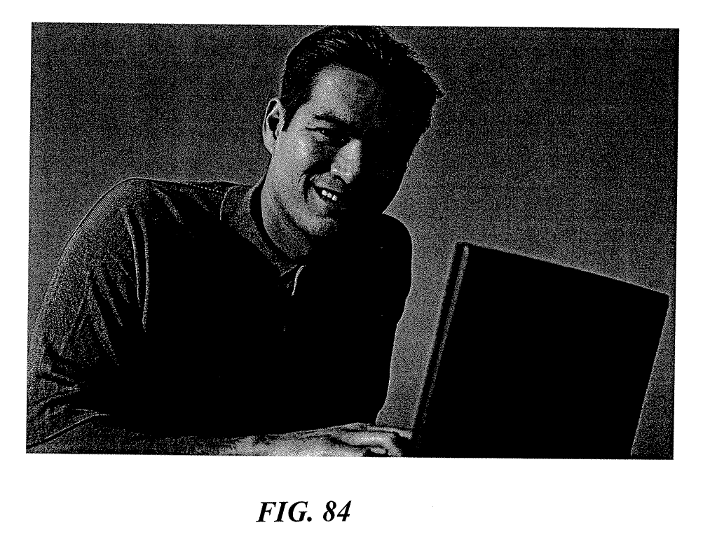

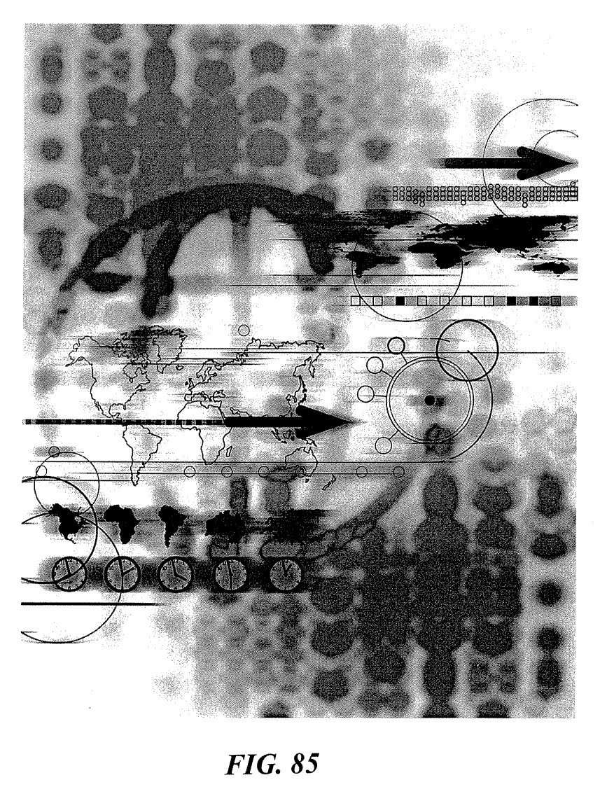

Wizard Page 1: Select a Profile and Request Type: This page allows the user to select what profile the bookmark is to be created in. The page also allows the user to add/remove items to/from the bookmark. See FIG. 46A.

Wizard Page 2: Name and describe this bookmark: This page allows the user to enter a name and description for the bookmark. The wizard automatically suggests a name and description for the bookmark based on the items in the bookmark. Examples include:
Document 1, Document 2, and Document 3
Documents Matching ‘Encryption’
Documents in the Folder ‘My Documents’ and Subfolders
Nervana Presentation (July 2003).ppt AND Documents Matching “Security” in the Folder ‘My Documents’ and Subfolders

The user is allowed to override the suggested name/description. The suggestions are truncated as needed based on a maximum name and description length. See FIG. 46B.

2. Scenarios

Show me all Presentations on Protein Engineering

Using the Create Request Wizard, select the Presentations information-type (in Documents\Presentations), and then select the Protein Engineering category as a filter. Hit Next—the wizard intelligently suggests a name for the request (Presentations on Protein Engineering) based on the semantics of the request. The wizard also selects the right default predicates. Hit Finish. The wizard compiles the query, sends the SQML to the KISes in the selected profile, and then displays the results.

3. Intelligent Publishing-Tool Metadata Suggestion and Maintenance

While the Information Nervous System does not rely or depend on metadata that is stored by Publishing Tools (e.g., the author of a document), having such metadata available and reliable can be advantageous. One problem with prior art is that publishing tools (e.g., Microsoft Word™, Adobe Acrobat, etc.) do not intelligently manage the metadata creation and maintenance process. Here are some ways that the preferred embodiment of the present invention can be used to make the metadata creation and maintenance process better:

a. When the user creates a new document, add the author's email address (this can be programmatically retrieved from the user's email client and in the event that the user has several addresses, the publishing tool should prompt the user for which address to use) to the metadata header of the document (rather than merely the author's name). This is because email addresses provide much more uniqueness (for instance, the name ‘John Smith’ could refer to one of millions of people—as such the existence of such data in the metadata of a document is not that useful). Note that one possible email address to use in the metadata header can be retrieved from, say, the logged on user's single sign-on account (e.g., Microsoft Passport™).

b. When the document is edited and if the current user is different from the author of the document (as is indicated in the metadata header), prompt the user if he/she wants to change the metadata header accordingly. This provides some basis form of intelligent metadata maintenance.

This model can be applied across different object types and metadata fields in cases where the publishing tool can validate the field (e.g., as in the case of the currently logged on user's name and email address).

P. Semantic Threads Specification for the Information Nervous System™

1. Semantic Threads

### Overview

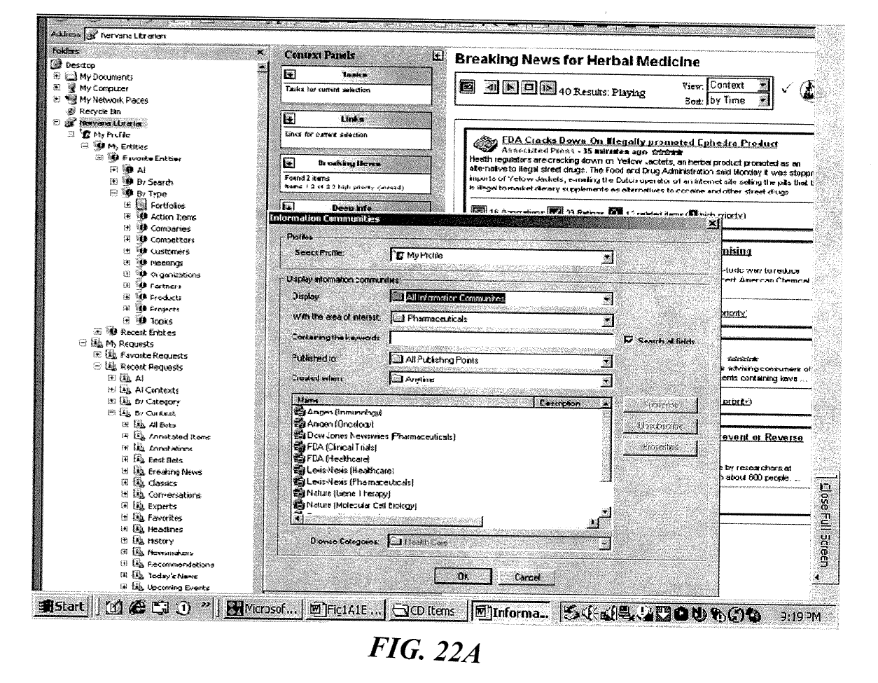

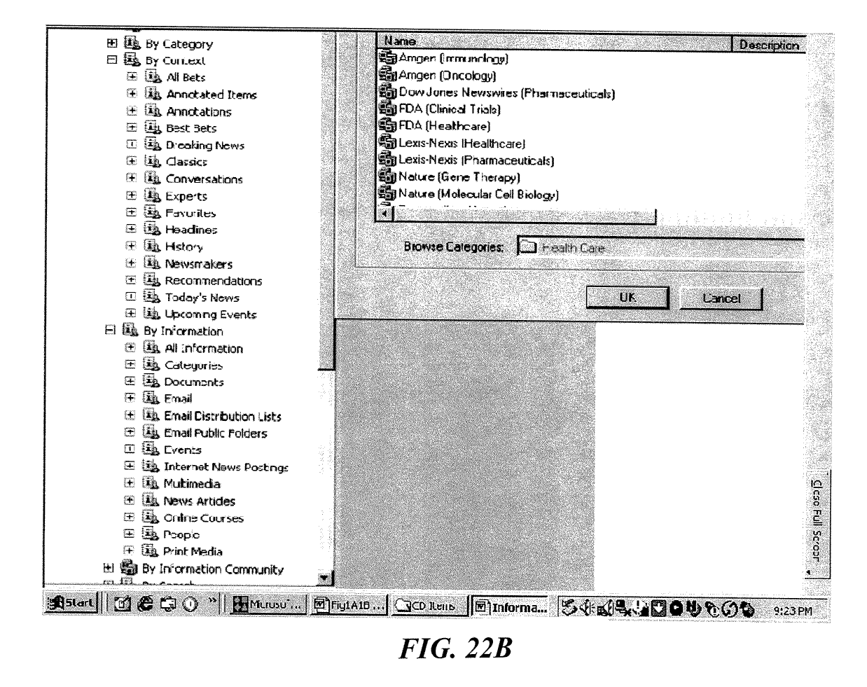

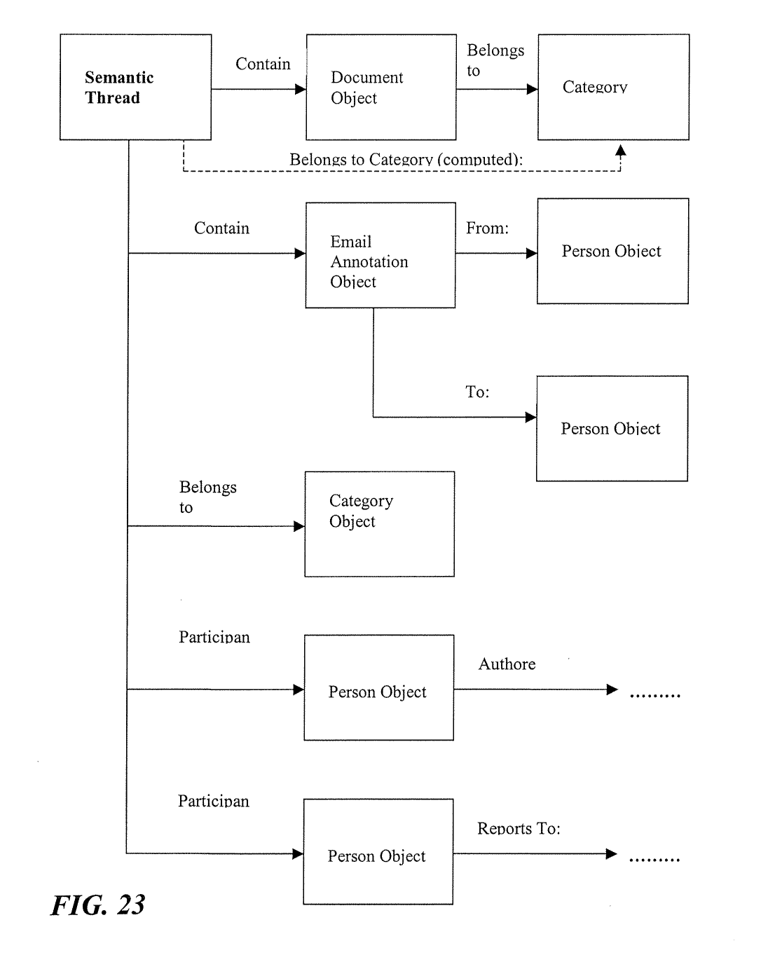

In the preferred embodiment, semantic threads are objects in the KIS semantic network that represent threads of annotations or conversations. They are different from regular email threads in that they are also semantic—they have object identifiers and type identifiers (the OBJECTTYPEID_THREAD identifier) thread-specific semantic links, they convey meaning via one or more ontology-based knowledge domains and they support dynamic linking. Also, because they are first-class objects in the Information Nervous System, they can be queried, copied, pasted, dragged, dropped, and used with the smart and object lenses. FIG. 23 illustrates a semantic thread object and its semantic links.

Because a semantic thread object is a first-class member of the semantic network and the entire Information Nervous System, it is subject to manipulation, presentation, and querying like other objects in the system. For example, the semantic browser will allow the user to navigate from a Person object to all threads that that person has participated in (via the “Participant” predicate—with a predicate type id of PREDICATETYPEID_PARTICIPANTOFTHREAD). The user can then navigate from the thread to all the thread's participants (People) and keep dynamically navigating from then on. To take another example, a thread object can also be a Best Bet in a given context (or none, if none is specified).

In the preferred embodiment, the semantic thread object also conveys meaning. This is advantageous because it means that the thread can be returned via a semantic query in the system. For instance, “Find me all threads on Topic A and Topic B.” The KIS maintains semantic links for semantic threads just like it does with other objects such as documents. However, because semantic threads can refer to multiple objects, the semantics of the thread evolve with the objects the thread contains. For example, a thread can start with one topic and quickly evolve to include other topics. Email threads can end in a very different “semantic domain” from where they started—participants introduce new perspectives, new information is added to the thread, email attachments might be added to the thread, etc., all on the basis of meaning.

The KIS manages the “semantic evolution” of semantic threads. It does this by adding semantic links to the thread to “track” the contents of the thread. For instance, if a thread starts off with one document and an annotation, the KIS adds a semantic link to the thread for each to which the category the document and annotation belong. In other words, the thread is asserted to have the same semantics as the document and annotation it contains. If another annotation is added to the thread (e.g., if a user annotates the first annotation), the KIS computes a new link strength for the categories of the new annotation that are already linked off the thread. It is preferable if it does this because the new annotation can attenuate or strengthen the semantics of the entire thread from a particular perspective. However, this modification of the strength of the semantic link(s) for the categories that are already present off the thread are preferably done on a per-category basis—as with other objects, the thread can belong to multiple categories with different strengths. The new link strength can be computed in at least two ways: in a simple embodiment, the average of all link strengths for the category being linked to the thread is used. However, this has the disadvantage that too many items in the thread of weak strength can erode the “perceived” (as far as the KIS semantic query processor is concerned) semantics of the entire thread. An alternative embodiment is to use the maximum link strength. However, this also has a disadvantage that the semantics of the thread might remain fixed to a domain/category even though the thread “has moved on” to new domains/categories. From a weighted-average perspective, this would likely return confusing results as the thread grows in size.

In the preferred embodiment, the KIS preferably computes a weighted average of all the link strengths for the categories to be linked to the thread. This new weighted average becomes the link strength. The weighted average is preferably computed using the number of concepts in each object in the thread. This has the benefit of ensuring that “semantically light” objects (such as short postings) do not erode the semantics of the thread relative to “semantically denser” objects in the thread (such as email attachments and long postings). The number of concepts, and not the size, is preferably used in the preferred embodiment because the size of the object is a less reliable indicator of the conceptual weight of the object. For instance, a document could contain images or could include much information that does not map well to key phrases or concepts

Preferably, the computed weight could also include the time when the entry was added (thereby “aging” the semantics of older items relative to newer ones). This weight is then multiplied by the category link strength and the multiples are added and then divided by the number of entries. Other weighting schemes can also be applied.

The following rules are applied when a new item is added to the semantic network and which is to be added to a semantic thread:

| | |
|---|---|
| 1. | Categorize the new item to be added to the thread |
| 2. | For each category in the returned list of categories which are |
| | already on the semantic thread |
| | { |

Compute new weighted-average link strength
Update category semantic link off the semantic
thread object

| | |
|---|---|
| | } |
| 3. | For each category in the returned list of categories which are not |
| | already on the semantic thread |
| | { |

Assign link strength
Add category semantic link off the semantic thread object

}

The weighted-average link strength is computed as follows:

$$New Link Strength = \frac{{\sum }_{}^{} Ci * Li}{N}$$

Where Ci is the normalized number of concepts (from 0 to 1) of object i, Li is the link strength of object i, and N is the number of objects in the thread (including the new object). The normalized number of concepts is computed by dividing the number of concepts in each object (extracted by the Knowledge Domain Manager (KDM)) by the number of concepts in the largest object in the thread (including the new object).

If a semantic thread comprises of standard, intrinsic (and unedited) email threads, the KIS modifies the semantic network differently. This is because most email clients include all prior email messages that form the thread in the most recent email message. As such, in this case, the KIS preferably simply uses the most recent email message as being representative of the entire thread. To accomplish this, the KIS preferably categorizes the most recent email message, and replace all prior semantic links (relating to categories) from the thread object with new semantic links corresponding with the new categories and link strengths.

For non-email threads (for example, threads that form based on an annotation of an existing object in the semantic network), the model described above should be employed. Alternatively, the KIS can maintain an Aggregate Thread Document (ATD) which is then categorized. This document should contain the text of the objects in the thread—roughly analogous to how an email message contains the text of prior messages in the same thread.

When a new object is added to the thread, the KIS preferably updates the last-modified-time of the thread object in the Semantic Metadata Store (SMS).

2. Semantic Thread Conversations

Semantic thread conversations in the Information Nervous System are a special form of semantic threads. Essentially, a conversation is a semantic thread that has more than one participant. Semantic thread conversations have the object type id, OBJECTTYPEID_THREADCONVERSATION.

The KIS creates a thread based on the number of participants in that thread and could immediately create the thread as a thread conversation. Alternatively, the KIS could “upgrade” a thread to a conversation once additional participants are detected.

3. Semantic Thread Management

The pseudo-code below illustrates how the KIS adds preferred threads and conversations to the semantic network:

| | |
|---|---|
| 1. | If an individual email message is detected and is a member of an |
| | existing thread object |
| | { |
| | Add the new email object to the thread and update the semantic |
| | network |
| | If the thread has more than one participant, change the thread's |
| | object type identifier to |
| | OBJECTTYPEID_THREADCONVERSATION |
| | } |
| 2. | If an email thread is detected |
| | { |
| | Create a new thread object and update the semantic network |
| | If the thread has more than one participant, change the thread's |
| | object type identifier to |
| | OBJECTTYPEID_THREADCONVERSATION |
| | } |
| 3. | If an email annotation of an existing object is detected |
| | { |
| | Add the annotation to the semantic network |
| | If the annotated object is not itself an annotation |
| | { |
| | Create a new thread object and update the semantic |
| | network |
| | } |
| | Else |
| | { |
| | Add the new annotation to the thread containing the |
| | annotated object (i.e., the existing annotation) and |
| | update the semantic network |
| | If the updated thread has more than one participant, |
| | change the thread's object type identifier to |
| | OBJECTTYPEID_THREADCONVERSATION |
| | } |
| | } |

Q. Sample Screen Shots

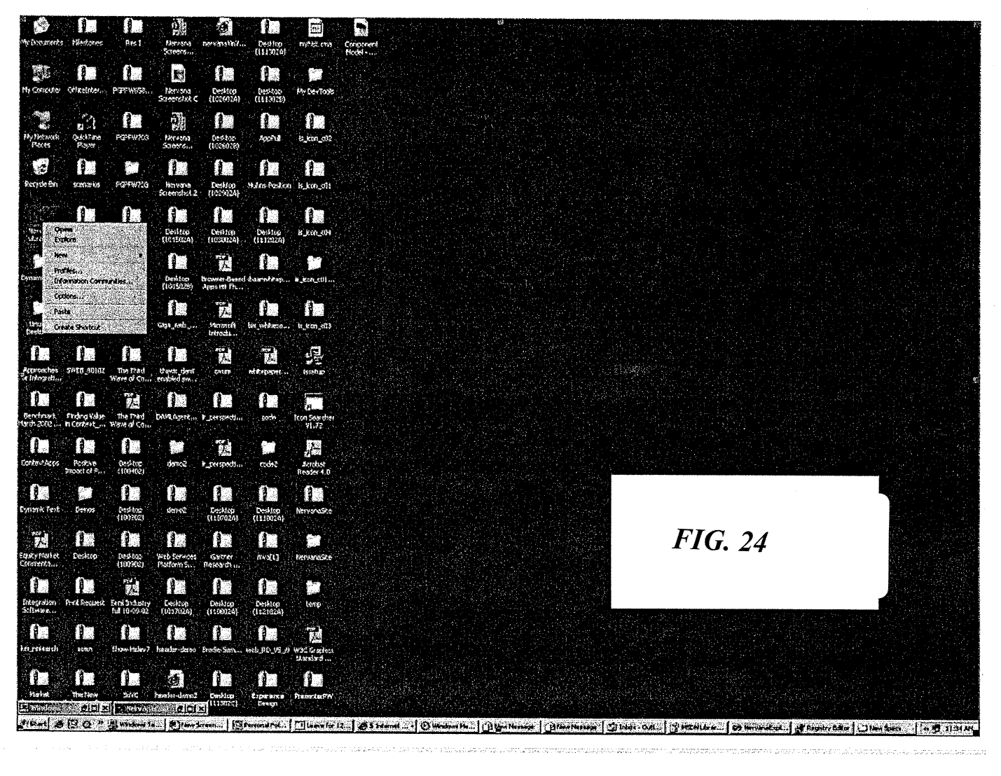

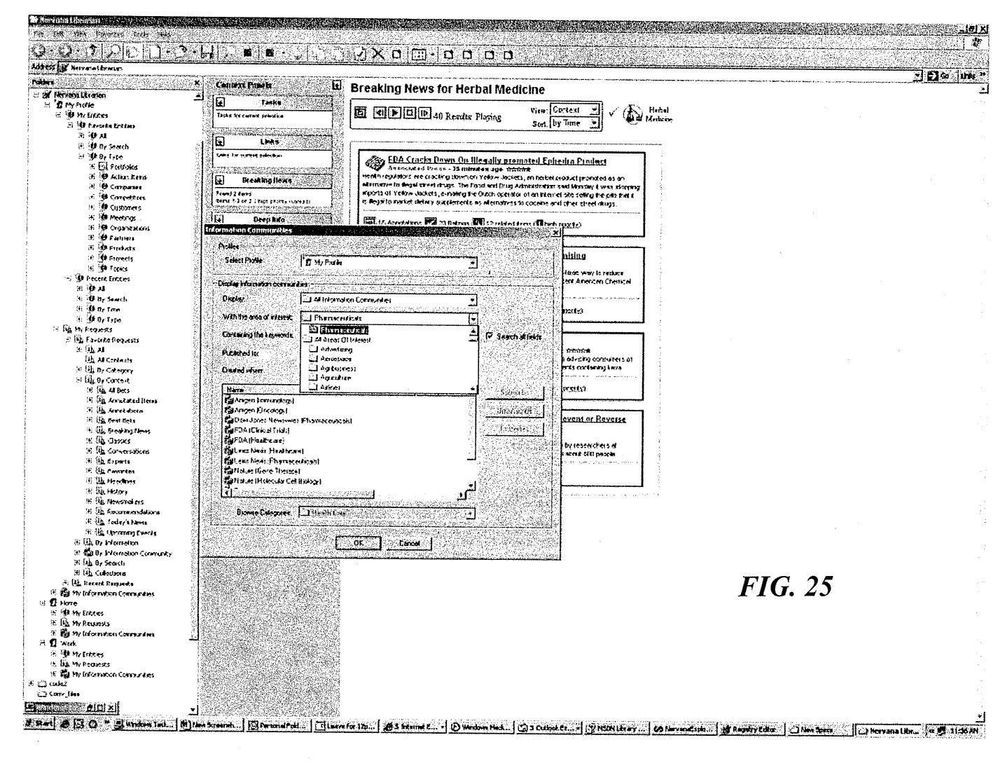

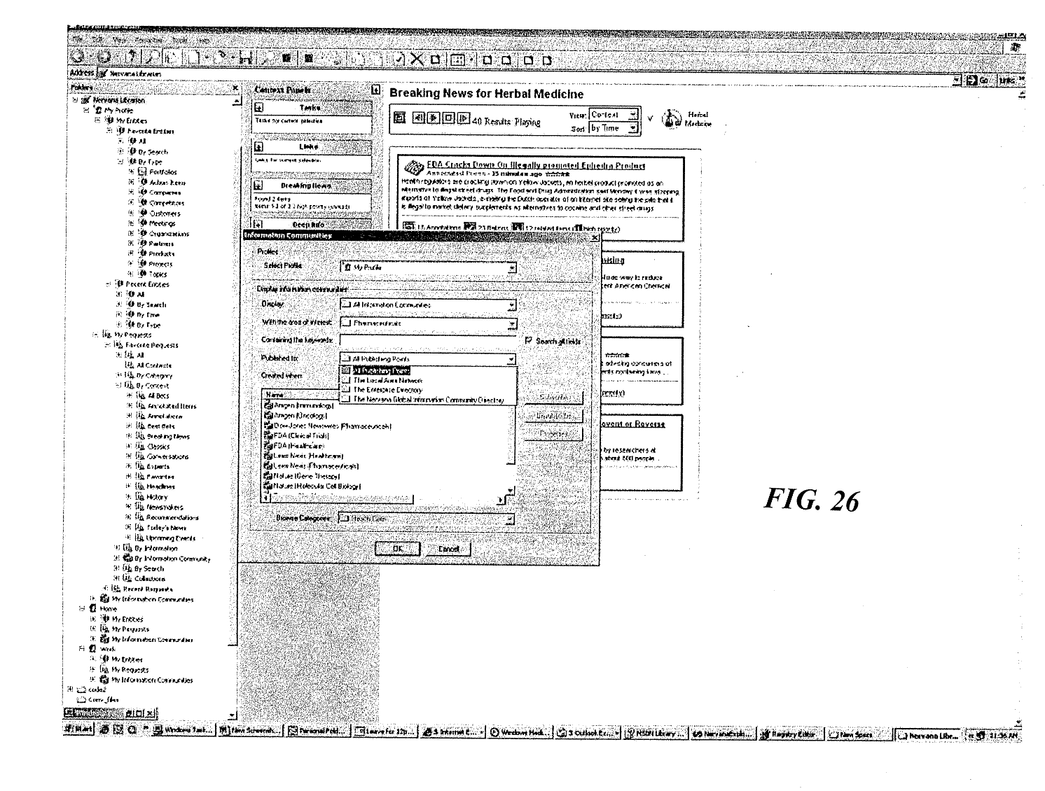

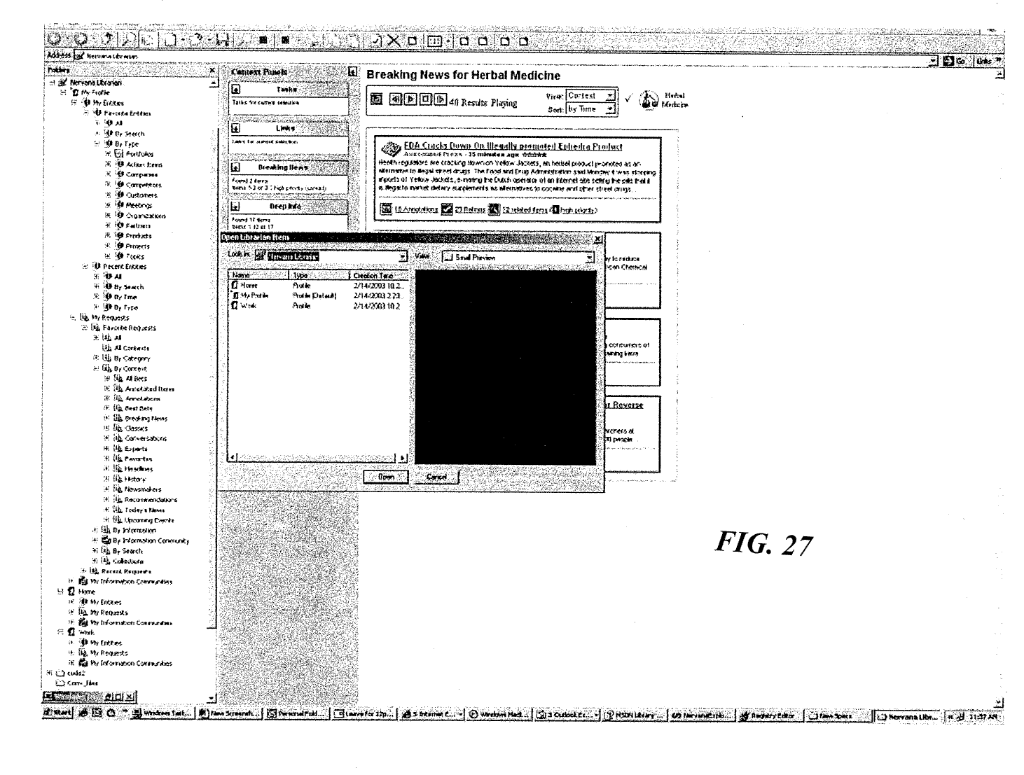

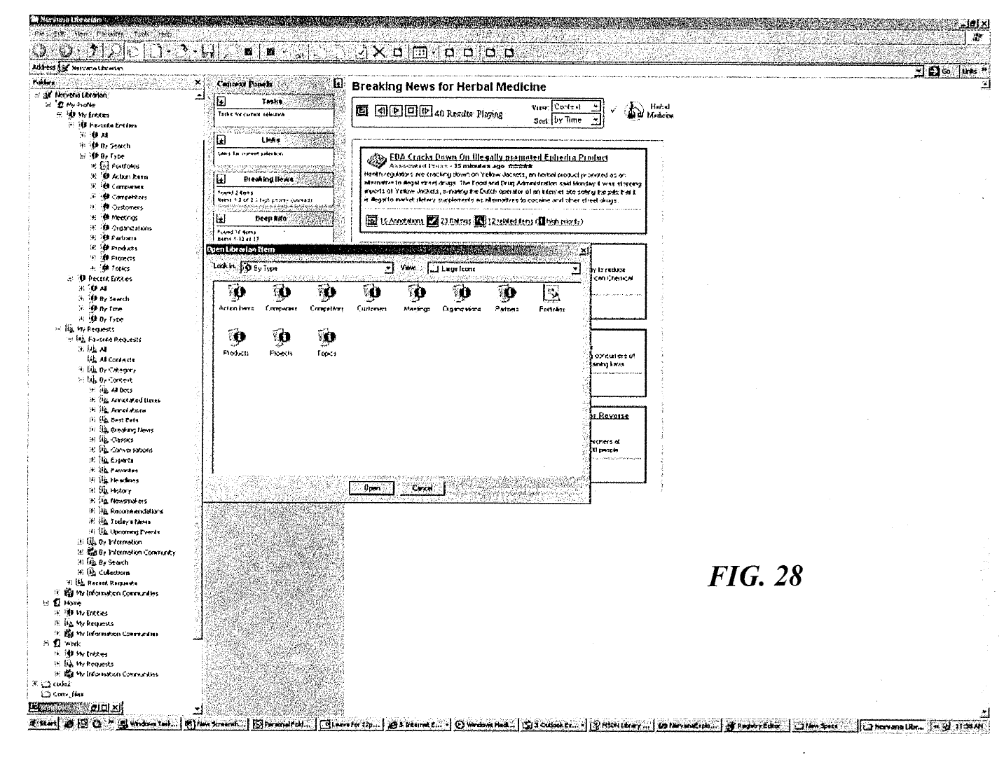

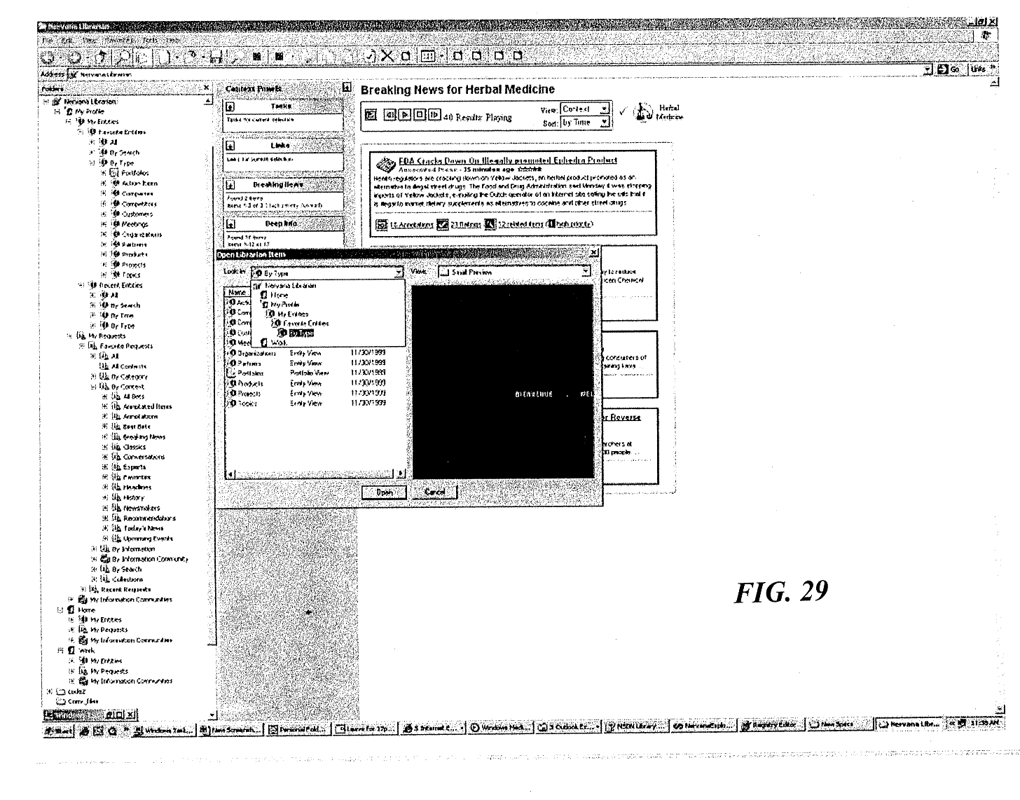

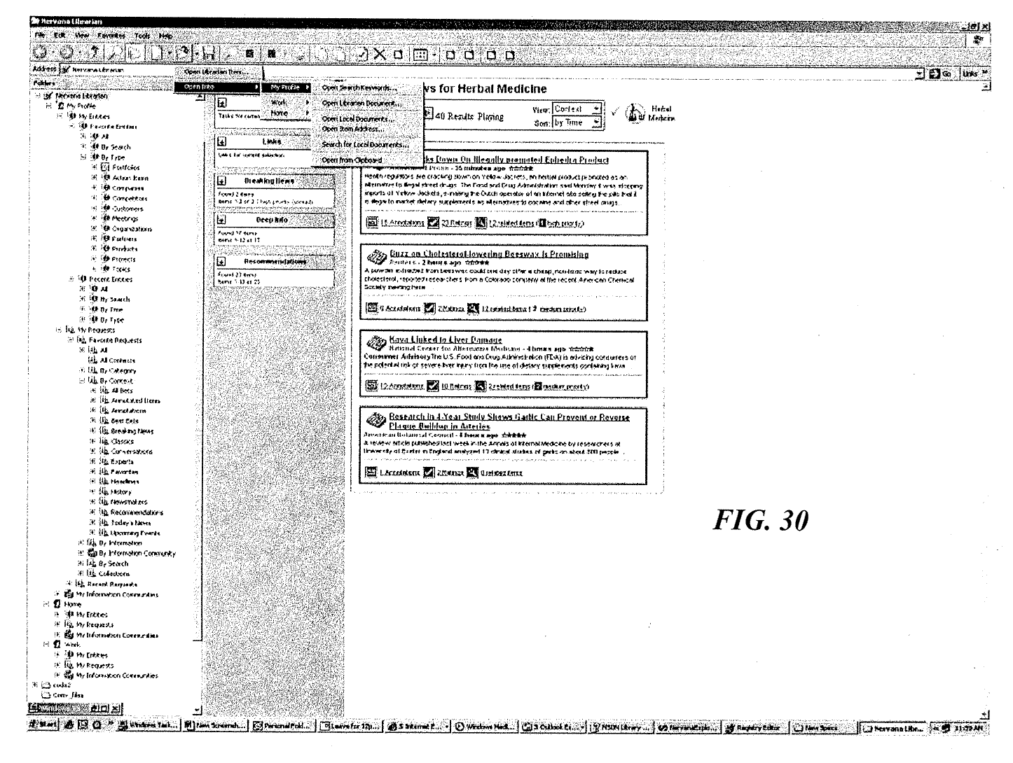

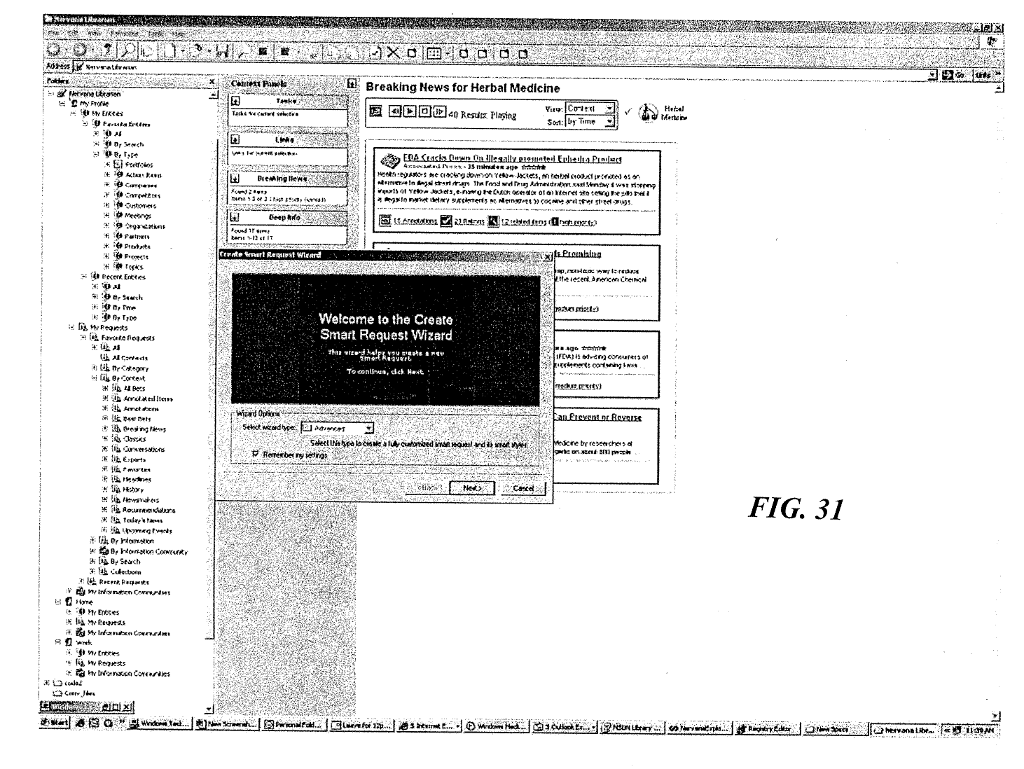

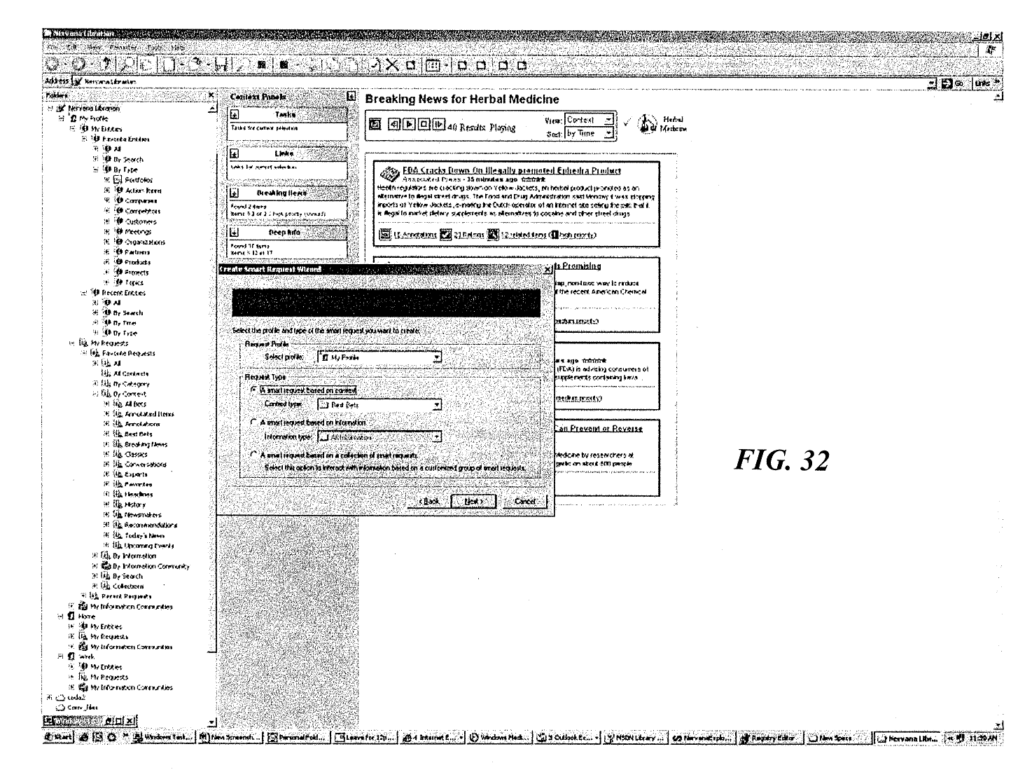

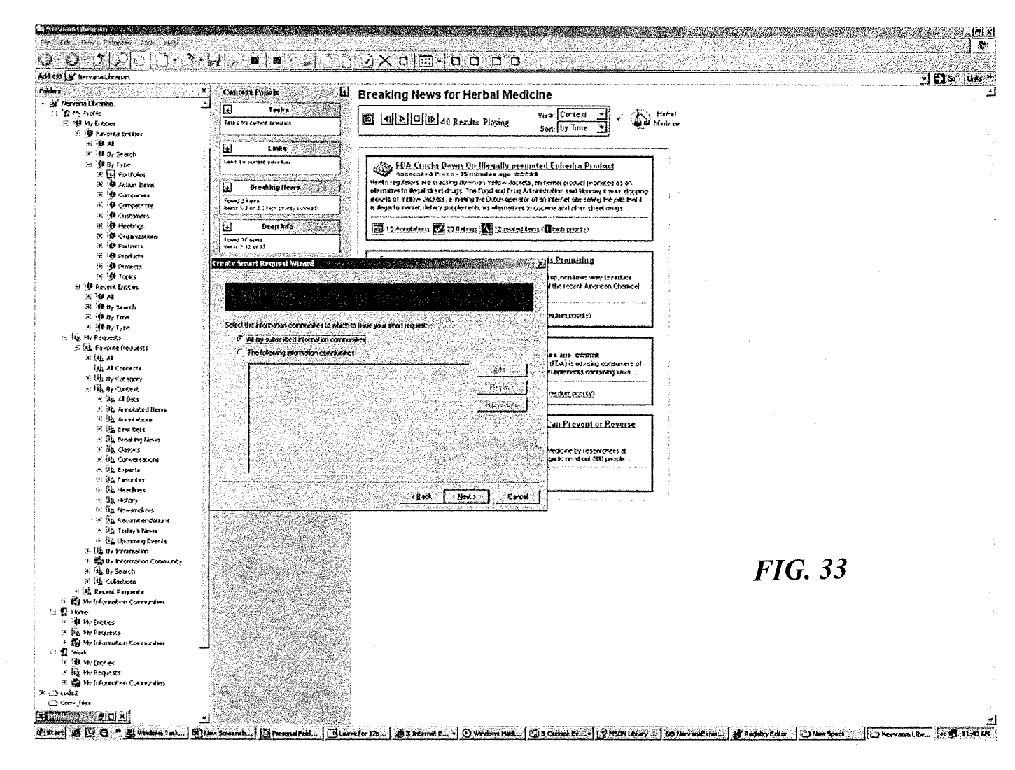

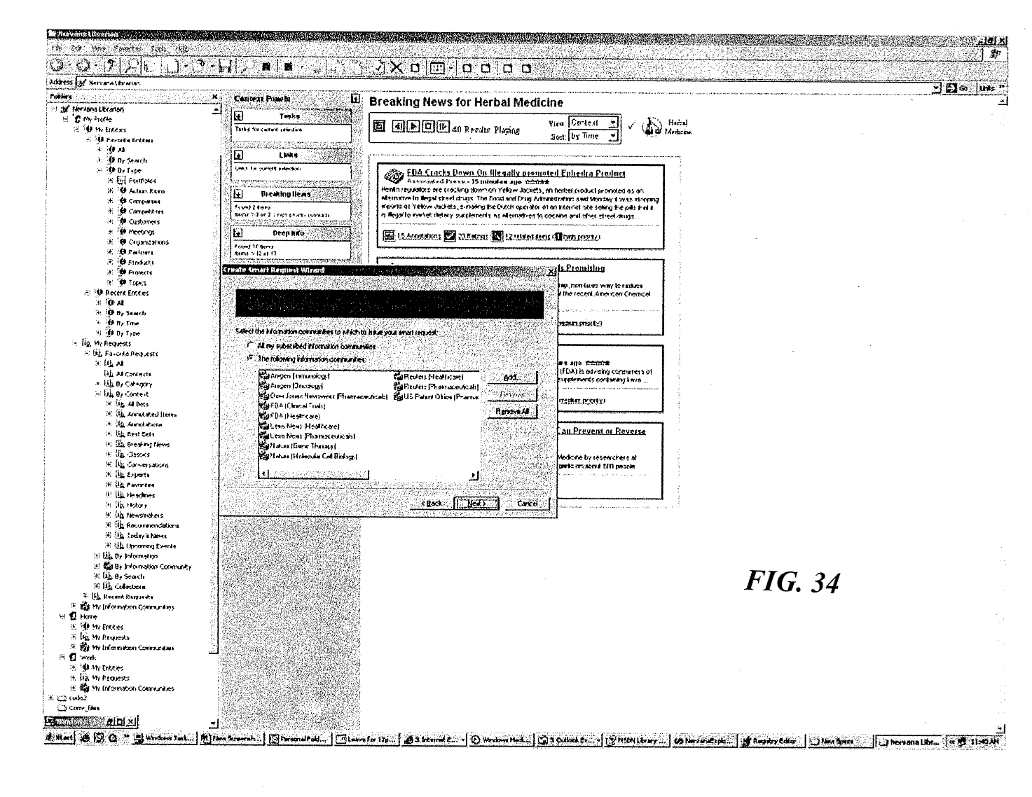

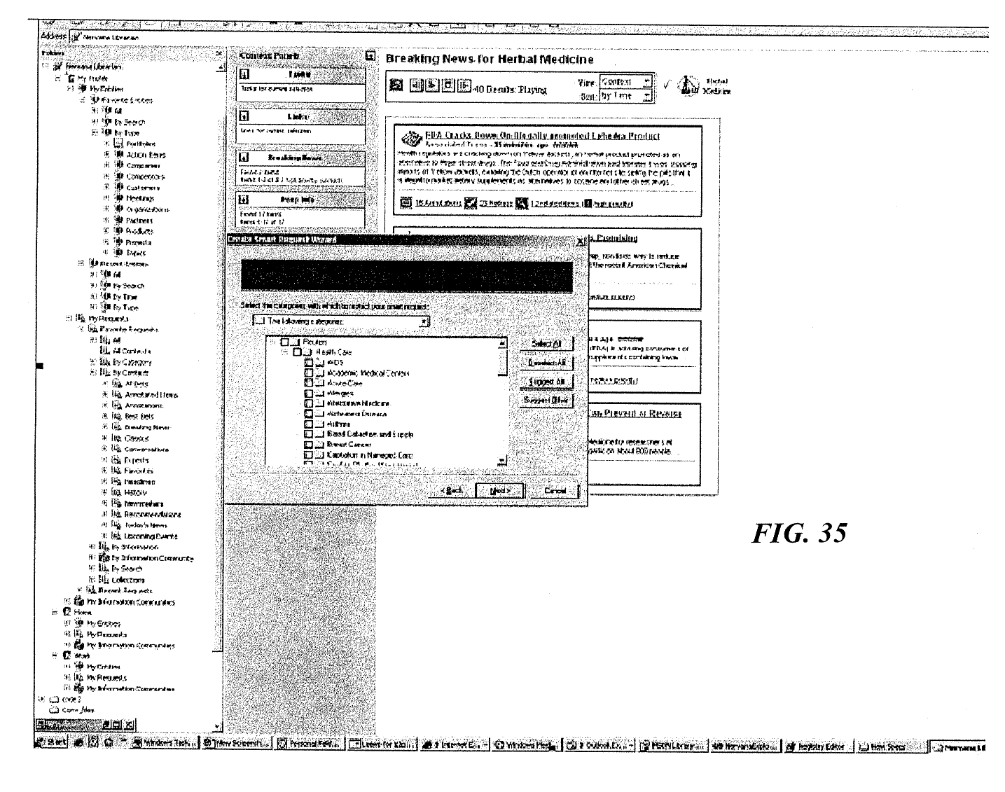

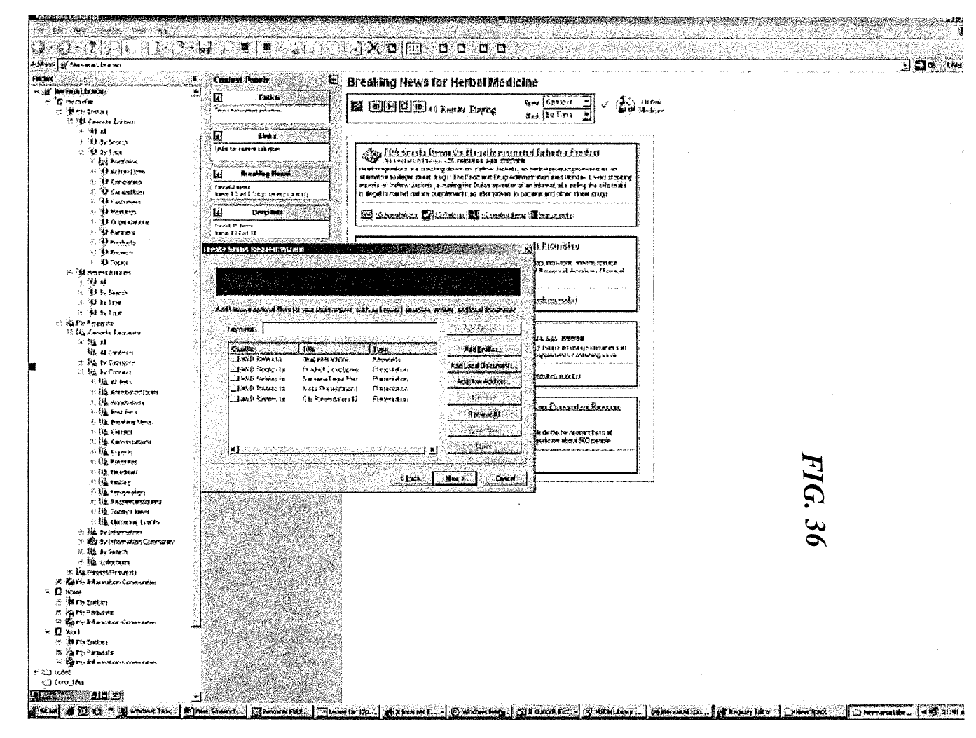

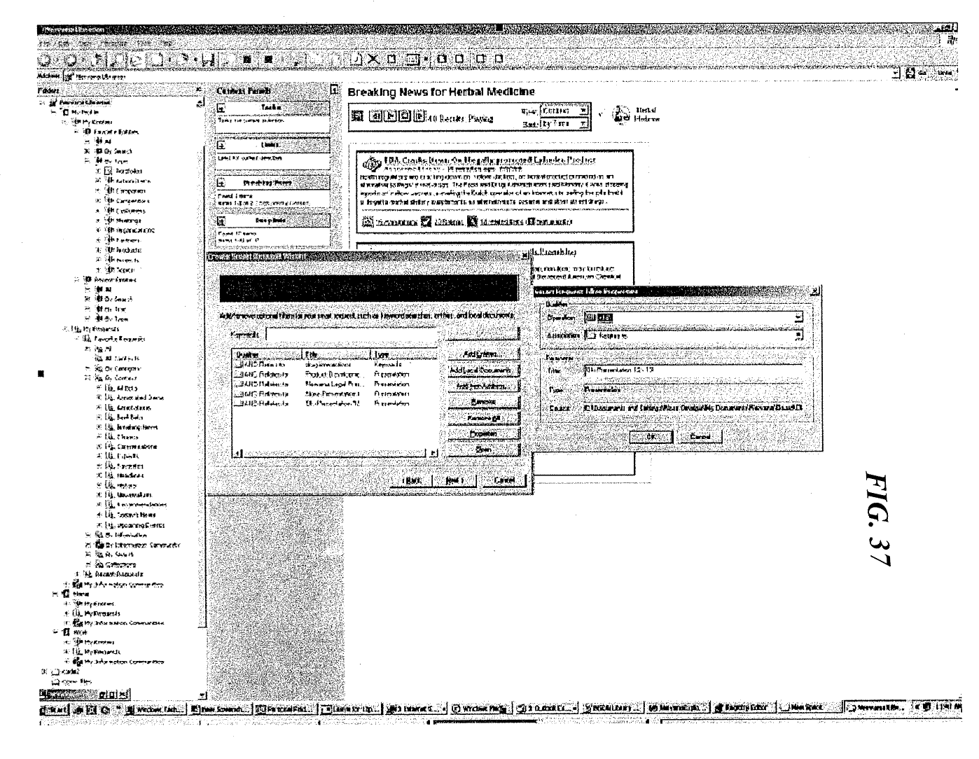

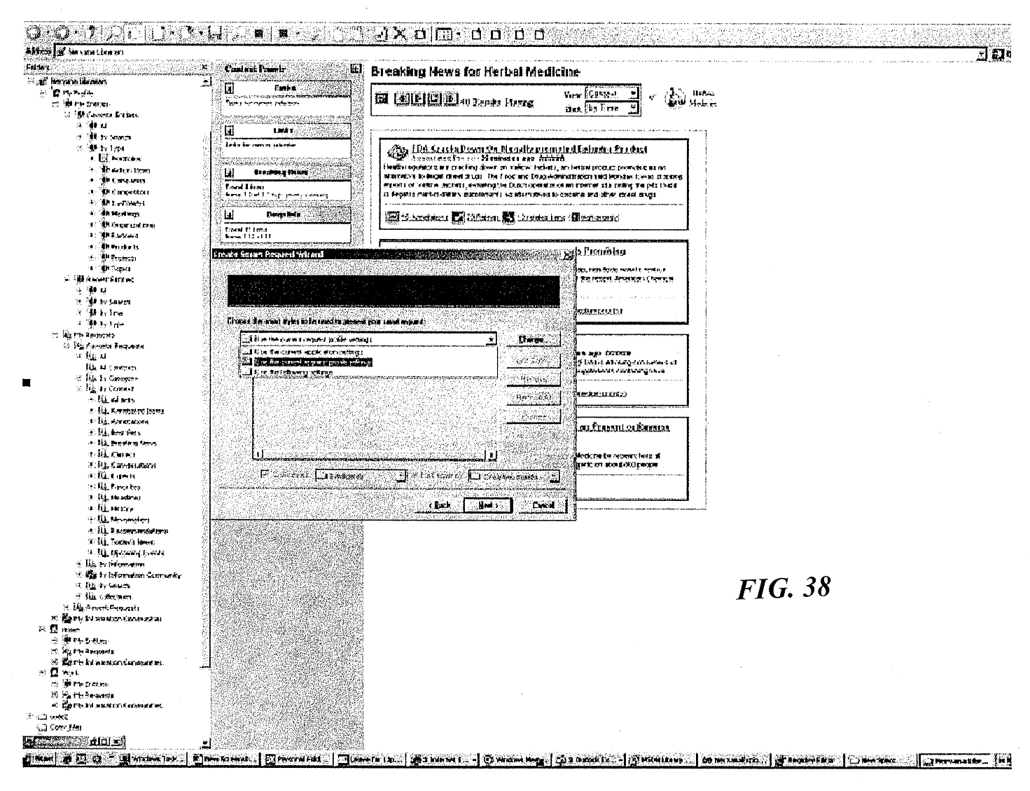

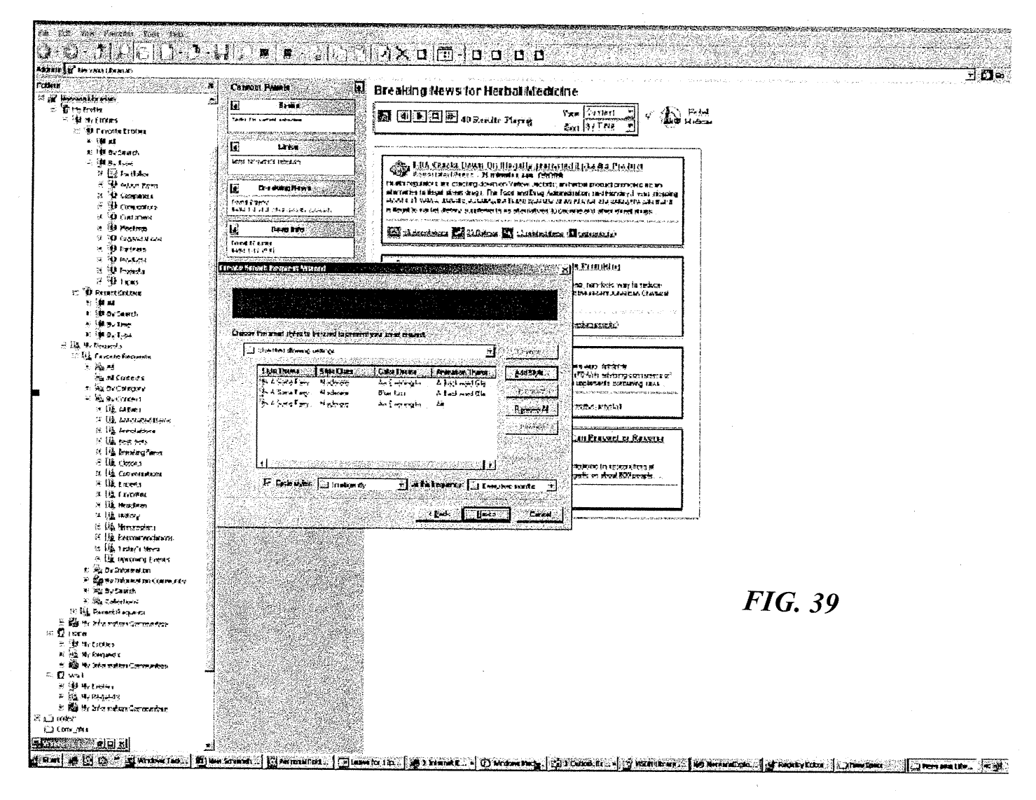

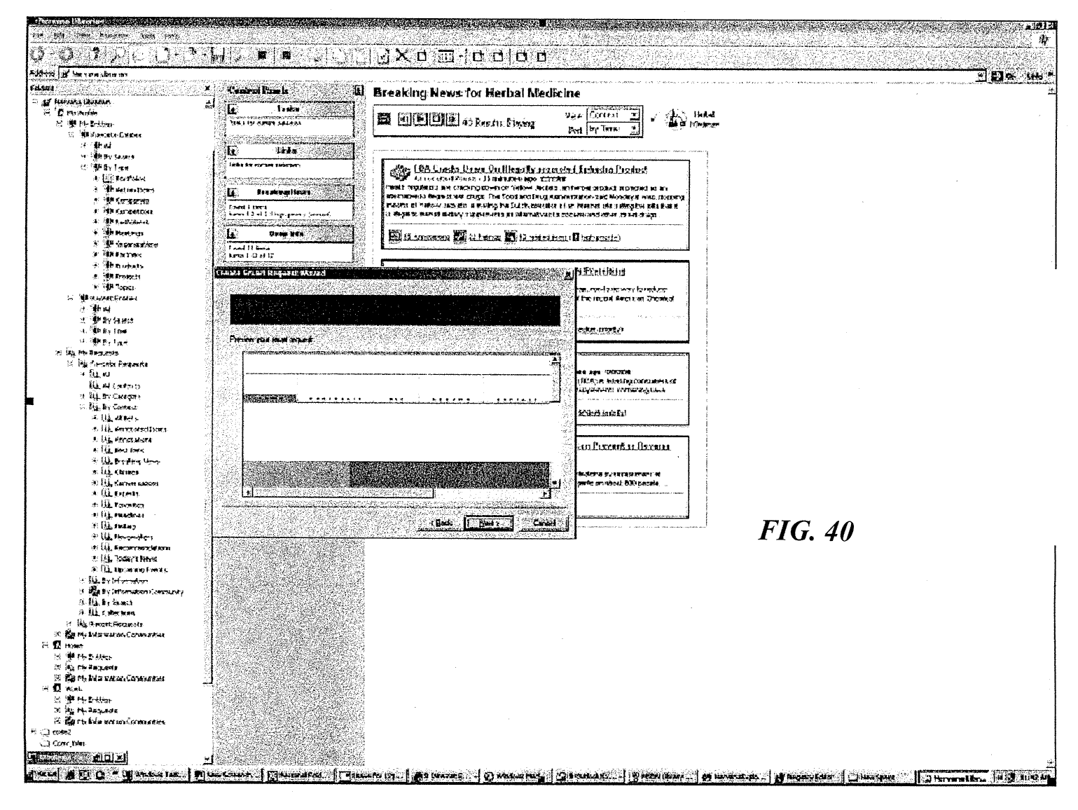

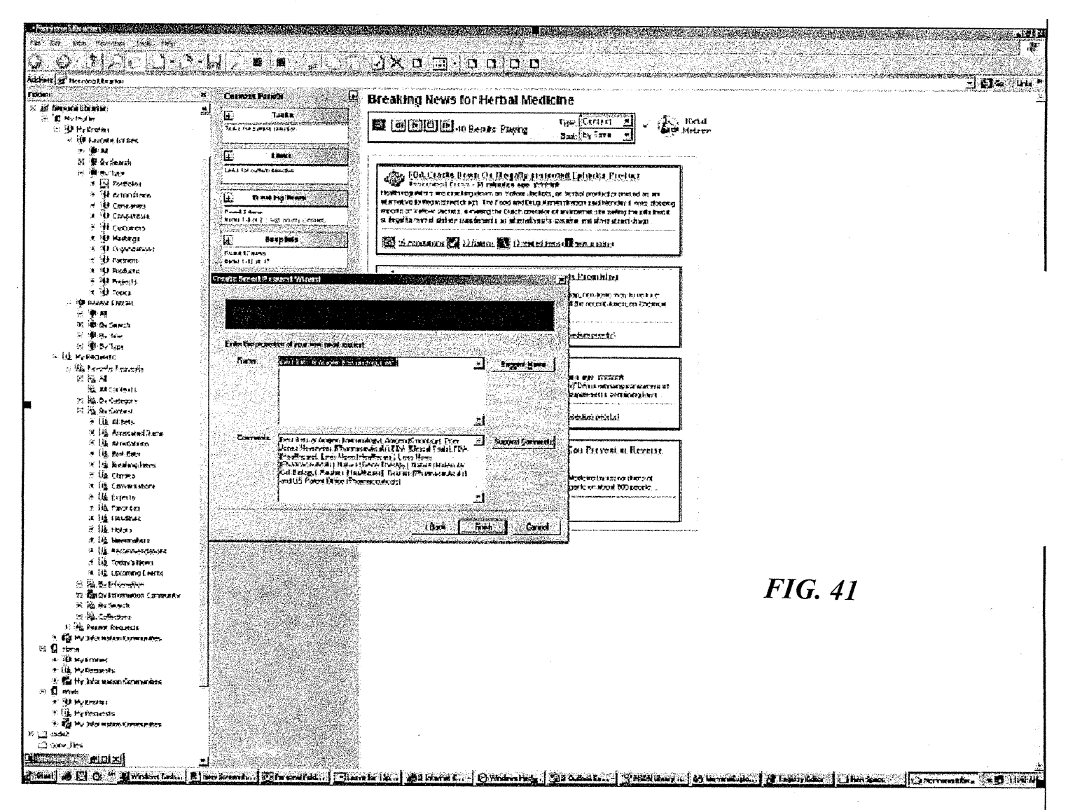

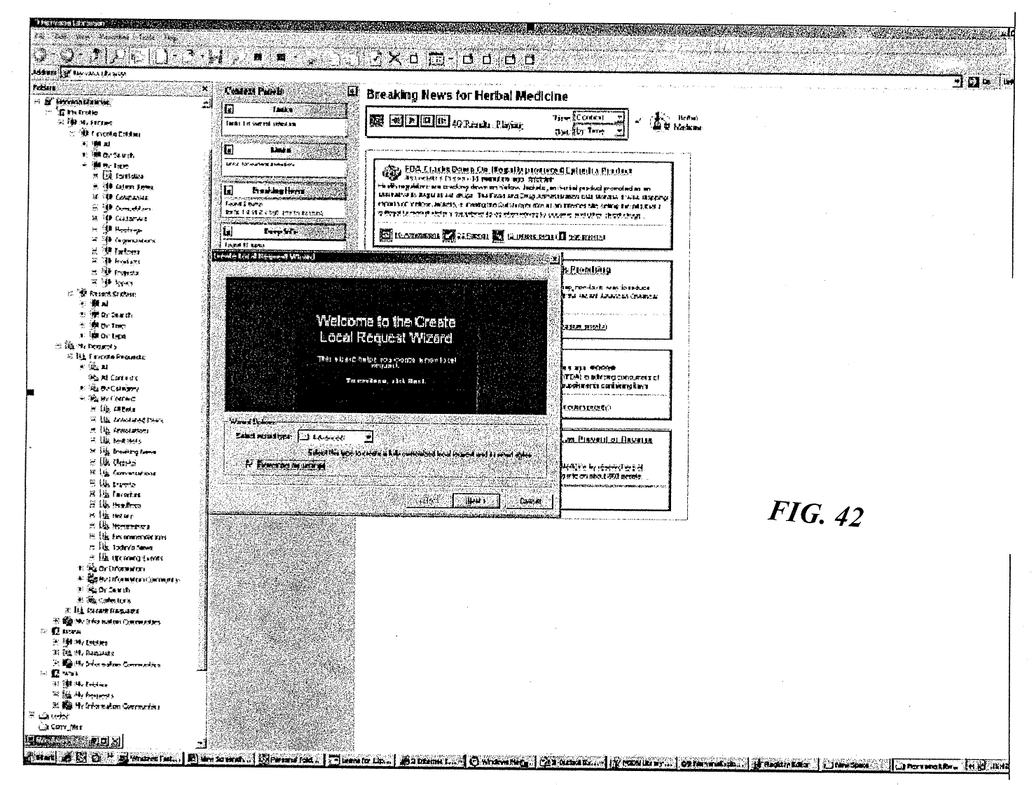

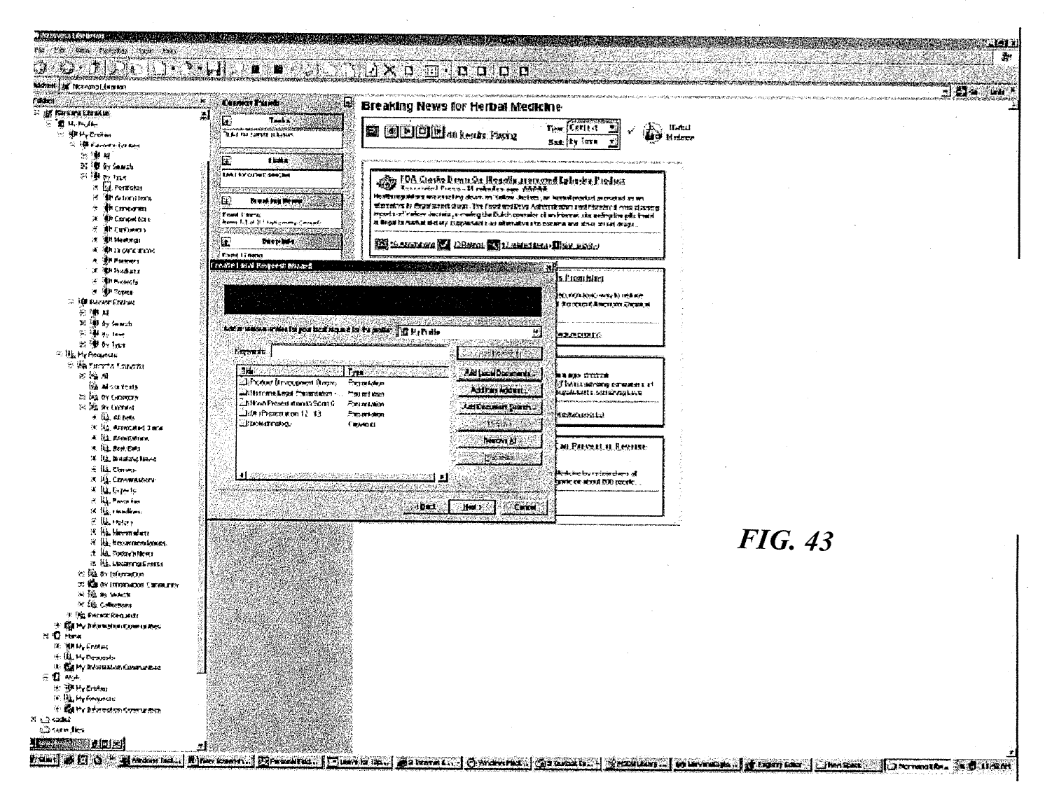

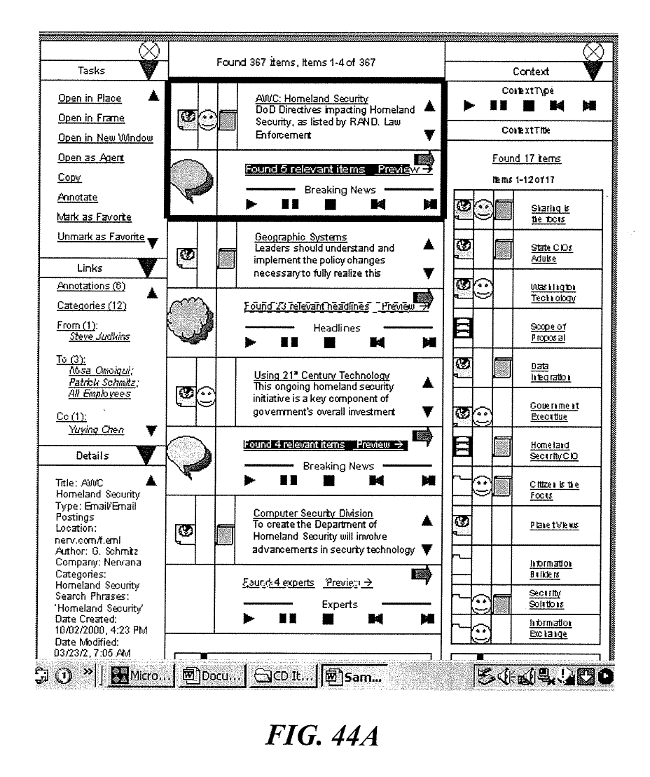

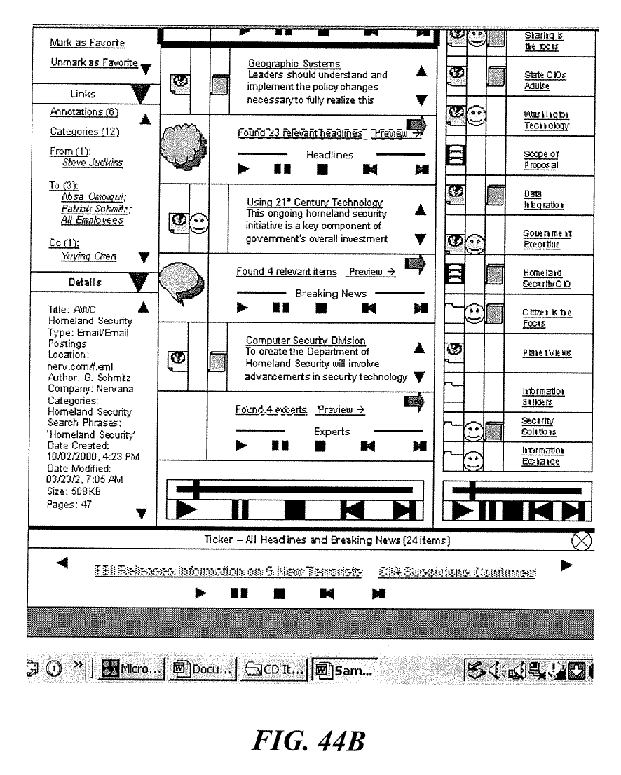

FIGS. 24-44B are additional screen shots further illustrating the functions, options and operations discussed above.

R. Specification for Semantic Query Definitions & Visualizations for the Information Nervous System

1. Semantic Images & Motion

a. Overview

Semantic images and motion can be an advantageous component of the preferred embodiment in terms of the Nervana semantic user experience. In other words, the user's experience with the system can be enhanced in an embodiment that has semantic image/motion metadata stored on a Nervana agency (information community) and accessed via the Nervana XML Web Service. In that embodiment, via Nervana, end users will have context and time-sensitive semantic access to their images. Imagine, for example only, using a Getty Images™ (or Corbis™) agent as a smart lens over an email message—when invoked, this will open images that are semantically related to the message. Or, imagine dragging and dropping a document from your hard drive to a Getty agent to view semantically related images. This will involve having image metadata (consistent with an image schema). The Nervana toolbox remains the same—we merely add a new information object type for images. Also, there are semantic skins for semantic images—different views, thumbnails, slide shows, filtering, aggregation, etc. For examples of semantic images, visit:

[http]://creative.gettyimages.com/source/search/resultsmain.asp?source=advSearch&hdnSync=Medicine % 7E0% 2C12% 2C449% 2C3% 2C15% 2C1% 2C0% 2C0% 2C0% 2C12287% 2C0% 2C7% 2C14% 2C6% 2C3% 2C3% 2C0% 2C12% 2C449% 2Cen % 2Dus&UQR=tfxfwz

Very generally, the properties of the semantic visualizations will vary depending upon several different variables. Among these variables will often be the context, including the context of what feature or property of the system is being invoked. In the next several sections some of the contextual variables that influence the semantic determinations will be listed and/or described. In many instances, there will be overlap or commonality of the variables or determinants of the semantic visualizations, but in some cases, the considerations or combination of considerations will be unique to the particular situation.

b. Industry-Specific Semantic Images and Motion

Industry-specific semantic images/motion are images/motion that can be used (and in the preferred embodiment are used) as part of the presentation atmosphere for semantic results for one or more categories (that map to industries). For instance, visit [http]://[www].corbis.com and [http]://[www].gettyimages.com and enter a search for the keywords listed below (which, in the aggregate, map to target industries, based on industry-standard taxonomies). Such images/motion can also be used as backgrounds, filter effects, transformations, and animations for context and category skins (that map to context templates and categories). In addition, these images/motion can be used for visuals for motion paths extracted from some of these images for superior screensavers. For example, imagine a skin displaying metadata and visualizations along a motion path extracted from one of these semantic images (e.g., metadata rotating inside a light bulb—for the “electric utilities” industry), along with chrome with other surrounding images and animations, etc. Other industries, with industry specific images and motion might include:

| | | |
|---|---|---|
| Pharmaceuticals | Telecommunications | Airlines |
| Medicine | Telecom Equipment | Retail |
| Healthcare | Telecom Services | Fashion |
| Life Sciences | Telecom Technology | Advertising |
| Biotechnology | Telecom Regulations | Aerospace |
| Oil and gas | Tobacco | Defense |
| Chemical | Automotive | Agribusiness |
| Energy | Automobiles | Agriculture |
| Electric Utilities | Insurance | Beverages |
| Gas Utilities | Consulting | Business services |
| Water Utilities | Information | E-commerce |
| | Technology | |
| Entertainment | Technology | Food |
| Environmental | Computer Equipment | Forest products |
| Services | | |
| Publishing | Computer | Health Care Providers |
| | Manufacturers | |
| Real Estate | Computing | Hospitality |
| Financial | Semiconductors | Internet |
| Brokerages | Nanotechnology | Law |
| Financial Services | Public Sector | Legal |
| Banking | Government | Manufacturing |
| Consumer | Homeland Security | Marketing |
| Consumer Products | Travel | Media |
| Consumer Services | Tourism | Networking |
| Communications | Transportation | |

For example, if the user launches a request/agent, Headlines on Bioinformatics or on Protein Engineering, the semantic browser will map the biotechnology-related categories from the SQML to a set of images in the biotechnology industry. It will then display one or more images as part of the skin for the results of the request/agent (thereby proving a pleasant user experience as well as visually conveying the “mood” of the request/agent).

FIG. 101 as a sample semantic image for Pharmaceuticals/Biotech industry (artistic DNA helix superimposed over a human face on the left and a organic chemical chart on the right, licensed from the Corbis™ web site).

The same applies to information types and context templates. Skins will do the smart thing based on the context/information type and the category/ontology and mix and match semantic images/motion across these properties in an intelligent manner. For instance, an agent titled “Headlines on Wireless Technology” can have chrome (and/or a smart hourglass—see below) that shows an image/motion-based animation toggling between a “Headlines” image/motion and a “Wireless” image/motion. A blender titled “Headlines on Wireless and Breaking News on Semiconductors and Email by anyone in my group related to the product specification” can have chrome (and/or a smart hourglass) that “toggles” between images/motion for “Headlines,” “News,” “Wireless,” “Semiconductors,” and “Email.”

The Presenter's query processor can enumerate all context template and information types and all categories (from the agent/blender SQML) and set up the chrome animation accordingly.

For information types, enter searches (e.g., on Corbis™ and Getty) for:

| | |
|---|---|
| Documents | Online Learning |
| Email | People |
| Books | Users |
| Magazines | Customers |
| Multimedia | |

Also, for context templates, enter searches for:

| | |
|---|---|
| Headlines | Favorites |
| News | Places |
| Discovery | Time (for “timeline” and |
| | “upcoming events”) |
| Conversations | Schedule |
| Experts | Appointment |

Also, note that semantic images/motion are preferably not completely random. However, preferably they are not from a bounded set either. Preferably, they are carefully picked and then skins can randomly select from the chosen set. But, preferably they are not random from the entire set on, for example, Corbis™ or Getty Images™. Otherwise there may be silly images, cartoons, and some potentially offensive or inappropriate images. Also, some of these guidelines preferably vary depending on whether the skin theme is in subtle, moderate, exciting, or super-exciting mode. In subtle mode, the skin might decide to choose one image/motion per visualization pivot. In other modes, this would likely lead to a boring user experience.

In low-flashiness mode, the skin can use a semantic image/motion as part of the chrome—not unlike a PowerPoint slide-deck background (e.g., alpha blended). Semantic images/motion can also be used in the smart hourglass (see below) as well as in part of the visualization (on the context bar, panel, or palette). For visualizing context and information types, semantic images/motion are preferably carefully picked to clearly indicate the information type or context. In addition, the selection mode can also be a skin property.

Also, the number of possible semantic images/motion used per skin would likely need to be capped—depending on where the images/motion are being displayed. However, in some scenarios, this might not be necessary. For instance, a blender skin might cycle between chrome backgrounds as the user navigates the blender results (from page to page or agent to agent)—to be consistent with what is currently being displayed from the blender. This can also be a skin property.

c. The Client-Side Semantic Image & Motion Cache

The Presenter has a smart expandable client-side cache with semantic images and motions that are downloaded and stored on the client (on installation). Skins can then select from these pre-cached images and motions. The images/motions can be pre-cached based on the user's favorite categories and areas of interest (which he or she selects)—which map to target industries. Skins can then complement the pre-cached semantic images/motions with on-demand image queries to an image server (an XML Web Service that exposes server-side images/motions—hosted by Nervana or a third party like Corbis™ or Getty Images™).

The Presenter will also do the smart thing and have a bias function such that recently downloaded images/motions are selected before older ones (as a tiebreaker). A “usage count” is also cached along with each image/motion—the Presenter uses this count in filtering which images/motions to display and when. Such “load balancing” will yield a fresher and non-repetitive user experience.

The cache is preferably populated on demand (based on the user's semantic queries)—for instance, there is no point in pre-caching pharmaceutical images/motions for a user's machine at Boeing. Preferably, he cache size is also capped and the image cache manager preferably purges “old” and “unused” images using an LRU algorithm or the equivalent. This way, the cache can be in “semantic sync” with the user's agent usage pattern and favorite agent's list.

2. The Smart Hourglass

A majority of the calls that the Nervana Presenter will make to provide the “semantic user experience” probably will be remote calls to the XML Web Service. As such, there will be unpredictable, potentially unbounded delays in the UI. One can expect a fair amount of bandwidth and server horsepower within the enterprise but the Nervana user interface must still “plan” for unknown latency in method invocations.

Operating systems today have this problem with unbounded I/O calls to disk or to the network. Some CPU-bound operations also have substantial delays. In the Windows™ and Mac™ UI, the user is made to perceive delay via a “wait” cursor—usually in the shape of an “hourglass.”

In the preferred embodiment, the Presenter will have semantic hints (via direct access to the SQML “method call”) with which it can display the equivalent of a “smart or semantic hourglass.” This could be in the form of an intermediate page that displays “Loading” or some other effect. Additionally, the Presenter can convey the semantics of the query by reading the SQML to get hints on the categories that the query represents and the information type or context template. The Presenter can then use these hints to display semantic images and text consistent with the query, even though it has not received the results. The more hints the query has, the smarter the hourglass can get. The “Loading” page can then convey the atmosphere of “what is to come”—even before the actual results arrive from the Web service and are merged (if necessary) by the Presenter to yield the final results.

This “smart hourglass” can be displayed not just on the main results pane, but perhaps also on smart lens balloon popup windows and inline preview windows (essentially at every call site to the Web service and where there is “focus”). The Presenter can do the smart thing by timing out on the query (perhaps after several hundred milliseconds—the implementation should use usability tests to arrive at a figure for this) before displaying the “hourglass.”

3. Visualizations—Context Templates

### Introduction

Context templates are scenario driven information query templates that map to specific semantic models for information access and retrieval. Essentially, context templates can be thought of as personal, digital semantic information retrieval “channels” that deliver information to a user by employing a predefined semantic template. Context templates preferably aggregate information across one or more Agencies.

The context templates described below have been defined. Additional context templates, directed towards the integration and dissemination of varied types of semantic information, are contemplated (examples include context templates related to emotion, e.g., “Angry,” “Sad,” etc.; context templates for location, mobility, ambient conditions, users tasks, etc.).

### Breaking News

The Breaking News context template can be analogized to a personal, digital version of CNN's “Breaking News” program insert in how it conveys semantic information. The context template allows a user to access information that is extremely time-critical from one or more Agencies, sorted according to the information creation or publishing time and a configurable amount of time that defines information criticality.

FIG. 102 is an illustration of a semantically appropriate image visualization for the Breaking News context template.

### Breaking News—Sample Object and Context Bar Visualizations

Below is a list of sample or representative elements of visualizations appropriate to the Breaking News context. As with all Visualizations (or components thereof) in the preferred embodiment, the “mood” or semantic feeling or connotation will be appropriate to the specific context. By way of very rough analogy, the Visualization will be appropriate to the context within the application in the same way that a “set” must be appropriate to the particular scene in a screenplay for a movie. This will be true not only for this particular Object and Context Bar Visualization, but for all Visualizations in the preferred embodiment.

1. Ticking clock showing publication or scheduled time of most recent or pending breaking news item over a background of the total number of upcoming breaking news items

2. Ticking clock showing publication or scheduled time of most recent or pending breaking news item over semantic image(s)

3. Ticking clock showing publication or scheduled time of most recent or pending breaking news item over semantic image(s) and the total number of breaking news items

4. Ticking clock showing publication or scheduled time of most recent or pending breaking news item over a plain background

5. Non-ticking clocks showing publication or scheduled time of all breaking news items (sequentially) over various backgrounds

6. Calendar view showing publication or scheduled time of most recent or pending breaking news item over various backgrounds

7. Calendar view showing publication or scheduled time of all breaking news items (sequentially) over various backgrounds

8. Scaled font size—depending on the publication or scheduled time of the most recent or pending breaking news item

9. Scaled font size—depending on the number of breaking news items

10. Animated font (e.g., flashing text, rotating text, text on motion path, etc.) with animation rate depending on the publication or scheduled time of the most recent or pending breaking news item

11. Animated font (e.g., flashing text, rotating text, text on motion path, etc.) with animation rate depending on the number of breaking news items

12. Varying font color—depending on the publication or scheduled time of the most recent or pending breaking news item

13. Varying font color—depending on the number of breaking news items

14. Animated graphic of breaking news semantic image(s) or an equivalent

15. Number of breaking news items

16. Titles of breaking news items animated in a sequence (list view)

17. Titles and details of breaking news items animated in a sequence (tiled view)

18. Semantic image/motion moving on an orbital motion path around the object

19. Balloon popup showing number of items on semantic image/motion background

20. Balloon popup showing number of items with plain background but animated with semantic image/motion

### Headlines

The Headlines context template can be analogized to a personal, digital version of CNN's “Headline News” program in how it conveys semantic information. The context template allows a user to access information headlines from one or more Agencies, sorted according to the information creation or publishing time and a configurable amount of time or number of items that defines information “freshness.” For example, CNN's “Headline News” displays headlines every 30 minutes (around the clock). In a preferred embodiment, the Headlines context template will be implemented as a SQL query on the server with the following sub queries chained in sequence: Recommendations Published Today, Favorites Published Today, Best Bets Published Today, Upcoming Events Occurring Today and Tomorrow, Annotated Items Published Today.

Preferably, all sub queries will be sorted by the publishing date/time and then be chained together. Additional filters will be applied to the query based on the predicate list in the SQML. The foregoing principles are illustrated in FIG. 103, which is a Headlines Visualization—Sample Image for smart hourglass, interstitial page, transition effects, background chrome, etc.

### Conversations Context Template

The Conversations context template can be analogized to a personal, digital version of CNN's “Crossfire” program in how it conveys semantic information. Like “Crossfire,” which uses Conversations and debates as the context for information dissemination, in the preferred embodiment, the Conversations context template tracks email postings, annotations, and threads for relevant information.

The Conversations context template comprises the following information object types:

1. Email of a thread depth of at least one (An email reply to an email message)

2. Annotations of a thread depth of at least one (The annotation of an annotation of an object)

3. Internet News Postings (A news posting reply to a news posting)

The query will be sorted by thread depth. Additional filters will be applied to the query based on the predicate list in the SQML. In addition, the context skin should display the information items by thread.

FIG. 104 is a Visualization—Sample Image for smart hourglass, interstitial page, transition effects, background chrome, etc. (Two People working at a desk)

### Conversations Context—Sample Object and Context Bar Visualizations

Below is a list of considerations for, or characteristics of visualization elements semantically appropriate to the corresponding indicated context (in parentheses).

1. Animated graphic of semantic image/motion(s) (icon and context guide view)

2. Maximum thread depth over plain background (icon and context guide view)

3 Maximum thread depth over semantic image/motion (icon and context guide view)

4. Titles of conversations animated in a sequence (list view)

5. Titles and details of conversations animated in a sequence (tiled view)

6. The number of conversations over a plain background (icon and context guide view)

7. The number of conversations over semantic image/motion(s) (icon and context guide view)

Newsmakers Context Template

The Newsmakers context template can be analogized to a personal, digital version of NBC's “Meet the Press” program in how it conveys semantic information. In this case, the emphasis is on “people in the news,” as opposed to the news itself or Conversations. Users navigate the network using the returned people as Information Object Pivots. The Newsmakers context template can be thought of as the Headlines context template, preferably with the “People” or “Users” object type filters, and the “authored by,” “possibly authored by,” “hosted by,” “annotated by,” “expert on,” etc. predicates (predicates that relate people to information). The “relevant to” default predicate preferably is used to cover all the germane specific predicates. The sort order of the relevant information, e.g., the newsmakers, is sorted based on the order of the “news they make,” e.g., headlines.

The query will be sorted by number of headlines. Additional filters will be applied to the query based on the predicate list in the SQML.

FIG. 105 illustrates a semantic “Newsmaker” Visualization or Sample Image for smart hourglass, interstitial page, transition effects, background chrome, etc. (Football Championship)

### Newsmakers—Sample Object and Context Bar Visualizations

1. Animated graphic of 2 talking heads in conversation (icon and context guide view)

2. Animated graphic of semantic image/motion(s) (icon and context guide view)

3. Total number of newsmakers (icon and context guide view)

4. Total number of newsmakers over semantic image/motion (icon and context guide view)

5. Names of newsmakers animated in a sequence (list view)

6. Names and details of newsmakers animated in a sequence (tiled view)

Upcoming Events Context Template

The Upcoming Events context template (and its resulting Special Agent) can be analogized to a personal digital version of special programs that convey information about upcoming events. Examples include specials for events such as “The World Series,” “The NBA Finals,” “The Soccer World Cup Finals,” etc. The equivalent in a knowledge-worker scenario is a user that wants to monitor all upcoming industry events that relate to one or more categories, documents or other Information Object Pivots. The Upcoming Events context template is preferably identical to the Headlines context template except that only upcoming events are filtered and displayed (preferably using a semantically appropriate “context Skin” that connotes events and time criticality). Returned objects are preferably sorted based on time criticality with the most impending events listed first.

FIG. 106 illustrates a semantic “Upcoming Events” Visualization—Sample Image for smart hourglass, interstitial page, transition effects, background chrome, etc. (Appointment Binder).

### Upcoming Events—Sample Object and Context Bar Visualizations

1. Ticking clock showing time till next event over a background of the total number of upcoming events (icon and context guide view)

2. Ticking clock showing time till next event over semantic image/motion(s) (icon and context guide view)

3. Ticking clock showing time till next event over semantic image/motion(s) and the total number of upcoming events (icon and context guide view)

4. Ticking clock showing time till next event over a plain background (icon and context guide view)

5. Non-ticking clocks showing time till all upcoming events (sequentially) over various backgrounds (icon and context guide view)

6. Calendar view showing scheduled time of next upcoming event over various backgrounds (icon and context guide view)

7. Calendar view showing scheduled time of all upcoming events (sequentially) over various backgrounds (icon and context guide view)

8. Animated graphic showing calendar motion (icon and context guide view)

9. Animated graphic of semantic image/motion(s) (e.g., schedule book) (icon and context guide view)

10. The total number of upcoming events over semantic image/motion(s) (icon and context guide view)

11. The total number of upcoming events over a plain background (icon and context guide view)

12. Titles of upcoming events animated in a sequence (list view)

13. Titles and details of upcoming events animated in a sequence (tiled view)

Discovery

The Discovery context template can be analogized to a personal, digital version of the “Discovery Channel.” In this case, the emphasis is on “documentaries” about particular topics. The Discovery context template simulates intelligent aggregation of information by randomly selecting information objects that relate to a given set of categories and which are posted within an optionally predetermined, configurable time period. The semantic weight as opposed to the time is the preferred consideration for determining how the information is to be ordered or presented. The context template can be implemented by filtering all information types by the semantic link strength for the categorization predicate. In this case, the filter should be less selective than the ‘Best Bets’ filter—the context template lies somewhere between ‘Best Bets’ and ‘All Items’ in terms of filtering.

FIG. 107 is a “Discovery” Visualization—Sample Image for smart hourglass, interstitial page, transition effects, background chrome, etc. (Petri Dish).

### Discovery—Sample Object and Context Bar Visualizations

1. Animated graphic of semantic image/motion(s) (e.g., a telescope, a voyager spacecraft, an old ship at sea) (icon and context guide view)

2. Titles of the first N information items in a sequential animation (list view)

3. Titles and details of the first N information items in a sequential animation (tiled view)

4. The total number of items over semantic image/motion(s) (icon and context guide view)

5. The total number of items (icon and context guide view)

History

The History context template can be analogized to a personal, digital version of the “History Channel.” In this case, the emphasis is on disseminating information not just about particular topics, but also with a historical context. For this template, the preferred axes are category and time. The History context template is similar to the Discovery context template, further in concert with “a minimum age limit.” The parameters are preferably the same as that of the Discovery context template, except that the “maximum age limit” parameter is replaced with a “minimum age limit” parameter (or an optional “history time span” parameter). In addition, returned objects are preferably sorted in reverse or random order based on their age in the system or their age since creation.

FIG. 108 illustrates a semantic “History” Visualization—Sample Image for smart hourglass, interstitial page, transition effects, background chrome, etc. (War Memorial).

### History—Sample Object and Context Bar Animations Visualizations

1. Animated graphic of semantic image/motion(s) or an equivalent

2. Titles of the oldest (or random) N information items in a sequential animation (list view)

3. Titles and details of the oldest (or random) N information items in a sequential animation (tiled view)

4. Total number of items over semantic image/motion(s) (icon and context guide view)

5. Total number of items over plain background (icon and context guide view)

All Items

The All Items context template represents context that returns any information that is relevant based on either semantics or based on a keyword or text based search. In this case, the emphasis is on disseminating information that may be even remotely relevant to the context. The primary axis for the All Items context template is preferably the mere possibility of relevance. In the preferred embodiment, the All Items context template employs both a semantic and text-based query in order to return the broadest possible set or universe of results that may be relevant.

FIG. 109 illustrates a semantic Visualization—Sample Image for smart hourglass, interstitial page, transition effects, background chrome, etc. (Outer Space).

### All Items—Visualization & Sample Object and Context Bar Animations

1. Animated graphic of semantic image/motion(s) or an equivalent

2. Titles of the most recent N information items in a sequential animation (list view)

3. Titles and details of the most recent N information items in a sequential animation (tiled view)

4. Total number of items over semantic image/motion(s) (icon and context guide view)

5 Total number of items over plain background (icon and context guide view)

Best Bets

The Best Bets context template (and its resulting Special Agent) represents context that returns only highly relevant information. In a preferred embodiment, the emphasis is on disseminating information that is deemed to be highly relevant and semantically significant. For this context template, the primary axis is relevance. In essence, the Best Bets context template employs a semantic query and will not use text based queries since it cannot guarantee the relevance of text-based query results. The Best Bets context template is preferably initialized with a category filter or keywords. If keywords are specified, the server performs categorization dynamically. Results are preferably sorted based on the relevance score, or the strength of the “belongs to category” semantic link from the object to the category filter.

FIG. 110 illustrates a “Best Bets” Visualization—Sample Image for smart hourglass, interstitial page, transition effects, background chrome, etc. (Microscope).

### Best Bet Visualization—Sample Object and Context Bar Animations

1. Animated graphic of semantic image/motion(s) or an equivalent

2. Titles of the most recent N information items in a sequential animation (list view)

3. Titles and details of the most recent N information items in a sequential animation (tiled view)

4. Total number of items over semantic image/motion(s) (icon and context guide view)

5. Total number of items over plain background (icon and context guide view)

### Favorites

The Favorites context template (and its resulting Special Agent) represents context that returns “favorite” or “popular” information. In this case, the emphasis is on disseminating information that has been endorsed by others and has been favorably accepted. In the preferred embodiment, the axes for the Favorites context template include the level of readership interest, the “reviews” the object received, and the depth of the annotation thread on the object. In one embodiment, the Favorites context template returns only information that has the “favorites” semantic link, and is sorted by counting the number of “votes” for the object (based on this semantic link).

FIG. 111 illustrates a semantic Visualization—Sample Image for smart hourglass, interstitial page, transition effects, background chrome, etc. (coffee and pastry).

### Favorites Visualization—Sample Object and Context Bar Animations

1. Animated graphic of semantic image/motion(s) or an equivalent

2. Titles of the most recent N information items in a sequential animation (list view)

3. Titles and details of the most recent N information items in a sequential animation (tiled view)

4. Total number of items over semantic image/motion(s) (icon and context guide view)

5. Total number of items over plain background (icon and context guide view)

### Classics

The Classics context template (and its resulting Special Agent) represents context that returns “classical” information, or information that is of recognized value. Like the Favorites context template, the emphasis is on disseminating information that has been endorsed by others and has been favorably accepted. For this context template, the preferred axes include a historical context, the level of readership interest, the “reviews” the object received and the depth of the annotation thread on the object. The Classics context template is preferably implemented based on the Favorites context template but with an additional minimum age limit filter and voting score, essentially functioning as an “Old Favorites” context template.

FIG. 112 illustrates a semantically appropriate Sample Image for “Classics” for smart hourglass, interstitial page, transition effects, background chrome, etc. (Car)

### Classics Visualizations—Sample Object and Context Bar Animations

1. Animated graphic of semantic image/motion(s) or an equivalent

2. Titles of the most recent N information items in a sequential animation (list view)

3. Titles and details of the most recent N information items in a sequential animation (tiled view)

4. Total number of items over semantic image/motion(s) (icon and context guide view)

5 Total number of items over plain background (icon and context guide view)

### Recommendations

The Recommendations context template represents context that returns “recommended” information, or information that the Agencies have inferred would be of interest to a user. Recommendations will be inserted by adding “recommendation” semantic links to the “SemanticLinks” table and by mining the favorite semantic links that users indicate. Recommendations are preferably made using techniques such as machine learning and collaborative filtering. The emphasis of this context template is on disseminating information that would likely be of interest to the user but which the user might not have already seen. For this context template, the primary axes preferably include the likelihood of interest and freshness.

FIG. 113 illustrates a semantically appropriate “Recommendation” Visualization—Sample Image for the contextual/application elements of smart hourglass, interstitial page, transition effects, background chrome, etc. (Thumbs up).

### Recommendation Visualization—Sample Object and Context Bar Animations

1. Animated graphic of semantic image/motion(s) or an equivalent

2. Titles of the most recent N information items in a sequential animation (list view)

3. Titles and details of the most recent N information items in a sequential animation (tiled view)

4. Total number of items over semantic image/motion(s) (icon and context guide view)

5. Total number of items over plain background (icon and context guide view)

### Today

The Today context template represents context that returns information posted or holding (in the case of events) “today.” The emphasis with this context template is preferably on disseminating information that is deemed to be current based on “today” being the filter to determine freshness.

FIG. 114 illustrates a semantic “Today” Visualization—Sample Image for the elements smart hourglass, interstitial page, transition effects, background chrome, etc.

### “Today Visualization”—Sample Object and Context Bar Animations

1. Animated graphic of semantic image/motion(s) or an equivalent

2. Titles of the most recent N information items in a sequential animation (list view)

3. Titles and details of the most recent N information items in a sequential animation (tiled view)

4. Total number of items over semantic image/motion(s) (icon and context guide view)

5. Total number of items over plain background (icon and context guide view)

### Annotated Items

The Annotated Items context template represents context that returns annotated information. The emphasis with this context template is on disseminating information that is likely to be important based on the fact that one or more users have annotated the items.

FIG. 115 illustrates a semantic “Annotated Items” Visualization—Sample Image for smart hourglass, interstitial page, transition effects, background chrome, etc.

### “Annotated Items” Visualization—Sample Object and Context Bar Animations

1. Animated graphic of semantic image/motion(s) or an equivalent

2. Titles of the most recent N information items in a sequential animation (list view)

3. Titles and details of the most recent N information items in a sequential animation (tiled view)

4. Total number of items over semantic image/motion(s) (icon and context guide view)

5. Total number of items over plain background (icon and context guide view)

### Annotations

The Annotations context template represents context that returns annotated information. The emphasis with this context template is on disseminating information that are annotations.

FIG. 116 illustrates a semantic Visualization—Sample Image for smart hourglass, interstitial page, transition effects, background chrome, etc. (Note pinned to Bulletin Board)

### “Annotations” Visualization—Sample Object and Context Bar Animations

1. Animated graphic of semantic image/motion(s) or an equivalent

2. Titles of the most recent N information items in a sequential animation (list view)

3. Titles and details of the most recent N information items in a sequential animation (tiled view)

4. Total number of items over semantic image/motion(s) (icon and context guide view)

5. Total number of items over plain background (icon and context guide view)

### Experts

FIG. 117 illustrates a semantic “Experts” Visualization—Sample Image for smart hourglass, interstitial page, transition effects, background chrome, etc. (Professor)

### “Experts” Visualization—Sample Object and Context Bar Animations

1. Animated graphic of semantic image/motion(s) or an equivalent

2. Names of the most recent N experts in a sequential animation (list view)

3. Names and details of the most recent N experts in a sequential animation (tiled view)

4. Total number of experts over semantic image/motion(s) (icon and context guide view)

5. Total number of experts over plain background (icon and context guide view)

### Places

FIG. 118 illustrates a semantic “Places” Visualization—Sample Image for smart hourglass, interstitial page, transition effects, background chrome, etc. (Paris)

### “Places” Visualization—Sample Object and Context Bar Animations

1. Animated graphic of semantic image/motion(s) or an equivalent

2. Names of the most recent N places in a sequential animation (list view)

3. Names and details of the most recent N places in a sequential animation (tiled view)

4. Total number of places over semantic image/motion(s) (icon and context guide view)

6. Total number of places over plain background (icon and context guide view)

### Blenders

FIG. 119 illustrates a semantic “Blenders” Visualization—Sample Image for smart hourglass, interstitial page, transition effects, background chrome, etc. (Blenders)

### “Blenders” Visualization—Sample Iconic Animations

1. Animated graphic of semantic image/motion(s) or an equivalent

2. Animated graphic of blender or mixer in action

3. Titles of the blender items in a sequential animation (list view)

4. Titles and details of the blender items in a sequential animation (tiled view)

5. Total number of items over semantic image/motion(s) (icon and context guide view)

6. Total number of items over plain background (icon and context guide view)

### Information Object Types

FIGS. 120 through 138 illustrate semantic Visualizations for the following Information Object Types, respectively: Documents, Books, Magazines, Presentations, Resumes, Spreadsheets, Text, Web pages, White Papers, Email, Email Annotations, Email Distribution Lists, Events, Meetings, Multimedia, Online Courses, People, Customers, and Users.

### Presentation Skin Types

### Timeline

FIG. 139 illustrates a semantic “Timeline” Visualization—Sample Image for smart hourglass, interstitial page, transition effects, background chrome, etc.

### “Timeline” Visualization—Sample Object and Context Bar Animations

1. Calendar view showing effective time (publication time, scheduled time, etc.) of information item over various backgrounds (icon and context guide view)

2. Calendar view showing effective time of all information items (sequentially) over various backgrounds (icon and context guide view)

3. Animated graphic showing calendar motion (icon and context guide view)

4. Animated graphic of semantic image/motion(s) (e.g., time warp image/motion) (icon and context guide view)

5. The total number of information items over semantic image/motion(s) (icon and context guide view)

6. The total number of information items over a plain background (icon and context guide view)

7. Titles of information items animated in a sequence (list view)

8. Titles and details of information items animated in a sequence (tiled view)

9. Scrolling, linear timeline control with items populated based on effective date/time

10. Animated timeline ticker control sorted by effective date/time

The Power of Semantic Visualizations.

One final note concerning Visualizations. The preferred embodiment not only searches for information semantically, and not only organizes and stores it semantically, it also presents it semantically. And, the presentation is not semantic only in the sequence, organization and relationships of the information, but also visually, as the foregoing Visualizations are, in part, intended to convey. As a result, the user is aided in understanding the information being presented by the system in roughly in the same way that a viewer of a movie is aided in understanding the meaning of dialogue by the surrounding context of the lighting, costume, music and entire set or scene. Put differently, the Visualizations, as with everything else presented or managed by, or located with, the preferred embodiment system, serve the purpose of conveying meaningful information; or, just as aptly, to convey information meaningfully. Meaning is a unifying theme of the preferred embodiment; it permeates the design and operation of the system, and each constituent component part of which the system is comprised.

While the preferred and some alternate embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for knowledge retrieval, management, delivery and presentation, comprising:
a server programmable to maintain semantic information;
a client providing a user interface for a user to communicate with the server; and
wherein the processor of the server operates to perform the steps of:
securing information from information sources;
semantic ascertaining one or more semantic properties of the information; and
responding to user queries based upon one or more of the semantic properties.

2. The system of claim 1, wherein the first server further comprises structure or methodology directed to providing at least one of the following: a Semantic Network, a Semantic Data Gatherer, a Semantic Network Consistency Checker, an Inference Engine, a Semantic Query Processor, a Natural Language Parser, an Email Knowledge Agent, or a Knowledge Domain Manager.

3. The system of claim 1, wherein:
the information comprises objects or events; and
the semantic properties of the objects or events are represented by active agents for semantically linking to the semantics and properties of the queries.

4. A method for knowledge retrieval, management, delivery and presentation for use with a server system programmed to add, maintain and host domain specific information that is used to classify and categorize semantic information, comprising:
securing information from information sources;
semantically linking the information from the information sources;
maintaining the semantic attributes of the semantically linked information;
delivering requested semantic information based upon user queries; and
presenting semantic information according to customizable user preferences.
